(19) United States
(12) Patent Application Publication
(10) Pub. No.: US 2026/0281368 A1
(43) Pub. Date: Sep. 17, 2026

(54) METHOD FOR IMAGE ENCODING/DECODING AND RECORDING MEDIUM STORING BITSTREAM

(71) Applicant: ELECTRONICS AND TELECOMMUNICATIONS RESEARCH INSTITUTE, Daejeon (KR)

(72) Inventors: Woong LIM, Daejeon (KR); Dong Hyun KIM, Daejeon (KR); Jong Ho KIM, Daejeon (KR); Sung Chang LIM, Daejeon (KR); Jin Soo CHOI, Daejeon (KR); Jung Won KANG, Daejeon (KR)

(21) Appl. No.: 19/163,803

(22) PCT Filed: Apr. 11, 2024
(86) PCT No.: PCT/KR2024/004872

§ 371 Date: Sep. 9, 2025

(30) Foreign Application Priority Data
Apr. 12, 2023 (KR) 10-2023-0048446
Jul. 3, 2023 (KR) 10-2023-0086129

(51) Int. Cl. H04N 19/137; H04N 19/105; H04N 19/176; H04N 19/70

(52) U.S. Cl. CPC H04N 19/137; H04N 19/105; H04N 19/176; H04N 19/70

(57) ABSTRACT

A method for decoding an image according to the present disclosure may include the steps of: configuring a block vector candidate list of a current block; deriving a block vector of the current block on the basis of the block vector candidate list; and deriving a prediction block of the current block on the basis of the block vector. Here, the block vector may be obtained by improving a prediction block vector derived from a block vector candidate included in the block vector candidate list.

### TECHNICAL FIELD

The present disclosure relates to a method, a device and a recording medium for image encoding/decoding.

### BACKGROUND ART

With the continuous development of the information and communication industries, broadcasting services supporting High-Definition (HD) resolution have been popularized all over the world. Through this popularization, a large number of users have become accustomed to high-resolution and high-definition images and/or video.

To satisfy users' demand for high definition, many institutions have accelerated the development of next-generation imaging devices. Users' interest in UHD TVs, having resolution that is more than four times as high as that of Full HD (FHD) TVs, as well as High-Definition TVs (HDTV) and FHD TVs, has increased. As interest therein has increased, image encoding/decoding technology for images having higher resolution and higher definition is currently required.

As image compression technology, there are various technologies, such as inter-prediction technology, intra-prediction technology, transform, quantization technology, filtering technology and entropy coding technology.

Inter-prediction technology is technology for predicting the value of a pixel included in a current picture using a picture previous to and/or a picture subsequent to the current picture. Intra-prediction technology is technology for predicting the value of a pixel included in a current picture using information about pixels in the current picture. Transform and quantization technology may be technology for compressing the energy of a residual signal. The entropy coding technology is technology for assigning a short codeword to a frequently occurring value and assigning a long codeword to a less frequently occurring value.

By utilizing this image compression technology, data about images may be effectively compressed, transmitted, and stored.

### DISCLOSURE

### Technical Problem

The present disclosure is to provide an encoding/decoding method, device and recording medium for improving a block vector of a current block.

The present disclosure is to provide an encoding/decoding method, device and recording medium for improving a block vector based on template matching on a decoder side.

The present disclosure is to provide an encoding/decoding method, device and recording medium for determining an offset vector for improving a block vector by using simplified index information.

The present disclosure is to provide an encoding/decoding method, device and recording medium for variably setting the resolution of a block vector.

### Technical Solution

A method for decoding an image according to the present disclosure may include configuring a block vector candidate list of a current block; deriving a block vector of the current block based on the block vector candidate list; and deriving a prediction block of the current block based on the block vector. In this case, the block vector may be obtained by improving a prediction block vector derived from a block vector candidate included in the block vector candidate list.

A method for encoding an image according to the present disclosure may include configuring a block vector candidate list of a current block; deriving a block vector of the current block based on the block vector candidate list; and deriving a prediction block of the current block based on the block vector. In this case, the block vector may be obtained by improving a prediction block vector derived from a block vector candidate included in the block vector candidate list.

In an image encoding/decoding method according to the present disclosure, the block vector may be obtained by searching for a reference template having the lowest template matching cost and a current template adjacent to the current block in a search range including a search start position indicated by the prediction block vector in a current picture.

In an image encoding/decoding method according to the present disclosure, a shape of the search range is determined based on index information indicating one of shape candidates, and a first shape candidate among the shape candidates may be a rectangular shape and a second shape candidate may be a rhombus shape.

In an image encoding/decoding method according to the present disclosure, when at least a part of a region to be set as the search range overlaps with the current block, a residual region excluding a region overlapping with the current block may be set as the search range. In an image encoding/decoding method according to the present disclosure, searching for a reference template having the lowest matching cost may include searching for a template matching cost for first candidate positions spaced apart by a first pixel from the search start position.

In an image encoding/decoding method according to the present disclosure, searching for a reference template having the lowest matching cost may further include searching for a template matching cost for second candidate positions spaced apart by a second pixel from a first candidate position having the smallest template matching cost among the first candidate positions. In this case, the second pixel may be smaller than a first pixel.

In an image encoding/decoding method according to the present disclosure, a size of the first pixel may be adaptively determined according to block vector resolution of the current block.

In an image encoding/decoding method according to the present disclosure, the block vector resolution is selected among a plurality of block vector resolution candidates, and a first block vector resolution candidate among the plurality of block vector resolution candidates may be a fractional pixel unit and a second block vector resolution candidate may be an integer pixel unit.

In an image encoding/decoding method according to the present disclosure, a size of the first pixel may have a value equal to or greater than a pixel unit indicated by the block vector resolution.

In an image encoding/decoding method according to the present disclosure, the block vector may be derived by adding an offset vector to the prediction block vector in a current picture, and the offset vector may be derived based on a size index indicating one of the size candidates of the offset vector and a direction index indicating one of the direction candidates of the offset vector.

In the present disclosure, a recording medium for recording a bitstream generated by the image encoding method may be provided.

### Technical Effect

According to the present disclosure, an encoding/decoding method, device and recording medium for improving a block vector of a current block may be provided.

According to the present disclosure, an encoding/decoding method, device and recording medium for improving a block vector based on template matching on a decoder side may be provided.

According to the present disclosure, an encoding/decoding method, device and recording medium for determining an offset vector for improving a block vector by using simplified index information may be provided.

According to the present disclosure, an encoding/decoding method, device and recording medium for variably setting the resolution of a block vector may be provided.

### BRIEF DESCRIPTION OF DRAWINGS

FIG. 1 is a block diagram illustrating the configuration of an embodiment of an encoding apparatus to which the present disclosure is applied.

FIG. 2 is a block diagram illustrating the configuration of an embodiment of a decoding apparatus to which the present disclosure is applied.

FIG. 3 is a diagram schematically illustrating the partition structure of an image when the image is encoded and decoded.

FIG. 4 is a diagram illustrating the form of a Prediction Unit (PU) that a Coding Unit (CU) can include.

FIG. 5 is a diagram illustrating the form of a Transform Unit (TU) that can be included in a CU.

FIG. 6 illustrates splitting of a block according to an example.

FIG. 7 is a diagram for explaining an embodiment of an intra-prediction procedure.

FIG. 8 is a diagram illustrating reference samples used in an intra-prediction procedure.

FIG. 9 is a diagram for explaining an embodiment of an inter-prediction procedure.

FIG. 10 illustrates spatial candidates according to an embodiment.

FIG. 11 illustrates the order of addition of motion information of spatial candidates to a merge list according to an embodiment.

FIG. 12 illustrates a transform and quantization process according to an example.

FIG. 13 illustrates diagonal scanning according to an example.

FIG. 14 illustrates horizontal scanning according to an example.

FIG. 15 illustrates vertical scanning according to an example.

FIG. 16 is a configuration diagram of an encoding apparatus according to an embodiment.

FIG. 17 is a configuration diagram of a decoding apparatus according to an embodiment.

FIG. 18 shows an example in which a reference block is determined based on a block vector of a current block.

FIG. 19 is a flowchart of a method for encoding a current block under an intra block copy mode.

FIG. 20 is a flowchart of a method for decoding a current block under an intra block copy mode.

FIGS. 21 to 23 shows an example in which a pair-wise average block vector candidate is added to a block vector candidate list.

FIG. 24 shows an example in which a block vector candidate list derived based on an upper block is shared with lower blocks.

FIG. 25 is an example for describing a block vector candidate that is unavailable to a lower block.

FIG. 26 shows a configuration example of a set including integer sample unit candidates.

FIG. 27 illustrates the shape of a template region.

FIG. 28 shows an example in which a reconstructed region not included in a current CTU is excluded from a template region.

FIG. 29 illustrates various shapes of template derived from the template region of a current block.

FIG. 30 shows an example in which a template is configured by sub-sampling a template region.

FIGS. 31 to 34 show an example in which a search start position is set.

FIGS. 35 to 42 is a diagram for describing a template search range.

FIG. 43 is a diagram for describing an example of a process for performing a template matching search within a template matching search range.

FIG. 44 shows an example in which a different weight is applied for each line within a template.

FIG. 45 shows an example in which a temporal prediction block vector is derived.

FIG. 46 shows an example in which a sub-block-based block vector prediction method is applied.

FIG. 47 is a diagram for describing an example in which the range of a block vector is restricted.

FIG. 48 is a diagram for describing the position of a reference block.

FIG. 49 is a drawing for describing a reference region buffer.

FIG. 50 shows an example in which a coordinate is set based on the center position of a reference region.

FIG. 51 shows a configuration example of a reference region buffer.

FIGS. 52 to 55 show an aspect in which a reference region buffer is updated as a CTB is encoded/decoded.

FIG. 56 shows an example in which a block vector is derived for each sub-block after a current chroma block is partitioned into a plurality of sub-blocks.

FIG. 57 illustrates a sample at a predefined position.

FIG. 58 is to describe an example in which a reference block indicated by a block vector is set as a prediction block.

FIGS. 59 and 60 are a drawing for describing an embodiment in which the residual block of a current chroma component block is derived.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component. The terms “and/or” may include combinations of a plurality of related described items or any of a plurality of related described items.

It will be understood that when a component is referred to as being “connected” or “coupled” to another component, the two components may be directly connected or coupled to each other, or intervening components may be present between the two components. On the other hand, it will be understood that when a component is referred to as being “directly connected or coupled”, no intervening components are present between the two components.

Also, components described in the embodiments are independently shown in order to indicate different characteristic functions, but this does not mean that each of the components is formed of a separate piece of hardware or software. That is, the components are arranged and included separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

The terms used in the embodiment are merely used to describe specific embodiments and are not intended to limit the present invention. A singular expression includes a plural expression unless a description to the contrary is specifically pointed out in context. In the embodiments, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present invention or the technical spirit of the present invention, but does not preclude the presence of components other than the specific component.

In the embodiments, a term “at least one” may mean one of one or more numbers, such as 1, 2, 3, and 4. In the embodiments, a term “a plurality of” may mean one of two or more numbers, such as 2, 3 and 4.

Some components of the embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted. Further, the same reference numerals are used to designate the same components throughout the drawings, and repeated descriptions of the same components will be omitted.

Hereinafter, “image” may mean a single picture constituting a video, or may mean the video itself. For example, “encoding and/or decoding of an image” may mean “encoding and/or decoding of a video”, and may also mean “encoding and/or decoding of any one of images constituting the video”.

Hereinafter, the terms “video” and “motion picture” may be used to have the same meaning, and may be used interchangeably with each other.

Hereinafter, a target image may be an encoding target image, which is the target to be encoded, and/or a decoding target image, which is the target to be decoded. Further, the target image may be an input image that is input to an encoding apparatus or an input image that is input to a decoding apparatus. And, a target image may be a current image, that is, the target to be currently encoded and/or decoded. For example, the terms “target image” and “current image” may be used to have the same meaning, and may be used interchangeably with each other.

Hereinafter, the terms “image”, “picture”, “frame”, and “screen” may be used to have the same meaning and may be used interchangeably with each other.

Hereinafter, a target block may be an encoding target block, i.e. the target to be encoded and/or a decoding target block, i.e. the target to be decoded. Further, the target block may be a current block, i.e. the target to be currently encoded and/or decoded. Here, the terms “target block” and “current block” may be used to have the same meaning, and may be used interchangeably with each other. A current block may denote an encoding target block, which is the target of encoding, during encoding and/or a decoding target block, which is the target of decoding, during decoding. Also, the current block may be at least one of a coding block, a prediction block, a residual block, and a transform block.

Hereinafter, the terms “block” and “unit” may be used to have the same meaning, and may be used interchangeably with each other. Alternatively, “block” may denote a specific unit.

Hereinafter, the terms “region” and “segment” may be used interchangeably with each other.

In the following embodiments, specific information, data, a flag, an index, an element, and an attribute may have their respective values. A value of “0” corresponding to each of the information, data, flag, index, element, and attribute may indicate a false, a logical false or a first predefined value. In other words, the value of “0”, a false, logical false, and a first predefined value may be used interchangeably with each other. A value of “1” corresponding to each of the information, data, flag, index, element, and attribute may indicate a true, a logical true or a second predefined value. In other words, the value of “1”, true, logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

In embodiments, the term “one or more” or the term “at least one” may mean the term “plural”. The term “one or more” or the term “at least one” may be used interchangeably with “plural”.

Below, the terms to be used in embodiments will be described.

Encoder: An encoder denotes a device for performing encoding. That is, an encoder may mean an encoding apparatus.

Decoder: A decoder denotes a device for performing decoding. That is, a decoder may mean a decoding apparatus.

Unit: A unit may denote the unit of image encoding and decoding. The terms “unit” and “block” may be used to have the same meaning, and may be used interchangeably with each other.
A unit may be an M×N array of samples. Each of M and N may be a positive integer. A unit may typically mean an array of samples in the form of two-dimensions.
In the encoding and decoding of an image, “unit” may be an area generated by the partitioning of one image. In other words, “unit” may be a region specified in one image. A single image may be partitioned into multiple units. Alternatively, one image may be partitioned into sub-parts, and the unit may denote each partitioned sub-part when encoding or decoding is performed on the partitioned sub-part.
In the encoding and decoding of an image, predefined processing may be performed on each unit depending on the type of the unit.
Depending on functions, the unit types may be classified into a macro unit, a Coding Unit (CU), a Prediction Unit (PU), a residual unit, a Transform Unit (TU), etc. Alternatively, depending on functions, the unit may denote a block, a macroblock, a coding tree unit, a coding tree block, a coding unit, a coding block, a prediction unit, a prediction block, a residual unit, a residual block, a transform unit, a transform block, etc. For example, a target unit, which is the target of encoding and/or decoding, may be at least one of a CU, a PU, a residual unit, and a TU.
The term “unit” may mean information including a luminance (luma) component block, a chrominance (chroma) component block corresponding thereto, and syntax elements for respective blocks so that the unit is designated to be distinguished from a block.
The size and shape of a unit may be variously implemented. Further, a unit may have any of various sizes and shapes. In particular, the shapes of the unit may include not only a square, but also a geometric figure that can be represented in two dimensions (2D), such as a rectangle, a trapezoid, a triangle, and a pentagon.
Further, unit information may include one or more of the type of a unit, the size of a unit, the depth of a unit, the order of encoding of a unit and the order of decoding of a unit, etc. For example, the type of a unit may indicate one of a CU, a PU, a residual unit and a TU.
One unit may be partitioned into sub-units, each having a smaller size than that of the relevant unit.
Depth: A depth may mean an extent to which the unit is partitioned. Further, the depth of the unit may indicate the level at which the corresponding unit is present when unit(s) are represented by a tree structure.
Unit partition information may include a depth indicating the depth of a unit. A depth may indicate the number of times the unit is partitioned and/or the degree to which the unit is partitioned.
In a tree structure, it may be considered that the depth of a root node is the smallest, and the depth of a leaf node is the largest. The root node may be the highest (top) node. The leaf node may be a lowest node.
A single unit may be hierarchically partitioned into multiple sub-units while having depth information based on a tree structure. In other words, the unit and sub-units, generated by partitioning the unit, may correspond to a node and child nodes of the node, respectively. Each of the partitioned sub-units may have a unit depth. Since the depth indicates the number of times the unit is partitioned and/or the degree to which the unit is partitioned, the partition information of the sub-units may include information about the sizes of the sub-units.
In a tree structure, the top node may correspond to the initial node before partitioning. The top node may be referred to as a “root node”. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
A QT depth may denote a depth for a quad-partitioning. A BT depth may denote a depth for a binary-partitioning. A TT depth may denote a depth for a ternary-partitioning.
Sample: A sample may be a base unit constituting a block. A sample may be represented by values from 0 to 2Bd-1 depending on the bit depth (Bd).
A sample may be a pixel or a pixel value.
Hereinafter, the terms “pixel” and “sample” may be used to have the same meaning, and may be used interchangeably with each other.

A Coding Tree Unit (CTU): A CTU may be composed of a single luma component (Y) coding tree block and two chroma component (Cb, Cr) coding tree blocks related to the luma component coding tree block. Further, a CTU may mean information including the above blocks and a syntax element for each of the blocks.
Each coding tree unit (CTU) may be partitioned using one or more partitioning methods, such as a quad tree (QT), a binary tree (BT), and a ternary tree (TT) so as to configure sub-units, such as a coding unit, a prediction unit, and a transform unit. A quad tree may mean a quarternary tree. Further, each coding tree unit may be partitioned using a multitype tree (MTT) using one or more partitioning methods.
“CTU” may be used as a term designating a pixel block, which is a processing unit in an image-decoding and encoding process, as in the case of partitioning of an input image.

Coding Tree Block (CTB): “CTB” may be used as a term designating any one of a Y coding tree block, a Cb coding tree block, and a Cr coding tree block.

Neighbor block: A neighbor block (or neighboring block) may mean a block adjacent to a target block. A neighbor block may mean a reconstructed neighbor block.
Hereinafter, the terms “neighbor block” and “adjacent block” may be used to have the same meaning and may be used interchangeably with each other.
A neighbor block may mean a reconstructed neighbor block.

Spatial neighbor block; A spatial neighbor block may a block spatially adjacent to a target block. A neighbor block may include a spatial neighbor block.
The target block and the spatial neighbor block may be included in a target picture.
The spatial neighbor block may mean a block, the boundary of which is in contact with the target block, or a block located within a predetermined distance from the target block.
The spatial neighbor block may mean a block adjacent to the vertex of the target block. Here, the block adjacent to the vertex of the target block may mean a block vertically adjacent to a neighbor block which is horizontally adjacent to the target block or a block horizontally adjacent to a neighbor block which is vertically adjacent to the target block.

Temporal neighbor block: A temporal neighbor block may be a block temporally adjacent to a target block. A neighbor block may include a temporal neighbor block.
The temporal neighbor block may include a co-located block (col block).
The col block may be a block in a previously reconstructed co-located picture (col picture). The location of the col block in the col-picture may correspond to the location of the target block in a target picture. Alternatively, the location of the col block in the col-picture may be equal to the location of the target block in the target picture. The col picture may be a picture included in a reference picture list.
The temporal neighbor block may be a block temporally adjacent to a spatial neighbor block of a target block.

Prediction mode: The prediction mode may be information indicating the mode used for intra prediction, or the mode used for inter prediction.

Prediction unit: A prediction unit may be a base unit for prediction, such as inter prediction, intra prediction, inter compensation, intra compensation, and motion compensation.

A single prediction unit may be divided into multiple partitions having smaller sizes or sub-prediction units. The multiple partitions may also be base units in the performance of prediction or compensation. The partitions generated by dividing the prediction unit may also be prediction units.

Prediction unit partition: A prediction unit partition may be the shape into which a prediction unit is divided.

Reconstructed neighbor unit: A reconstructed neighbor unit may be a unit which has already been decoded and reconstructed neighboring a target unit.
A reconstructed neighbor unit may be a unit that is spatially adjacent to the target unit or that is temporally adjacent to the target unit.
A reconstructed spatial neighbor unit may be a unit which is included in a target picture and which has already been reconstructed through encoding and/or decoding.
A reconstructed temporal neighbor unit may be a unit which is included in a reference image and which has already been reconstructed through encoding and/or decoding. The location of the reconstructed temporal neighbor unit in the reference image may be identical to that of the target unit in the target picture, or may correspond to the location of the target unit in the target picture. Also, a reconstructed temporal neighbor unit may be a block neighboring the corresponding block in a reference image. Here, the location of the corresponding block in the reference image may correspond to the location of the target block in the target image. Here, the fact that the locations of blocks correspond to each other may mean that the locations of the blocks are identical to each other, may mean that one block is included in another block, or may mean that one block occupies a specific location in another block.

Sub-picture: A picture may be divided into one or more sub-pictures. A sub-picture may be composed of one or more tile rows and one or more tile columns.
A sub-picture may be a region having a square shape or a rectangular (i.e., a non-square rectangular) shape in a picture. Further, a sub-picture may include one or more CTUs.
A sub-picture may be a rectangular region of one or more slices in a picture.
One sub-picture may include one or more tiles, one or more bricks, and/or one or more slices.

Tile: A tile may be a region having a square shape or rectangular (i.e., a non-square rectangular) shape in a picture.
A tile may include one or more CTUs.
A tile may be partitioned into one or more bricks.

Brick: A brick may denote one or more CTU rows in a tile.
A tile may be partitioned into one or more bricks. Each brick may include one or more CTU rows.
A tile that is not partitioned into two parts may also denote a brick.

Slice: A slice may include one or more tiles in a picture. Alternatively, a slice may include one or more bricks in a tile.
A sub-picture may contain one or more slices that collectively cover a rectangular region of a picture. Consequently, each sub-picture boundary is also always a slice boundary, and each vertical sub-picture boundary is always also a vertical tile boundary.

Parameter set: A parameter set may correspond to header information in the internal structure of a bitstream.
A parameter set may include at least one of a video parameter set (VPS), a sequence parameter set (SPS), a picture parameter set (PPS), an adaptation parameter set (APS), a decoding parameter set (DPS), etc.

Information signaled through each parameter set may be applied to pictures which refer to the corresponding parameter set. For example, information in a VPS may be applied to pictures which refer to the VPS. Information in an SPS may be applied to pictures which refer to the SPS. Information in a PPS may be applied to pictures which refer to the PPS.

Each parameter set may refer to a higher parameter set. For example, a PPS may refer to an SPS. An SPS may refer to a VPS.
Further, a parameter set may include a tile group, slice header information, and tile header information. The tile group may be a group including multiple tiles. Also, the meaning of “tile group” may be identical to that of “slice”.

Rate-distortion optimization: An encoding apparatus may use rate-distortion optimization so as to provide high coding efficiency by utilizing combinations of the size of a coding unit (CU), a prediction mode, the size of a prediction unit (PU), motion information, and the size of a transform unit (TU).
A rate-distortion optimization scheme may calculate rate-distortion costs of respective combinations so as to select an optimal combination from among the combinations. The rate-distortion costs may be calculated using the equation “D+λ*R”. Generally, a combination enabling the rate-distortion cost to be minimized may be selected as the optimal combination in the rate-distortion optimization scheme.
D may denote distortion. D may be the mean of squares of differences (i.e. mean square error) between original transform coefficients and reconstructed transform coefficients in a transform unit.
R may denote the rate, which may denote a bit rate using related-context information.
λ denotes a Lagrangian multiplier. R may include not only coding parameter information, such as a prediction mode, motion information, and a coded block flag, but also bits generated due to the encoding of transform coefficients.
An encoding apparatus may perform procedures, such as inter prediction and/or intra prediction, transform, quantization, entropy encoding, inverse quantization (dequantization), and/or inverse transform so as to calculate precise D and R. These procedures may greatly increase the complexity of the encoding apparatus.

Bitstream: A bitstream may denote a stream of bits including encoded image information.

Parsing: Parsing may be the decision on the value of a syntax element, made by performing entropy decoding on a bitstream. Alternatively, the term “parsing” may mean such entropy decoding itself.

Symbol: A symbol may be at least one of the syntax element, the coding parameter, and the transform coefficient of an encoding target unit and/or a decoding target unit. Further, a symbol may be the target of entropy encoding or the result of entropy decoding.

Reference picture: A reference picture may be an image referred to by a unit so as to perform inter prediction or motion compensation. Alternatively, a reference picture may be an image including a reference unit referred to by a target unit so as to perform inter prediction or motion compensation.

Hereinafter, the terms “reference picture” and “reference image” may be used to have the same meaning, and may be used interchangeably with each other.

Reference picture list: A reference picture list may be a list including one or more reference images used for inter prediction or motion compensation.
The types of a reference picture list may include List Combined (LC), List 0 (L0), List 1 (L1), List 2 (L2), List 3 (L3), etc.
For inter prediction, one or more reference picture lists may be used.

Inter-prediction indicator: An inter-prediction indicator may indicate the inter-prediction direction for a target unit. Inter prediction may be one of unidirectional prediction and bidirectional prediction. Alternatively, the inter-prediction indicator may denote the number of reference pictures used to generate a prediction unit of a target unit. Alternatively, the inter-prediction indicator may denote the number of prediction blocks used for inter prediction or motion compensation of a target unit.

Prediction list utilization flag: A prediction list utilization flag may indicate whether a prediction unit is generated using at least one reference picture in a specific reference picture list.
An inter-prediction indicator may be derived using the prediction list utilization flag. In contrast, the prediction list utilization flag may be derived using the inter-prediction indicator. For example, the case where the prediction list utilization flag indicates “0”, which is a first value, may indicate that, for a target unit, a prediction block is not generated using a reference picture in a reference picture list. The case where the prediction list utilization flag indicates “1”, which is a second value, may indicate that, for a target unit, a prediction unit is generated using the reference picture list.

Reference picture index: A reference picture index may be an index indicating a specific reference picture in a reference picture list.

Picture Order Count (POC): A POC value for a picture may denote an order in which the corresponding picture is displayed.

Motion vector (MV): A motion vector may be a 2D vector used for inter prediction or motion compensation. A motion vector may mean an offset between a target image and a reference image.
For example, a MV may be represented in a form such as (mvₓ, mv_{y}). mvₓ may indicate a horizontal component, and mv_{y} may indicate a vertical component.

Search range: A search range may be a 2D area in which a search for a MV is performed during inter prediction. For example, the size of the search range may be M×N. M and N may be respective positive integers.

Motion vector candidate: A motion vector candidate may be a block that is a prediction candidate or the motion vector of the block that is a prediction candidate when a motion vector is predicted.
A motion vector candidate may be included in a motion vector candidate list.

Motion vector candidate list: A motion vector candidate list may be a list configured using one or more motion vector candidates.

Motion vector candidate index: A motion vector candidate index may be an indicator for indicating a motion vector candidate in the motion vector candidate list. Alternatively, a motion vector candidate index may be the index of a motion vector predictor.

Motion information: Motion information may be information including at least one of a reference picture list, a reference image, a motion vector candidate, a motion vector candidate index, a merge candidate, and a merge index, as well as a motion vector, a reference picture index, and an inter-prediction indicator.

Merge candidate list: A merge candidate list may be a list configured using one or more merge candidates.

Merge candidate: A merge candidate may be a spatial merge candidate, a temporal merge candidate, a combined merge candidate, a combined bi-prediction merge candidate, a candidate based on a history, a candidate based on an average of two candidates, a zero-merge candidate, etc. A merge candidate may include an inter-prediction indicator, and may include motion information such as prediction type information, a reference picture index for each list, a motion vector, a prediction list utilization flag, and an inter-prediction indicator.

Merge index: A merge index may be an indicator for indicating a merge candidate in a merge candidate list.

A merge index may indicate a reconstructed unit used to derive a merge candidate between a reconstructed unit spatially adjacent to a target unit and a reconstructed unit temporally adjacent to the target unit.
A merge index may indicate at least one of pieces of motion information of a merge candidate.

Transform unit: A transform unit may be the base unit of residual signal encoding and/or residual signal decoding, such as transform, inverse transform, quantization, dequantization, transform coefficient encoding, and transform coefficient decoding. A single transform unit may be partitioned into multiple sub-transform units having a smaller size. Here, a transform may include one or more of a primary transform and a secondary transform, and an inverse transform may include one or more of a primary inverse transform and a secondary inverse transform.

Scaling: Scaling may denote a procedure for multiplying a factor by a transform coefficient level.
As a result of scaling of the transform coefficient level, a transform coefficient may be generated. Scaling may also be referred to as “dequantization”.

Quantization Parameter (QP): A quantization parameter may be a value used to generate a transform coefficient level for a transform coefficient in quantization. Alternatively, a quantization parameter may also be a value used to generate a transform coefficient by scaling the transform coefficient level in dequantization. Alternatively, a quantization parameter may be a value mapped to a quantization step size.

Delta quantization parameter: A delta quantization parameter may mean a difference value between a predicted quantization parameter and the quantization parameter of a target unit.

Scan: Scan may denote a method for aligning the order of coefficients in a unit, a block or a matrix. For example, a method for aligning a 2D array in the form of a one-dimensional (1D) array may be referred to as a “scan”. Alternatively, a method for aligning a 1D array in the form of a 2D array may also be referred to as a “scan” or an “inverse scan”.

Transform coefficient: A transform coefficient may be a coefficient value generated as an encoding apparatus performs a transform. Alternatively, the transform coefficient may be a coefficient value generated as a decoding apparatus performs at least one of entropy decoding and dequantization.

A quantized level or a quantized transform coefficient level generated by applying quantization to a transform coefficient or a residual signal may also be included in the meaning of the term “transform coefficient”.

Quantized level: A quantized level may be a value generated as the encoding apparatus performs quantization on a transform coefficient or a residual signal. Alternatively, the quantized level may be a value that is the target of dequantization as the decoding apparatus performs dequantization.

A quantized transform coefficient level, which is the result of transform and quantization, may also be included in the meaning of a quantized level.

Non-zero transform coefficient: A non-zero transform coefficient may be a transform coefficient having a value other than 0 or a transform coefficient level having a value other than 0. Alternatively, a non-zero transform coefficient may be a transform coefficient, the magnitude of the value of which is not 0, or a transform coefficient level, the magnitude of the value of which is not 0.

Quantization matrix: A quantization matrix may be a matrix used in a quantization procedure or a dequantization procedure so as to improve the subjective image quality or objective image quality of an image. A quantization matrix may also be referred to as a “scaling list”.

Quantization matrix coefficient: A quantization matrix coefficient may be each element in a quantization matrix. A quantization matrix coefficient may also be referred to as a “matrix coefficient”.

Default matrix: A default matrix may be a quantization matrix predefined by the encoding apparatus and the decoding apparatus.

Non-default matrix: A non-default matrix may be a quantization matrix that is not predefined by the encoding apparatus and the decoding apparatus. The non-default matrix may mean a quantization matrix to be signaled from the encoding apparatus to the decoding apparatus by a user.

Most Probable Mode (MPM): An MPM may denote an intra-prediction mode having a high probability of being used for intra prediction for a target block.
An encoding apparatus and a decoding apparatus may determine one or more MPMs based on coding parameters related to the target block and the attributes of entities related to the target block.
The encoding apparatus and the decoding apparatus may determine one or more MPMs based on the intra-prediction mode of a reference block. The reference block may include multiple reference blocks. The multiple reference blocks may include spatial neighbor blocks adjacent to the left of the target block and spatial neighbor blocks adjacent to the top of the target block. In other words, depending on which intra-prediction modes have been used for the reference blocks, one or more different MPMs may be determined.
The one or more MPMs may be determined in the same manner both in the encoding apparatus and in the decoding apparatus. That is, the encoding apparatus and the decoding apparatus may share the same MPM list including one or more MPMs.

MPM list: An MPM list may be a list including one or more MPMs. The number of the one or more MPMs in the MPM list may be defined in advance.

MPM indicator: An MPM indicator may indicate an MPM to be used for intra prediction for a target block among one or more MPMs in the MPM list. For example, the MPM indicator may be an index for the MPM list.
Since the MPM list is determined in the same manner both in the encoding apparatus and in the decoding apparatus, there may be no need to transmit the MPM list itself from the encoding apparatus to the decoding apparatus.
The MPM indicator may be signaled from the encoding apparatus to the decoding apparatus. As the MPM indicator is signaled, the decoding apparatus may determine the MPM to be used for intra prediction for the target block among the MPMs in the MPM list.

MPM use indicator: An MPM use indicator may indicate whether an MPM usage mode is to be used for prediction for a target block. The MPM usage mode may be a mode in which the MPM to be used for intra prediction for the target block is determined using the MPM list.
The MPM use indicator may be signaled from the encoding apparatus to the decoding apparatus.

Signaling: “signaling” may denote that information is transferred from an encoding apparatus to a decoding apparatus. Alternatively, “signaling” may mean information is included in in a bitstream or a recoding medium by an encoding apparatus. Information signaled by an encoding apparatus may be used by a decoding apparatus.
The encoding apparatus may generate encoded information by performing encoding on information to be signaled. The encoded information may be transmitted from the encoding apparatus to the decoding apparatus. The decoding apparatus may obtain information by decoding the transmitted encoded information. Here, the encoding may be entropy encoding, and the decoding may be entropy decoding.

Selective Signaling: Information may be signaled selectively. A selective signaling FOR information may mean that an encoding apparatus selectively includes information (according to a specific condition) in a bitstream or a recording medium. Selective signaling for information may mean that a decoding apparatus selectively extracts information from a bitstream (according to a specific condition).

Omission of signaling: Signaling for information may be omitted. Omission of signaling for information on information may mean that an encoding apparatus does not include information (according to a specific condition) in a bitstream or a recording medium. Omission of signaling for information may mean that a decoding apparatus does not extract information from a bitstream (according to a specific condition).

Statistic value: A variable, a coding parameter, a constant, etc. may have values that can be calculated. The statistic value may be a value generated by performing calculations (operations) on the values of specified targets. For example, the statistic value may indicate one or more of the average, weighted average, weighted sum, minimum value, maximum value, mode, median value, and interpolated value of the values of a specific variable, a specific coding parameter, a specific constant, or the like.

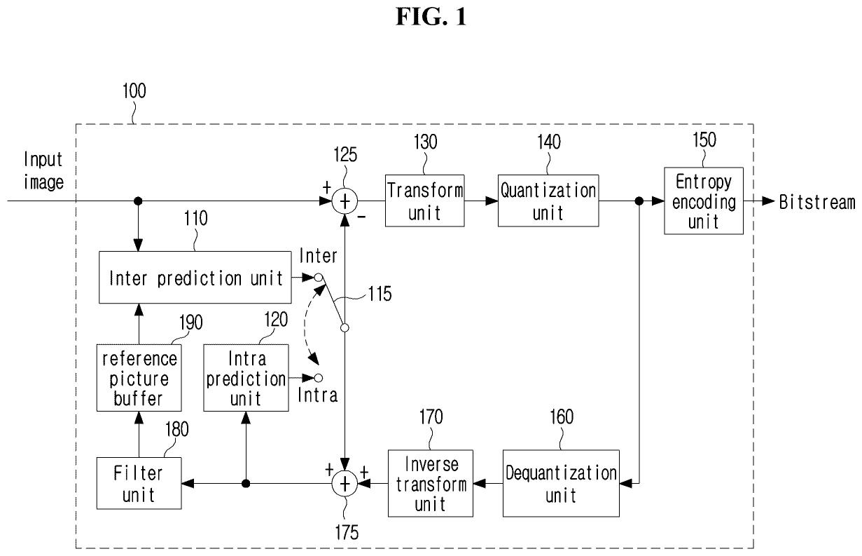

FIG. 1 is a block diagram illustrating the configuration of an embodiment of an encoding apparatus to which the present disclosure is applied.

An encoding apparatus 100 may be an encoder, a video encoding apparatus or an image encoding apparatus. A video may include one or more images. The encoding apparatus 100 may sequentially encode one or more images of the video.

Referring to FIG. 1, the encoding apparatus 100 includes an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180 and a reference picture buffer 190.

The encoding apparatus 100 may perform encoding on a target image using an intra mode and/or an inter mode. In other words, a prediction mode for a target block may be one of an intra mode and an inter mode.

Hereinafter, the terms “intra mode”, “intra-prediction mode”, “intra-picture mode” and “intra-picture prediction mode” may be used to have the same meaning, and may be used interchangeably with each other.

Hereinafter, the terms “inter mode”, “inter-prediction mode”, “inter-picture mode” and “inter-picture prediction mode” may be used to have the same meaning, and may be used interchangeably with each other.

Hereinafter, the term “image” may indicate only part of an image, or may indicate a block. Also, the processing of an “image” may indicate sequential processing of multiple blocks.

Further, the encoding apparatus 100 may generate a bitstream, including encoded information, via encoding on the target image, and may output and store the generated bitstream. The generated bitstream may be stored in a computer-readable storage medium and may be streamed through a wired and/or wireless transmission medium.

When the intra mode is used as a prediction mode, the switch 115 may switch to the intra mode. When the inter mode is used as a prediction mode, the switch 115 may switch to the inter mode.

The encoding apparatus 100 may generate a prediction block of a target block. Further, after the prediction block has been generated, the encoding apparatus 100 may encode a residual block for the target block using a residual between the target block and the prediction block.

When the prediction mode is the intra mode, the intra-prediction unit 120 may use pixels of previously encoded/decoded neighbor blocks adjacent to the target block as reference samples. The intra-prediction unit 120 may perform spatial prediction on the target block using the reference samples, and may generate prediction samples for the target block via spatial prediction. The prediction samples may mean samples in the prediction block.

The inter-prediction unit 110 may include a motion prediction unit and a motion compensation unit.

When the prediction mode is an inter mode, the motion prediction unit may search a reference image for the area most closely matching the target block in a motion prediction procedure, and may derive a motion vector for the target block and the found area based on the found area. Here, the motion-prediction unit may use a search range as a target area for searching.

The reference image may be stored in the reference picture buffer 190. More specifically, an encoded and/or decoded reference image may be stored in the reference picture buffer 190 when the encoding and/or decoding of the reference image have been processed.

Since a decoded picture is stored, the reference picture buffer 190 may be a Decoded Picture Buffer (DPB).

The motion compensation unit may generate a prediction block for the target block by performing motion compensation using a motion vector. Here, the motion vector may be a two-dimensional (2D) vector used for inter-prediction. Further, the motion vector may indicate an offset between the target image and the reference image.

The motion prediction unit and the motion compensation unit may generate a prediction block by applying an interpolation filter to a partial area of a reference image when the motion vector has a value other than an integer. In order to perform inter prediction or motion compensation, it may be determined which one of a skip mode, a merge mode, an advanced motion vector prediction (AMVP) mode, and a current picture reference mode corresponds to a method for predicting the motion of a PU included in a CU, based on the CU, and compensating for the motion, and inter prediction or motion compensation may be performed depending on the mode.

The subtractor 125 may generate a residual block, which is the differential between the target block and the prediction block. A residual block may also be referred to as a “residual signal”.

The residual signal may be the difference between an original signal and a prediction signal. Alternatively, the residual signal may be a signal generated by transforming or quantizing the difference between an original signal and a prediction signal or by transforming and quantizing the difference. A residual block may be a residual signal for a block unit.

The transform unit 130 may generate a transform coefficient by transforming the residual block, and may output the generated transform coefficient. Here, the transform coefficient may be a coefficient value generated by transforming the residual block.

The transform unit 130 may use one of multiple predefined transform methods when performing a transform.

The multiple predefined transform methods may include a Discrete Cosine Transform (DCT), a Discrete Sine Transform (DST), a Karhunen-Loeve Transform (KLT), etc.

The transform method used to transform a residual block may be determined depending on at least one of coding parameters for a target block and/or a neighbor block. For example, the transform method may be determined based on at least one of an inter-prediction mode for a PU, an intra-prediction mode for a PU, the size of a TU, and the shape of a TU. Alternatively, transformation information indicating the transform method may be signaled from the encoding apparatus 100 to the decoding apparatus 200.

When a transform skip mode is used, the transform unit 130 may omit transforming the residual block.

By applying quantization to the transform coefficient, a quantized transform coefficient level or a quantized level may be generated. Hereinafter, in the embodiments, each of the quantized transform coefficient level and the quantized level may also be referred to as a ‘transform coefficient’.

The quantization unit 140 may generate a quantized transform coefficient level (i.e., a quantized level or a quantized coefficient) by quantizing the transform coefficient depending on quantization parameters. The quantization unit 140 may output the quantized transform coefficient level that is generated. In this case, the quantization unit 140 may quantize the transform coefficient using a quantization matrix.

The entropy encoding unit 150 may generate a bitstream by performing probability distribution-based entropy encoding based on values, calculated by the quantization unit 140, and/or coding parameter values, calculated in the encoding procedure. The entropy encoding unit 150 may output the generated bitstream.

The entropy encoding unit 150 may perform entropy encoding on information about the pixels of the image and information required to decode the image. For example, the information required to decode the image may include syntax elements or the like.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, the entropy encoding unit 150 may use a coding method such as exponential Golomb, Context-Adaptive Variable Length Coding (CAVLC), or Context-Adaptive Binary Arithmetic Coding (CABAC). For example, the entropy encoding unit 150 may perform entropy encoding using a Variable Length Coding/Code (VLC) table. For example, the entropy encoding unit 150 may derive a binarization method for a target symbol. Further, the entropy encoding unit 150 may derive a probability model for a target symbol/bin. The entropy encoding unit 150 may perform arithmetic coding using the derived binarization method, a probability model, and a context model.

The entropy encoding unit 150 may transform the coefficient of the form of a 2D block into the form of a 1D vector through a transform coefficient scanning method so as to encode a quantized transform coefficient level.

The coding parameters may be information required for encoding and/or decoding. The coding parameters may include information encoded by the encoding apparatus 100 and transferred from the encoding apparatus 100 to a decoding apparatus, and may also include information that may be derived in the encoding or decoding procedure. For example, information transferred to the decoding apparatus may include syntax elements.

The coding parameters may include not only information (or a flag or an index), such as a syntax element, which is encoded by the encoding apparatus and is signaled by the encoding apparatus to the decoding apparatus, but also information derived in an encoding or decoding process. Further, the coding parameters may include information required so as to encode or decode images. For example, the coding parameters may include at least one value, combinations or statistics of a size of a unit/block, a shape/form of a unit/block, a depth of a unit/block, partition information of a unit/block, a partition structure of a unit/block, information indicating whether a unit/block is partitioned in a quad-tree structure, information indicating whether a unit/block is partitioned in a binary tree structure, a partitioning direction of a binary tree structure (horizontal direction or vertical direction), a partitioning form of a binary tree structure (symmetrical partitioning or asymmetrical partitioning), information indicating whether a unit/block is partitioned in a ternary tree structure, a partitioning direction of a ternary tree structure (horizontal direction or vertical direction), a partitioning form of a ternary tree structure (symmetrical partitioning or asymmetrical partitioning, etc.), information indicating whether a unit/block is partitioned in a multi-type tree structure, a combination and a direction (horizontal direction or vertical direction, etc.) of a partitioning of the multi-type tree structure, a partitioning form of a multi-type tree structure (symmetrical partitioning or asymmetrical partitioning, etc.), a partitioning tree (a binary tree or a ternary tree) of the multi-type tree form, a type of a prediction (intra prediction or inter prediction), an intra-prediction mode/direction, an intra luma prediction mode/direction, an intra chroma prediction mode/direction, an intra partitioning information, an inter partitioning information, a coding block partitioning flag, a prediction block partitioning flag, a transform block partitioning flag, a reference sample filtering method, a reference sample filter tap, a reference sample filter coefficient, a prediction block filtering method, a prediction block filter tap, a prediction block filter coefficient, a prediction block boundary filtering method, a prediction block boundary filter tap, a prediction block boundary filter coefficient, an inter-prediction mode, motion information, a motion vector, a motion vector difference, a reference picture index, an inter-prediction direction, an inter-prediction indicator, a prediction list utilization flag, a reference picture list, a reference image, a POC, a motion vector predictor, a motion vector prediction index, a motion vector prediction candidate, a motion vector candidate list, information indicating whether a merge mode is used, a merge index, a merge candidate, a merge candidate list, information indicating whether a skip mode is used, a type of an interpolation filter, a tap of an interpolation filter, a filter coefficient of an interpolation filter, a magnitude of a motion vector, accuracy of motion vector representation, a transform type, a transform size, information indicating whether a first transform is used, information indicating whether an additional (secondary) transform is used, first transform selection information (or a first transform index), secondary transform selection information (or a secondary transform index), information indicating a presence or absence of a residual signal, a coded block pattern, a coded block flag, a quantization parameter, a residual quantization parameter, a quantization matrix, information about an intra-loop filter, information indicating whether an intra-loop filter is applied, a coefficient of an intra-loop filter, a tap of an intra-loop filter, a shape/form of an intra-loop filter, information indicating whether a deblocking filter is applied, a coefficient of a deblocking filter, a tap of a deblocking filter, deblocking filter strength, a shape/form of a deblocking filter, information indicating whether an adaptive sample offset is applied, a value of an adaptive sample offset, a category of an adaptive sample offset, a type of an adaptive sample offset, information indicating whether an adaptive in-loop filter is applied, a coefficient of an adaptive in-loop filter, a tap of an adaptive in-loop filter, a shape/form of an adaptive in-loop filter, a binarization/inverse binarization method, a context model, a context model decision method, a context model update method, information indicating whether a regular mode is performed, information whether a bypass mode is performed, a significant coefficient flag, a last significant coefficient flag, a coding flag for a coefficient group, a position of a last significant coefficient, information indicating whether a value of a coefficient is greater than 1, information indicating whether a value of a coefficient is greater than 2, information indicating whether a value of a coefficient is greater than 3, a remaining coefficient value information, a sign information, a reconstructed luma sample, a reconstructed chroma sample, a context bin, a bypass bin, a residual luma sample, a residual chroma sample, a transform coefficient, a luma transform coefficient, a chroma transform coefficient, a quantized level, a luma quantized level, a chroma quantized level, a transform coefficient level, a transform coefficient level scanning method, a size of a motion vector search region on a side of a decoding apparatus, a shape/form of a motion vector search region on a side of a decoding apparatus, the number of a motion vector search on a side of a decoding apparatus, a size of a CTU, a minimum block size, a maximum block size, a maximum block depth, a minimum block depth, an image display/output order, slice identification information, a slice type, slice partition information, tile group identification information, a tile group type, a tile group partitioning information, tile identification information, a tile type, tile partitioning information, a picture type, bit depth, input sample bit depth, reconstructed sample bit depth, residual sample bit depth, transform coefficient bit depth, quantized level bit depth, information about a luma signal, information about a chroma signal, a color space of a target block and a color space of a residual block. Further, the above-described coding parameter-related information may also be included in the coding parameter. Information used to calculate and/or derive the above-described coding parameter may also be included in the coding parameter. Information calculated or derived using the above-described coding parameter may also be included in the coding parameter.

The first transform selection information may indicate a first transform which is applied to a target block.

The second transform selection information may indicate a second transform which is applied to a target block.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal. A residual block may be the residual signal for a block.

Here, signaling information may mean that the encoding apparatus 100 includes an entropy-encoded information, generated by performing entropy encoding a flag or an index, in a bitstream, and that the decoding apparatus 200 acquires information by performing entropy decoding on the entropy-encoded information, extracted from the bitstream. Here, the information may comprise a flag, an index, etc.

A signal may mean information to be signaled. Hereinafter, information for an image and a block may be referred to as a signal. Further, hereinafter, the terms “information” and “signal” may be used to have the same meaning and may be used interchangeably with each other. For example, a specific signal may be a signal representing a specific block. An original signal may be a signal representing a target block. A prediction signal may be a signal representing a prediction block. A residual signal may be a signal representing a residual block.

A bitstream may include information based on a specific syntax. The encoding apparatus 100 may generate a bitstream including information depending on a specific syntax. The decoding apparatus 200 may acquire information from the bitstream depending on a specific syntax.

Since the encoding apparatus 100 performs encoding via inter prediction, the encoded target image may be used as a reference image for additional image(s) to be subsequently processed. Therefore, the encoding apparatus 100 may reconstruct or decode the encoded target image and store the reconstructed or decoded image as a reference image in the reference picture buffer 190. For decoding, dequantization and inverse transform on the encoded target image may be processed.

The quantized level may be inversely quantized by the dequantization unit 160, and may be inversely transformed by the inverse transform unit 170. The dequantization unit 160 may generate an inversely quantized coefficient by performing inverse transform for the quantized level. The inverse transform unit 170 may generate a inversely quantized and inversely transformed coefficient by performing inverse transform for the inversely quantized coefficient.

The inversely quantized and inversely transformed coefficient may be added to the prediction block by the adder 175. The inversely quantized and inversely transformed coefficient and the prediction block are added, and then a reconstructed block may be generated. Here, the inversely quantized and/or inversely transformed coefficient may denote a coefficient on which one or more of dequantization and inverse transform are performed, and may also denote a reconstructed residual block. Here, the reconstructed block may mean a recovered block or a decoded block.

The reconstructed block may be subjected to filtering through the filter unit 180. The filter unit 180 may apply one or more of a deblocking filter, a Sample Adaptive Offset (SAO) filter, an Adaptive Loop Filter (ALF), and a Non Local Filter (NLF) to a reconstructed sample, the reconstructed block or a reconstructed picture. The filter unit 180 may also be referred to as an “in-loop filter”.

The deblocking filter may eliminate block distortion occurring at the boundaries between blocks in a reconstructed picture. In order to determine whether to apply the deblocking filter, the number of columns or rows which are included in a block and which include pixel(s) based on which it is determined whether to apply the deblocking filter to a target block may be decided on.

When the deblocking filter is applied to the target block, the applied filter may differ depending on the strength of the required deblocking filtering. In other words, among different filters, a filter decided on in consideration of the strength of deblocking filtering may be applied to the target block. When a deblocking filter is applied to a target block, one or more filters of a long-tap filter, a strong filter, a weak filter and Gaussian filter may be applied to the target block depending on the strength of required deblocking filtering.

Also, when vertical filtering and horizontal filtering are performed on the target block, the horizontal filtering and the vertical filtering may be processed in parallel.

The SAO may add a suitable offset to the values of pixels to compensate for coding error. The SAO may perform, for the image to which deblocking is applied, correction that uses an offset in the difference between an original image and the image to which deblocking is applied, on a pixel basis. To perform an offset correction for an image, a method for dividing the pixels included in the image into a certain number of regions, determining a region to which an offset is to be applied, among the divided regions, and applying an offset to the determined region may be used, and a method for applying an offset in consideration of edge information of each pixel may also be used.

The ALF may perform filtering based on a value obtained by comparing a reconstructed image with an original image. After pixels included in an image have been divided into a predetermined number of groups, filters to be applied to each group may be determined, and filtering may be differentially performed for respective groups. information related to whether to apply an adaptive loop filter may be signaled for each CU. Such information may be signaled for a luma signal. The shapes and filter coefficients of ALFs to be applied to respective blocks may differ for respective blocks. Alternatively, regardless of the features of a block, an ALF having a fixed form may be applied to the block.

A non-local filter may perform filtering based on reconstructed blocks, similar to a target block. A region similar to the target block may be selected from a reconstructed picture, and filtering of the target block may be performed using the statistical properties of the selected similar region. Information about whether to apply a non-local filter may be signaled for a Coding Unit (CU). Also, the shapes and filter coefficients of the non-local filter to be applied to blocks may differ depending on the blocks.

The reconstructed block or the reconstructed image subjected to filtering through the filter unit 180 may be stored in the reference picture buffer 190 as a reference picture. The reconstructed block subjected to filtering through the filter unit 180 may be a part of a reference picture. In other words, the reference picture may be a reconstructed picture composed of reconstructed blocks subjected to filtering through the filter unit 180. The stored reference picture may be subsequently used for inter prediction or a motion compensation.

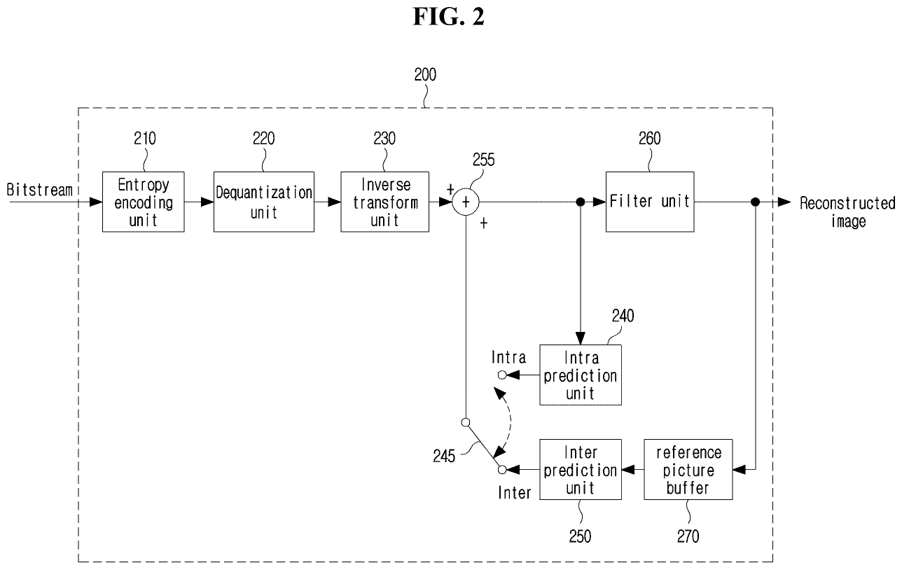

FIG. 2 is a block diagram illustrating the configuration of an embodiment of a decoding apparatus to which the present disclosure is applied.

A decoding apparatus 200 may be a decoder, a video decoding apparatus or an image decoding apparatus.

Referring to FIG. 2, the decoding apparatus 200 may include an entropy decoding unit 210, a dequantization (inverse quantization) unit 220, an inverse transform unit 230, an intra-prediction unit 240, an inter-prediction unit 250, a switch 245 an adder 255, a filter unit 260, and a reference picture buffer 270.

The decoding apparatus 200 may receive a bitstream output from the encoding apparatus 100. The decoding apparatus 200 may receive a bitstream stored in a computer-readable storage medium, and may receive a bitstream that is streamed through a wired/wireless transmission medium.

The decoding apparatus 200 may perform decoding on the bitstream in an intra mode and/or an inter mode. Further, the decoding apparatus 200 may generate a reconstructed image or a decoded image via decoding, and may output the reconstructed image or decoded image.

For example, switching to an intra mode or an inter mode based on the prediction mode used for decoding may be performed by the switch 245. When the prediction mode used for decoding is an intra mode, the switch 245 may be operated to switch to the intra mode. When the prediction mode used for decoding is an inter mode, the switch 245 may be operated to switch to the inter mode.

The decoding apparatus 200 may acquire a reconstructed residual block by decoding the input bitstream, and may generate a prediction block. When the reconstructed residual block and the prediction block are acquired, the decoding apparatus 200 may generate a reconstructed block, which is the target to be decoded, by adding the reconstructed residual block and the prediction block.

The entropy decoding unit 210 may generate symbols by performing entropy decoding on the bitstream based on the probability distribution of a bitstream. The generated symbols may include symbols in a form of a quantized transform coefficient level (i.e., a quantized level or a quantized coefficient). Here, the entropy decoding method may be similar to the above-described entropy encoding method. That is, the entropy decoding method may be the reverse procedure of the above-described entropy encoding method.

The entropy decoding unit 210 may change a coefficient having a one-dimensional (1D) vector form to a 2D block shape through a transform coefficient scanning method in order to decode a quantized transform coefficient level.

For example, the coefficients of the block may be changed to 2D block shapes by scanning the block coefficients using up-right diagonal scanning. Alternatively, which one of up-right diagonal scanning, vertical scanning, and horizontal scanning is to be used may be determined depending on the size and/or the intra-prediction mode of the corresponding block.

The quantized coefficient may be inversely quantized by the dequantization unit 220. The dequantization unit 220 may generate an inversely quantized coefficient by performing dequantization on the quantized coefficient. Further, the inversely quantized coefficient may be inversely transformed by the inverse transform unit 230. The inverse transform unit 230 may generate a reconstructed residual block by performing an inverse transform on the inversely quantized coefficient. As a result of performing dequantization and the inverse transform on the quantized coefficient, the reconstructed residual block may be generated. Here, the dequantization unit 220 may apply a quantization matrix to the quantized coefficient when generating the reconstructed residual block.

When the intra mode is used, the intra-prediction unit 240 may generate a prediction block by performing spatial prediction that uses the pixel values of previously decoded neighbor blocks adjacent to a target block for the target block.

The inter-prediction unit 250 may include a motion compensation unit. Alternatively, the inter-prediction unit 250 may be designated as a “motion compensation unit”.

When the inter mode is used, the motion compensation unit may generate a prediction block by performing motion compensation that uses a motion vector and a reference image stored in the reference picture buffer 270 for the target block.

The motion compensation unit may apply an interpolation filter to a partial area of the reference image when the motion vector has a value other than an integer, and may generate a prediction block using the reference image to which the interpolation filter is applied. In order to perform motion compensation, the motion compensation unit may determine which one of a skip mode, a merge mode, an Advanced Motion Vector Prediction (AMVP) mode, and a current picture reference mode corresponds to the motion compensation method used for a PU included in a CU, based on the CU, and may perform motion compensation depending on the determined mode.

The reconstructed residual block and the prediction block may be added to each other by the adder 255. The adder 255 may generate a reconstructed block by adding the reconstructed residual block to the prediction block.

The reconstructed block may be subjected to filtering through the filter unit 260. The filter unit 260 may apply at least one of a deblocking filter, an SAO filter, an ALF, and a NLF to the reconstructed block or the reconstructed image. The reconstructed image may be a picture including the reconstructed block.

The filter unit may output the reconstructed image.

The reconstructed image and/or the reconstructed block subjected to filtering through the filter unit 260 may be stored as a reference picture in the reference picture buffer 270. The reconstructed block subjected to filtering through the filter unit 260 may be a part of the reference picture. In other words, the reference picture may be an image composed of reconstructed blocks subjected to filtering through the filter unit 260. The stored reference picture may be subsequently used for inter prediction or a motion compensation.

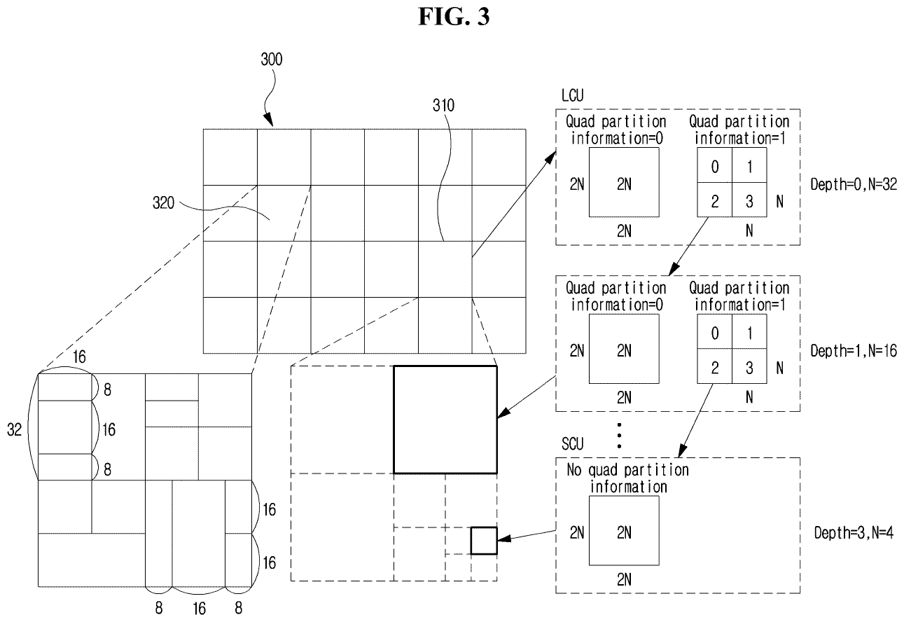

FIG. 3 is a diagram schematically illustrating the partition structure of an image when the image is encoded and decoded.

FIG. 3 may schematically illustrate an example in which a single unit is partitioned into multiple sub-units.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

A CU may be used as a base unit for image encoding/decoding. A CU may be used as a unit to which one mode selected from an intra mode and an inter mode in image encoding/decoding is applied. In other words, in image encoding/decoding, which one of an intra mode and an inter mode is to be applied to each CU may be determined.

Further, a CU may be a base unit in prediction, transform, quantization, inverse transform, dequantization, and encoding/decoding of transform coefficients.

Referring to FIG. 3, an image 300 may be sequentially partitioned into units corresponding to a Largest Coding Unit (LCU), and a partition structure may be determined for each LCU. Here, the LCU may be used to have the same meaning as a Coding Tree Unit (CTU).

The partitioning of a unit may mean the partitioning of a block corresponding to the unit. Block partition information may include depth information about the depth of a unit. The depth information may indicate the number of times the unit is partitioned and/or the degree to which the unit is partitioned. A single unit may be hierarchically partitioned into a plurality of sub-units while having depth information based on a tree structure.

Each of partitioned sub-units may have depth information. The depth information may be information indicating the size of a CU. The depth information may be stored for each CU.

Each CU may have depth information. When the CU is partitioned, CUs resulting from partitioning may have a depth increased from the depth of the partitioned CU by 1.

The partition structure may mean the distribution of Coding Units (CUs) to efficiently encode the image in an LCU 310. Such a distribution may be determined depending on whether a single CU is to be partitioned into multiple CUs. The number of CUs generated by partitioning may be a positive integer of 2 or more, including 2, 3, 4, 8, 16, etc.

The horizontal size and the vertical size of each of CUs generated by the partitioning may be less than the horizontal size and the vertical size of a CU before being partitioned, depending on the number of CUs generated by partitioning. For example, the horizontal size and the vertical size of each of CUs generated by the partitioning may be half of the horizontal size and the vertical size of a CU before being partitioned.

Each partitioned CU may be recursively partitioned into four CUs in the same way. Via the recursive partitioning, at least one of the horizontal size and the vertical size of each partitioned CU may be reduced compared to at least one of the horizontal size and the vertical size of the CU before being partitioned.

The partitioning of a CU may be recursively performed up to a predefined depth or a predefined size.

For example, the depth of a CU may have a value ranging from 0 to 3. The size of the CU may range from a size of 64×64 to a size of 8×8 depending on the depth of the CU.

For example, the depth of an LCU 310 may be 0, and the depth of a Smallest Coding Unit (SCU) may be a predefined maximum depth. Here, as described above, the LCU may be the CU having the maximum coding unit size, and the SCU may be the CU having the minimum coding unit size.

Partitioning may start at the LCU 310, and the depth of a CU may be increased by 1 whenever the horizontal and/or vertical sizes of the CU are reduced by partitioning.

For example, for respective depths, a CU that is not partitioned may have a size of 2N×2N. Further, in the case of a CU that is partitioned, a CU having a size of 2N×2N may be partitioned into four CUs, each having a size of N×N. The value of N may be halved whenever the depth is increased by 1.

Referring to FIG. 3, an LCU having a depth of 0 may have 64×64 pixels or 64×64 blocks. 0 may be a minimum depth. An SCU having a depth of 3 may have 8×8 pixels or 8×8 blocks. 3 may be a maximum depth. Here, a CU having 64×64 blocks, which is the LCU, may be represented by a depth of 0. A CU having 32×32 blocks may be represented by a depth of 1. A CU having 16×16 blocks may be represented by a depth of 2. A CU having 8×8 blocks, which is the SCU, may be represented by a depth of 3.

Information about whether the corresponding CU is partitioned may be represented by the partition information of the CU. The partition information may be 1-bit information. All CUs except the SCU may include partition information. For example, the value of the partition information of a CU that is not partitioned may be a first value. The value of the partition information of a CU that is partitioned may be a second value. When the partition information indicates whether a CU is partitioned or not, the first value may be “0” and the second value may be “1”.

For example, when a single CU is partitioned into four CUs, the horizontal size and vertical size of each of four CUs generated by partitioning may be half the horizontal size and the vertical size of the CU before being partitioned. When a CU having a 32×32 size is partitioned into four CUs, the size of each of four partitioned CUs may be 16×16. When a single CU is partitioned into four CUs, it may be considered that the CU has been partitioned in a quad-tree structure. In other words, it may be considered that a quad-tree partition has been applied to a CU.

For example, when a single CU is partitioned into two CUs, the horizontal size or the vertical size of each of two CUs generated by partitioning may be half the horizontal size or the vertical size of the CU before being partitioned. When a CU having a 32×32 size is vertically partitioned into two CUs, the size of each of two partitioned CUs may be 16×32. When a CU having a 32×32 size is horizontally partitioned into two CUs, the size of each of two partitioned CUs may be 32×16. When a single CU is partitioned into two CUs, it may be considered that the CU has been partitioned in a binary-tree structure. In other words, it may be considered that a binary-tree partition has been applied to a CU.

For example, when a single CU is partitioned (or split) into three CUs, the original CU before being partitioned is partitioned so that the horizontal size or vertical size thereof is divided at a ratio of 1:2:1, thus enabling three sub-CUs to be generated. For example, when a CU having a 16×32 size is horizontally partitioned into three sub-CUs, the three sub-CUs resulting from the partitioning may have sizes of 16×8, 16×16, and 16×8, respectively, in a direction from the top to the bottom. For example, when a CU having a 32×32 size is vertically partitioned into three sub-CUs, the three sub-CUs resulting from the partitioning may have sizes of 8×32, 16×32, and 8×32, respectively, in a direction from the left to the right. When a single CU is partitioned into three CUs, it may be considered that the CU is partitioned in a ternary-tree form. In other words, it may be considered that a ternary-tree partition has been applied to the CU.

Both of quad-tree partitioning and binary-tree partitioning are applied to the LCU 310 of FIG. 3.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned, and may have a quad-tree structure.

By the recursive partitioning of a CU, an optimal partitioning method that incurs a minimum rate-distortion cost may be selected.

The Coding Tree Unit (CTU) 320 in FIG. 3 is an example of a CTU to which all of a quad-tree partition, a binary-tree partition, and a ternary-tree partition are applied.

As described above, in order to partition a CTU, at least one of a quad-tree partition, a binary-tree partition, and a ternary-tree partition may be applied to the CTU. Partitions may be applied based on specific priority.

For example, a quad-tree partition may be preferentially applied to the CTU. A CU that cannot be partitioned in a quad-tree form any further may correspond to a leaf node of a quad-tree. A CU corresponding to the leaf node of the quad-tree may be a root node of a binary tree and/or a ternary tree. That is, the CU corresponding to the leaf node of the quad-tree may be partitioned in a binary-tree form or a ternary-tree form, or may not be partitioned any further. In this case, each CU, which is generated by applying a binary-tree partition or a ternary-tree partition to the CU corresponding to the leaf node of a quad-tree, is prevented from being subjected again to quad-tree partitioning, thus effectively performing partitioning of a block and/or signaling of block partition information.

The partition of a CU corresponding to each node of a quad-tree may be signaled using quad-partition information. Quad-partition information having a first value (e.g., “1”) may indicate that the corresponding CU is partitioned in a quad-tree form. Quad-partition information having a second value (e.g., “0”) may indicate that the corresponding CU is not partitioned in a quad-tree form. The quad-partition information may be a flag having a specific length (e.g., 1 bit).

Priority may not exist between a binary-tree partition and a ternary-tree partition. That is, a CU corresponding to the leaf node of a quad-tree may be partitioned in a binary-tree form or a ternary-tree form. Also, the CU generated through a binary-tree partition or a ternary-tree partition may be further partitioned in a binary-tree form or a ternary-tree form, or may not be partitioned any further.

Partitioning performed when priority does not exist between a binary-tree partition and a ternary-tree partition may be referred to as a “multi-type tree partition”. That is, a CU corresponding to the leaf node of a quad-tree may be the root node of a multi-type tree. Partitioning of a CU corresponding to each node of the multi-type tree may be signaled using at least one of information indicating whether the CU is partitioned in a multi-type tree, partition direction information, and partition tree information. For partitioning of a CU corresponding to each node of a multi-type tree, information indicating whether partitioning in the multi-type tree is performed, partition direction information, and partition tree information may be sequentially signaled.

For example, information indicating whether a CU is partitioned in a multi-type tree and having a first value (e.g., “1”) may indicate that the corresponding CU is partitioned in a multi-type tree form. Information indicating whether a CU is partitioned in a multi-type tree and having a second value (e.g., “0”) may indicate that the corresponding CU is not partitioned in a multi-type tree form.

When a CU corresponding to each node of a multi-type tree is partitioned in a multi-type tree form, the corresponding CU may further include partition direction information.

The partition direction information may indicate the partition direction of the multi-type tree partition. Partition direction information having a first value (e.g., “1”) may indicate that the corresponding CU is partitioned in a vertical direction. Partition direction information having a second value (e.g., “0”) may indicate that the corresponding CU is partitioned in a horizontal direction.

When a CU corresponding to each node of a multi-type tree is partitioned in a multi-type tree form, the corresponding CU may further include partition-tree information. The partition-tree information may indicate the tree that is used for a multi-type tree partition.

For example, partition-tree information having a first value (e.g., “1”) may indicate that the corresponding CU is partitioned in a binary-tree form. Partition-tree information having a second value (e.g., “0”) may indicate that the corresponding CU is partitioned in a ternary-tree form.

Here, each of the above-described information indicating whether partitioning in the multi-type tree is performed, partition-tree information, and partition direction information may be a flag having a specific length (e.g., 1 bit).

At least one of the above-described quad-partition information, information indicating whether partitioning in the multi-type tree is performed, partition direction information, and partition-tree information may be entropy-encoded and/or entropy-decoded. In order to perform entropy encoding/decoding of such information, information of a neighbor CU adjacent to a target CU may be used.

For example, it may be considered that there is a high probability that the partition form of a left CU and/or an above CU (i.e., partitioning/non-partitioning, a partition tree and/or a partition direction) and the partition form of a target CU will be similar to each other. Therefore, based on the information of a neighbor CU, context information for entropy encoding and/or entropy decoding of the information of the target CU may be derived. Here, the information of the neighbor CU may include at least one of 1) quad-partition information of the neighbor CU, 2) information indicating whether the neighbor CU is partitioned in a multi-type tree, 3) partition direction information of the neighbor CU, and 4) partition-tree information of the neighbor CU.

In another embodiment, of a binary-tree partition and a ternary-tree partition, the binary-tree partition may be preferentially performed. That is, the binary-tree partition may be first applied, and then a CU corresponding to the leaf node of a binary tree may be set to the root node of a ternary tree. In this case, a quad-tree partition or a binary-tree partition may not be performed on the CU corresponding to the node of the ternary tree.

A CU, which is not partitioned any further through a quad-tree partition, a binary-tree partition, and/or a ternary-tree partition, may be the unit of encoding, prediction and/or transform. That is, the CU may not be partitioned any further for prediction and/or transform. Therefore, a partition structure for partitioning the CU into Prediction Units (PUs) and/or Transform Units (TUs), partition information thereof, etc. may not be present in a bitstream.

However, when the size of a CU, which is the unit of partitioning, is greater than the size of a maximum transform block, the CU may be recursively partitioned until the size of the CU becomes less than or equal to the size of the maximum transform block. For example, when the size of a CU is 64×64 and the size of the maximum transform block is 32×32, the CU may be partitioned into four 32×32 blocks so as to perform a transform. For example, when the size of a CU is 32×64 and the size of the maximum transform block is 32×32, the CU may be partitioned into two 32×32 blocks.

In this case, information indicating whether a CU is partitioned for a transform may not be separately signaled. Without signaling, whether a CU is partitioned may be determined via a comparison between the horizontal size (and/or vertical size) of the CU and the horizontal size (and/or vertical size) of the maximum transform block. For example, when the horizontal size of the CU is greater than the horizontal size of the maximum transform block, the CU may be vertically bisected. Further, when the vertical size of the CU is greater than the vertical size of the maximum transform block, the CU may be horizontally bisected.

Information about the maximum size and/or minimum size of a CU and information about the maximum size and/or minimum size of a transform block may be signaled or determined at a level higher than that of the CU. For example, the higher level may be a sequence level, a picture level, a tile level, a tile group level or a slice level. For example, the minimum size of the CU may be set to 4×4. For example, the maximum size of the transform block may be set to 64×64. For example, the maximum size of the transform block may be set to 4×4.

Information about the minimum size of a CU corresponding to the leaf node of a quad-tree (i.e., the minimum size of the quad-tree) and/or information about the maximum depth of a path from the root node to the leaf node of a multi-type tree (i.e., the maximum depth of a multi-type tree) may be signaled or determined at a level higher than that of the CU. For example, the higher level may be a sequence level, a picture level, a slice level, a tile group level or a tile level. Information about the minimum size of a quad-tree and/or information about the maximum depth of a multi-type tree may be separately signaled or determined at each of an intra-slice level and an inter-slice level.

Information about the difference between the size of a CTU and the maximum size of a transform block may be signaled or determined at a level higher than that of a CU. For example, the higher level may be a sequence level, a picture level, a slice level, a tile group level or a tile level. Information about the maximum size of a CU corresponding to each node of a binary tree (i.e., the maximum size of the binary tree) may be determined based on the size and the difference information of a CTU. The maximum size of a CU corresponding to each node of a ternary tree (i.e., the maximum size of the ternary tree) may have different values depending on the type of slice. For example, the maximum size of the ternary tree at an intra-slice level may be 32×32. For example, the maximum size of the ternary tree at an inter-slice level may be 128×128. For example, the minimum size of a CU corresponding to each node of a binary tree (i.e., the minimum size of the binary tree) and/or the minimum size of a CU corresponding to each node of a ternary tree (i.e., the minimum size of the ternary tree) may be set to the minimum size of a CU.

In a further example, the maximum size of a binary tree and/or the maximum size of a ternary tree may be signaled or determined at a slice level. Also, the minimum size of a binary tree and/or the minimum size of a ternary tree may be signaled or determined at a slice level.

Based on the above-described various block sizes and depths, quad-partition information, information indicating whether partitioning in a multi-type tree is performed, partition tree information and/or partition direction information may or may not be present in a bitstream.

For example, when the size of a CU is not greater than the minimum size of a quad-tree, the CU may not include quad-partition information, and quad-partition information of the CU may be inferred as a second value.

For example, when the size of a CU corresponding to each node of a multi-type tree (horizontal size and vertical size) is greater than the maximum size of a binary tree (horizontal size and vertical size) and/or the maximum size of a ternary tree (horizontal size and vertical size), the CU may not be partitioned in a binary-tree form and/or a ternary-tree form. By means of this determination manner, information indicating whether partitioning in a multi-type tree is performed may not be signaled, but may be inferred as a second value.

Alternatively, when the size of a CU corresponding to each node of a multi-type tree (horizontal size and vertical size) is equal to the minimum size of a binary tree (horizontal size and vertical size), or when the size of a CU (horizontal size and vertical size) is equal to twice the minimum size of a ternary tree (horizontal size and vertical size), the CU may not be partitioned in a binary tree form and/or a ternary tree form. By means of this determination manner, information indicating whether partitioning in a multi-type tree is performed may not be signaled, but may be inferred as a second value. The reason for this is that, when a CU is partitioned in a binary tree form and/or a ternary tree form, a CU smaller than the minimum size of the binary tree and/or the minimum size of the ternary tree is generated.

Alternatively, a binary-tree partition or a ternary-tree partition may be limited based on the size of a virtual pipeline data unit (i.e., the size of a pipeline buffer). For example, when a CU is partitioned into sub-CUs unsuitable for the size of a pipeline buffer through a binary-tree partition or a ternary-tree partition, a binary-tree partition or a ternary-tree partition may be limited. The size of the pipeline buffer may be equal to the maximum size of a transform block (e.g., 64×64).

For example, when the size of the pipeline buffer is 64×64, the following partitions may be limited.
Ternary-tree partition for N×M CU (where N and/or M are 128)
Horizontal binary-tree partition for 128×N CU (where N<=64)
Vertical binary-tree partition for N×128 CU (where N<=64)

Alternatively, when the depth of a CU corresponding to each node of a multi-type tree is equal to the maximum depth of the multi-type tree, the CU may not be partitioned in a binary-tree form and/or a ternary-tree form. By means of this determination manner, information indicating whether partitioning in a multi-type tree is performed may not be signaled, but may be inferred as a second value.

Alternatively, information indicating whether partitioning in a multi-type tree is performed may be signaled only when at least one of a vertical binary-tree partition, a horizontal binary-tree partition, a vertical ternary-tree partition, and a horizontal ternary-tree partition is possible for a CU corresponding to each node of a multi-type tree. Otherwise, the CU may not be partitioned in a binary-tree form and/or a ternary-tree form. By means of this determination manner, information indicating whether partitioning in a multi-type tree is performed may not be signaled, but may be inferred as a second value.

Alternatively, partition direction information may be signaled only when both a vertical binary-tree partition and a horizontal binary-tree partition are possible or only when both a vertical ternary-tree partition and a horizontal ternary-tree partition are possible, for a CU corresponding to each node of a multi-type tree. Otherwise, the partition direction information may not be signaled, but may be inferred as a value indicating the direction in which the CU can be partitioned.

Alternatively, partition tree information may be signaled only when both a vertical binary-tree partition and a vertical ternary-tree partition are possible or only when both a horizontal binary-tree partition and a horizontal ternary-tree partition are possible, for a CU corresponding to each node of a multi-type tree. Otherwise, the partition tree information may not be signaled, but may be inferred as a value indicating a tree that can be applied to the partition of the CU.

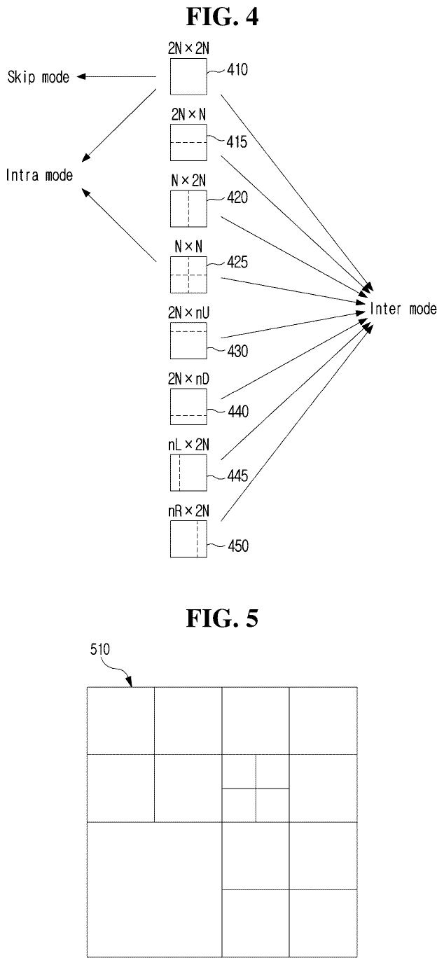

FIG. 4 is a diagram illustrating the form of a Prediction Unit that a Coding Unit can include.

Among CUs partitioned from a LCU, a CU, which is not partitioned any further, may be divided into one or more Prediction Units (PUs).

A PU may be a base unit for prediction. A PU may be encoded and decoded in any one of a skip mode, an inter mode, and an intra mode. A PU may be partitioned into various shapes depending on respective modes. For example, the target block, described above with reference to FIG. 1, and the target block, described above with reference to FIG. 2, may each be a PU.

A CU may not be split into PUs. When the CU is not split into PUs, the size of the CU and the size of a PU may be equal to each other.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2N×nU mode 430, a 2N×nD mode 435, an nL×2N mode 440, and an nR×2N mode 445 may be supported.

In an intra mode, the 2N×2N mode 410 and the N×N mode 425 may be supported. In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8. In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having a size of N×N may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which of a PU having a size of 2N×2N and PUs having sizes of N×N to be encoded based on a comparison of a rate-distortion cost of the PU having a size of 2N×2N and a rate-distortion costs of the PUs having sizes of N×N.

A single CU may be partitioned into one or more PUs, and a PU may be partitioned into multiple PUs.

For example, when a single PU is partitioned into four PUs, the horizontal size and vertical size of each of four PUs generated by partitioning may be half the horizontal size and the vertical size of the PU before being partitioned. When a PU having a 32×32 size is partitioned into four PUs, the size of each of four partitioned PUs may be 16×16. When a single PU is partitioned into four PUs, it may be considered that the PU has been partitioned in a quad-tree structure.

For example, when a single PU is partitioned into two PUs, the horizontal size or the vertical size of each of two PUs generated by partitioning may be half the horizontal size or the vertical size of the PU before being partitioned. When a PU having a 32×32 size is vertically partitioned into two PUs, the size of each of two partitioned PUs may be 16×32. When a PU having a 32×32 size is horizontally partitioned into two PUs, the size of each of two partitioned PUs may be 32×16. When a single PU is partitioned into two PUs, it may be considered that the PU has been partitioned in a binary-tree structure.

FIG. 5 is a diagram illustrating the form of a Transform Unit that can be included in a Coding Unit.

A Transform Unit (TU) may have a base unit that is used for a procedure, such as transform, quantization, inverse transform, dequantization, entropy encoding, and entropy decoding, in a CU.

A TU may have a square shape or a rectangular shape. A shape of a TU may be determined based on a size and/or a shape of a CU.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

It can be considered that when a single CU is split two or more times, the CU is recursively split. Through splitting, a single CU may be composed of Transform Units (TUs) having various sizes.

Alternatively, a single CU may be split into one or more TUs based on the number of vertical lines and/or horizontal lines that split the CU.

A CU may be split into symmetric TUs or asymmetric TUs. For splitting into asymmetric TUs, information about the size and/or shape of each TU may be signaled from the encoding apparatus 100 to the decoding apparatus 200. Alternatively, the size and/or shape of each TU may be derived from information about the size and/or shape of the CU.

A CU may not be split into TUs. When the CU is not split into TUs, the size of the CU and the size of a TU may be equal to each other.

A single CU may be partitioned into one or more TUs, and a TU may be partitioned into multiple TUs.

For example, when a single TU is partitioned into four TUs, the horizontal size and vertical size of each of four TUs generated by partitioning may be half the horizontal size and the vertical size of the TU before being partitioned. When a TU having a 32×32 size is partitioned into four TUs, the size of each of four partitioned TUs may be 16×16. When a single TU is partitioned into four TUs, it may be considered that the TU has been partitioned in a quad-tree structure.

For example, when a single TU is partitioned into two TUs, the horizontal size or the vertical size of each of two TUs generated by partitioning may be half the horizontal size or the vertical size of the TU before being partitioned. When a TU having a 32×32 size is vertically partitioned into two TUs, the size of each of two partitioned TUs may be 16×32. When a TU having a 32×32 size is horizontally partitioned into two TUs, the size of each of two partitioned TUs may be 32×16. When a single TU is partitioned into two TUs, it may be considered that the TU has been partitioned in a binary-tree structure.

In a way differing from that illustrated in FIG. 5, a CU may be split.

For example, a single CU may be split into three CUs. The horizontal sizes or vertical sizes of the three CUs generated from splitting may be ¼, ½, and ¼, respectively, of the horizontal size or vertical size of the original CU before being split.

For example, when a CU having a 32×32 size is vertically split into three CUs, the sizes of the three CUs generated from the splitting may be 8×32, 16×32, and 8×32, respectively. In this way, when a single CU is split into three CUs, it may be considered that the CU is split in the form of a ternary tree.

One of exemplary splitting forms, that is, quad-tree splitting, binary tree splitting, and ternary tree splitting, may be applied to the splitting of a CU, and multiple splitting schemes may be combined and used together for splitting of a CU. Here, the case where multiple splitting schemes are combined and used together may be referred to as “complex tree-format splitting”.

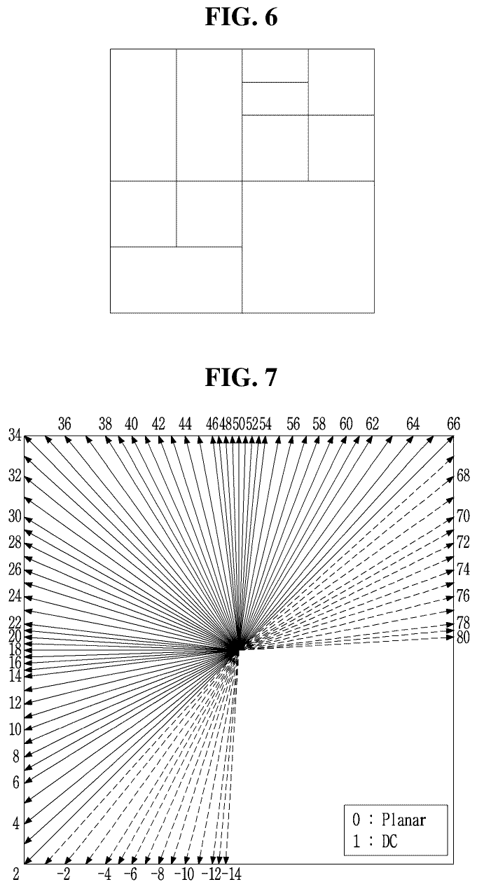

FIG. 6 illustrates the splitting of a block according to an example.

In a video encoding and/or decoding process, a target block may be split, as illustrated in FIG. 6. For example, the target block may be a CU.

For splitting of the target block, an indicator indicating split information may be signaled from the encoding apparatus 100 to the decoding apparatus 200. The split information may be information indicating how the target block is split.

The split information may be one or more of a split flag (hereinafter referred to as “split_flag”), a quad-binary flag (hereinafter referred to as “QB_flag”), a quad-tree flag (hereinafter referred to as “quadtree_flag”), a binary tree flag (hereinafter referred to as “binarytree_flag”), and a binary type flag (hereinafter referred to as “Btype_flag”).

“split_flag” may be a flag indicating whether a block is split. For example, a split_flag value of 1 may indicate that the corresponding block is split. A split_flag value of 0 may indicate that the corresponding block is not split.

“QB_flag” may be a flag indicating which one of a quad-tree form and a binary tree form corresponds to the shape in which the block is split. For example, a QB_flag value of 0 may indicate that the block is split in a quad-tree form. A QB_flag value of 1 may indicate that the block is split in a binary tree form. Alternatively, a QB_flag value of 0 may indicate that the block is split in a binary tree form. A QB_flag value of 1 may indicate that the block is split in a quad-tree form.

“quadtree_flag” may be a flag indicating whether a block is split in a quad-tree form. For example, a quadtree_flag value of 1 may indicate that the block is split in a quad-tree form. A quadtree_flag value of 0 may indicate that the block is not split in a quad-tree form.

“binarytree_flag” may be a flag indicating whether a block is split in a binary tree form. For example, a binarytree_flag value of 1 may indicate that the block is split in a binary tree form. A binarytree_flag value of 0 may indicate that the block is not split in a binary tree form.

“Btype_flag” may be a flag indicating which one of a vertical split and a horizontal split corresponds to a split direction when a block is split in a binary tree form. For example, a Btype_flag value of 0 may indicate that the block is split in a horizontal direction. A Btype_flag value of 1 may indicate that a block is split in a vertical direction. Alternatively, a Btype_flag value of 0 may indicate that the block is split in a vertical direction. A Btype_flag value of 1 may indicate that a block is split in a horizontal direction.

For example, the split information of the block in FIG. 6 may be derived by signaling at least one of quadtree_flag, binarytree_flag, and Btype_flag, as shown in the following Table 1.

TABLE 1

| quadtree_flag | binarytree_flag | Btype_flag |
|---|---|---|
| 1 | | |
| 0 | | |
| | 1 | |
| | | 1 |
| | 0 | |
| | 0 | |
| 1 | | |
| 0 | | |
| | 1 | |
| | | 0 |
| | 0 | |
| | 0 | |
| 0 | | |
| | 0 | |
| 0 | | |
| | 0 | |
| 0 | | |
| | 0 | |
| 0 | | |
| | 1 | |
| | | 0 |
| | 1 | |
| | | 1 |
| | 0 | |
| | 0 | |
| | 0 | |
| 0 | | |
| | 0 | |

For example, the split information of the block in FIG. 6 may be derived by signaling at least one of split_flag, QB_flag and Btype_flag, as shown in the following Table 2 . . .

TABLE 2

| split_flag | QB_flag | Btype_flag |
|---|---|---|
| 1 | | |
| | 0 | |
| 1 | | |
| | 1 | |
| | | 1 |
| 0 | | |
| 0 | | |
| 1 | | |
| | 0 | |
| 1 | | |
| | 1 | |
| | | 0 |
| 0 | | |
| 0 | | |
| 0 | | |
| 0 | | |
| 0 | | |
| 1 | | |
| | 1 | |
| | | 0 |
| 1 | | |
| | | 1 |
| 0 | | |
| 0 | | |
| 0 | | |
| 0 | | |

The splitting method may be limited only to a quad-tree or to a binary tree depending on the size and/or shape of the block. When this limitation is applied, split_flag may be a flag indicating whether a block is split in a quad-tree form or a flag indicating whether a block is split in a binary tree form. The size and shape of a block may be derived depending on the depth information of the block, and the depth information may be signaled from the encoding apparatus 100 to the decoding apparatus 200.

When the size of a block falls within a specific range, only splitting in a quad-tree form may be possible. For example, the specific range may be defined by at least one of a maximum block size and a minimum block size at which only splitting in a quad-tree form is possible.

Information indicating the maximum block size and the minimum block size at which only splitting in a quad-tree form is possible may be signaled from the encoding apparatus 100 to the decoding apparatus 200 through a bitstream. Further, this information may be signaled for at least one of units such as a video, a sequence, a picture, a parameter, a tile group, and a slice (or a segment).

Alternatively, the maximum block size and/or the minimum block size may be fixed sizes predefined by the encoding apparatus 100 and the decoding apparatus 200. For example, when the size of a block is above 64×64 and below 256×256, only splitting in a quad-tree form may be possible. In this case, split_flag may be a flag indicating whether splitting in a quad-tree form is performed.

When the size of a block is greater than the maximum size of a transform block, only partitioning in a quad-tree form may be possible. Here, a sub-block resulting from partitioning may be at least one of a CU and a TU.

In this case, split_flag may be a flag indicating whether a CU is partitioned in a quad-tree form.

When the size of a block falls within the specific range, only splitting in a binary tree form or a ternary tree form may be possible. For example, the specific range may be defined by at least one of a maximum block size and a minimum block size at which only splitting in a binary tree form or a ternary tree form is possible.

Information indicating the maximum block size and/or the minimum block size at which only splitting in a binary tree form or splitting in a ternary tree form is possible may be signaled from the encoding apparatus 100 to the decoding apparatus 200 through a bitstream. Further, this information may be signaled for at least one of units such as a sequence, a picture, and a slice (or a segment).

Alternatively, the maximum block size and/or the minimum block size may be fixed sizes predefined by the encoding apparatus 100 and the decoding apparatus 200. For example, when the size of a block is above 8×8 and below 16×16, only splitting in a binary tree form may be possible. In this case, split_flag may be a flag indicating whether splitting in a binary tree form or a ternary tree form is performed.

The above description of partitioning in a quad-tree form may be equally applied to a binary-tree form and/or a ternary-tree form.

The partition of a block may be limited by a previous partition. For example, when a block is partitioned in a specific binary-tree form and then multiple sub-blocks are generated from the partitioning, each sub-block may be additionally partitioned only in a specific tree form. Here, the specific tree form may be at least one of a binary-tree form, a ternary-tree form, and a quad-tree form.

When the horizontal size or vertical size of a partition block is a size that cannot be split further, the above-described indicator may not be signaled.

FIG. 7 is a diagram for explaining an embodiment of an intra-prediction process.

Arrows radially extending from the center of the graph in FIG. 7 indicate the prediction directions of intra-prediction modes. Further, numbers appearing near the arrows indicate examples of mode values assigned to intra-prediction modes or to the prediction directions of the intra-prediction modes.

In FIG. 7, A number 0 may represent a Planar mode which is a non-directional intra prediction mode. A number 1 may represent a DC mode which is a non-directional intra prediction mode.

Intra encoding and/or decoding may be performed using a reference sample of neighbor block of a target block. The neighbor block may be a reconstructed neighbor block. The reference sample may mean a neighbor sample.

For example, intra encoding and/or decoding may be performed using the value of a reference sample which are included in are reconstructed neighbor block or the coding parameters of the reconstructed neighbor block.

The encoding apparatus 100 and/or the decoding apparatus 200 may generate a prediction block by performing intra prediction on a target block based on information about samples in a target image. When intra prediction is performed, the encoding apparatus 100 and/or the decoding apparatus 200 may generate a prediction block for the target block by performing intra prediction based on information about samples in the target image. When intra prediction is performed, the encoding apparatus 100 and/or the decoding apparatus 200 may perform directional prediction and/or non-directional prediction based on at least one reconstructed reference sample.

A prediction block may be a block generated as a result of performing intra prediction. A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include sizes of 4×4, 8×8, 16×16, 32×32, 64×64, or the like.

Alternatively, a prediction block may a square block having a size of 2×2, 4×4, 8×8, 16×16, 32×32, 64×64 or the like or a rectangular block having a size of 2×8, 4×8, 2×16, 4×16, 8×16, or the like.

Intra prediction may be performed in consideration of the intra-prediction mode for the target block. The number of intra-prediction modes that the target block can have may be a predefined fixed value, and may be a value determined differently depending on the attributes of a prediction block. For example, the attributes of the prediction block may include the size of the prediction block, the type of prediction block, etc. Further, the attribute of a prediction block may indicate a coding parameter for the prediction block.

For example, the number of intra-prediction modes may be fixed at N regardless of the size of a prediction block. Alternatively, the number of intra-prediction modes may be, for example, 3, 5, 9, 17, 34, 35, 36, 65, 67 or 95.

The intra-prediction modes may be non-directional modes or directional modes.

For example, the intra-prediction modes may include two non-directional modes and 65 directional modes corresponding to numbers 0 to 66 illustrated in FIG. 7.

For example, the specified intra-prediction method is used, an intra prediction mode may include two non-directional modes and 93 directional modes corresponding to numbers −14 to 80 illustrated in FIG. 7.

The two non-directional modes may include a DC mode and a planar mode.

A directional mode may be a prediction mode having a specific direction or a specific angle. The directional mode may also be referred to as an “angular mode”.

An intra-prediction mode may be represented by at least one of a mode number, a mode value, a mode angle, and a mode direction. In other words, the terms “(mode) number of the intra-prediction mode”, “(mode) value of the intra-prediction mode”, “(mode) angle of the intra-prediction mode”, and “(mode) direction of the intra-prediction mode” may be used to have the same meaning, and may be used interchangeably with each other.

The number of intra-prediction modes may be M. The value of M may be 1 or more. In other words, the number of intra-prediction modes may be M, which includes the number of non-directional modes and the number of directional modes.

The number of intra-prediction modes may be fixed to M regardless of the size and/or the color component of a block. For example, the number of intra-prediction modes may be fixed at any one of 35 and 67 regardless of the size of a block.

Alternatively, the number of intra-prediction modes may differ depending on the shape, the size and/or the type of the color component of a block.

For example, in FIG. 7, directional prediction modes illustrated as dashed lines may be applied only for a prediction for a non-square block.

For example, the larger the size of the block, the greater the number of intra-prediction modes. Alternatively, the larger the size of the block, the smaller the number of intra-prediction modes. When the size of the block is 4×4 or 8×8, the number of intra-prediction modes may be 67. When the size of the block is 16×16, the number of intra-prediction modes may be 35. When the size of the block is 32×32, the number of intra-prediction modes may be 19. When the size of a block is 64×64, the number of intra-prediction modes may be 7.

For example, the number of intra prediction modes may differ depending on whether a color component is a luma signal or a chroma signal. Alternatively, the number of intra-prediction modes corresponding to a luma component block may be greater than the number of intra-prediction modes corresponding to a chroma component block.

For example, in a vertical mode having a mode value of 50, prediction may be performed in a vertical direction based on the pixel value of a reference sample. For example, in a horizontal mode having a mode value of 18, prediction may be performed in a horizontal direction based on the pixel value of a reference sample.

Even in directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 7, the intra-prediction modes in which a mode value is one of 51, 52, 53, 54, 55, 56, 57, 58, 59, 60, 61, 62, 63, 64, 65, and 66 may be vertical-right modes. Intra-prediction modes in which a mode value is one of 2, 3, 4, 5, 6, 7, 8, 9, 10, 11, 12, 13, 14, 15, 16, and 17 may be horizontal-below modes.

The non-directional mode may include a DC mode and a planar mode. For example, a value of the DC mode may be 1. A value of the planar mode may be 0.

The directional mode may include an angular mode. Among the plurality of the intra prediction modes, remaining modes except for the DC mode and the planar mode may be directional modes.

When the intra-prediction mode is a DC mode, a prediction block may be generated based on the average of pixel values of a plurality of reference pixels. For example, a value of a pixel of a prediction block may be determined based on the average of pixel values of a plurality of reference pixels.

The number of above-described intra-prediction modes and the mode values of respective intra-prediction modes are merely exemplary. The number of above-described intra-prediction modes and the mode values of respective intra-prediction modes may be defined differently depending on the embodiments, implementation and/or requirements.

In order to perform intra prediction on a target block, the step of checking whether samples included in a reconstructed neighbor block can be used as reference samples of a target block may be performed. When a sample that cannot be used as a reference sample of the target block is present among samples in the neighbor block, a value generated via copying and/or interpolation that uses at least one sample value, among the samples included in the reconstructed neighbor block, may replace the sample value of the sample that cannot be used as the reference sample. When the value generated via copying and/or interpolation replaces the sample value of the existing sample, the sample may be used as the reference sample of the target block.

When intra prediction is used, a filter may be applied to at least one of a reference sample and a prediction sample based on at least one of the intra-prediction mode and the size of the target block.

The type of filter to be applied to at least one of a reference sample and a prediction sample may differ depending on at least one of the intra-prediction mode of a target block, the size of the target block, and the shape of the target block. The types of filters may be classified depending on one or more of the length of filter tap, the value of a filter coefficient, and filter strength. The length of filter tap may mean the number of filter taps. Also, the number of filter tap may mean the length of the filter.

When the intra-prediction mode is a planar mode, a sample value of a prediction target block may be generated using a weighted sum of an above reference sample of the target block, a left reference sample of the target block, an above-right reference sample of the target block, and a below-left reference sample of the target block depending on the location of the prediction target sample in the prediction block when the prediction block of the target block is generated.

When the intra-prediction mode is a DC mode, the average of reference samples above the target block and the reference samples to the left of the target block may be used when the prediction block of the target block is generated. Also, filtering using the values of reference samples may be performed on specific rows or specific columns in the target block. The specific rows may be one or more upper rows adjacent to the reference sample. The specific columns may be one or more left columns adjacent to the reference sample.

When the intra-prediction mode is a directional mode, a prediction block may be generated using the above reference samples, left reference samples, above-right reference sample and/or below-left reference sample of the target block.

In order to generate the above-described prediction sample, real-number-based interpolation may be performed.

The intra-prediction mode of the target block may be predicted from intra prediction mode of a neighbor block adjacent to the target block, and the information used for prediction may be entropy-encoded/decoded.

For example, when the intra-prediction modes of the target block and the neighbor block are identical to each other, it may be signaled, using a predefined flag, that the intra-prediction modes of the target block and the neighbor block are identical.

For example, an indicator for indicating an intra-prediction mode identical to that of the target block, among intra-prediction modes of multiple neighbor blocks, may be signaled.

When the intra-prediction modes of the target block and a neighbor block are different from each other, information about the intra-prediction mode of the target block may be encoded and/or decoded using entropy encoding and/or decoding.

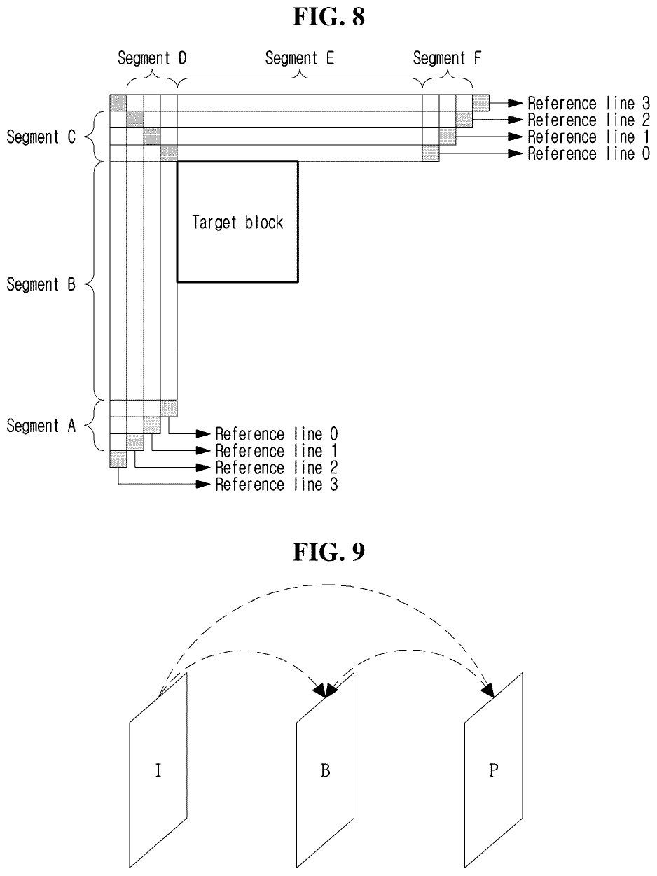

FIG. 8 is a diagram illustrating reference samples used in an intra-prediction procedure.

Reconstructed reference samples used for intra prediction of the target block may include below-left reference samples, left reference samples, an above-left corner reference sample, above reference samples, and above-right reference samples.

For example, the left reference samples may mean reconstructed reference pixels adjacent to the left side of the target block. The above reference samples may mean reconstructed reference pixels adjacent to the top of the target block. The above-left corner reference sample may mean a reconstructed reference pixel located at the above-left corner of the target block. The below-left reference samples may mean reference samples located below a left sample line composed of the left reference samples, among samples located on the same line as the left sample line. The above-right reference samples may mean reference samples located to the right of an above sample line composed of the above reference samples, among samples located on the same line as the above sample line.

When the size of a target block is N×N, the numbers of the below-left reference samples, the left reference samples, the above reference samples, and the above-right reference samples may each be N.

By performing intra prediction on the target block, a prediction block may be generated. The generation of the prediction block may include the determination of the values of pixels in the prediction block. The sizes of the target block and the prediction block may be equal.

The reference samples used for intra prediction of the target block may vary depending on the intra-prediction mode of the target block. The direction of the intra-prediction mode may represent a dependence relationship between the reference samples and the pixels of the prediction block. For example, the value of a specified reference sample may be used as the values of one or more specified pixels in the prediction block. In this case, the specified reference sample and the one or more specified pixels in the prediction block may be the sample and pixels which are positioned in a straight line in the direction of an intra-prediction mode. In other words, the value of the specified reference sample may be copied as the value of a pixel located in a direction reverse to the direction of the intra-prediction mode. Alternatively, the value of a pixel in the prediction block may be the value of a reference sample located in the direction of the intra-prediction mode with respect to the location of the pixel.

In an example, when the intra-prediction mode of a target block is a vertical mode, the above reference samples may be used for intra prediction. When the intra-prediction mode is the vertical mode, the value of a pixel in the prediction block may be the value of a reference sample vertically located above the location of the pixel. Therefore, the above reference samples adjacent to the top of the target block may be used for intra prediction. Furthermore, the values of pixels in one row of the prediction block may be identical to those of the above reference samples.

In an example, when the intra-prediction mode of a target block is a horizontal mode, the left reference samples may be used for intra prediction. When the intra-prediction mode is the horizontal mode, the value of a pixel in the prediction block may be the value of a reference sample horizontally located left to the location of the pixel. Therefore, the left reference samples adjacent to the left of the target block may be used for intra prediction. Furthermore, the values of pixels in one column of the prediction block may be identical to those of the left reference samples.

In an example, when the mode value of the intra-prediction mode of the current block is 34, at least some of the left reference samples, the above-left corner reference sample, and at least some of the above reference samples may be used for intra prediction. When the mode value of the intra-prediction mode is 34, the value of a pixel in the prediction block may be the value of a reference sample diagonally located at the above-left corner of the pixel.

Further, At least a part of the above-right reference samples may be used for intra prediction in a case that an intra prediction mode of which a mode value is a value ranging from 52 to 66.

Further, At least a part of the below-left reference samples may be used for intra prediction in a case that an intra prediction mode of which a mode value is a value ranging from 2 to 17.

Further, the above-left corner reference sample may be used for intra prediction in a case that an intra prediction mode of which a mode value is a value ranging from 19 to 49.

The number of reference samples used to determine the pixel value of one pixel in the prediction block may be either 1, or 2 or more.

As described above, the pixel value of a pixel in the prediction block may be determined depending on the location of the pixel and the location of a reference sample indicated by the direction of the intra-prediction mode. When the location of the pixel and the location of the reference sample indicated by the direction of the intra-prediction mode are integer positions, the value of one reference sample indicated by an integer position may be used to determine the pixel value of the pixel in the prediction block.

When the location of the pixel and the location of the reference sample indicated by the direction of the intra-prediction mode are not integer positions, an interpolated reference sample based on two reference samples closest to the location of the reference sample may be generated. The value of the interpolated reference sample may be used to determine the pixel value of the pixel in the prediction block. In other words, when the location of the pixel in the prediction block and the location of the reference sample indicated by the direction of the intra-prediction mode indicate the location between two reference samples, an interpolated value based on the values of the two samples may be generated.

The prediction block generated via prediction may not be identical to an original target block. In other words, there may be a prediction error which is the difference between the target block and the prediction block, and there may also be a prediction error between the pixel of the target block and the pixel of the prediction block.

Hereinafter, the terms “difference”, “error”, and “residual” may be used to have the same meaning, and may be used interchangeably with each other.

For example, in the case of directional intra prediction, the longer the distance between the pixel of the prediction block and the reference sample, the greater the prediction error that may occur. Such a prediction error may result in discontinuity between the generated prediction block and neighbor blocks.

In order to reduce the prediction error, filtering for the prediction block may be used. Filtering may be configured to adaptively apply a filter to an area, regarded as having a large prediction error, in the prediction block. For example, the area regarded as having a large prediction error may be the boundary of the prediction block. Further, an area regarded as having a large prediction error in the prediction block may differ depending on the intra-prediction mode, and the characteristics of filters may also differ depending thereon.

As illustrated in FIG. 8, for intra prediction of a target block, at least one of reference line 0 to reference line 3 may be used.

Each reference line in FIG. 8 may indicate a reference sample line comprising one or more reference samples. As the number of the reference line is lower, a line of reference samples closer to a target block may be indicated.

Samples in segment A and segment F may be acquired through padding that uses samples closest to the target block in segment B and segment E instead of being acquired from reconstructed neighbor blocks.

Index information indicating a reference sample line to be used for intra-prediction of the target block may be signaled. The index information may indicate a reference sample line to be used for intra-prediction of the target block, among multiple reference sample lines. For example, the index information may have a value corresponding to any one of 0 to 3.

When the top boundary of the target block is the boundary of a CTU, only reference sample line 0 may be available. Therefore, in this case, index information may not be signaled. When an additional reference sample line other than reference sample line 0 is used, filtering of a prediction block, which will be described later, may not be performed.

In the case of inter-color intra prediction, a prediction block for a target block of a second color component may be generated based on the corresponding reconstructed block of a first color component.

For example, the first color component may be a luma component, and the second color component may be a chroma component.

In order to perform inter-color intra prediction, parameters for a linear model between the first color component and the second color component may be derived based on a template.

The template may include reference samples above the target block (above reference samples) and/or reference samples to the left of the target block (left reference samples), and may include above reference samples and/or left reference samples of a reconstructed block of the first color component, which correspond to the reference samples.

For example, parameters for a linear model may be derived using 1) the value of the sample of a first color component having the maximum value, among the samples in the template, 2) the value of the sample of a second color component corresponding to the sample of the first color component, 3) the value of the sample of a first color component having the minimum value, among the samples in the template, and 4) the value of the sample of a second color component corresponding to the sample of the first color component.

When the parameters for the linear model are derived, a prediction block for the target block may be generated by applying the corresponding reconstructed block to the linear model.

Depending on the image format, sub-sampling may be performed on samples neighbor the reconstructed block of the first color component and the corresponding reconstructed block of the first color component. For example, when one sample of the second color component corresponds to four samples of the first color component, one corresponding sample may be calculated by performing sub-sampling on the four samples of the first color component. When sub-sampling is performed, derivation of the parameters for the linear model and inter-color intra prediction may be performed based on the sub-sampled corresponding sample.

Information about whether inter-color intra prediction is performed and/or the range of the template may be signaled in an intra-prediction mode.

The target block may be partitioned into two or four sub-blocks in a horizontal direction and/or a vertical direction.

The sub-blocks resulting from the partitioning may be sequentially reconstructed. That is, as intra-prediction is performed on each sub-block, a sub-prediction block for the sub-block may be generated. Also, as dequantization (inverse quantization) and/or an inverse transform are performed on each sub-block, a sub-residual block for the corresponding sub-block may be generated. A reconstructed sub-block may be generated by adding the sub-prediction block to the sub-residual block. The reconstructed sub-block may be used as a reference sample for intra prediction of the sub-block having the next priority.

A sub-block may be a block including a specific number (e.g., 16) of samples or more. For example, when the target block is an 8×4 block or a 4×8 block, the target block may be partitioned into two sub-blocks. Also, when the target block is a 4×4 block, the target block cannot be partitioned into sub-blocks. When the target block has another size, the target block may be partitioned into four sub-blocks.

Information about whether intra prediction based on such sub-blocks is performed and/or information about a partition direction (horizontal direction or vertical direction) may be signaled.

Such sub-block-based intra prediction may be limited such that it is performed only when reference sample line 0 is used. When sub-block-based intra-prediction is performed, filtering of a prediction block, which will be described below, may not be performed.

A final prediction block may be generated by performing filtering on the prediction block generated via intra prediction.

Filtering may be performed by applying specific weights to a filtering target sample, which is the target to be filtered, a left reference sample, an above reference sample, and/or an above-left reference sample.

The weights and/or reference samples (e.g., the range of reference samples, the locations of the reference samples, etc.) used for filtering may be determined based on at least one of a block size, an intra-prediction mode, and the location of the filtering target sample in a prediction block.

For example, filtering may be performed only in a specific intra-prediction mode (e.g., DC mode, planar mode, vertical mode, horizontal mode, diagonal mode and/or adjacent diagonal mode).

The adjacent diagonal mode may be a mode having a number obtained by adding k to the number of the diagonal mode, and may be a mode having a number obtained by subtracting k from the number of the diagonal mode. In other words, the number of the adjacent diagonal mode may be the sum of the number of the diagonal mode and k, or may be the difference between the number of the diagonal mode and k. For example, k may be a positive integer of 8 or less.

The intra-prediction mode of the target block may be derived using the intra-prediction mode of a neighbor block present near the target block, and such a derived intra-prediction mode may be entropy-encoded and/or entropy-decoded.

For example, when the intra-prediction mode of the target block is identical to the intra-prediction mode of the neighbor block, information indicating that the intra-prediction mode of the target block is identical to the intra-prediction mode of the neighbor block may be signaled using specific flag information.

Further, for example, indicator information for a neighbor block having an intra-prediction mode identical to the intra-prediction mode of the target block, among intra-prediction modes of multiple neighbor blocks, may be signaled.

For example, when the intra-prediction mode of the target block is different from the intra-prediction mode of the neighbor block, entropy encoding and/or entropy decoding may be performed on information about the intra-prediction mode of the target block by performing entropy encoding and/or entropy decoding based on the intra-prediction mode of the neighbor block.

FIG. 9 is a diagram for explaining an embodiment of an inter prediction procedure.

The rectangles shown in FIG. 9 may represent images (or pictures). Further, in FIG. 9, arrows may represent prediction directions. An arrow pointing from a first picture to a second picture means that the second picture refers to the first picture. That is, each image may be encoded and/or decoded depending on the prediction direction.

Images may be classified into an Intra Picture (I picture), a Uni-prediction Picture or Predictive Coded Picture (P picture), and a Bi-prediction Picture or Bi-predictive Coded Picture (B picture) depending on the encoding type. Each picture may be encoded and/or decoded depending on the encoding type thereof.

When a target image that is the target to be encoded is an I picture, the target image may be encoded using data contained in the image itself without inter prediction that refers to other images. For example, an I picture may be encoded only via intra prediction.

When a target image is a P picture, the target image may be encoded via inter prediction, which uses reference pictures existing in one direction. Here, the one direction may be a forward direction or a backward direction.

When a target image is a B picture, the image may be encoded via inter prediction that uses reference pictures existing in two directions, or may be encoded via inter prediction that uses reference pictures existing in one of a forward direction and a backward direction. Here, the two directions may be the forward direction and the backward direction.

A P picture and a B picture that are encoded and/or decoded using reference pictures may be regarded as images in which inter prediction is used.

Below, inter prediction in an inter mode according to an embodiment will be described in detail.

Inter prediction or a motion compensation may be performed using a reference image and motion information.

In an inter mode, the encoding apparatus 100 may perform inter prediction and/or motion compensation on a target block. The decoding apparatus 200 may perform inter prediction and/or motion compensation, corresponding to inter prediction and/or motion compensation performed by the encoding apparatus 100, on a target block.

Motion information of the target block may be individually derived by the encoding apparatus 100 and the decoding apparatus 200 during the inter prediction. The motion information may be derived using motion information of a reconstructed neighbor block, motion information of a col block, and/or motion information of a block adjacent to the col block.

For example, the encoding apparatus 100 or the decoding apparatus 200 may perform prediction and/or motion compensation by using motion information of a spatial candidate and/or a temporal candidate as motion information of the target block. The target block may mean a PU and/or a PU partition.

A spatial candidate may be a reconstructed block which is spatially adjacent to the target block.

A temporal candidate may be a reconstructed block corresponding to the target block in a previously reconstructed co-located picture (col picture).

In inter prediction, the encoding apparatus 100 and the decoding apparatus 200 may improve encoding efficiency and decoding efficiency by utilizing the motion information of a spatial candidate and/or a temporal candidate. The motion information of a spatial candidate may be referred to as ‘spatial motion information’. The motion information of a temporal candidate may be referred to as ‘temporal motion information’.

Below, the motion information of a spatial candidate may be the motion information of a PU including the spatial candidate. The motion information of a temporal candidate may be the motion information of a PU including the temporal candidate. The motion information of a candidate block may be the motion information of a PU including the candidate block.

Inter prediction may be performed using a reference picture.

The reference picture may be at least one of a picture previous to a target picture and a picture subsequent to the target picture. The reference picture may be an image used for the prediction of the target block.

In inter prediction, a region in the reference picture may be specified by utilizing a reference picture index (or refIdx) for indicating a reference picture, a motion vector, which will be described later, etc. Here, the region specified in the reference picture may indicate a reference block.

Inter prediction may select a reference picture, and may also select a reference block corresponding to the target block from the reference picture. Further, inter prediction may generate a prediction block for the target block using the selected reference block.

The motion information may be derived during inter prediction by each of the encoding apparatus 100 and the decoding apparatus 200.

A spatial candidate may be a block 1) which is present in a target picture, 2) which has been previously reconstructed via encoding and/or decoding, and 3) which is adjacent to the target block or is located at the corner of the target block. Here, the “block located at the corner of the target block” may be either a block vertically adjacent to a neighbor block that is horizontally adjacent to the target block, or a block horizontally adjacent to a neighbor block that is vertically adjacent to the target block. Further, “block located at the corner of the target block” may have the same meaning as “block adjacent to the corner of the target block”. The meaning of “block located at the corner of the target block” may be included in the meaning of “block adjacent to the target block”.

For example, a spatial candidate may be a reconstructed block located to the left of the target block, a reconstructed block located above the target block, a reconstructed block located at the below-left corner of the target block, a reconstructed block located at the above-right corner of the target block, or a reconstructed block located at the above-left corner of the target block.

Each of the encoding apparatus 100 and the decoding apparatus 200 may identify a block present at the location spatially corresponding to the target block in a col picture. The location of the target block in the target picture and the location of the identified block in the col picture may correspond to each other.

Each of the encoding apparatus 100 and the decoding apparatus 200 may determine a col block present at the predefined relative location for the identified block to be a temporal candidate. The predefined relative location may be a location present inside and/or outside the identified block.

For example, the col block may include a first col block and a second col block. When the coordinates of the identified block are (xP, yP) and the size of the identified block is represented by (nPSW, nPSH), the first col block may be a block located at coordinates (xP+nPSW, yP+nPSH). The second col block may be a block located at coordinates (xP+ (nPSW>>1), yP+ (nPSH>>1)). The second col block may be selectively used when the first col block is unavailable.

The motion vector of the target block may be determined based on the motion vector of the col block. Each of the encoding apparatus 100 and the decoding apparatus 200 may scale the motion vector of the col block. The scaled motion vector of the col block may be used as the motion vector of the target block. Further, a motion vector for the motion information of a temporal candidate stored in a list may be a scaled motion vector.

The ratio of the motion vector of the target block to the motion vector of the col block may be identical to the ratio of a first temporal distance to a second temporal distance. The first temporal distance may be the distance between the reference picture and the target picture of the target block. The second temporal distance may be the distance between the reference picture and the col picture of the col block.

The scheme for deriving motion information may change depending on the inter-prediction mode of a target block. For example, as inter-prediction modes applied for inter prediction, an Advanced Motion Vector Predictor (AMVP) mode, a merge mode, a skip mode, a merge mode with a motion vector difference, a sub block merge mode, a triangle partition mode, an inter-intra combined prediction mode, an affine inter mode, a current picture reference mode, etc. may be present. The merge mode may also be referred to as a “motion merge mode”. Individual modes will be described in detail below.

### 1) AMVP Mode

When an AMVP mode is used, the encoding apparatus 100 may search a neighbor region of a target block for a similar block. The encoding apparatus 100 may acquire a prediction block by performing prediction on the target block using motion information of the found similar block. The encoding apparatus 100 may encode a residual block, which is the difference between the target block and the prediction block.

### 1-1) Creation of List of Prediction Motion Vector Candidates

When an AMVP mode is used as the prediction mode, each of the encoding apparatus

100 and the decoding apparatus 200 may create a list of prediction motion vector candidates using the motion vector of a spatial candidate, the motion vector of a temporal candidate, and a zero vector. The prediction motion vector candidate list may include one or more prediction motion vector candidates. At least one of the motion vector of a spatial candidate, the motion vector of a temporal candidate, and a zero vector may be determined and used as a prediction motion vector candidate.

Hereinafter, the terms “prediction motion vector (candidate)” and “motion vector (candidate)” may be used to have the same meaning, and may be used interchangeably with each other.

Hereinafter, the terms “prediction motion vector candidate” and “AMVP candidate” may be used to have the same meaning, and may be used interchangeably with each other.

Hereinafter, the terms “prediction motion vector candidate list” and “AMVP candidate list” may be used to have the same meaning, and may be used interchangeably with each other. Spatial candidates may include a reconstructed spatial neighbor block. In other words, the motion vector of the reconstructed neighbor block may be referred to as a “spatial prediction motion vector candidate”.

Temporal candidates may include a col block and a block adjacent to the col block. In other words, the motion vector of the col block or the motion vector of the block adjacent to the col block may be referred to as a “temporal prediction motion vector candidate”.

The zero vector may be a (0, 0) motion vector.

The prediction motion vector candidates may be motion vector predictors for predicting a motion vector. Also, in the encoding apparatus 100, each prediction motion vector candidate may be an initial search location for a motion vector.

1-2) Search for Motion Vectors that Use List of Prediction Motion Vector Candidates

The encoding apparatus 100 may determine the motion vector to be used to encode a target block within a search range using a list of prediction motion vector candidates. Further, the encoding apparatus 100 may determine a prediction motion vector candidate to be used as the prediction motion vector of the target block, among prediction motion vector candidates present in the prediction motion vector candidate list.

The motion vector to be used to encode the target block may be a motion vector that can be encoded at minimum cost.

Further, the encoding apparatus 100 may determine whether to use the AMVP mode to encode the target block.

### 1-3) Transmission of Inter-Prediction Information

The encoding apparatus 100 may generate a bitstream including inter-prediction information required for inter prediction. The decoding apparatus 200 may perform inter prediction on the target block using the inter-prediction information of the bitstream.

The inter-prediction information may contain 1) mode information indicating whether an AMVP mode is used, 2) a prediction motion vector index, 3) a Motion Vector Difference (MVD), 4) a reference direction, and 5) a reference picture index.

Hereinafter, the terms “prediction motion vector index” and “AMVP index” may be used to have the same meaning, and may be used interchangeably with each other.

Further, the inter-prediction information may contain a residual signal.

The decoding apparatus 200 may acquire a prediction motion vector index, an MVD, a reference direction, and a reference picture index from the bitstream through entropy decoding when mode information indicates that the AMVP mode is used.

The prediction motion vector index may indicate a prediction motion vector candidate to be used for the prediction of a target block, among prediction motion vector candidates included in the prediction motion vector candidate list.

1-4) Inter Prediction in AMVP Mode that Uses Inter-Prediction Information

The decoding apparatus 200 may derive prediction motion vector candidates using a prediction motion vector candidate list, and may determine the motion information of a target block based on the derived prediction motion vector candidates.

The decoding apparatus 200 may determine a motion vector candidate for the target block, among the prediction motion vector candidates included in the prediction motion vector candidate list, using a prediction motion vector index. The decoding apparatus 200 may select a prediction motion vector candidate, indicated by the prediction motion vector index, from among prediction motion vector candidates included in the prediction motion vector candidate list, as the prediction motion vector of the target block.

The encoding apparatus 100 may generate an entropy-encoded prediction motion vector index by applying entropy encoding to a prediction motion vector index, and may generate a bitstream including the entropy-encoded prediction motion vector index. The entropy-encoded prediction motion vector index may be signaled from the encoding apparatus 100 to the decoding apparatus 200 through a bitstream. The decoding apparatus 200 may extract the entropy-encoded prediction motion vector index from the bitstream, and may acquire the prediction motion vector index by applying entropy decoding to the entropy-encoded prediction motion vector index.

The motion vector to be actually used for inter prediction of the target block may not match the prediction motion vector. In order to indicate the difference between the motion vector to be actually used for inter prediction of the target block and the prediction motion vector, an MVD may be used. The encoding apparatus 100 may derive a prediction motion vector similar to the motion vector to be actually used for inter prediction of the target block so as to use an MVD that is as small as possible.

A Motion Vector Difference (MVD) may be the difference between the motion vector of the target block and the prediction motion vector. The encoding apparatus 100 may calculate the MVD, and may generate an entropy-encoded MVD by applying entropy encoding to the MVD. The encoding apparatus 100 may generate a bitstream including the entropy-encoded MVD.

The MVD may be transmitted from the encoding apparatus 100 to the decoding apparatus 200 through the bitstream. The decoding apparatus 200 may extract the entropy-encoded MVD from the bitstream, and may acquire the MVD by applying entropy decoding to the entropy-encoded MVD.

The decoding apparatus 200 may derive the motion vector of the target block by summing the MVD and the prediction motion vector. In other words, the motion vector of the target block derived by the decoding apparatus 200 may be the sum of the MVD and the motion vector candidate.

Also, the encoding apparatus 100 may generate entropy-encoded MVD resolution information by applying entropy encoding to calculated MVD resolution information, and may generate a bitstream including the entropy-encoded MVD resolution information. The decoding apparatus 200 may extract the entropy-encoded MVD resolution information from the bitstream, and may acquire MVD resolution information by applying entropy decoding to the entropy-encoded MVD resolution information. The decoding apparatus 200 may adjust the resolution of the MVD using the MVD resolution information.

Meanwhile, the encoding apparatus 100 may calculate an MVD based on an affine model. The decoding apparatus 200 may derive the affine control motion vector of the target block through the sum of the MVD and an affine control motion vector candidate, and may derive the motion vector of a sub-block using the affine control motion vector.

The reference direction may indicate a list of reference pictures to be used for prediction of the target block. For example, the reference direction may indicate one of a reference picture list L0 and a reference picture list L1.

The reference direction merely indicates the reference picture list to be used for prediction of the target block, and may not mean that the directions of reference pictures are limited to a forward direction or a backward direction. In other words, each of the reference picture list L0 and the reference picture list L1 may include pictures in a forward direction and/or a backward direction.

That the reference direction is unidirectional may mean that a single reference picture list is used. That the reference direction is bidirectional may mean that two reference picture lists are used. In other words, the reference direction may indicate one of the case where only the reference picture list L0 is used, the case where only the reference picture list L1 is used, and the case where two reference picture lists are used.

The reference picture index may indicate a reference picture that is used for prediction of the target block, among reference pictures present in a reference picture list. The encoding apparatus 100 may generate an entropy-encoded reference picture index by applying entropy encoding to the reference picture index, and may generate a bitstream including the entropy-encoded reference picture index. The entropy-encoded reference picture index may be signaled from the encoding apparatus 100 to the decoding apparatus 200 through the bitstream. The decoding apparatus 200 may extract the entropy-encoded reference picture index from the bitstream, and may acquire the reference picture index by applying entropy decoding to the entropy-encoded reference picture index.

When two reference picture lists are used to predict the target block, a single reference picture index and a single motion vector may be used for each of the reference picture lists. Further, when two reference picture lists are used to predict the target block, two prediction blocks may be specified for the target block. For example, the (final) prediction block of the target block may be generated using the average or weighted sum of the two prediction blocks for the target block.

The motion vector of the target block may be derived by the prediction motion vector index, the MVD, the reference direction, and the reference picture index.

The decoding apparatus 200 may generate a prediction block for the target block based on the derived motion vector and the reference picture index. For example, the prediction block may be a reference block, indicated by the derived motion vector, in the reference picture indicated by the reference picture index.

Since the prediction motion vector index and the MVD are encoded without the motion vector itself of the target block being encoded, the number of bits transmitted from the encoding apparatus 100 to the decoding apparatus 200 may be decreased, and encoding efficiency may be improved.

For the target block, the motion information of reconstructed neighbor blocks may be used. In a specific inter-prediction mode, the encoding apparatus 100 may not separately encode the actual motion information of the target block. The motion information of the target block is not encoded, and additional information that enables the motion information of the target block to be derived using the motion information of reconstructed neighbor blocks may be encoded instead. As the additional information is encoded, the number of bits transmitted to the decoding apparatus 200 may be decreased, and encoding efficiency may be improved.

For example, as inter-prediction modes in which the motion information of the target block is not directly encoded, there may be a skip mode and/or a merge mode. Here, each of the encoding apparatus 100 and the decoding apparatus 200 may use an identifier and/or an index that indicates a unit, the motion information of which is to be used as the motion information of the target unit, among reconstructed neighbor units.

### 2) Merge Mode

As a scheme for deriving the motion information of a target block, there is merging. The term “merging” may mean the merging of the motion of multiple blocks. “Merging” may mean that the motion information of one block is also applied to other blocks. In other words, a merge mode may be a mode in which the motion information of the target block is derived from the motion information of a neighbor block.

When a merge mode is used, the encoding apparatus 100 may predict the motion information of a target block using the motion information of a spatial candidate and/or the motion information of a temporal candidate. The spatial candidate may include a reconstructed spatial neighbor block that is spatially adjacent to the target block. The spatial neighbor block may include a left neighbor block and an above neighbor block. The temporal candidate may include a col block. The terms “spatial candidate” and “spatial merge candidate” may be used to have the same meaning, and may be used interchangeably with each other. The terms “temporal candidate” and “temporal merge candidate” may be used to have the same meaning, and may be used interchangeably with each other.

The encoding apparatus 100 may acquire a prediction block via prediction. The encoding apparatus 100 may encode a residual block, which is the difference between the target block and the prediction block.

### 2-1) Creation of Merge Candidate List

When the merge mode is used, each of the encoding apparatus 100 and the decoding apparatus 200 may create a merge candidate list using the motion information of a spatial candidate and/or the motion information of a temporal candidate. The motion information may include 1) a motion vector, 2) a reference picture index, and 3) a reference direction. The reference direction may be unidirectional or bidirectional. The reference direction may mean a inter prediction indicator.

The merge candidate list may include merge candidates. The merge candidates may be motion information. In other words, the merge candidate list may be a list in which pieces of motion information are stored.

The merge candidates may be pieces of motion information of temporal candidates and/or spatial candidates. In other words, the merge candidates list may comprise motion information of a temporal candidates and/or spatial candidates, etc.

Further, the merge candidate list may include new merge candidates generated by a combination of merge candidates that are already present in the merge candidate list. In other words, the merge candidate list may include new motion information generated by a combination of pieces of motion information previously present in the merge candidate list.

Also, a merge candidate list may include history-based merge candidates. The history-based merge candidates may be the motion information of a block which is encoded and/or decoded prior to a target block.

Also, a merge candidate list may include a merge candidate based on an average of two merge candidates.

The merge candidates may be specific modes deriving inter prediction information. The merge candidate may be information indicating a specific mode deriving inter prediction information. Inter prediction information of a target block may be derived according to a specific mode which the merge candidate indicates. Furthermore, the specific mode may include a process of deriving a series of inter prediction information. This specific mode may be an inter prediction information derivation mode or a motion information derivation mode.

The inter prediction information of the target block may be derived according to the mode indicated by the merge candidate selected by the merge index among the merge candidates in the merge candidate list.

For example, the motion information derivation modes in the merge candidate list may be at least one of 1) motion information derivation mode for a sub-block unit and 2) an affine motion information derivation mode.

Furthermore, the merge candidate list may include motion information of a zero vector. The zero vector may also be referred to as a “zero-merge candidate”.

In other words, pieces of motion information in the merge candidate list may be at least one of 1) motion information of a spatial candidate, 2) motion information of a temporal candidate, 3) motion information generated by a combination of pieces of motion information previously present in the merge candidate list, and 4) a zero vector.

Motion information may include 1) a motion vector, 2) a reference picture index, and 3) a reference direction. The reference direction may also be referred to as an “inter-prediction indicator”. The reference direction may be unidirectional or bidirectional. The unidirectional reference direction may indicate L0 prediction or L1 prediction.

The merge candidate list may be created before prediction in the merge mode is performed.

The number of merge candidates in the merge candidate list may be predefined. Each of the encoding apparatus 100 and the decoding apparatus 200 may add merge candidates to the merge candidate list depending on the predefined scheme and predefined priorities so that the merge candidate list has a predefined number of merge candidates. The merge candidate list of the encoding apparatus 100 and the merge candidate list of the decoding apparatus 200 may be made identical to each other using the predefined scheme and the predefined priorities.

Merging may be applied on a CU basis or a PU basis. When merging is performed on a CU basis or a PU basis, the encoding apparatus 100 may transmit a bitstream including predefined information to the decoding apparatus 200. For example, the predefined information may contain 1) information indicating whether to perform merging for individual block partitions, and 2) information about a block with which merging is to be performed, among blocks that are spatial candidates and/or temporal candidates for the target block.

2-2) Search for Motion Vector that Uses Merge Candidate List

The encoding apparatus 100 may determine merge candidates to be used to encode a target block. For example, the encoding apparatus 100 may perform prediction on the target block using merge candidates in the merge candidate list, and may generate residual blocks for the merge candidates. The encoding apparatus 100 may use a merge candidate that incurs the minimum cost in prediction and in the encoding of residual blocks to encode the target block.

Further, the encoding apparatus 100 may determine whether to use a merge mode to encode the target block.

### 2-3) Transmission of Inter-Prediction Information

The encoding apparatus 100 may generate a bitstream that includes inter-prediction information required for inter prediction. The encoding apparatus 100 may generate entropy-encoded inter-prediction information by performing entropy encoding on inter-prediction information, and may transmit a bitstream including the entropy-encoded inter-prediction information to the decoding apparatus 200. Through the bitstream, the entropy-encoded inter-prediction information may be signaled to the decoding apparatus 200 by the encoding apparatus 100. The decoding apparatus 200 may extract entropy-encoded inter-prediction information from the bitstream, and may acquire inter-prediction information by applying entropy decoding to the entropy-encoded inter-prediction information.

The decoding apparatus 200 may perform inter prediction on the target block using the inter-prediction information of the bitstream.

information indicating whether a merge mode is used, 2) a merge index and 3) correction information.

Further, the inter-prediction information may contain a residual signal.

The decoding apparatus 200 may acquire the merge index from the bitstream only when the mode information indicates that the merge mode is used.

The mode information may be a merge flag. The unit of the mode information may be a block. Information about the block may include mode information, and the mode information may indicate whether a merge mode is applied to the block.

The merge index may indicate a merge candidate to be used for the prediction of the target block, among merge candidates included in the merge candidate list. Alternatively, the merge index may indicate a block with which the target block is to be merged, among neighbor blocks spatially or temporally adjacent to the target block.

The encoding apparatus 100 may select a merge candidate having the highest encoding performance among the merge candidates included in the merge candidate list and set a value of the merge index to indicate the selected merge candidate.

Correction information may be information used to correct a motion vector. The encoding apparatus 100 may generate correction information. The decoding apparatus 200 may correct the motion vector of a merge candidate selected by a merge index based on the correction information.

The correction information may include at least one of information indicating whether correction is to be performed, correction direction information, and correction size information. A prediction mode in which the motion vector is corrected based on the signaled correction information may be referred to as a “merge mode having a motion vector difference”.

2-4) Inter Prediction of Merge Mode that Uses Inter-Prediction Information

The decoding apparatus 200 may perform prediction on the target block using the merge candidate indicated by the merge index, among merge candidates included in the merge candidate list.

The motion vector of the target block may be specified by the motion vector, reference picture index, and reference direction of the merge candidate indicated by the merge index.

3) Skip mode

A skip mode may be a mode in which the motion information of a spatial candidate or the motion information of a temporal candidate is applied to the target block without change. Also, the skip mode may be a mode in which a residual signal is not used. In other words, when the skip mode is used, a reconstructed block may be the same as a prediction block.

The difference between the merge mode and the skip mode lies in whether or not a residual signal is transmitted or used. That is, the skip mode may be similar to the merge mode except that a residual signal is not transmitted or used.

When the skip mode is used, the encoding apparatus 100 may transmit information about a block, the motion information of which is to be used as the motion information of the target block, among blocks that are spatial candidates or temporal candidates, to the decoding apparatus 200 through a bitstream. The encoding apparatus 100 may generate entropy-encoded information by performing entropy encoding on the information, and may signal the entropy-encoded information to the decoding apparatus 200 through a bitstream. The decoding apparatus 200 may extract entropy-encoded information from the bitstream, and may acquire information by applying entropy decoding to the entropy-encoded information.

Further, when the skip mode is used, the encoding apparatus 100 may not transmit other syntax information, such as an MVD, to the decoding apparatus 200. For example, when the skip mode is used, the encoding apparatus 100 may not signal a syntax element related to at least one of an MVD, a coded block flag, and a transform coefficient level to the decoding apparatus 200.

### 3-1) Creation of Merge Candidate List

The skip mode may also use a merge candidate list. In other words, a merge candidate list may be used both in the merge mode and in the skip mode. In this aspect, the merge candidate list may also be referred to as a “skip candidate list” or a “merge/skip candidate list”.

Alternatively, the skip mode may use an additional candidate list different from that of the merge mode. In this case, in the following description, a merge candidate list and a merge candidate may be replaced with a skip candidate list and a skip candidate, respectively.

The merge candidate list may be created before prediction in the skip mode is performed.

3-2) Search for Motion Vector that Uses Merge Candidate List

The encoding apparatus 100 may determine the merge candidates to be used to encode a target block. For example, the encoding apparatus 100 may perform prediction on the target block using the merge candidates in a merge candidate list. The encoding apparatus 100 may use a merge candidate that incurs the minimum cost in prediction to encode the target block.

Further, the encoding apparatus 100 may determine whether to use a skip mode to encode the target block.

### 3-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may include 1) mode information indicating whether a skip mode is used, and 2) a skip index.

The skip index may be identical to the above-described merge index.

When the skip mode is used, the target block may be encoded without using a residual signal. The inter-prediction information may not contain a residual signal. Alternatively, the bitstream may not include a residual signal.

The decoding apparatus 200 may acquire a skip index from the bitstream only when the mode information indicates that the skip mode is used. As described above, a merge index and a skip index may be identical to each other. The decoding apparatus 200 may acquire the skip index from the bitstream only when the mode information indicates that the merge mode or the skip mode is used.

The skip index may indicate the merge candidate to be used for the prediction of the target block, among the merge candidates included in the merge candidate list.

3-4) Inter Prediction in Skip Mode that Uses Inter-Prediction Information

The decoding apparatus 200 may perform prediction on the target block using a merge candidate indicated by a skip index, among the merge candidates included in a merge candidate list.

The motion vector of the target block may be specified by the motion vector, reference picture index, and reference direction of the merge candidate indicated by the skip index.

### 4) Current Picture Reference Mode

The current picture reference mode may denote a prediction mode that uses a previously reconstructed region in a target picture to which a target block belongs.

A motion vector for specifying the previously reconstructed region may be used. Whether the target block has been encoded in the current picture reference mode may be determined using the reference picture index of the target block.

A flag or index indicating whether the target block is a block encoded in the current picture reference mode may be signaled by the encoding apparatus 100 to the decoding apparatus 200. Alternatively, whether the target block is a block encoded in the current picture reference mode may be inferred through the reference picture index of the target block.

When the target block is encoded in the current picture reference mode, the target picture may exist at a fixed location or an arbitrary location in a reference picture list for the target block.

For example, the fixed location may be either a location where a value of the reference picture index is 0 or the last location.

When the target picture exists at an arbitrary location in the reference picture list, an additional reference picture index indicating such an arbitrary location may be signaled by the encoding apparatus 100 to the decoding apparatus 200.

### 5) Subblock Merge Mode

A sub-block merge mode may be a mode in which motion information is derived from the sub-block of a CU.

When the sub-block merge mode is applied, a sub-block merge candidate list may be generated using the motion information of a co-located sub-block (col-sub-block) of a target sub-block (i.e., a sub-block-based temporal merge candidate) in a reference image and/or an affine control point motion vector merge candidate.

### 6) Triangle Partition Mode

In a triangle partition mode, a target block may be partitioned in a diagonal direction, and sub-target blocks resulting from partitioning may be generated. For each sub-target block, motion information of the corresponding sub-target block may be derived, and a prediction sample for each sub-target block may be derived using the derived motion information. A prediction sample for the target block may be derived through a weighted sum of the prediction samples for the sub-target blocks resulting from the partitioning.

### 7) Combination Inter-Intra Prediction Mode

The combination inter-intra prediction mode may be a mode in which a prediction sample for a target block is derived using a weighted sum of a prediction sample generated via inter-prediction and a prediction sample generated via intra-prediction.

In the above-described modes, the decoding apparatus 200 may autonomously correct derived motion information. For example, the decoding apparatus 200 may search a specific area for motion information having the minimum sum of Absolute Differences (SAD) based on a reference block indicated by the derived motion information, and may derive the found motion information as corrected motion information.

In the above-described modes, the decoding apparatus 200 may compensate for the prediction sample derived via inter prediction using an optical flow.

In the above-described AMVP mode, merge mode, skip mode, etc., motion information to be used for prediction of the target block may be specified among pieces of motion information in a list using the index information of the list.

In order to improve encoding efficiency, the encoding apparatus 100 may signal only the index of an element that incurs the minimum cost in inter prediction of the target block, among elements in the list. The encoding apparatus 100 may encode the index, and may signal the encoded index.

Therefore, the above-described lists (i.e. the prediction motion vector candidate list and the merge candidate list) must be able to be derived by the encoding apparatus 100 and the decoding apparatus 200 using the same scheme based on the same data. Here, the same data may include a reconstructed picture and a reconstructed block. Further, in order to specify an element using an index, the order of the elements in the list must be fixed.

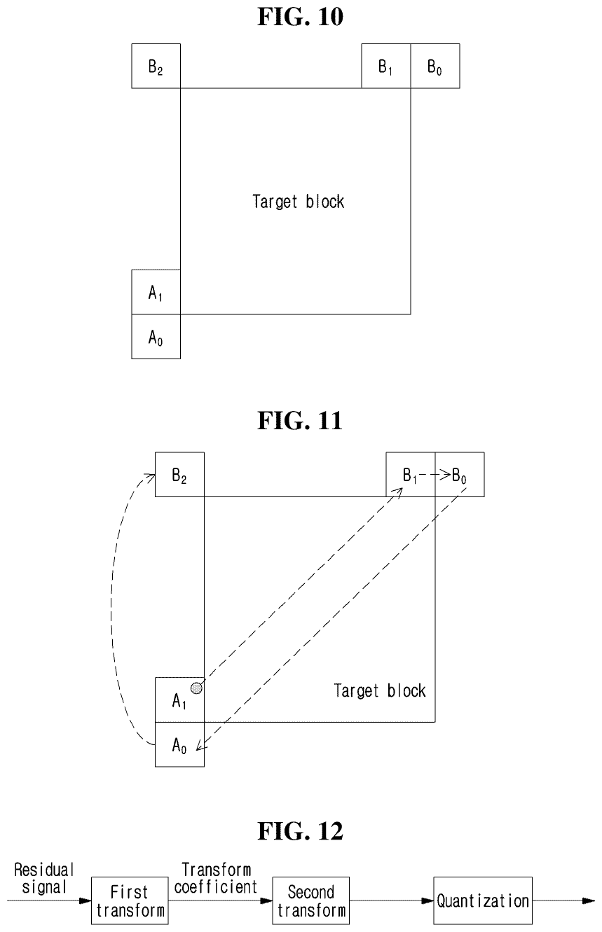

FIG. 10 illustrates spatial candidates according to an embodiment.

In FIG. 10, the locations of spatial candidates are illustrated.

The large block in the center of the drawing may denote a target block. Five small blocks may denote spatial candidates.

The coordinates of the target block may be (xP, yP), and the size of the target block may be represented by (nPSW, nPSH).

Spatial candidate A₀ may be a block adjacent to the below-left corner of the target block. A₀ may be a block that occupies pixels located at coordinates (xP−1, yP+nPSH).

Spatial candidate A₁ may be a block adjacent to the left of the target block. A₁ may be a lowermost block, among blocks adjacent to the left of the target block. Alternatively, A₁ may be a block adjacent to the top of A₀. A₁ may be a block that occupies pixels located at coordinates (xP−1, yP+nPSH−1).

Spatial candidate B₀ may be a block adjacent to the above-right corner of the target block. B₀ may be a block that occupies pixels located at coordinates (xP+nPSW, yP−1).

Spatial candidate B₁ may be a block adjacent to the top of the target block. B₁ may be a rightmost block, among blocks adjacent to the top of the target block. Alternatively, B₁ may be a block adjacent to the left of B₀. B₁ may be a block that occupies pixels located at coordinates (xP+nPSW−1, yP−1).

Spatial candidate B₂ may be a block adjacent to the above-left corner of the target block. B₂ may be a block that occupies pixels located at coordinates (xP−1, yP−1).

### Determination of Availability of Spatial Candidate and Temporal Candidate

In order to include the motion information of a spatial candidate or the motion information of a temporal candidate in a list, it must be determined whether the motion information of the spatial candidate or the motion information of the temporal candidate is available.

Hereinafter, a candidate block may include a spatial candidate and a temporal candidate.

For example, the determination may be performed by sequentially applying the following steps 1) to 4).

Step 1) When a PU including a candidate block is out of the boundary of a picture, the availability of the candidate block may be set to “false”. The expression “availability is set to false” may have the same meaning as “set to be unavailable”.

Step 2) When a PU including a candidate block is out of the boundary of a slice, the availability of the candidate block may be set to “false”. When the target block and the candidate block are located in different slices, the availability of the candidate block may be set to “false”.

Step 3) When a PU including a candidate block is out of the boundary of a tile, the availability of the candidate block may be set to “false”. When the target block and the candidate block are located in different tiles, the availability of the candidate block may be set to “false”.

Step 4) When the prediction mode of a PU including a candidate block is an intra-prediction mode, the availability of the candidate block may be set to “false”. When a PU including a candidate block does not use inter prediction, the availability of the candidate block may be set to “false”.

FIG. 11 illustrates the order of addition of motion information of spatial candidates to a merge list according to an embodiment.

As shown in FIG. 11, when pieces of motion information of spatial candidates are added to a merge list, the order of A₁, B₁, B₀, A₀, and B₂ may be used. That is, pieces of motion information of available spatial candidates may be added to the merge list in the order of A₁, B₁, B₀, A₀, and B₂.

### Method for Deriving Merge List in Merge Mode and Skip Mode

As described above, the maximum number of merge candidates in the merge list may be set. The set maximum number is indicated by “N”. The set number may be transmitted from the encoding apparatus 100 to the decoding apparatus 200. The slice header of a slice may include N. In other words, the maximum number of merge candidates in the merge list for the target block of the slice may be set by the slice header. For example, the value of N may be basically 5.

Pieces of motion information (i.e., merge candidates) may be added to the merge list in the order of the following steps 1) to 4).

Step 1) Among spatial candidates, available spatial candidates may be added to the merge list. Pieces of motion information of the available spatial candidates may be added to the merge list in the order illustrated in FIG. 11. Here, when the motion information of an available spatial candidate overlaps other motion information already present in the merge list, the motion information may not be added to the merge list. The operation of checking whether the corresponding motion information overlaps other motion information present in the list may be referred to in brief as an “overlap check”.

The maximum number of pieces of motion information that are added may be N.

Step 2) When the number of pieces of motion information in the merge list is less than N and a temporal candidate is available, the motion information of the temporal candidate may be added to the merge list. Here, when the motion information of the available temporal candidate overlaps other motion information already present in the merge list, the motion information may not be added to the merge list.

Step 3) When the number of pieces of motion information in the merge list is less than N and the type of a target slice is “B”, combined motion information generated by combined bidirectional prediction (bi-prediction) may be added to the merge list.

The target slice may be a slice including a target block.

The combined motion information may be a combination of L0 motion information and L1 motion information. L0 motion information may be motion information that refers only to a reference picture list L0. L1 motion information may be motion information that refers only to a reference picture list L1.

In the merge list, one or more pieces of L0 motion information may be present. Further, in the merge list, one or more pieces of L1 motion information may be present.

The combined motion information may include one or more pieces of combined motion information. When the combined motion information is generated, L0 motion information and L1 motion information, which are to be used for generation, among the one or more pieces of L0 motion information and the one or more pieces of L1 motion information, may be predefined. One or more pieces of combined motion information may be generated in a predefined order via combined bidirectional prediction, which uses a pair of different pieces of motion information in the merge list. One of the pair of different pieces of motion information may be L0 motion information and the other of the pair may be L1 motion information.

For example, combined motion information that is added with the highest priority may be a combination of L0 motion information having a merge index of 0 and L1 motion information having a merge index of 1. When motion information having a merge index of 0 is not L0 motion information or when motion information having a merge index of 1 is not L1 motion information, the combined motion information may be neither generated nor added. Next, the combined motion information that is added with the next priority may be a combination of L0 motion information, having a merge index of 1, and L1 motion information, having a merge index of 0. Subsequent detailed combinations may conform to other combinations of video encoding/decoding fields.

Here, when the combined motion information overlaps other motion information already present in the merge list, the combined motion information may not be added to the merge list.

Step 4) When the number of pieces of motion information in the merge list is less than N, motion information of a zero vector may be added to the merge list.

The zero-vector motion information may be motion information for which the motion vector is a zero vector.

The number of pieces of zero-vector motion information may be one or more. The reference picture indices of one or more pieces of zero-vector motion information may be different from each other. For example, the value of the reference picture index of first zero-vector motion information may be 0. The value of the reference picture index of second zero-vector motion information may be 1.

The number of pieces of zero-vector motion information may be identical to the number of reference pictures in the reference picture list.

The reference direction of zero-vector motion information may be bidirectional. Both of the motion vectors may be zero vectors. The number of pieces of zero-vector motion information may be the smaller one of the number of reference pictures in the reference picture list L0 and the number of reference pictures in the reference picture list L1. Alternatively, when the number of reference pictures in the reference picture list L0 and the number of reference pictures in the reference picture list L1 are different from each other, a reference direction that is unidirectional may be used for a reference picture index that may be applied only to a single reference picture list.

The encoding apparatus 100 and/or the decoding apparatus 200 may sequentially add the zero-vector motion information to the merge list while changing the reference picture index.

When zero-vector motion information overlaps other motion information already present in the merge list, the zero-vector motion information may not be added to the merge list.

The order of the above-described steps 1) to 4) is merely exemplary, and may be changed. Further, some of the above steps may be omitted depending on predefined conditions.

### Method for Deriving Prediction Motion Vector Candidate List in AMVP Mode

The maximum number of prediction motion vector candidates in a prediction motion vector candidate list may be predefined. The predefined maximum number is indicated by N. For example, the predefined maximum number may be 2.

Pieces of motion information (i.e. prediction motion vector candidates) may be added to the prediction motion vector candidate list in the order of the following steps 1) to 3).

Step 1) Available spatial candidates, among spatial candidates, may be added to the prediction motion vector candidate list. The spatial candidates may include a first spatial candidate and a second spatial candidate.

The first spatial candidate may be one of A₀, A₁, scaled A₀, and scaled A₁. The second spatial candidate may be one of B₀, B₁, B₂, scaled B₀, scaled B₁, and scaled B₂.

Pieces of motion information of available spatial candidates may be added to the prediction motion vector candidate list in the order of the first spatial candidate and the second spatial candidate. In this case, when the motion information of an available spatial candidate overlaps other motion information already present in the prediction motion vector candidate list, the motion information may not be added to the prediction motion vector candidate list. In other words, when the value of N is 2, if the motion information of a second spatial candidate is identical to the motion information of a first spatial candidate, the motion information of the second spatial candidate may not be added to the prediction motion vector candidate list.

The maximum number of pieces of motion information that are added may be N.

Step 2) When the number of pieces of motion information in the prediction motion vector candidate list is less than N and a temporal candidate is available, the motion information of the temporal candidate may be added to the prediction motion vector candidate list. In this case, when the motion information of the available temporal candidate overlaps other motion information already present in the prediction motion vector candidate list, the motion information may not be added to the prediction motion vector candidate list.

Step 3) When the number of pieces of motion information in the prediction motion vector candidate list is less than N, zero-vector motion information may be added to the prediction motion vector candidate list.

The zero-vector motion information may include one or more pieces of zero-vector motion information. The reference picture indices of the one or more pieces of zero-vector motion information may be different from each other.

The encoding apparatus 100 and/or the decoding apparatus 200 may sequentially add pieces of zero-vector motion information to the prediction motion vector candidate list while changing the reference picture index.

When zero-vector motion information overlaps other motion information already present in the prediction motion vector candidate list, the zero-vector motion information may not be added to the prediction motion vector candidate list.

The description of the zero-vector motion information, made above in connection with the merge list, may also be applied to zero-vector motion information. A repeated description thereof will be omitted.

The order of the above-described steps 1) to 3) is merely exemplary, and may be changed. Further, some of the steps may be omitted depending on predefined conditions.

FIG. 12 illustrates a transform and quantization process according to an example.

As illustrated in FIG. 12, quantized levels may be generated by performing a transform and/or quantization process on a residual signal.

A residual signal may be generated as the difference between an original block and a prediction block. Here, the prediction block may be a block generated via intra prediction or inter prediction.

The residual signal may be transformed into a signal in a frequency domain through a transform procedure that is a part of a quantization procedure.

A transform kernel used for a transform may include various DCT kernels, such as Discrete Cosine Transform (DCT) type 2 (DCT-II) and Discrete Sine Transform (DST) kernels.

These transform kernels may perform a separable transform or a two-dimensional (2D) non-separable transform on the residual signal. The separable transform may be a transform indicating that a one-dimensional (1D) transform is performed on the residual signal in each of a horizontal direction and a vertical direction.

The DCT type and the DST type, which are adaptively used for a 1D transform, may include DCT-V, DCT-VIII, DST-I, and DST-VII in addition to DCT-II, as shown in each of the following Table 3 and the following table 4.

TABLE 3

| Transform set | Transform candidates |
|---|---|
| 0 | DST-VII, DCT-VIII |
| 1 | DST-VII, DST-I |
| 2 | DST-VII, DCT-V |

TABLE 4

| Transform set | Transform candidates |
|---|---|
| 0 | DST-VII, DCT-VIII, DST-I |
| 1 | DST-VII, DST-I, DCT-VIII |
| 2 | DST-VII, DCT-V, DST-I |

As shown in Table 3 and Table 4, when a DCT type or a DST type to be used for a transform is derived, transform sets may be used. Each transform set may include multiple transform candidates. Each transform candidate may be a DCT type or a DST type.

The following Table 5 shows examples of a transform set to be applied to a horizontal direction and a transform set to be applied to a vertical direction depending on intra-prediction modes.

TABLE 5

| Intra | | | | | | | | | | |
|---|---|---|---|---|---|---|---|---|---|---|
| prediction | | | | | | | | | | |
| mode | 0 | 1 | 2 | 3 | 4 | 5 | 6 | 7 | 8 | 9 |
| Vertical | 2 | 1 | 0 | 1 | 0 | 1 | 0 | 1 | 0 | 1 |
| direction | | | | | | | | | | |
| transform | | | | | | | | | | |
| set | | | | | | | | | | |
| Horizontal | 2 | 1 | 0 | 1 | 0 | 1 | 0 | 1 | 0 | 1 |
| direction | | | | | | | | | | |
| transform | | | | | | | | | | |
| set | | | | | | | | | | |
| Intra | | | | | | | | | | |
| prediction | | | | | | | | | | |
| mode | 10 | 11 | 12 | 13 | 14 | 15 | 16 | 17 | 18 | 19 |
| Vertical | 0 | 1 | 0 | 1 | 0 | 0 | 0 | 0 | 0 | 0 |
| direction | | | | | | | | | | |
| transform | | | | | | | | | | |
| set | | | | | | | | | | |
| Horizontal | 0 | 1 | 0 | 1 | 2 | 2 | 2 | 2 | 2 | 2 |
| direction | | | | | | | | | | |
| transform | | | | | | | | | | |
| set | | | | | | | | | | |
| Intra | | | | | | | | | | |
| prediction | | | | | | | | | | |
| mode | 20 | 21 | 22 | 23 | 24 | 25 | 26 | 27 | 28 | 29 |
| Vertical | 0 | 0 | 0 | 1 | 0 | 1 | 0 | 1 | 0 | 1 |
| direction | | | | | | | | | | |
| transform | | | | | | | | | | |
| set | | | | | | | | | | |
| Horizontal | 2 | 2 | 2 | 1 | 0 | 1 | 0 | 1 | 0 | 1 |
| direction | | | | | | | | | | |
| transform | | | | | | | | | | |
| set | | | | | | | | | | |
| Intra | | | | | | | | | | |
| prediction | | | | | | | | | | |
| mode | 30 | 31 | 32 | 33 | 34 | 35 | 36 | 37 | 38 | 39 |
| Vertical | 0 | 1 | 0 | 1 | 0 | 1 | 0 | 1 | 0 | 1 |
| direction | | | | | | | | | | |
| transform | | | | | | | | | | |
| set | | | | | | | | | | |
| Horizontal | 0 | 1 | 0 | 1 | 0 | 1 | 0 | 1 | 0 | 1 |
| direction | | | | | | | | | | |
| transform | | | | | | | | | | |
| set | | | | | | | | | | |
| Intra | | | | | | | | | | |
| prediction | | | | | | | | | | |
| mode | 40 | 41 | 42 | 43 | 44 | 45 | 46 | 47 | 48 | 49 |
| Vertical | 0 | 1 | 0 | 1 | 0 | 1 | 2 | 2 | 2 | 2 |
| direction | | | | | | | | | | |
| transform | | | | | | | | | | |
| set | | | | | | | | | | |
| Horizontal | 0 | 1 | 0 | 1 | 0 | 1 | 0 | 0 | 0 | 0 |
| direction | | | | | | | | | | |
| transform | | | | | | | | | | |
| set | | | | | | | | | | |
| Intra | | | | | | | | | | |
| prediction | | | | | | | | | | |
| mode | 50 | 51 | 52 | 53 | 54 | 55 | 56 | 57 | 58 | 59 |
| Vertical | 2 | 2 | 2 | 2 | 2 | 1 | 0 | 1 | 0 | 1 |
| direction | | | | | | | | | | |
| transform | | | | | | | | | | |
| set | | | | | | | | | | |
| Horizontal | 0 | 0 | 0 | 0 | 0 | 1 | 0 | 1 | 0 | 1 |
| direction | | | | | | | | | | |
| transform | | | | | | | | | | |
| set | | | | | | | | | | |

| Intra | | | | | | | |
|---|---|---|---|---|---|---|---|
| prediction | | | | | | | |
| mode | 60 | 61 | 62 | 63 | 64 | 65 | 66 |
| Vertical | 0 | 1 | 0 | 1 | 0 | 1 | 0 |
| direction | | | | | | | |
| transform | | | | | | | |
| set | | | | | | | |
| Horizontal | 0 | 1 | 0 | 1 | 0 | 1 | 0 |
| direction | | | | | | | |
| transform | | | | | | | |
| set | | | | | | | |

In Table 5, numbers of vertical transform sets and horizontal transform sets that are to be applied to the horizontal direction of a residual signal depending on the intra-prediction modes of the target block are indicated.

As exemplified in Table 5, transform sets to be applied to the horizontal direction and the vertical direction may be predefined depending on the intra-prediction mode of the target block. The encoding apparatus 100 may perform a transform and an inverse transform on the residual signal using a transform included in the transform set corresponding to the intra-prediction mode of the target block. Further, the decoding apparatus 200 may perform an inverse transform on the residual signal using a transform included in the transform set corresponding to the intra-prediction mode of the target block.

In the transform and inverse transform, transform sets to be applied to the residual signal may be determined, as exemplified in Tables 3, 4, and 5, and may not be signaled. Transform indication information may be signaled from the encoding apparatus 100 to the decoding apparatus 200. The transform indication information may be information indicating which one of multiple transform candidates included in the transform set to be applied to the residual signal is used.

For example, when the size of the target block is 64×64 or less, transform sets, transform sets having three transforms may be configured depending on the intra-prediction mode, respectively. An optimal transform method may be selected from among a total of nine multiple transform methods resulting from combinations of three transforms in a horizontal direction and three transforms in a vertical direction. Through such an optimal transform method, the residual signal may be encoded and/or decoded, and thus coding efficiency may be improved.

Here, information indicating which one of transforms belonging to each transform set has been used for at least one of a vertical transform and a horizontal transform may be entropy-encoded and/or -decoded. Here, truncated unary binarization may be used to encode and/or decode such information.

As described above, methods using various transforms may be applied to a residual signal generated via intra prediction or inter prediction.

The transform may include at least one of a first transform and a secondary transform. A transform coefficient may be generated by performing the first transform on the residual signal, and a secondary transform coefficient may be generated by performing the secondary transform on the transform coefficient.

The first transform may be referred to as a “primary transform”. Further, the first transform may also be referred to as an “Adaptive Multiple Transform (AMT) scheme”. AMT may mean that, as described above, different transforms are applied to respective 1D directions (i.e. a vertical direction and a horizontal direction).

A secondary transform may be a transform for improving energy concentration on a transform coefficient generated by the first transform. Similar to the first transform, the secondary transform may be a separable transform or a non-separable transform. Such a non-separable transform may be a Non-Separable Secondary Transform (NSST).

The first transform may be performed using at least one of predefined multiple transform methods. For example, the predefined multiple transform methods may include a Discrete Cosine Transform (DCT), a Discrete Sine Transform (DST), a Karhunen-Loeve Transform (KLT), etc.

Further, a first transform may be a transform having various transform types depending on a kernel function that defines a Discrete Cosine Transform (DCT) or a Discrete Sine Transform (DST).

For example, the transform type may be determined based at least one of 1) a prediction mode of a target block (for example, one of an intra prediction and an inter prediction), 2) a size of a target block, 3) a shape of a target block, 4) an intra prediction mode of a target block, 5) a component of a target block (for example, one of a luma component an a chroma component), and 6) a partitioning type applied to a target block (for example, one of a Quad Tree, a Binary Tree and a Ternary Tree).

For example, the first transform may include transforms, such as DCT-2, DCT-5, DCT-7, DST-7, DST-1, DST-8, and DCT-8 depending on the transform kernel presented in the following Table 6. In the following Table 6, various transform types and transform kernel functions for Multiple Transform Selection (MTS) are exemplified.

MTS may refer to the selection of combinations of one or more DCT and/or DST kernels so as to transform a residual signal in a horizontal and/or vertical direction.

TABLE 6

| Transform | |
|---|---|
| type | Transform kernel function Tᵢ(j) |
| DCT-2 | ${T}_{i} ( j ) = {ω}_{0} \cdot \sqrt{\frac{2}{N}} \cdot cos ( \frac{π \cdot i \cdot ( 2 j + 1 )}{2 N} ) where$ ${ω}_{0} = \sqrt{\frac{2}{N}} ( i = 0 ) or 1 ( otherwise )$ |
| DST-7 | ${T}_{i} ( j ) = \sqrt{\frac{4}{2 N + 1}} \cdot sin ( \frac{π \cdot ( 2 j + 1 ) \cdot ( j + 1 )}{2 N + 1} )$ |
| DCT-5 | ${T}_{i} ( j ) = {ω}_{0} \cdot {ω}_{1} \cdot \sqrt{\frac{2}{2 N - 1}} \cdot cos ( \frac{2 π \cdot i \cdot j}{2 N + 1} ) where$ ${ω}_{0 / 1} = \sqrt{\frac{2}{N}} ( i or j = 0 ) or 1 ( otherwise )$ |
| DCT-8 | ${T}_{i} ( j ) = \sqrt{\frac{4}{2 N + 1}} \cdot cos ( \frac{π \cdot ( 2 j + 1 ) \cdot ( 2 j + 1 )}{4 N + 2} )$ |
| DST-1 | ${T}_{i} ( j ) = \sqrt{\frac{2}{N + 1}} \cdot sin ( \frac{π \cdot ( i + 1 ) \cdot ( j + 1 )}{N + 1} )$ |

In Table 6, i and j may be integer values that are equal to or greater than 0 and are less than or equal to N−1.

The secondary transform may be performed on the transform coefficient generated by performing the first transform.

As in the first transform, transform sets may also be defined in a secondary transform. The methods for deriving and/or determining the above-described transform sets may be applied not only to the first transform but also to the secondary transform.

The first transform and the secondary transform may be determined for a specific target.

For example, a first transform and a secondary transform may be applied to signal components corresponding to one or more of a luminance (luma) component and a chrominance (chroma) component. Whether to apply the first transform and/or the secondary transform may be determined depending on at least one of coding parameters for a target block and/or a neighbor block. For example, whether to apply the first transform and/or the secondary transform may be determined depending on the size and/or shape of the target block.

In the encoding apparatus 100 and the decoding apparatus 200, transform information indicating the transform method to be used for the target may be derived by utilizing specified information.

For example, the transform information may include a transform index to be used for a primary transform and/or a secondary transform. Alternatively, the transform information may indicate that a primary transform and/or a secondary transform are not used.

For example, when the target of a primary transform and a secondary transform is a target block, the transform method(s) to be applied to the primary transform and/or the secondary transform indicated by the transform information may be determined depending on at least one of coding parameters for the target block and/or blocks neighbor the target block.

Alternatively, transform information indicating a transform method for a specific target may be signaled from the encoding apparatus 100 to the decoding apparatus 200.

For example, for a single CU, whether to use a primary transform, an index indicating the primary transform, whether to use a secondary transform, and an index indicating the secondary transform may be derived as the transform information by the decoding apparatus 200. Alternatively, for a single CU, the transform information, which indicates whether to use a primary transform, an index indicating the primary transform, whether to use a secondary transform, and an index indicating the secondary transform, may be signaled.

The quantized transform coefficient (i.e. the quantized levels) may be generated by performing quantization on the result, generated by performing the first transform and/or the secondary transform, or on the residual signal.

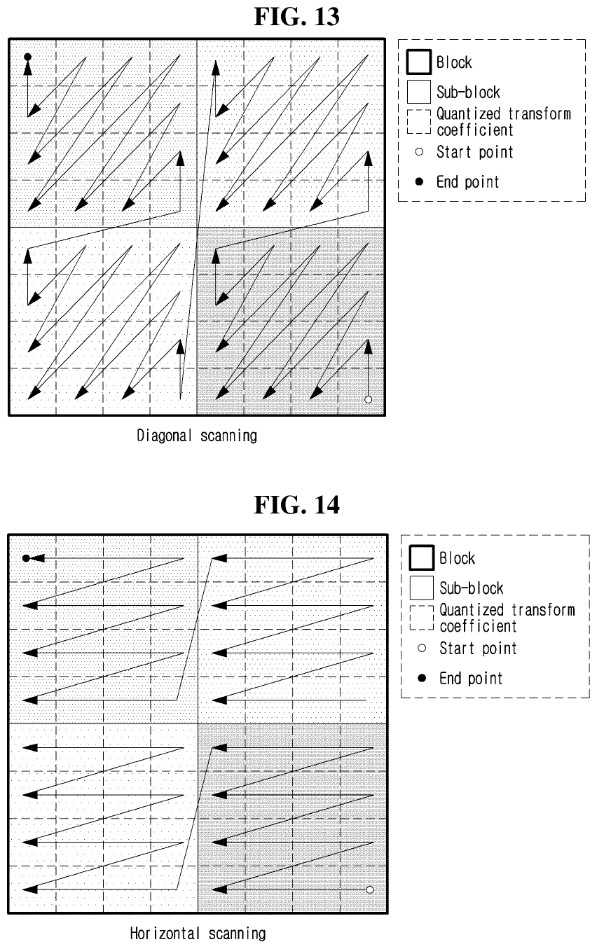

FIG. 13 illustrates diagonal scanning according to an example.

FIG. 14 illustrates horizontal scanning according to an example.

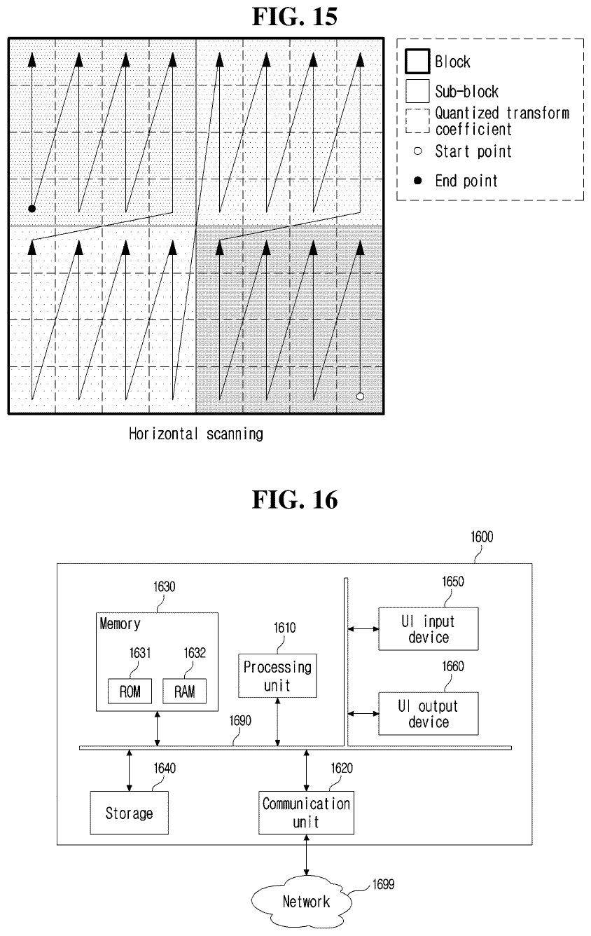

FIG. 15 illustrates vertical scanning according to an example.

Quantized transform coefficients may be scanned via at least one of (up-right) diagonal scanning, vertical scanning, and horizontal scanning depending on at least one of an intra-prediction mode, a block size, and a block shape. The block may be a Transform Unit (TU).

Each scanning may be initiated at a specific start point, and may be terminated at a specific end point.

For example, quantized transform coefficients may be changed to 1D vector forms by scanning the coefficients of a block using diagonal scanning of FIG. 13. Alternatively, horizontal scanning of FIG. 14 or vertical scanning of FIG. 15, instead of diagonal scanning, may be used depending on the size and/or intra-prediction mode of a block.

Vertical scanning may be the operation of scanning 2D block-type coefficients in a column direction. Horizontal scanning may be the operation of scanning 2D block-type coefficients in a row direction.

In other words, which one of diagonal scanning, vertical scanning, and horizontal scanning is to be used may be determined depending on the size and/or inter-prediction mode of the block.

As illustrated in FIGS. 13, 14, and 15, the quantized transform coefficients may be scanned along a diagonal direction, a horizontal direction or a vertical direction.

The quantized transform coefficients may be represented by block shapes. Each block may include multiple sub-blocks. Each sub-block may be defined depending on a minimum block size or a minimum block shape.

In scanning, a scanning sequence depending on the type or direction of scanning may be primarily applied to sub-blocks. Further, a scanning sequence depending on the direction of scanning may be applied to quantized transform coefficients in each sub-block.

For example, as illustrated in FIGS. 13, 14, and 15, when the size of a target block is 8×8, quantized transform coefficients may be generated through a first transform, a secondary transform, and quantization on the residual signal of the target block. Therefore, one of three types of scanning sequences may be applied to four 4×4 sub-blocks, and quantized transform coefficients may also be scanned for each 4×4 sub-block depending on the scanning sequence.

The encoding apparatus 100 may generate entropy-encoded quantized transform coefficients by performing entropy encoding on scanned quantized transform coefficients, and may generate a bitstream including the entropy-encoded quantized transform coefficients.

The decoding apparatus 200 may extract the entropy-encoded quantized transform coefficients from the bitstream, and may generate quantized transform coefficients by performing entropy decoding on the entropy-encoded quantized transform coefficients. The quantized transform coefficients may be aligned in the form of a 2D block via inverse scanning. Here, as the method of inverse scanning, at least one of up-right diagonal scanning, vertical scanning, and horizontal scanning may be performed.

In the decoding apparatus 200, dequantization may be performed on the quantized transform coefficients. A secondary inverse transform may be performed on the result generated by performing dequantization depending on whether to perform the secondary inverse transform. Further, a first inverse transform may be performed on the result generated by performing the secondary inverse transform depending on whether the first inverse transform is to be performed. A reconstructed residual signal may be generated by performing the first inverse transform on the result generated by performing the secondary inverse transform.

For a luma component which is reconstructed via intra prediction or inter prediction, inverse mapping having a dynamic range may be performed before in-loop filtering.

The dynamic range may be divided into 16 equal pieces, and mapping functions for respective pieces may be signaled. Such a mapping function may be signaled at a slice level or a tile group level.

An inverse mapping function for performing inverse mapping may be derived based on the mapping function.

In-loop filtering, the storage of a reference picture, and motion compensation may be performed in an inverse mapping area.

A prediction block generated via inter prediction may be changed to a mapped area through mapping using a mapping function, and the changed prediction block may be used to generate a reconstructed block. However, since intra prediction is performed in the mapped area, a prediction block generated via intra prediction may be used to generate a reconstructed block without requiring mapping and/or inverse mapping.

For example, when the target block is a residual block of a chroma component, the residual block may be changed to an inversely mapped area by scaling the chroma component of the mapped area.

Whether scaling is available may be signaled at a slice level or a tile group level.

For example, scaling may be applied only to the case where mapping is available for a luma component and where the partitioning of the luma component and the partitioning of the chroma component follow the same tree structure.

Scaling may be performed based on the average of the values of samples in a luma prediction block, which corresponds to a chroma prediction block. Here, when the target block uses inter prediction, the luma prediction block may mean a mapped luma prediction block.

A value required for scaling may be derived by referring to a look-up table using the index of a piece to which the average of sample values of the luma prediction block belongs.

The residual block may be changed to an inversely mapped area by scaling the residual block using a finally derived value. Thereafter, for the block of a chroma component, reconstruction, intra prediction, inter prediction, in-loop filtering, and the storage of a reference picture may be performed in the inversely mapped area.

For example, information indicating whether the mapping and/or inverse mapping of a luma component and a chroma component are available may be signaled through a sequence parameter set.

A prediction block for the target block may be generated based on a block vector. The block vector may indicate displacement between the target block and a reference block. The reference block may be a block in a target image.

In this way, a prediction mode in which the prediction block is generated by referring to the target image may be referred to as an “Intra-Block Copy (IBC) mode”.

An IBC mode may be applied to a CU having a specific size. For example, the IBC mode may be applied to an M×N CU. Here, M and N may be less than or equal to 64.

The IBC mode may include a skip mode, a merge mode, an AMVP mode, etc. In the case of the skip mode or the merge mode, a merge candidate list may be configured, and a merge index is signaled, and thus a single merge candidate may be specified among merge candidates present in the merge candidate list. The block vector of the specified merge candidate may be used as the block vector of the target block.

In the case of the AMVP mode, a differential block vector may be signaled. Also, a prediction block vector may be derived from the left neighbor block and the above neighbor block of the target block. Further, an index indicating which neighbor block is to be used may be signaled.

A prediction block in the IBC mode may be included in a target CTU or a left CTU, and may be limited to a block within a previously reconstructed area. For example, the value of a block vector may be limited so that a prediction block for a target block is located in a specific area. The specific area may be an area defined by three 64×64 blocks that are encoded and/or decoded prior to a 64×64 block including the target block. The value of the block vector is limited in this way, and thus memory consumption and device complexity caused by the implementation of the IBC mode may be decreased.

FIG. 16 is a configuration diagram of an encoding apparatus according to an embodiment.

An encoding apparatus 1600 may correspond to the above-described encoding apparatus 100.

The encoding apparatus 1600 may include a processing unit 1610, memory 1630, a user interface (UI) input device 1650, a UI output device 1660, and storage 1640, which communicate with each other through a bus 1690. The encoding apparatus 1600 may further include a communication unit 1620 coupled to a network 1699.

The processing unit 1610 may be a Central Processing Unit (CPU) or a semiconductor device for executing processing instructions stored in the memory 1630 or the storage 1640. The processing unit 1610 may be at least one hardware processor.

The processing unit 1610 may generate and process signals, data or information that are input to the encoding apparatus 1600, are output from the encoding apparatus 1600, or are used in the encoding apparatus 1600, and may perform examination, comparison, determination, etc. related to the signals, data or information. In other words, in embodiments, the generation and processing of data or information and examination, comparison and determination related to data or information may be performed by the processing unit 1610.

The processing unit 1610 may include an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

At least some of the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190 may be program modules, and may communicate with an external device or system. The program modules may be included in the encoding apparatus 1600 in the form of an operating system, an application program module, or other program modules.

The program modules may be physically stored in various types of well-known storage devices. Further, at least some of the program modules may also be stored in a remote storage device that is capable of communicating with the encoding apparatus 1200.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1600.

The processing unit 1610 may execute instructions or code in the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190.

A storage unit may denote the memory 1630 and/or the storage 1640. Each of the memory 1630 and the storage 1640 may be any of various types of volatile or nonvolatile storage media. For example, the memory 1630 may include at least one of Read-Only Memory (ROM) 1631 and Random Access Memory (RAM) 1632.

The storage unit may store data or information used for the operation of the encoding apparatus 1600. In an embodiment, the data or information of the encoding apparatus 1600 may be stored in the storage unit.

For example, the storage unit may store pictures, blocks, lists, motion information, inter-prediction information, bitstreams, etc.

The encoding apparatus 1600 may be implemented in a computer system including a computer-readable storage medium.

The storage medium may store at least one module required for the operation of the encoding apparatus 1600. The memory 1630 may store at least one module, and may be configured such that the at least one module is executed by the processing unit 1610.

Functions related to communication of the data or information of the encoding apparatus 1600 may be performed through the communication unit 1620.

For example, the communication unit 1620 may transmit a bitstream to a decoding apparatus 1600, which will be described later.

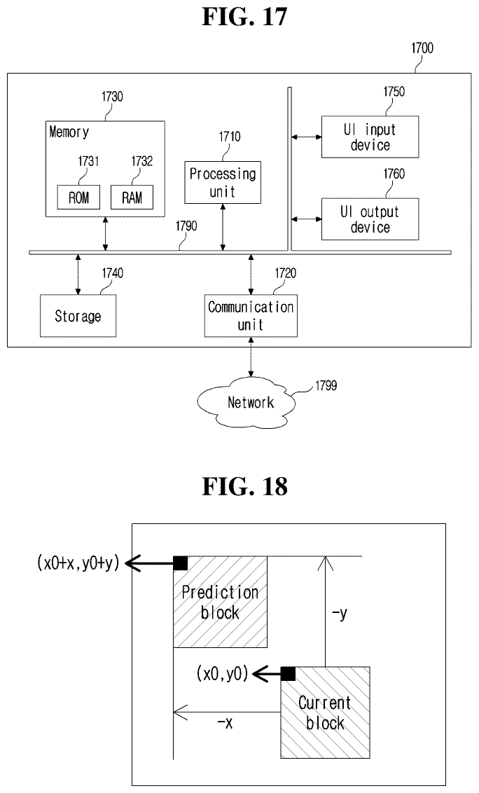

FIG. 17 is a configuration diagram of a decoding apparatus according to an embodiment.

The decoding apparatus 1700 may correspond to the above-described decoding apparatus 200.

The decoding apparatus 1700 may include a processing unit 1710, memory 1730, a user interface (UI) input device 1750, a UI output device 1760, and storage 1740, which communicate with each other through a bus 1790. The decoding apparatus 1700 may further include a communication unit 1720 coupled to a network 1799.

The processing unit 1710 may be a Central Processing Unit (CPU) or a semiconductor device for executing processing instructions stored in the memory 1730 or the storage 1740. The processing unit 1710 may be at least one hardware processor.

The processing unit 1710 may generate and process signals, data or information that are input to the decoding apparatus 1700, are output from the decoding apparatus 1700, or are used in the decoding apparatus 1700, and may perform examination, comparison, determination, etc. related to the signals, data or information. In other words, in embodiments, the generation and processing of data or information and examination, comparison and determination related to data or information may be performed by the processing unit 1710.

The processing unit 1710 may include an entropy decoding unit 210, a dequantization unit 220, an inverse transform unit 230, an intra-prediction unit 240, an inter-prediction unit 250, a switch 245, an adder 255, a filter unit 260, and a reference picture buffer 270.

At least some of the entropy decoding unit 210, the dequantization unit 220, the inverse transform unit 230, the intra-prediction unit 240, the inter-prediction unit 250, the adder 255, the switch 245, the filter unit 260, and the reference picture buffer 270 of the decoding apparatus 200 may be program modules, and may communicate with an external device or system. The program modules may be included in the decoding apparatus 1700 in the form of an operating system, an application program module, or other program modules.

The program modules may be physically stored in various types of well-known storage devices. Further, at least some of the program modules may also be stored in a remote storage device that is capable of communicating with the decoding apparatus 1700.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the decoding apparatus 1700.

The processing unit 1710 may execute instructions or code in the entropy decoding unit 210, the dequantization unit 220, the inverse transform unit 230, the intra-prediction unit 240, the inter-prediction unit 250, the switch 245, the adder 255, the filter unit 260, and the reference picture buffer 270.

A storage unit may denote the memory 1730 and/or the storage 1740. Each of the memory 1730 and the storage 1740 may be any of various types of volatile or nonvolatile storage media. For example, the memory 1730 may include at least one of ROM 1731 and RAM 1732.

The storage unit may store data or information used for the operation of the decoding apparatus 1700. In an embodiment, the data or information of the decoding apparatus 1700 may be stored in the storage unit.

For example, the storage unit may store pictures, blocks, lists, motion information, inter-prediction information, bitstreams, etc.

The decoding apparatus 1700 may be implemented in a computer system including a computer-readable storage medium.

The storage medium may store at least one module required for the operation of the decoding apparatus 1700. The memory 1730 may store at least one module, and may be configured such that the at least one module is executed by the processing unit 1710.

Functions related to communication of the data or information of the decoding apparatus 1700 may be performed through the communication unit 1720.

For example, the communication unit 1720 may receive a bitstream from the encoding apparatus 1700.

Hereinafter, a processing unit may represent the processing unit 1610 of the encoding apparatus 1600 and/or the processing unit 1710 of the decoding apparatus 1700. For example, as to functions relating to prediction, the processing unit may represent the switch 115 and/or the switch 245. As to functions relating to inter prediction, the processing unit may represent the inter-prediction unit 110, the subtractor 125 and the adder 175, and may represent the inter prediction unit 250 and the adder 255. As to functions relating to intra prediction, the processing unit may represent the intra prediction unit 120, the subtractor 125, and the adder 175, and may represent the intra prediction unit 240 and the adder 255. As to functions related to transform, the processing unit may represent the transform unit 130 and the inverse transform unit 170, and may represent the inverse transform unit 230. As to functions relating quantization, the processing unit may represent the quantization unit 140 and the inverse quantization unit 160, and may indicate the inverse quantization unit 220. As to functions relating to entropy encoding and/or entropy decoding, the processing unit may represent the entropy encoding unit 150 and/or the entropy decoding unit 210. As to functions relating filtering, the processing unit may represent the filter unit 180 and/or the filter unit 260. As to functions relating a reference picture, the processing unit may indicate the reference picture buffer 190 and/or the reference picture buffer 270.

By reference to the above-described description, embodiments of an image encoding/decoding method, device and recording medium storing a bitstream for performing intra block copy proposed in the present disclosure will be described.

One picture may be encoded/decoded based on at least one of an intra prediction, inter prediction or intra block copy mode.

In addition, one block may be encoded/decoded based on at least one of an intra prediction, inter prediction or intra block copy mode.

An intra block copy prediction-based encoding/decoding method may be used for at least one of a case where a luma component and a chroma component have an independent block partition structure (i.e., a dual tree structure) or a case where a luma component and a chroma component have the same block partition structure (i.e., a single tree structure).

An intra block copy prediction mode may be a method for deriving a prediction block from a pre-encoded/decoded region within the same picture by using a block vector (BV). The same picture may mean a picture including a current block, which is a prediction target, i.e., a current picture. A current block represents a block to be currently encoded/decoded.

A block vector may also be called an intra block vector.

A pre-encoded/decoded region within a current picture may also be called a region within a reconstructed image or a region within a decoded image for a current picture. A region within a reconstructed image may mean a pre-reconstructed region within a current picture, and a region within a decoded image may mean a pre-decoded region within a current picture.

Here, a pre-encoded/decoded region within a current picture may be a region to which at least one in-loop filter is not applied. An in-loop filter may include at least one of chroma scaling and luma mapping, deblocking filtering, adaptive sample offset or adaptive in-loop filtering. In other words, an intra block copy prediction mode may refer to a non-reconstructed region within a current picture where at least one of chroma scaling and luma mapping, deblocking filtering, adaptive sample offset or adaptive in-loop filtering is not performed.

Alternatively, conversely, a prediction block based on an intra block copy prediction mode may be derived by using a pre-encoded/decoded region within a current picture to which at least one in-loop filter is applied.

When a current block is encoded/decoded in an intra block copy mode, a block vector for a current block may be derived. When a block vector derived for a current block is (x, y), a reference block having the same size as a current block which includes a sample horizontally separated by x from a current block (specifically, a sample horizontally separated by x when x is a positive integer, and a sample horizontally separated by −x when x is a negative integer) and a sample vertically separated by y (specifically, a sample vertically separated by y when y is a positive integer and a sample vertically separated by −y when y is a negative integer) may be used as the prediction block of a current block. In this case, a reference block may exist in a pre-encoded/decoded region within a current picture.

FIG. 18 shows an example in which a reference block is determined based on a block vector of a current block.

As in an example shown in FIG. 18, when both the x component and the y component of a block vector are a negative integer and the top-left sample position of a current block is (x0, y0), a reference block where a top-left sample position is (x0+x, y0+y) may be selected.

The sign of a block vector described in the above-described embodiment and a sample position may be applied in reverse. For example, when the x of a block vector is a positive integer, a sample that is x away in a left horizontal direction may be selected, and when x is a negative integer, a sample that is-x away in a right horizontal direction may be selected. In addition, when y is a positive integer, a sample that is y away in a top horizontal direction may be selected, and when y is a negative integer, a sample that is-y away in a bottom horizontal direction may be selected.

Unlike the above-described embodiment, the size of a reference block may be different from the size of a current block. For example, the size of a current block may be reduced by performing down-sampling or sub-sampling on a current block. A reference block having the same size as a downsized current block is determined through the block vector of a current block. Thereafter, a prediction block for a current block may be derived by performing up-sampling or interpolation on a determined reference block.

At least one of the size of a current block or the size of a reference block may be adaptively determined according to at least one of the encoding parameter of a current block/a CTB/a CTU.

When prediction using an intra block copy mode is applied to a luma component block, one of the following methods may be used to encode/decode a luma component block.
Skip Mode: Similar to a skip mode in an inter prediction mode, the block vector of a current block may be derived from the block vector of a block encoded/decoded before a current block. In addition, when a skip mode is applied, a residual block for a current block may not be entropy encoded/decoded. In other words, a prediction block derived through an intra block copy mode may become the reconstructed block of a current block.
Merge Mode: Similar to a merge mode in an inter prediction mode, the block vector of a current block may be derived from the block vector of a block encoded/decoded before a current block. In addition, when a merge mode is applied, a residual block for a current block may be entropy encoded/decoded.
Intra Block Copy AMVP Mode: Similar to an advanced motion vector prediction (AMVP) mode in an inter prediction mode, a block vector may be encoded/decoded. Specifically, one of the block vector prediction candidates included in a block vector prediction list may be selected, and a selected block vector prediction candidate may be set as a block vector prediction value. In addition, a block vector difference value showing a difference between a block vector and a block vector prediction value may be explicitly encoded/decoded. A decoder may derive the block vector of a current block by adding a block vector prediction value and a block vector difference value.

Meanwhile, also in an intra block copy mode, similar to an adaptive motion vector resolution (AMVR) mode in an inter prediction mode, one of at least one resolution may be selected, and a block vector may be encoded/decoded with selected resolution. An AMVR mode in an intra block copy mode may be referred to as an intra block copy AMVR mode.

In addition, an intra block copy mode may be utilized as one of a plurality of modes configuring a multi-hypothesis mode. As an example, a multi-hypothesis mode may be for obtaining the final prediction block of a current block by performing the weighted sum on a plurality of prediction blocks derived by using a plurality of prediction modes. In this case, at least one of a plurality of prediction modes for a multi-hypothesis mode may be an intra block copy mode.

As an example, the final prediction block of a current block may be obtained based on the weighted sum operation of a first prediction block derived based on an intra block copy mode and a second prediction block derived based on at least one of an intra prediction mode, an inter prediction mode or an intra block copy mode.

Meanwhile, when a multi-hypothesis mode is applied, instead of performing the weighted sum on a plurality of prediction blocks, a statistical value based on a plurality of prediction blocks may be used to derive the final prediction block of a current block.

Information indicating whether to use at least one of an intra block copy skip mode, an intra block copy merge mode, an intra block copy AMVP mode, an intra block copy AMVR mode or a multi-hypothesis intra block copy mode may be encoded/decoded. As an example, a flag indicating whether to use one of the listed modes may be encoded.

Meanwhile, the information may be entropy-encoded/decoded according to at least one of the encoding parameters of a current block/a CTB (or, a CTU) or a neighboring block/CTB adjacent to a current block/a CTB.

Whether a deblocking filter is performed at the boundary of a current block may be determined depending on whether an intra block copy mode is performed.

For example, when at least one of the neighboring blocks adjacent to the boundary of a current block is encoded/decoded in an intra block copy mode, the boundary of a current block may be set as the boundary of a target block which will perform deblocking filtering. Accordingly, deblocking filtering may be performed on a boundary between a current block and a neighboring block.

As another example, when all of the neighboring blocks adjacent to the boundary of a current block are not encoded/decoded in an intra block copy mode, the boundary of a current block is not set as the boundary of a target block which will perform deblocking filtering. Accordingly, deblocking filtering may not be performed on a boundary between a current block and a neighboring block.

Meanwhile, in determining whether to apply a deblocking filter, a block to which an intra block copy mode is applied may be considered as a block to which an inter prediction mode is applied to determine whether to apply a deblocking filter. As an example, if the boundary of a current block is set as the boundary of a target block which will perform deblocking filtering when at least one of the neighboring blocks adjacent to the boundary of a current block is applied in an inter prediction mode, the boundary of a current block may be set as the boundary of a target block which will perform deblocking filtering even when a neighboring block adjacent to the boundary of a current block is encoded/decoded in an intra block copy mode.

Alternatively, in determining whether to apply a deblocking filter, a block to which an intra block copy mode is applied may be considered as a block to which an intra prediction mode is applied to determine whether to apply a deblocking filter. As an example, if the boundary of a current block is set as the boundary of a target block which will perform deblocking filtering when at least one of the neighboring blocks adjacent to the boundary of a current block is applied in an intra prediction mode, the boundary of a current block may be set as the boundary of a target block which will perform deblocking filtering even when a neighboring block adjacent to the boundary of a current block is encoded/decoded in an intra block copy mode.

When it is determined to perform deblocking filtering on the boundary of a current block, deblocking filtering may be performed on at least a part of a current block to which an intra block copy mode is applied. Specifically, a deblocking filter in a 8×8 unit may be applied to the boundary of a current block.

At least one of whether to apply a deblocking filter to the boundary of a current block or the filter strength of the deblocking filter may be determined according to at least one of the encoding parameters for an intra block copy mode.

As an example, when a block vector difference value between a current block and a neighboring block adjacent to the boundary of a current block is greater than or equal to a threshold value, a deblocking filter may be set to be applied at the boundary of a current block. Here, a block vector difference value may include at least one of the difference value of a x-axis component or the difference value of a y-axis component.

Meanwhile, in an encoder/a decoder, a luma component and a chroma component may be encoded/decoded, respectively. For convenience of a description, a block to be encoded/decoded for a luma component is called a current luma component block, and a block to be encoded/decoded for a chroma component is called a current chroma component block.

At least one of the following encoding information may be used to determine the encoding mode of a current luma component block. Here, an encoding mode may refer to a prediction mode. In addition, encoding information may refer to prediction mode information.

At least one of the encoding information described below may be entropy-encoded/decoded.

1) Information showing whether a skip mode is applied to a current luma component block (e.g., a skip mode identifier, a skip mode flag or a skip mode index (e.g., skip_flag or cu_skip_flag))

According to information showing whether a skip mode is applied, it is possible to show whether a skip mode is applied to a current luma component block. As an example, when a skip mode identifier, a skip mode flag or a skip mode index has a first value (e.g., 1), it may represent that a skip mode is applied to a current luma component block. On the other hand, when a skip mode identifier, a skip mode flag or a skip mode index has a second value (e.g., 0), it may represent that a skip mode is not applied to a current luma component block.

2) Prediction mode information of a current luma component block (e.g., an index, a flag or an identifier)

Whether at least one of an intra prediction mode, an inter prediction mode or an intra block copy mode is applied to a current luma component block may be determined based on the prediction mode information.

For example, when a syntax element representing prediction mode information has a first value (e.g., 0), it represents that an intra prediction mode is applied to a current luma component block. In addition, when the syntax element has a second value (e.g., 1), it represents that an inter prediction mode is applied to a current luma component block. Alternatively, when the syntax element has a third value (e.g., 2), it represents that an intra block copy mode is applied to a current luma component block.

As another example, a plurality of prediction mode information may be encoded/decoded. As an example, among a plurality of prediction mode information, first prediction mode information (e.g., an index, a flag or an identifier (e.g., pred_mode_flag)) may represent whether an intra prediction mode is applied to a current luma component block. As an example, when first prediction mode information has a first value (e.g., 1), it represents that an intra prediction mode is applied to a current luma component block, and when the first prediction mode information has a second value (e.g., 0), it represents that an intra prediction mode is not applied to a current luma component block. When the first prediction mode information represents that an intra prediction mode is not applied, second prediction mode information (e.g., an index, a flag or an identifier (e.g., pred_mode_ibc_flag)) may be additionally entropy-encoded/decoded. The second prediction mode information may represent whether an inter prediction mode is applied or an intra block copy mode is applied to a current luma component block. As an example, when second prediction mode information has a first value (e.g., 1), it may represent that an intra block copy mode is applied to a current luma component block. On the other hand, when the second prediction mode information has a second value (e.g., 0), it may represent that an inter prediction mode is applied to a current luma component block.

As another example, whether an intra prediction mode is applied or an inter prediction mode is applied to a current luma component block may be determined based on first prediction mode information (e.g., an index, a flag or an identifier (e.g., pred_mode_flag)). When first prediction mode information has a first value (e.g., 1), it may represent that an intra prediction mode is applied to a current luma component block. On the other hand, when first prediction mode information has a second value (e.g., 0), it may represent that an inter prediction mode is applied to a current luma component block. Meanwhile, second prediction mode information (e.g., an index or a flag or an identifier or pred_mode_ibc_flag, etc.) representing whether an intra block copy mode is applied to a current luma component block may be entropy encoded/decoded, or the value of the second prediction mode information may be derived from a current luma component block without entropy encoding/decoding the second prediction mode information. As an example, when second prediction mode information has a first value (e.g., 1), it represents that an intra block copy mode is applied to a current luma component block. On the other hand, when second prediction information mode is a second value (e.g., 0), an intra prediction mode or an inter prediction mode may be applied to a current luma component block according to first prediction mode information.

3) Information representing whether a merge mode is applied to a luma component block (e.g., a merge mode identifier, a merge mode flag or a merge mode index (e.g., merge_flag))

When it is determined that a skip mode is not applied to a current luma component block and an intra block copy mode is applied to a current luma component block, information representing whether a merge mode is applied to a current luma component block may be encoded/decoded. Based on the information, whether a merge mode is applied to a current luma component block may be determined. For example, when information representing a merge mode has a first value (e.g., 1), it represents that a merge mode is applied to a current luma component block. On the other hand, when information representing the merge mode has a second value (e.g., 0), it represents that a merge mode is not applied to a current luma component block.

Encoding/decoding of encoding information for determining the encoding mode of a current luma component block may be omitted. In this case, the encoding mode of a current luma component block may be derived based on at least one of the encoding parameters of a current block/a CTB or a neighboring block/CTB adjacent to a current block/a CTB.

In the present disclosure, for convenience of a description, ‘first value’, ‘second value’ or ‘third value’ is expressed as matching a specific natural number. However, ‘first value’, ‘second value’ or ‘third value’ may be set differently from the example of the present disclosure. As an example, in the above-described embodiment, it was illustrated that ‘first value’ is 1 and ‘second value’ is 0, but conversely, ‘first value’ may be set as 0 and ‘second value’ may be set as 1. In the present disclosure, embodiments applied to a current luma component block may also be applied to a current chroma component block. For example, in an embodiment where it is not explicitly described that it is not applied to a current chroma component block, a corresponding embodiment may be implemented by replacing ‘current luma component block’ in an embodiment with ‘current chroma component block’.

According to the above-described encoding information, the encoding mode of a current luma component block may be determined as follows.

When a skip mode is applied to a current luma component block and a sub-picture, a brick, a tile, a tile group or a slice including a current luma component block is an I type, the encoding mode of a current block may be determined as an intra block copy skip mode.

In an I type, an intra prediction mode and an intra block copy mode may be used, but inter prediction may not be used. Accordingly, it may be determined that an intra block copy skip mode is applied to a current luma component block without entropy encoding/decoding prediction mode information representing whether inter prediction is applied to a current luma component block.

Meanwhile, when a skip mode is applied to a current luma component block and a sub-picture, a brick, a tile, a tile group or a slice including a current luma component block is not an I type, prediction mode information may be entropy encoded/decoded. If it is determined that an intra block copy mode is applied to a current luma component block based on the prediction mode information, the encoding mode of a current luma component block may be determined as an intra block copy skip mode. On the other hand, when it is determined that an inter prediction mode is applied to a current luma component block based on prediction mode information, it may be determined that an inter prediction skip mode is applied to a current luma component block.

When it is determined that a skip mode is not applied to a current luma component block, but an intra block copy mode is applied to a current luma component block based on prediction mode information, information representing whether a merge mode is applied to a current luma component block may be entropy encoded/decoded.

In this case, when information representing whether the merge mode is applied indicates that a merge mode is applied to a current luma component block, it may be determined that an intra block copy merge mode is applied to a current luma component block.

Alternatively, it is assumed that a skip mode is not applied to a current luma component block, but a residual block is encoded/decoded for a current luma component block and a current chroma component block. In this case, when it is determined that an intra block copy mode is applied to a current luma component block based on prediction mode information, information representing whether a merge mode is applied to a current luma component block may be entropy encoded/decoded.

In this case, when information representing whether the merge mode is applied indicates that a merge mode is applied to a current luma component block, it may be determined that an intra block copy merge mode is applied to a current luma component block.

When information representing whether a merge mode is applied represents that a merge mode is not applied, it may be determined that an intra block copy AMVP mode is applied to a current luma component block. In other words, when it is determined that both a skip mode and a merge mode are not applied to a current luma component block and it is determined that an intra block copy mode is applied to a current luma component block, it may be determined that an intra block copy AMVP mode is applied to a current luma component block.

The encoding mode of a current luma component block may be determined/derived based on at least one of the encoding information described above or at least one of the encoding parameters of a current block/a CTB or a neighboring block/CTB adjacent to a current block/CTB.

Meanwhile, in the present disclosure, an intra block copy mode may refer to at least one of an intra block copy skip mode, an intra block copy merge mode or an intra block copy AMVP mode.

Information related to the partition of a CTU may be encoded/decoded.

As an example, qtbtt_dual_tree_intra_flag represents whether root nodes of a luma component block and a chroma component block are the same for an I slice. As an example, when qtbtt_dual_tree_intra_flag is a first value (e.g., 0), it may indicate that a 64×64 encoding unit partitioned from a CTU is not used as root nodes of a luma component and a chroma component. On the other hand, when qtbtt_dual_tree_intra_flag is a second value (e.g., 1), it may indicate that a 64×64 encoding unit partitioned from a CTU is used as root nodes of a luma component and a chroma component.

When qtbtt_dual_tree_intra_flag is a first value (e.g., 0), it represents that a block partition structure for a luma component and a block partition structure for a chroma component are the same. However, according to the format of a chroma component, block sizes of a luma component and a chroma component may be different from each other. When block partition structures of a luma component and a chroma component are the same, it may be referred to as a single tree structure. A single tree type may be identified as SINGLE_TREE.

When a slice type is an I slice and qtbtt_dual_tree_intra_flag is a second value (e.g., 1), it represents that when a 64×64 encoding unit is used as a root node, a block partition structure for a luma component and a block partition structure for a chroma component may be different from each other. In other words, a block partition structure for a luma component and a block partition structure for a chroma component may be determined independently. When a block partition structure for a luma component and a block partition structure for a chroma component are independent, it may be referred to as a dual tree structure. In a dual tree structure, a tree type for a luma component may be identified as DUAL_TREE_LUMA, and a tree type for a chroma component may be identified as DUAL_TREE_CHROMA.

When a single tree structure is applied, the minimum size of a chroma component block for applying an intra block copy mode may be 2×2. In other words, a block having a size smaller than a 2×2 block for a chroma component may not be used. Accordingly, a 2×2 chroma component block using an intra block copy mode may not be allowed to be partitioned into a size smaller than 2×2.

Alternatively, when a single tree structure is applied, the minimum size of a chroma component block for applying an intra block copy mode may be 4×4. In other words, a block having a size smaller than 4×4 block for a chroma component (e.g., a 2×2 block, a 2×4 block or a 4×2 size) may not be used. Accordingly, a block larger than 2×2, 2×4 or 4×2 using an intra block copy mode may not be allowed to be partitioned into blocks in a 2×2, 2×4 or 4×2 size.

Alternatively, when a double tree structure is applied, the minimum size of a chroma component block for applying an intra block copy mode may be 4×4. In other words, a block having a size smaller than 4×4 block for a chroma component (e.g., a 2×2 block, a 2×4 block or a 4×2 size) may not be used. Accordingly, a block larger than 2×2, 2×4 or 4×2 using an intra block copy mode may not be allowed to be partitioned into blocks in a 2×2, 2×4 or 4×2 size.

In order to improve the subjective/objective image quality of an image, an encoder may perform primary transform on a residual block to generate a primary transform coefficient and perform secondary transform on a primary transform coefficient to generate a secondary transform coefficient. In addition, a secondary transform coefficient may be quantized to generate a quantized coefficient level, and a quantized coefficient level may be entropy encoded.

A decoder may perform entropy decoding on a quantized coefficient level and dequantize a quantized coefficient level to generate a secondary transform coefficient. And, secondary inverse transform may be performed on a secondary transform coefficient to generate a primary transform coefficient and primary inverse transform may be performed on a primary transform coefficient to reconstruct a residual block.

In an encoder, secondary transform may be performed between primary transform and quantization. In a decoder, secondary inverse transform may be performed between dequantization and primary inverse transform. In this case, secondary transform may be reduced secondary transform or low-frequency non-separable transform (LFNST).

When an intra block copy mode is applied to a current block, the secondary transform/inverse transform may be applied to a current block. Here, secondary transform/inverse transform may be performed on at least one of a current luma component block and a current chroma component block.

In addition, in order to perform secondary transform/inverse transform, the transform matrix set of a current block may be determined. In this case, when secondary transform is performed on a current block, a transform matrix index representing which transform matrix among the transform matrices included in a transform matrix set will be used for secondary transform/inverse transform may be entropy encoded/decoded.

In an encoder/a decoder, the encoding mode of a current chroma component block may be derived as follows.

First, when a luma component and a chroma component have the same block partition structure (i.e., a single tree type (SINGLE_TREE)), the encoding mode of a current chroma component block may be determined as follows.

The prediction mode of a current chroma component block may be set to be the same as the prediction mode of a corresponding current luma component block. Here, a prediction mode may include at least one of an intra prediction mode, an inter prediction mode or an intra block copy mode.

As an example, when an intra block copy skip mode is applied to a current luma component block, encoding/decoding of a residual block may be omitted for a current chroma component block corresponding to the current luma component block and accordingly, residual block information may not be signaled. Meanwhile, entropy encoding/decoding for information representing whether residual block information is signaled (e.g., an encoding block flag (cu_cbf or tu_cbf)) may also be omitted. An encoding block flag tu_cbf may include information by chroma component (e.g., at least one of tu_cbf_cb or tu_cbf_cr). Entropy encoding/decoding for an encoding block flag may be omitted, and it may be inferred that the value of an encoding block flag represents that residual block information is not signaled.

Alternatively, when an intra block copy merge mode is applied to a current luma component block, encoding/decoding of a residual block may be omitted for a current chroma component block corresponding to the current luma component block and accordingly, residual block information may not be signaled. Meanwhile, entropy encoding/decoding for information representing whether residual block information is signaled (e.g., an encoding block flag (cu_cbf or tu_cbf)) may also be omitted. An encoding block flag tu_cbf may include information by chroma component (e.g., at least one of tu_cbf_cb or tu_cbf_cr). Entropy encoding/decoding for an encoding block flag may be omitted, and it may be inferred that the value of an encoding block flag represents that residual block information is not signaled.

When a luma component and a chroma component have the same block partition structure and an intra block copy mode is applied to a current chroma component block, encoding/decoding information of a current chroma component block corresponding to the current luma component block may be derived from encoding/decoding information of a current luma component block.

In this case, encoding information of a current chroma component block may be derived from encoding information of a luma component block corresponding to a sample position corresponding to the center of a current chroma component block. Alternatively, encoding information of a current chroma component block may be derived from encoding information of a luma component block corresponding to a sample position corresponding to the top-left of a current chroma component block.

The encoding mode of a current chroma component block may be derived based on at least one of the encoding parameters of a current chroma component block/a CTB or a luma component block/a CTB corresponding to a current chroma component block/a CTB.

When a luma component and a chroma component have an independent block partition structures (a tree type DUAL_TREE_LUMA or DUAL_TREE_CHROMA for a dual tree structure), encoding mode information for determining the encoding mode of a current chroma component block may be entropy encoded/decoded. Here, an encoding mode may represent a prediction mode. The encoding mode of a chroma component block may include at least one of an intra prediction mode, an inter prediction mode or an intra block copy mode in the same way as the encoding mode of a luma component block.

As an example, when a syntax element representing the prediction mode information of a current chroma component block has a first value (e.g., 0), the encoding mode of a current chroma component block may be determined as an intra prediction mode. When a syntax element representing the prediction mode information of a current chroma component block has a second value (e.g., 1), the encoding mode of a current chroma component block may be determined as an inter prediction mode. When a syntax element representing the prediction mode information of a current chroma component block has a third value (e.g., 2), the encoding mode of a current chroma component block may be determined as an intra block copy mode.

Alternatively, based on first prediction mode information (e.g., an index, a flag or an identifier (e.g., pred_mode_flag)), whether an intra prediction mode is applied to a chroma component block may be determined. As an example, when first prediction mode information has a first value (e.g., 1), it represents that an intra prediction mode is applied to a chroma component block, and when first prediction mode information has a second value (e.g., 0), it represents that an intra prediction mode is not applied to a chroma component block.

When an intra prediction mode is not applied to a chroma component block, second prediction mode information (e.g., an index, a flag or an identifier (e.g., pred_mode_ibc_flag)) may be additionally entropy encoded/decoded. Second prediction mode information may represent whether an intra prediction mode or an intra block copy mode is applied to a chroma component block. As an example, when second prediction mode information has a first value (e.g., 1), it may represent that an intra block copy mode is applied to a chroma component block. On the other hand, when second prediction mode information has a second value (e.g., 2), it may represent that an inter prediction mode is applied to a chroma component block.

Alternatively, first prediction mode information (e.g., an index, a flag or an identifier (e.g., pred_mode_flag)) may represent whether an intra prediction mode or an inter prediction mode is applied to a chroma component block. As an example, when first prediction mode information is a first value (e.g., 1), it represents that an intra prediction mode is applied to a chroma component block. On the other hand, when second prediction mode information has a second value (e.g., 0), it represents that an inter prediction mode is applied to a chroma component block. Second prediction mode information (e.g., an index, a flag or an identifier (e.g., pred_mode_ibc_flag)) representing whether an intra block copy mode is applied may be additionally entropy encoded/decoded, or may derive the value of second prediction mode information. As an example, when second prediction mode information is a first value (e.g., 1), it represents that an intra block copy mode is applied to a chroma component block. On the other hand, when second prediction mode information is a second value (e.g., 0), it represents that an intra prediction mode or an inter prediction mode determined in first prediction mode information is applied to a chroma component block.

Alternatively, when second prediction mode information is a first value (e.g., 1), it represents that an intra block copy mode is applied to a chroma component block, and when second prediction mode information is a second value (e.g., 0), it represents that an intra prediction mode is applied to a chroma component block.

When a luma component and a chroma component have an independent block partition structure and an intra block copy mode is applied to a current chroma component block, information (e.g., a block vector) required for encoding/decoding a current chroma component block may be derived from encoding information of a luma component block corresponding to a current chroma component block.

In this case, encoding information of a luma component block corresponding to a sample position corresponding to the center of a current chroma component block may be used. Alternatively, encoding information of a luma component block corresponding to a sample position corresponding to the top-left of a current chroma component block may be used.

Based on the above-described description, when an intra block copy mode is applied to a current block, a method for encoding/decoding a current block will be described in detail.

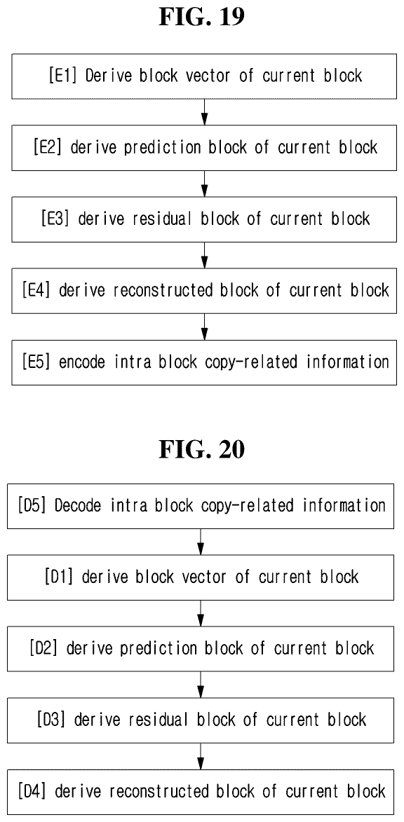

FIG. 19 is a flowchart of a method for encoding a current block under an intra block copy mode.

FIG. 20 is a flowchart of a method for decoding a current block under an intra block copy mode.

Hereinafter, each step in FIGS. 19 and 20 will be described in detail.

### [E1/D1] A Step for Deriving Block Vector Information for Intra Block Copy Prediction;

Prediction block vector information for intra block copy mode prediction may include at least one of a block vector, resolution information of a block vector and/or information related to a prediction method.

The information related to a prediction method may include information related to at least one of intra prediction, inter prediction, intra block copy prediction, local illumination compensation (LIC) prediction, template matching-based intra block copy merge (IBC-TM merge), intra template matching prediction (IntraTMP), geometric partition prediction or reconstruction-reordered intra block copy (RR-IBC, or Reconstruction-reordered IBC). Here, each information may indicate whether to perform a specific prediction method among a plurality of the listed prediction methods.

Information related to a prediction method may include additional information related to a prediction method. In this case, additional information may include additional information necessary for a specific prediction mode to be applied.

For example, in order to perform prediction based on an intra prediction mode, information related to a prediction method may include at least one of information for determining a prediction mode or index information indicating at least one reference pixel line. Here, information for determining a prediction mode may include at least one of information for indicating at least one of the prediction modes for intra prediction (e.g., PLANAR, DC or directional prediction modes) or, when deriving a prediction mode based on a template region around a current block, a flag or an index indicating whether a template matching prediction mode is performed.

For example, in order to perform prediction based on an intra block copy prediction mode, information related to a prediction method may include at least one of information indicating whether to perform an intra block copy prediction mode based on an AMVP, information indicating whether to perform a merge mode-based intra block copy prediction mode an index indicating a prediction block vector, a flag indicating whether to apply a sub-pixel block vector, an index indicating the resolution of a block vector, the difference value (DBV or MBVD) of a block vector, information indicating whether to apply a block vector improvement method based on template matching, information indicating whether to apply local illumination compensation, information indicating whether to apply a template matching-based intra block copy merge mode, information on a partition mode for geometric partition prediction and a block vector corresponding to each region, or information indicating whether to apply an reconstruction-reordered intra block copy and a reordering direction/angle.

For example, in order to perform prediction based on an intra template matching prediction mode, information related to a prediction method may include at least one of a flag indicating whether to apply a sub-pixel block vector, an index indicating the resolution of a block vector, the difference value (DBV or MBVD) of a block vector, information indicating whether to apply a block vector improvement method based on template matching, information indicating whether to apply local illumination compensation, information indicating whether to apply a template matching-based intra block copy merge, a partition mode for geometric partition prediction and a block vector corresponding to each region, or information indicating whether to apply an reconstruction-reordered intra block copy and a reordering direction/angle.

Meanwhile, a method for deriving block vector information from a luma component block and a method for deriving block vector information from a chroma component block may be different. Accordingly, a method for deriving block vector information from a luma component block (hereinafter, step [E1-1/D1-1]) and a method for deriving block vector information from a chroma component block (hereinafter, step [E1-2/D1-2]) will be separately described.

### [E1-1/D1-1] A Step for Deriving the Block Vector of a Luma Component Block;

When an intra block copy skip mode or an intra block copy merge mode is applied to a current luma component block, the block vector of a current luma component block may be derived as follows.

In order to derive the block vector of a current luma component block, the block vector of a luma component block encoded/decoded before a current block is derived as a block vector candidate. At least one block vector candidate may be inserted to configure a block vector candidate list and select at least one of the block vector candidates included in a configured block vector candidate list. A selected block vector candidate may be set as the block vector of a current block.

In this case, block vector candidate information (e.g., an identifier, an index or a flag (e.g., merge_idx)) for identifying a block vector candidate used for a current luma component block among a plurality of block vector candidates included in a block vector candidate list may be entropy encoded/decoded. Alternatively, encoding/decoding of block vector candidate information may be omitted, and a value thereof may be derived based on at least one of the encoding parameters.

In this case, at least one block vector candidate list may be configured for a current block. In addition, at least one block vector candidate may be selected for a current block.

A block vector candidate list may be configured with up to N candidates. In this case, N may be a positive integer and may refer to the maximum number of block vector candidates that may be included in a block vector candidate list. N may be derived based on at least one of the encoding parameters of a current block/a CTB. Alternatively, N may be predefined in an encoder and a decoder. Alternatively, information for determining the N may be entropy encoded/decoded.

A block vector candidate may further include at least one of the prediction mode of a previously encoded/decoded luma component block, resolution information of a block vector, information related to a prediction method or additional information related to a prediction method, as well as the block vector of a luma component block encoded/decoded before a current block.

In the present disclosure, an expression such as a block vector, block vector information or a block vector candidate may include the information.

Alternatively, when an intra block copy skip mode or an intra block copy merge mode is applied to a current luma component block, the block vector of a current luma component block may be derived as follows.

First, at least one of the following block vector candidates may be added to a block vector candidate list.

A block vector candidate derived from the top neighboring block (A1) of a current block

A block vector candidate derived from the left neighboring block (B1) of a current block

A block vector candidate derived from the bottom-left neighboring block (B0) of a current block

A block vector candidate derived from the top-right neighboring block (A0) of a current block

A block vector candidate derived from the top-left neighboring block (B2) of a current block

Meanwhile, for a neighboring block B2 adjacent to the top-left corner of a current block, when all of neighboring blocks A1, B1, B0 and A0 are available (e.g., when block vector information exists in all of A1, B1, B0 and A1), they may be determined to be unavailable as a block vector candidate. In other words, in this case, block vector information of block B₂ may not be included in a block vector candidate list.

In addition, according to a predetermined priority, whether block vector information exists in neighboring blocks at the position of A0, A1, B0, B1 and B2 (i.e., whether a corresponding neighboring block is encoded/decoded by using an intra block copy mode or whether the encoding mode of a corresponding neighboring block is an intra block copy mode) may be determined. When block vector information exists in a corresponding neighboring block, the block vector of a corresponding neighboring block may be set as a block vector candidate. In this case, at least one of the block vectors determined as a set block vector candidate may be inserted into a block vector candidate list. As an example, the search order (i.e., priority) of block vector candidates for configuring a block vector candidate list may be the order of A1, B1, B0, A0 and B2.

In configuring a block vector candidate list according to a predetermined priority, a redundancy/similarity check may be performed between a block vector candidate existing in a block vector candidate list and a block vector candidate to be newly added to a block vector candidate list. For example, when a block vector candidate to be newly added to a block vector candidate list overlaps with or is similar to a block vector candidate existing in a block vector candidate list, a new block vector candidate may not be added to a block vector candidate list.

A redundancy/similarity check may be performed between a block vector candidate to be added to a block vector candidate list and all block vector candidates existing in a block vector candidate list.

Alternatively, a redundancy/similarity check may be performed only on some of the block vector candidates included in a block vector candidate list. For example, in configuring a block vector candidate list in the order of A1, B1, B0, A0 and B2, a B1 block may perform a redundancy/similarity check with a A1 block, and a B0 block may perform a redundancy/similarity check with a B1 block. In addition, a A0 block may perform a redundancy/similarity check with a A1 block, and a B2 block may perform a redundancy/similarity check with a A1 block and a B1 block. A redundancy/similarity check may be performed only when a block vector exists in a corresponding block.

A similarity test between block vector candidates may be to determine whether the absolute value of a difference between x and y elements of a block vector is smaller than Th.

For example, when the absolute value of a difference between x elements of two block vectors is smaller than Th and the absolute value of a difference between y elements is smaller than Th, it may be determined that two block vectors are similar to each other.

For example, when any one of the absolute value of a difference between x elements of two block vectors and the absolute value of a difference between y elements is greater than or equal to Th, it may be determined that two block vectors are not similar to each other. In addition, each of the blocks at the position of A0, A1, B0, B1 and B2 may be available as a block vector candidate only when block vector information exists in a corresponding block and the block vector information is available in a current block. The block vector of a neighbor block available as a block vector candidate may be determined as a block vector candidate. A neighbor block that is not available as a block vector candidate may not be used as a block vector candidate. In this case, whether the block vector information of a neighbor block is available may be determined based on whether a reference sample (or, a reference block) at a position indicated by the block vector is available when the block vector of a neighbor block is applied to a current block.

For example, when the position of a reference sample or a reference block indicated by the block vector of a neighbor block indicates a sample included in a current block or includes a sample included in a current block, it may be determined that the block vector of a corresponding neighbor block is not available for a current block.

For example, when the position of a reference sample or a reference block indicated by the block vector of a neighbor block includes at least one of a region/a position/a sample beyond the boundary of a sub-picture, a slice, a tile group, a tile or a brick, it may be determined that the block vector of a corresponding neighbor block is not available for a current block.

The block vector of at least one of the blocks encoded/decoded before a current block may be stored in a buffer, and at least one of the block vectors stored in a corresponding buffer may be set as a block vector candidate for a current block. In this case, at least one block vector candidate derived from the buffer may be included in the block vector candidate list of a current block.

The size of a buffer may be predefined in an encoder and a decoder. The block vector of a block encoded/decoded in an intra block copy mode may be stored in a buffer. When a buffer is full, a block vector stored first may be deleted, and a new block vector (i.e., the block vector of the most recently encoded/decoded block) may be stored in a buffer.

According to the storage order among the block vectors stored in a buffer (e.g., the oldest storage order or the most recent storage order), the order of adding a block vector stored in a buffer to a block vector candidate list may be determined. For example, a block vector stored last in a buffer may be added first to a block vector candidate list. In other words, as it is stored later in a buffer, it may be added faster to a block vector candidate list. Alternatively, a block vector stored first in a buffer may be added first to a block vector candidate list. In other words, as it is stored faster in a buffer, it may be added faster to a block vector candidate list.

A buffer storing block vector candidates may be called a history-based block vector candidate list, and a block vector candidate included in the buffer may be called a history-based block vector candidate.

A buffer including a history-based block vector may be managed/used separately from a buffer including a history-based motion vector in an inter prediction mode.

When a history-based block vector candidate is added to a block vector candidate list, whether a corresponding history-based block vector candidate is available for a current block may be determined. Only when it is determined that a history-based block vector candidate is available for a current block, a corresponding history-based block vector candidate may be added to a block vector candidate list. In this case, whether a history-based block vector candidate is available may be determined based on whether a reference sample (or a reference block) at a position indicated by the block vector of a corresponding candidate is available.

For example, when the position of a reference sample or a reference block indicated by the block vector of a history-based block vector candidate indicates a sample included in a current block or includes a sample included in a current block, it may be determined that a corresponding history-based block vector candidate is not available for a current block.

For example, when the position of a reference sample or a reference block indicated by the block vector of a history-based block vector candidate includes at least one of a region/a position/a sample beyond the boundary of a sub-picture, a slice, a tile group, a tile or a brick, it may be determined that a corresponding history-based block vector candidate is not available for a current block. When a history-based block vector candidate is added to a block vector candidate list, a redundancy check may be performed between a history-based block vector candidate and block vector candidates existing in a block vector candidate list. A history-based block vector candidate may be added to a block vector candidate list when the same block vector candidate does not exist in a block vector candidate list.

As another example, when a history-based block vector candidate is added to a block vector candidate list, a history-based block vector candidate may be added to a block vector candidate list without performing a redundancy check with a block vector candidate existing in a block vector candidate list.

A buffer including history-based block vector candidates may be initialized in the unit of a picture, a slice, a sub-picture, a brick, a tile group, a tile, a CTU, a CTU row or a CTU column. In other words, the buffer may be maintained and used while encoding/decoding listed units.

In addition, the buffer may include at least one of the encoding information of a previously encoded/decoded block based on a current block within the unit of a picture, a slice, a sub-picture, a brick, a tile group, a tile, a CTU, a CTU row or a CTU column.

When a buffer is initialized, all block vectors existing in a buffer may be deleted. Alternatively, when a buffer is initialized, a block vector existing in a buffer may be changed to a predetermined value, or all candidates in a buffer may be deleted and an initial history-based block vector candidate having a predetermined value may be inserted into a buffer. In this case, a predetermined value may represent the value of at least one of the x component or the y component of a block vector. A predetermined value may be an integer predefined in an encoder and a decoder (e.g., (0, 0), (1, 1), (−1, −1), etc.).

Any two of the block vector candidates stored in a block vector candidate list may be selected, and a new block vector candidate may be generated by using two selected block vector candidates. As an example, a block vector derived by performing a pair-wise average on block vectors of two block vector candidates may be set as a new block vector candidate and inserted into a block vector candidate list.

In this case, a block vector obtained by averaging two block vectors may be called a pair-wise average block vector.

At least one pair-wise average block vector candidate may be added to a block vector candidate list.

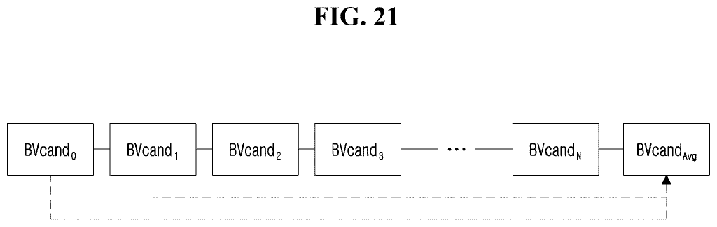

FIGS. 21 to 23 shows an example in which a pair-wise average block vector candidate is added to a block vector candidate list.

A pair-wise average block vector may be derived as follows.

First, two candidates may be randomly selected from history-based block vector candidates and/or block vector candidates derived from an adjacent encoding/decoding region around a current block. In this case, two selected candidates may be block vector candidates having the smallest index (i.e., index 0 and index 1) in a block vector candidate list, as in an example shown in FIG. 21.

Two block vector candidates may be selected among the block vector candidates, and a pair-wise average block vector candidate (BVcandAvg) derived based on two selected block vector candidates may be added to a block vector candidate list.

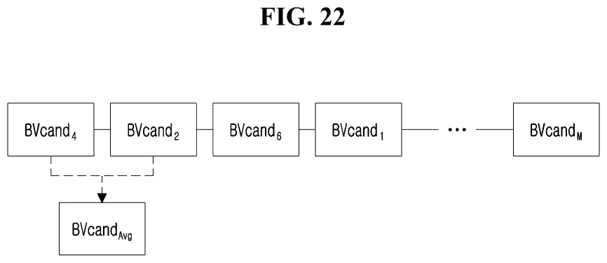

As another example, after reordering block vector candidates in a block vector candidate list, two block vector candidates may be selected among the reordered block vector candidates. Here, reordering may order block vector candidates in ascending or descending order based on a template matching cost for each of the block vector candidates. FIG. 22 shows an example in which block vector candidates shown in FIG. 21 are reordered in the ascending order of template matching costs.

As in an example shown in FIG. 22, after reordering block vector candidates, block vector candidates with the smallest index (i.e., index 0 and index 1) among the reordered candidates may be selected. In this case, block vector candidates with the smallest index may be two block vector candidates with the smallest template matching cost.

Two block vector candidates among the reordered block vector candidates may be selected, and a pair-wise average block vector candidate (BVcandAvg) derived based on two selected block vector candidates may be added to a block vector candidate list.

The largest index may be allocated to a pair-wise average block vector candidate added to a block vector candidate list.

Alternatively, a template matching cost may also be derived for a pair-wise average block vector candidate. Then, a block vector candidate list to which a pair-wise average block vector candidate is added may be reordered again according to a template matching cost. In other words, an index allocated to a pair-wise average block vector candidate may be determined based on a template matching cost.

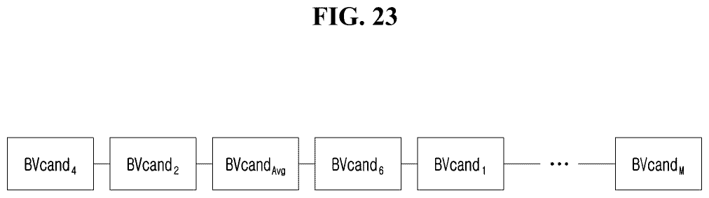

FIG. 23 shows an example in which an index allocated to a pair-wise average block vector candidate is determined according to a template matching cost.

When the template matching cost of a pair-wise average block vector candidate is greater than BVcand₂ and smaller than BVcand₆ shown in FIG. 22, a pair-wise average block vector candidate may be added between BVcand₂ and BVcand₆, as in an example shown in FIG. 23.

A pair-wise average block vector candidate may be added to a block vector candidate list after any step in the process of configuring a block vector candidate list. As an example, a pair-wise average block vector candidate may be added to a block vector candidate list after inserting a block vector candidate derived from spatial neighbor blocks of a current block into a block vector candidate list or after inserting a predefined block vector candidate into a block vector candidate list. Meanwhile, a predefined block vector candidate may be a zero block vector candidate whose block vector is (0, 0).

When block vectors of two block vector candidates are referred to as (hor₀, ver₀) and (hor₁, ver₁), respectively, the block vector (hor_{Avg}, Ver_{Avg}) of a pair-wise average block vector candidate may be derived based on Equation 1 below.

$${hor}_{Avg} = ( ( h o {r}_{0} + h o {r}_{1} ) + Offset - Sign ( {hor}_{0} + h o {r}_{1} ) ) ≫ shift \qquad [ Equation 1 ]$$

$${ver}_{Avg} = ( ( v e {r}_{0} + v e {r}_{1} ) + Offset - Sign ( {ver}_{0} + {ver}_{1} ) ≫ shift$$

In Equation 1 above, the value of a shifting parameter shift may be 1. In addition, an offset offset may be derived as a rounding parameter, such as (1<< (shift−1)). Sign( ) may be a function that outputs sign information of a specific value x. As an example, when x is less than 0 (i.e., x<0), 0 may be output, and when x is equal to or greater than 0 (i.e., x>=0), 1 may be output.

In configuring a block vector candidate list, a block vector that satisfies at least one of the conditions listed below may be set to be unavailable as a block vector candidate. In other words, a block having a block vector that satisfies at least one of the conditions listed below is unavailable as a block vector candidate, and the block vector of a corresponding block may not be included in a block vector candidate list.
When all or part of a reference region covering a position indicated by a block vector is included in a region, not the decoding reference region of intra block copy among the decoding regions within a current picture, the block vector may be set to be unavailable as a block vector candidate. Here, a decoding reference region may be defined based on a syntax signaled at a higher level. A higher level may include at least one of a parameter set, a slice header or a picture header. In addition, a reference region may have the same width and height as a current block.
When all or part of a reference region covering a position indicated by a block vector overlaps at least a part of a current block, the block vector may be set to be unavailable as a block vector candidate.

Alternatively, even when it is a block vector satisfying at least one of the conditions listed above, a corresponding block vector may be set as a block vector candidate and added to a block vector candidate list.

A combined block vector candidate may be configured by combining at least two of the block vector candidates existing in a block vector candidate list. A combined block vector candidate generated by combining at least two block vector candidates may be added to a block vector candidate list.

A combined block vector candidate may be derived based on a statistical value for each of the x component and the y component of a block vector of block vector candidates. As an example, for a plurality of block vector candidates, the value of a x component with the highest frequency and the value of a y component with the highest frequency may be set as the value of a x component and the value of a y component of a combined block vector candidate, respectively.

In this case, in configuring a combined block vector candidate, a history-based block vector candidate may be set not to be used. Alternatively, in configuring a combined block vector candidate, a block vector candidate derived from a neighboring block adjacent to a current block may be set not to be used.

A combined block vector candidate may be added to a block vector candidate list only when a combined block vector candidate derived from block vector candidates is available in a current block. In this case, whether a combined block vector is available may be determined based on whether a reference sample (block) at a position indicated by the block vector of a combined block vector is available.

For example, when a region/a position indicated by a combined block vector candidate includes at least one of the samples included in a current block, a combined block vector candidate may be determined to be unavailable.

For example, when a region/a position indicated by a combined block vector candidate includes at least one of a region/a position/a sample beyond the boundary of a picture, a sub-picture, a slice, a tile group, a tile or a brick, a combined block vector candidate may be determined to be unavailable.

A block vector candidate may also be derived based on the size of a current block. As an example, when the horizontal length of a current luma component block is W and a vertical length is H, (−(W<<n)+a, −(H<<n)+b), (−(W<<n)+c, 0) or (0, −(H<<n)+d) may be added to a block vector candidate list as a block vector candidate. In this case, n may be a positive integer and a, b, c and d may be an integer. A block vector candidate derived based on the size of a current block may be called a fixed basic block vector candidate.

A block vector candidate list may be configured by adding at least one of a block vector candidate derived from a neighboring block adjacent to a current block, a history-based block vector candidate, a combined block vector candidate or a fixed basic block vector candidate.

In this case, the insertion order of block vector candidates may follow a predetermined priority. As an example, the insertion order of block vector candidates may be the order of the block vector candidate of a neighboring block adjacent to a current block, a history-based block vector candidate, a combined block vector candidate and a fixed basic block vector candidate.

Alternatively, when the number of block vector candidates included in a block vector candidate list is not the maximum number, a fixed basic block vector candidate may be inserted into a block vector candidate list until the number of block vector candidates in a block vector candidate list reaches the maximum number. As an example, a fixed basic block vector candidate may be added to a block vector candidate list in the following order.

$$1. ( - ( W ≪ 1 ) , 0 )$$

$$2. ( 0 , - ( H ≪ 1 ) )$$

$$3. ( - ( W ≪ 1 ) - 1 , 0 )$$

$$4. ( 0 , - ( H ≪ 1 ) - 1 )$$

$$5. ( - ( W ≪ 1 ) - 2 , 0 )$$

$$6. ( 0 , - ( H ≪ 1 ) - 2 )$$

$$7. ( - ( W ≪ 1 ) - 3 , 0 )$$

$$8. ( 0 , - ( H ≪ 1 ) - 3 )$$

$$7. ( - ( W ≪ 1 ) - 4 , 0 )$$

$$8. ( 0 , - ( H ≪ 1 ) - 4 )$$

As another example, a fixed basic block vector may be a (0, 0) vector. When the number of block vector candidates in a block vector candidate list is smaller than the maximum number of block vector candidates that may be included in a block vector candidate list, a fixed basic block vector may be repeatedly added to a block vector candidate list until the number of block vector candidates reaches the maximum number.

In configuring a block vector candidate list, the maximum number of spatial block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m. A spatial block vector candidate represents a block vector candidate derived from a neighboring block adjacent to a current block.

In configuring a block vector candidate list, the maximum number of history-based block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m.

In configuring a block vector candidate list, the maximum number of combined block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m.

In configuring a block vector candidate list, the maximum number of fixed basic block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m.

The maximum number of block vector candidates that may be included in a block vector candidate list may be preset in an encoder/a decoder. Alternatively, information for determining the maximum number may be encoded in an encoder and signaled to a decoder.

A block vector candidate may be derived according to at least one of the encoding parameters of a current block/a CTB.

A block vector candidate may be added to a block vector candidate list according to at least one of the encoding parameters of a current block/a CTB.

Candidate block vectors in a block vector candidate list may be reordered through template matching. Through template matching, a template matching cost between a template adjacent to a current block (a current template) and a reference template indicated by a block vector candidate may be calculated. In this case, a current template for template matching may be configured with pre-encoded/decoded samples around a current block. As an example, a current template may be configured to include at least one of the R top sample lines adjacent to a current block, the R left sample lines adjacent to a current block or the R×R top-left samples adjacent to a current block.

A reference template may be spaced apart from a current template by the block vector of a block vector candidate. In addition, a reference template may have the same size and shape as a current template.

A template matching cost between the template of a current block and a reference template indicated by the block vector of a block vector candidate may be calculated.

A cost function for calculating the template matching cost may include at least one of the sum of absolute difference (SAD), the mean-removed sum of absolute differences (MR-SAD), the mean squared error (MSE) or the sum of squared error (SSE). However, a cost function other than listed types may be used to calculate A template matching cost.

After calculating a template matching cost for each block vector candidate, block vector candidates in a block vector candidate list may be reordered in ascending order of template matching costs.

Only K candidates with the lowest template matching cost among the reordered block vector candidates in a block vector candidate list may be used as final block vector candidates. In this case, K may be an integer greater than 1. As an example, K may be 6.

Accordingly, an index (e.g., a merge index) indicating one of the block vector candidates included in a block vector candidate list may have a value from 0 to (K−1). In addition, the index may be entropy encoded/decoded.

A block vector candidate may be derived according to at least one of the encoding parameters of a current block/a CTB.

A block vector candidate may be added to a block vector candidate list according to at least one of the encoding parameters of a current block/a CTB.

Each of a plurality of blocks generated by partitioning an upper block may be encoded/decoded in an intra block copy skip mode, an intra block copy merge mode or an intra block copy AMVP mode. In this case, when the size of at least one of the blocks partitioned from an upper block is smaller than a predetermined threshold value, a block vector candidate list configured based on an upper block may be used. For example, blocks partitioned from an upper block may share a block vector candidate list configured based on an upper block.

Whether to share a block vector candidate list configured in an upper block may be determined based on at least one of the width (W) or height (H) of an upper block or a lower block generated by partitioning an upper block. For example, when at least one of the conditions below is satisfied, at least one of the lower blocks (i.e., blocks partitioned from an upper block) may use a block vector candidate list configured based on an upper block.
When an upper block is quad tree-partitioned: (width of upper block X height of upper block)/4<threshold value
When an upper block is binary tree-partitioned horizontally or vertically: (width of upper block X height of upper block)/2<threshold value
When an upper block is ternary tree-partitioned horizontally or vertically: (width of upper block X height of upper block)/4<threshold value

In the above-described conditions, a threshold value may be a preset value in an encoder/a decoder. Alternatively, information for determining the threshold value may be encoded in an encoder and signaled to a decoder. Alternatively, according to a partition type applied to an upper block (i.e., a quad tree, a binary tree or a ternary tree), a threshold value may be set differently.

Meanwhile, a threshold value may be a positive integer. In addition, the threshold value may be at least one of the width of a block, the height of a block or the product of the width and height of a block (i.e., the area of a block).

Alternatively, the threshold value may be determined based on at least one of the encoding parameters of a current block/a CTB.

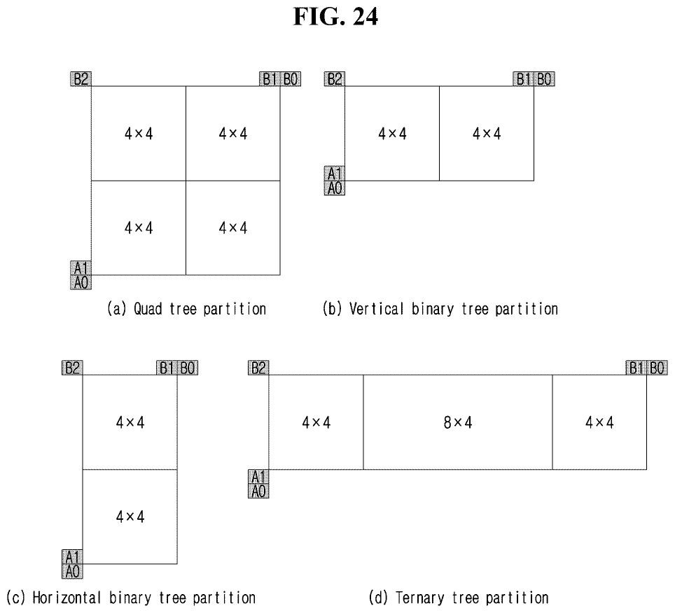

FIG. 24 shows an example in which a block vector candidate list derived based on an upper block is shared with lower blocks.

It is assumed that a threshold value is 32. When quad tree partition, vertical or horizontal binary tree partition or vertical or horizontal ternary tree partition is applied to an upper block and the area of at least one lower block generated accordingly is smaller than a threshold value 32, a lower block to which an intra block copy skip mode, an intra block copy merge mode or an intra block copy AMVP mode is applied may be encoded/decoded based on a block vector candidate list derived based on an upper block. In this case, a block vector candidate list derived based on an upper block may be configured by including at least one of a block vector candidate derived from a neighboring block adjacent to an upper block (i.e., at least one of A1, B1, B0, A0 or B2), a history-based block vector candidate previously encoded/decoded based on an upper block and stored in a buffer, a combined block vector candidate or a fixed basic block vector. In this case, a fixed basic block vector may be derived based on the width and height of an upper block.

When a block vector candidate list derived based on an upper block is used in at least one of the lower blocks, a block vector candidate whose reference block indicated by a block vector is positioned within an upper block may not be available to a lower block.

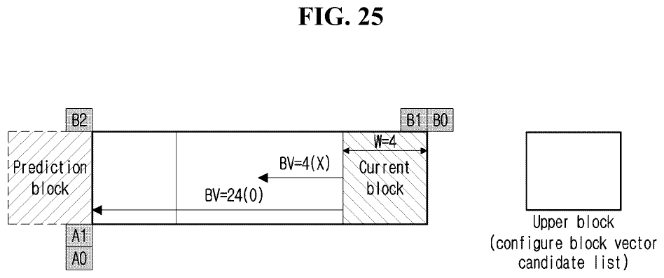

FIG. 25 is an example for describing a block vector candidate that is unavailable to a lower block.

In an example shown in FIG. 25, a bold solid line represents an upper block including a lower block (a current block) indicated by a thin solid line. When a block vector candidate list derived based on an upper block is used for a current block, a block vector candidate may be determined to be valid for a current block only when a region/a position/a sample indicated by a block vector from a current block indicates a region/a position/a sample encoded/decoded before an upper block.

In other words, a block vector candidate may not be available for a lower block when a region/a position/a sample indicated by a block vector from a current block includes a region/a position/a sample included in an upper block.

For a lower block, information indicating one of the block vector candidates included in a block vector candidate list may be encoded and signaled. In this case, the information may indicate one of the block vector candidates available for a lower block in a block vector candidate list. In other words, a block vector candidate list may be reconfigured only with block vector candidates available to a lower block and information indicating one of the reconfigured block vector candidates may be encoded/decoded for a lower block.

When an intra block copy skip mode or an intra block copy merge mode is applied to at least one of the partitioned lower blocks, a block vector candidate list configured based on an upper block may be used in at least one of the lower blocks.

Alternatively, when a merge candidate list configured based on an upper block is used in at least one of the lower blocks, a lower block may not be encoded/decoded in an intra block copy skip mode and an intra block copy merge mode. In this case, a lower block may be encoded/decoded in an intra block copy AMVP mode. However, in this case, a block vector candidate may be available to a lower block only when the block vector of a block vector candidate indicates a region encoded/decoded before an upper block.

When at least one of the width and/or height of a current block is equal to or smaller than a threshold value, it may not be allowed to apply at least one of an intra block copy skip mode or an intra block copy merge mode to a current block. The threshold value may be a positive integer predefined in an encoder/a decoder. Alternatively, information representing the threshold value may be encoded in an encoder and signaled to a decoder.

For example, when the width and height of a current block are smaller than 8, it may not be allowed to apply at least one of an intra block copy skip mode or an intra block copy merge mode to a current block.

A threshold value may be set under a condition for using a merge candidate list configured based on an upper block in a lower block. In this case, when the product of the width and height of a current block is equal to or less than a threshold value for using a merge candidate list configured based on an upper block in a lower block, it may not be allowed to apply at least one of an intra block copy skip mode or an intra block copy merge mode to a current block. In this case, a current block may be one of the blocks partitioned from an upper block.

For example, it is assumed that a threshold value for determining whether a merge candidate list configured based on an upper block is available in a lower block is 32. In this case, only when the product of the width and height of a current block is greater than 32, it may be allowed to apply at least one of an intra block copy skip mode or an intra block copy merge mode to a current block.

In contrast to the embodiment, when the size of a current block (e.g., the product of the width and height of a current block) is less than or equal to a threshold value for determining whether a block vector candidate list configured based on an upper block is available in a lower block, it may not be allowed to apply at least one of a skip mode or a merge mode to a current block. In this case, at least one of the skip mode and the merge mode may refer to a mode for performing encoding/decoding through motion compensation based on a motion vector, not a block vector.

For example, let's assume that a threshold value for determining whether a block vector candidate list configured based on an upper block is available in a lower block is 32. In this case, only when the product of the width and height of a current block is greater than 32, it may be allowed to apply at least one of a skip mode or a merge mode based on a motion vector, not a block vector, to a current block.

In the embodiment and/or another embodiment in the present disclosure, when a specific mode is not allowed, it may mean that a specific mode is not used as the encoding mode of a current block.

It is also possible to configure an integrated merge candidate list that includes both motion vector information and block vector information. As an example, when a first neighbor block adjacent to a current block is encoded/decoded by inter prediction, motion information of a first neighbor block may be derived as a first merge candidate and inserted into a merge candidate list. In addition, when a second neighbor block adjacent to a current block is encoded/decoded by intra block copy, the block vector of a second neighbor block may be derived as a second merge candidate and inserted into a merge candidate list.

According to the encoding mode of a current block, available merge candidates in an integrated merge candidate list may be determined. As an example, when inter prediction is applied to a current block, only merge candidates having motion information in an integrated merge candidate list may be available for a current block. Alternatively, when an intra block copy mode is applied to a current block, only merge candidates having a block vector in an integrated merge candidate list may be available for a current block.

For example, when a current block is encoded/decoded in an intra block copy skip mode or an intra block copy merge mode, a current block may be encoded/decoded based on at least one of the merge candidates having a block vector, not a motion vector, in an integrated merge candidate list. In this case, when an intra block copy skip mode or an intra block copy merge mode is applied to a current block, index information (i.e., a merge index) for identifying one of the merge candidates included in an integrated merge candidate list may indicate one of the candidates having a block vector included in an integrated merge candidate list.

For example, when a current block is encoded/decoded in a skip mode or a merge mode, a current block may be encoded/decoded based on at least one of the merge candidates having a motion vector, not a block vector, in an integrated merge candidate list. In this case, when a skip mode or a merge mode is applied to a current block, index information (i.e., a merge index) for identifying one of the merge candidates included in an integrated merge candidate list may indicate one of the candidates having a motion vector included in an integrated merge candidate list.

Meanwhile, an integrated merge candidate list derived based on an upper block may be used for at least one lower block. As an example, when at least one of the lower blocks partitioned from an upper block is smaller than a predetermined threshold value, an integrated merge candidate list configured based on an upper block may be used for at least one of the lower blocks.

Meanwhile, an integrated merge candidate list may include at least one of a motion vector candidate derived from a neighboring block adjacent to a block, a block vector candidate derived from a neighboring block adjacent to a block, a temporal motion vector candidate, a history-based motion vector candidate, a history-based block vector candidate, a (0,0) motion vector candidate or a fixed basic block vector candidate.

When a block vector candidate list configured based on an upper block is used in at least one of the lower blocks, the block vector of a lower block may not be added to a buffer used to derive a history-based block vector candidate. In other words, the buffer may not be updated with the block vector of a lower block.

On the other hand, when a block vector candidate list configured based on an upper block is not used in at least one of the lower blocks (e.g., when the block vector list of a lower block is configured based on a lower block), the block vector of a lower block may be added to a buffer used to derive a history-based block vector candidate. In other words, an update may be performed to add the block vector of a lower block to the buffer.

As another example, when a current block is a luma component block and an intra block copy AMVP mode is applied to a current luma component block, a method for deriving the block vector of a current luma component block may be as follows.

Similar to an intra block copy skip mode or an intra block copy merge mode, a prediction block vector candidate list may be configured that may include up to N prediction block vector candidates. In this case, N may be a positive integer. Here, N may refer to the maximum number of prediction block vector candidates that may be included in a prediction block vector candidate list.

At least one of the prediction block vector candidates included in a prediction block vector candidate list may be selected. In a prediction block vector candidate list, at least one of the information (e.g., an identifier or an index or a flag or mvp_l0_flag, etc.) for identifying a prediction block vector candidate selected for a current block may be entropy encoded/decoded. Alternatively, a prediction block vector candidate may be selected based on at least one of the encoding parameters.

In this case, at least one prediction block vector candidate list may be configured. In addition, at least one prediction block vector candidate may be used in a current block. In addition, at least one prediction block vector candidate information may be entropy encoded/decoded. Prediction block vector candidate information may be for selecting at least one of a plurality of prediction block vector candidates. When there are a plurality of prediction block candidate lists, prediction block vector candidate information may be entropy encoded/decoded for each list.

A prediction block vector candidate selected by prediction vector candidate information may be used for a current block. Specifically, the block vector of a prediction block vector candidate may be set as the prediction block vector of a current block.

An encoder may calculate a block vector difference (BVD) between the block vector of a current block and a prediction block vector and entropy encode a calculated block vector difference.

A decoder may entropy decode a block vector difference and derive the block vector of a current block by combining a block vector difference and the prediction block vector of a current block.

Meanwhile, information about a block vector difference may include sign information of a block vector difference and magnitude information of a block vector difference.

In this case, sign information may be entropy encoded/decoded based on prediction of a block vector sign. As an example, the sign combination of a block vector difference is four: (+, +), (−, +), (−, +), and (−, −). Accordingly, when the magnitude information of a block vector difference is (Vxd, Vyd), the block vector difference of a current block may be (Vxd, Vyd), (−Vxd, Vyd), (Vxd, −Vyd) and (−Vxd, −Vyd).

A prediction block vector may be added to each of the four block vector difference candidates to derive four block vectors and calculate a template matching cost for each of the four block vectors. Afterwards, a sign combination may be sorted according to a template matching cost. Specifically, the smallest index may be allocated to a sign combination with the smallest template matching cost.

Afterwards, one of the four sign combinations may be selected based on an index.

In addition, instead of encoding/decoding the entire magnitude of a block vector, some bits may be replaced with an index. As an example, magnitude combinations may be configured for N most significant suffix bins (MSSB) among the bits generated when the size of a block vector difference is encoded/decoded with an exponential golomb code. As an example, N may be a natural number greater than or equal to 1 such as 2, 4 or 6. Afterwards, according to the magnitude combinations, N block vector candidates are derived, and a prediction block vector is added to each of the N block vector candidates to derive N block vectors. Then, a template matching cost may be calculated for each of the N block vectors, and magnitude candidates may be sorted according to a template matching cost. Specifically, the smallest index may be allocated to a magnitude candidate with the smallest template matching cost.

Afterwards, one of the N magnitude candidates may be selected based on an index.

In addition, entropy encoding/decoding based on prediction may be applied for both a sign and a magnitude. As an example, when N is 4, a total of 16 block vector difference value candidates may be derived. A template matching cost for each of the 16 block vector difference value candidates may be calculated, and block vector difference value candidates may be sorted according to a template matching cost.

Afterwards, one of the 16 block vector difference value candidates may be selected based on an index.

A block vector candidate list for an intra block copy AMVP mode may be configured in the same manner as the block vector candidate list of an intra block copy merge mode. For example, a prediction block vector candidate list may include at least one of the following prediction block vector candidates.
A prediction block vector candidate derived from a neighboring block adjacent to a current block,
A temporal prediction block vector candidate,
A history-based prediction block vector candidate,
A (0,0) vector candidate,
A fixed basic block vector candidate

After configuring a prediction block vector candidate list in the same manner as the block vector candidate list of an intra block copy merge mode, N candidates (from a first candidate to the N-th candidate) among the prediction block vector candidates included in a prediction block candidate list may be selected, and a prediction vector candidate list may be reconfigured with selected block vector candidates. Here, N is an integer greater than 1, e.g., may be 2. In other words, a prediction block vector candidate list may include only two prediction block vector candidates.

As another example, when a current block is a luma component block and an intra block copy skip mode, an intra block copy merge mode or an intra block copy AMVP mode is applied to a current luma component block, the block vector of a current luma component block may be derived as follows.

First, a block vector candidate list may include up to N block vector candidates. Here, N is a positive integer, and may represent the maximum number of block vector candidates that may be included in a block vector candidate list. N may be derived based on the encoding parameter of a current block/a CTB.

The maximum number of block vector candidates that may be included in a block vector candidate list may be determined based on the maximum number of merge candidates that may be included in a merge candidate list under an inter prediction mode.

For example, information indicating the maximum number of merge candidates that may be included in a merge candidate list used in an inter prediction mode (e.g., six_minus_max_num_merge_cand) may be entropy encoded/decoded. The maximum number of merge candidates that may be included in a merge candidate list used in an inter prediction mode may be derived as in Equation 2 below.

$$MaxNumMergeCand = N - six\_minus \_max \_num \_merge \_cand \qquad [ Equation 2 ]$$

A variable MaxNumMergeCand represents the maximum number of merge candidates that may be included in a merge candidate list. MaxNumMergeCand may have a value from 1 to N. Here, N may be a positive integer. As an example, N may be 6.

MaxNumMergeCand, the maximum number of merge candidate that may be included in a merge candidate list used in an inter prediction mode, may be set as the maximum number of block vector candidates that may be included in a block vector candidate list.

$$MaxNumIBCCand = maxNumMergeCand \qquad [ Equation 3 ]$$

In Equation 3 above, a variable MaxNumIBCCand represents the maximum number of block vector candidates that may be included in a block vector candidate list.

As another example, information indicating the maximum number of merge candidates that may be included in a merge candidate list used in an inter prediction mode (e.g., six_minus_max_num_merge_cand) may be entropy encoded/decoded. Based on the information, the maximum number (MaxNumMergeCand) of merge candidates that may be included in a merge candidate list used in an inter prediction mode may be derived. Meanwhile, based on the maximum number MaxNumMergeCand, the maximum number of block vector candidates that may be included in a block vector candidate list may be determined as in Equation 4 below.

$$MaxNumIBCCand = Max ( M , MaxNumMergeCand ) \qquad [ Equation 4 ]$$

In Equation 4 above, M is a positive integer, for example, may be 2.

As another example, information indicating the maximum number of merge candidates that may be included in a merge candidate list used in an inter prediction mode (e.g., six_minus_max_num_merge_cand) may be entropy encoded/decoded. Based on the information, the maximum number (MaxNumMergeCand) of merge candidates that may be included in a merge candidate list used in an inter prediction mode may be derived. Meanwhile, based on the maximum number MaxNumMergeCand and the encoding mode of a current block, the maximum number of block vector candidates that may be included in a block vector candidate list may be derived.

As an example, when an intra block copy skip mode or an intra block copy merge mode is applied to a current block, MaxNumIBCCand, the maximum number of block vector candidates that may be included in a block vector candidate list, may be set to be the same as the maximum number MaxNumMergeCand according to Equation 3.

On the other hand, when an intra block copy AMVP mode is applied to a current block, MaxNumIBCCand, the maximum number of block vector candidates that may be included in a block vector candidate list, may be determined according to Equation 4.

For example, let's assume that M is 2 and MaxNumMergeCand is 1. When an intra block copy skip mode or an intra block copy merge mode is applied to a current block, the maximum number of block vector candidates that may be included in a block vector candidate list may be determined as 1 according to Equation 3. On the other hand, when an intra block copy AMVP mode is applied to a current block, the maximum number of block vector candidates that may be included in a block vector candidate list may be determined as 2 according to Equation 4.

As another example, when an intra block copy skip mode or an intra block copy merge mode is applied to a current block, MaxNumIBCCand, the maximum number of block vector candidates that may be included in a block vector candidate list, may be set to be the same as the maximum number MaxNumMergeCand according to Equation 3.

On the other hand, when an intra block copy AMVP mode is applied to a current block, the maximum number of block vector candidates that may be included in a block vector candidate list may be fixed to M.

Here, M is a positive integer, for example, may be 2.

For example, it is assumed that MaxNumMergeCand is 6 and M is 2. In this case, when an intra block copy skip mode or an intra block copy merge mode is applied to a current block, the maximum number of block vector candidates that may be included in the block vector candidate list of a current block may be set as 6. On the other hand, when an intra block copy AMVP mode is applied to a current block, the maximum number of block vector candidates that may be included in the block vector candidate list of a current block may be determined as 2.

Alternatively, information indicating the maximum number of block vector candidates that may be included in a block vector candidate list may be separately entropy encoded/decoded.

For example, information indicating the maximum number of block vector candidates that may be included in a block vector candidate list (e.g., six_minus_max_num_ibc_cand) may be entropy encoded/decoded. In this case, the maximum number of block vector candidates that may be included in a block vector candidate list may be derived as in Equation 5 below.

$$MaxNumIBCCand = N - six\_minus \_max \_num \_ibc \_cand \qquad [ Equation 5 ]$$

A variable MaxNumIBCCand may have a value from 0 to N. Here, N may be a positive integer. For example, N may be 6.

As another example, information indicating a difference between the maximum number of merge candidates that may be included in a merge candidate list and the maximum number of block vector candidates that may be included in a block vector candidate list (e.g., max_num_merge_cand_minus_max_num_ibc_cand) may be entropy encoded/decoded. In this case, the maximum number of block vector candidates that may be included in a block vector candidate list may be derived according to Equation 6 below.

$$MaxNumIBCCand = MaxNumMergeCand - max\_num \_merge \_cand \_minus \_max \_num \_ibc \_cand \qquad [ Equation 6 ]$$

In Equation 6 above, MaxNumIBCCand may have a value from 2 to MaxNumMergeCand.

Information indicating the maximum number of block vector candidates that may be included in a block vector candidate list (e.g., at least one of six_minus_max_num_ibc_cand or max_num_merge_cand_minus_max_num_ibc_cand) may be encoded/decoded in a high level parameter or header within a bitstream. Meanwhile, information related to the maximum number may be entropy encoded/decoded only when information indicating whether an intra block copy (IBC) function signaled in a high level parameter or header is used indicates that an intra block copy (IBC) function is used.

For example, information related to the maximum number may be entropy encoded/decoded only when sps_ibc_enabled_flag which is entropy encoded/decoded in a sequence parameter set is a second value (e.g., 1).

At least one of the N and M may be derived according to at least one of the encoding parameters of a current block/a CTB.

Alternatively, the maximum number of block vector candidates that may be included in a block vector candidate list may be fixed/pre-defined as N in an encoder/a decoder. Here, N may have a positive integer value. N may also be derived according to at least one of the encoding parameters of a current block/a CTB.

For example, N, the maximum number of candidates in a block vector candidate list, may be 2.

For example, N, the maximum number of candidates in a block vector candidate list, may be 5.

For example, N, the maximum number of candidates in a block vector candidate list, may be 6.

Meanwhile, a value of N may be determined differently according to the encoding mode of a current block. Here, an encoding mode may represent at least one of an intra block copy skip mode, an intra block copy merge mode or an intra block copy AMVP mode based on an intra block copy mode.

For example, when an intra block copy skip mode or an intra block copy merge mode is applied to a current block, a value of N may be 6.

For example, when an intra block copy AMVP mode is applied to a current block, a value of N may be 2.

When a block vector candidate list is configured, information for identifying one of the candidates included in a block vector candidate list (e.g., at least one of an identifier, an index or a flag) may be entropy encoded/decoded or may be derived based on at least one of the encoding parameters.

As an example, when a current block is an intra block copy skip mode or an intra block copy merge mode, a block vector candidate in a block vector candidate list identified by block vector candidate information (e.g., a merge index) may be used as the block vector of a current block. In other words, in the same way as in an inter prediction mode, a block vector candidate may also be identified based on a merge index even in an intra block copy skip mode or an intra block copy merge mode.

As an example, when an intra block copy skip mode or an intra block copy merge mode is applied to a current block, merge index (e.g., merge_idx) information may be encoded/decoded or inferred for a current block. Based on the merge index, one of a plurality of candidates included in a block vector candidate list may be identified. Here, a merge index may indicate an index for a block vector.

Alternatively, when an intra block copy AMVP mode is applied to a current block, a prediction block vector candidate in a block vector candidate list identified by block vector candidate information may be set as the prediction block vector of a current block.

As an example, when an intra block copy AMVP mode is applied to a current block, L0 motion prediction flag (e.g., mvp_l0_flag) information for identifying block vector candidate information of a current block may be encoded/decoded or inferred. In other words, in the same manner as in an inter prediction mode, also in an intra AMVP mode, a block vector candidate may be identified based on a L0 motion prediction flag.

Based on the L0 motion prediction flag, a block vector candidate in a block vector candidate list may be selected. Here, a L0 motion prediction flag may represent an index allocated to a block vector candidate in a block vector candidate list.

Meanwhile, the above-described merge index or L0 motion prediction flag may not be entropy encoded/decoded when the maximum number of block vector candidates in a block vector candidate list is 1. When a merge index or a L0 motion prediction flag is not entropy encoded/decoded, its value may be inferred as 0.

Table 7 shows an example in which encoding/decoding of a L0 motion prediction flag is omitted according to the maximum number of block vector candidates.

TABLE 7

| | |
|---|---|
| } else if ( CuPredMode[ x0 ][ y0 ] = = MODE_IBC ) { | |
| mvd_coding(x0, y0, 0, 0) | |
| if( MaxNumMergeCand > 1) | |
| mvp_10_flag[ x0 ][ y0 ] | ae( |
| | v) |
| if( sps_amvr_enabled_flag && | |
| ( MvdL0[ x0 ][ y0 ][ 1 ] != 0 \| \| | |
| MvdL0[ x0 ][ y0 ][ 0 ] != 0 ) ) { | |
| amvr_precision_flag[ x0 ][ y0 ] | ae( |
| } | v) |

In Table 7, MaxNumMergeCand represents the maximum number of block vector candidates in a block vector candidate list. As in an example in Table 7, when MaxNumMergeCand is 1, a L0 motion prediction flag may not be entropy encoded/decoded. In this case, the value of a L0 motion prediction flag may be inferred as 0.

In other words, a L0 motion prediction flag may be entropy encoded/decoded only when MaxNumMergeCand is greater than 1.

As another example, the maximum number (MaxNumIBCCand) of candidates in a block vector candidate list may always be set to be greater than 1. In this case, when a current block corresponds to an intra block copy skip mode or an intra block copy merge mode, merge index information may always be entropy encoded/decoded regardless of the maximum number of candidates in a block vector candidate list.

Table 8 shows an example therefor.

TABLE 8

| | Descr |
|---|---|
| | iptor |
| coding_unit( x0, y0, cbWidth, cbHeight, treeType ) { | |
| ... | |
| if( CuPredMode[ x0 ][ y0 ] = = MODE_IBC ) { | |
| merge_idx[ x0 ][ y0 ] | ae(v) |
| } else { | |

Meanwhile, a block vector candidate selected under an intra AMVP mode may be set as the prediction block vector of a current block. The block vector of a current block may be derived by adding a block vector difference to be entropy encoded/decoded to a prediction block vector.

Meanwhile, rounding may be performed on a prediction block vector identified by block vector candidate information. The rounding may be performed based on the resolution of a block vector of a current block.

The resolution of a block vector may be adaptively determined. In other words, a block vector may have resolution in the unit of an integer pixel or resolution in the unit of a fractional pixel. The resolution of a block vector may be called an integer sample unit size.

The number of integer sample unit size values that may be applied to a block vector (i.e., the number of integer sample unit size candidates or resolution candidates) may be explicitly entropy encoded/decoded.

As an example, information indicating the total number of integer sample unit size values that may be applied to a block vector (num_amvr_precisions) may be entropy encoded/decoded in at least one of a parameter set, a header, a brick, a CTU, a CU, a PU, a TU, a CB, a PB or a TB.

A syntax num_amvr_precisions may refer to the total number of integer sample unit size values that may be applied to a block vector. The number of integer sample unit size candidates that may be applied to a block vector may be M. M may be a positive interger.

In this case, a set of amvr_precisions[num_amvr_precisions] consisting of integer sample unit size candidates as many as determined by num_amvr_precisions may be transmitted to a decoder.

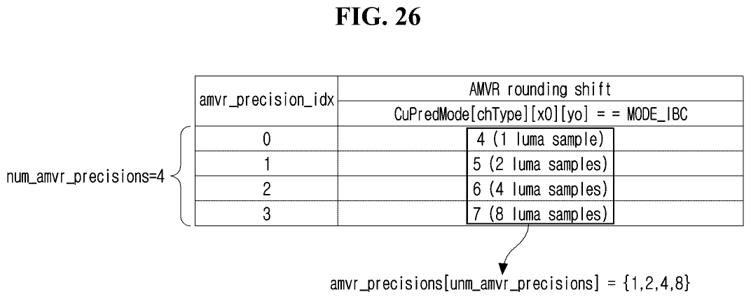

FIG. 26 shows a configuration example of a set including integer sample unit candidates.

When a syntax num_amvr_precision is 4, it represents that 4 integer sample unit size candidates are included in a set. In addition, in FIG. 26, it was illustrated that each integer sample unit size candidate is 1, 2, 4 and 8, respectively.

The value of each integer sample unit size candidate may be encoded and signaled. In other words, an amvr_precisions set, which is a set of integer sample unit size values that may be applied to a block vector, may be entropy encoded/decoded in at least one of a parameter set, a header, a brick, a CTU, a CU, a PU, a TU, a CB, a PB or a TB.

As an example, a syntax amvr_precision[i] indicating an integer sample unit size value may be encoded and signaled. A syntax amvr_precision[i] may represent the value of an integer sample unit size candidate whose index in an integer sample unit set is i. As an example, the value of an integer sample unit size candidate whose index is i may be determined as 2^{(amvr_precisions[i])}.

Alternatively, integer sample unit size candidates having an index from 0 to num_amvr_precisions among the integer sample unit size candidates that are predefined in a decoder may be available for a current block.

The value of an integer sample unit size for a current block may be determined by an index i indicating an integer sample unit size that may be applied to a current block vector among a plurality of integer sample unit size candidates. As an example, the value of an integer sample unit size available for a current block may be determined as 2^{(amvr_precisions[i])}.

An index i may be determined based on one of amvr_precision_idx, amvr_precision_flag or amvr_flag. amvr_precision[i] represents an integer sample unit size candidate whose index is i among the integer sample unit size candidates included in an integer sample unit size set.

An amvr_precisions set including integer sample unit size candidates that may be applied to a block vector may be entropy encoded/decoded in at least one of a parameter set, a header, a brick, a CTU, a CU, a PU, a TU, a CB, a PB or a TB.

At least one of information indicating the maximum number of block vector candidates that may be included in a block vector candidate list, information indicating the maximum number of merge candidates that may be included in a merge candidate list used in an inter prediction mode, block vector candidate information, a merge index, a L0 motion prediction flag or AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

An embodiment in Table 9 represents the size of an integer sample unit applied to a block vector of a current block and the size of a rounding shift value corresponding thereto according to the value of amvr_flag and amvr_precision_idx when the prediction mode of a current block is an intra block copy mode.

TABLE 9

| | amvr_{—} | AMVR rounding shift |
|---|---|---|
| amvr_{—} | precision_{—} | CuPredMode[ chType ][ x0 ][ y0 ] = = |
| flag | idx | MODE_IBC |
| 0 | — | — |
| 1 | 0 | 2 (¼ luma sample) |
| 1 | 1 | 3 (½ luma samples) |
| 1 | 2 | 4 (1 luma samples) |
| 1 | 3 | 6 (4 luma samples) |
| . . . | . . . | . . . |

When amvr_flag is 0, block vector rounding may not be applied to the block vector of a current block.

When amvr_flag is 1, resolution (i.e., an integer sample unit size) of a block vector may be set differently according to the value of amvr_precision_idx.

As an example, when amvr_precision_idx is 0, the integer sample unit size of a block vector of a current block may be the same as the size of a ¼ sample.

As an example, when amvr_precision_idx is 1, the integer sample unit size of a block vector of a current block may be the same as the size of a ½ sample.

As an example, when amvr_precision_idx is 2, the integer sample unit size of a block vector of a current block may be the same as the size of a 1 integer sample.

As an example, when amvr_precision_idx is 3, the integer sample unit size of a block vector of a current block may be the same as the size of 4 integer samples.

Alternatively, as in Table 10, the size of an integer sample unit applied to the block vector of a current block and the size of a rounding shift value corresponding thereto may be determined according to the value of amvr_flag and amvr_precision_idx.

TABLE 10

| | amvr_{—} | AMVR rounding shift |
|---|---|---|
| amvr_{—} | precision_{—} | CuPredMode[ chType ][ x0 ][ y0 ] = = |
| flag | idx | MODE_IBC |
| 0 | — | — |
| 1 | 0 | 4 (1 luma sample) |
| 1 | 1 | 5 (2 luma samples) |
| 1 | 2 | 6 (4 luma samples) |
| 1 | 3 | 7 (8 luma samples) |
| . . . | . . . | . . . |

When amvr_flag is 0, block vector rounding may not be applied to the block vector of a current block.

When amvr_flag is 1, resolution (i.e., an integer sample unit size) of a block vector may be set differently according to the value of amvr_precision_idx.

As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 2 integer samples.

As an example, when amvr_precision_idx is 2, the integer sample unit size of a block vector of a current block may be the same as the size of 4 integer samples.

As an example, when amvr_precision_idx is 3, the integer sample unit size of a block vector of a current block may be the same as the size of 8 integer samples.

Information indicating the maximum value of amvr_precision_idx (max_amvr_precision_idx) may be entropy encoded/decoded in at least one of a parameter set, a header, a brick, a CTU, a CU, a PU, a TU, a CB, a PB or a TB.

In this case, the value of information indicating the maximum value of amvr_precision_idx (max_amvr_precision_idx) may be an integer greater than or equal to 0.

Alternatively, the maximum value of amvr_precision_idx may be determined according to num_amvr_precisions, a syntax representing the number of integer sample unit size candidates.

As another example, when an intra block copy AMVP mode is applied to a current block, a prediction block vector in a block vector candidate list may be selected. In this case, a prediction block vector may be identified by block vector candidate information. Afterwards, the block vector of a current block may be derived by adding a block vector difference that is entropy encoded/decoded to a prediction block vector.

Meanwhile, rounding may be performed on a prediction block vector (mvX[0] and mvX[1]) identified by block vector candidate information according to the value of at least one of amvr_flag and amvr_precision_idx that are entropy encoded/decoded. Specifically, a block vector difference and/or resolution of a prediction block vector may be determined based on the value of at least one of amvr_flag and amvr_precision_idx.

As an example, when amvr_flag is a first value (e.g., 0), a block vector may have a size of N integer sample units.

In addition, when amvr_flag is a second value (e.g., 1), a block vector may have a sample unit size greater than or equal to M.

As an example, when amvr_flag is a second value and amvr_precision_idx is 0, a block vector may have M sample unit sizes.

As an example, when amvr_flag is a second value and amvr_precision_idx is 1, a block vector may have P sample unit sizes.

As an example, when amvr_flag is a second value and amvr_precision_idx is 2, a block vector may have Q sample unit sizes.

As an example, when amvr_flag is a second value and amvr_precision_idx is 3, a block vector may have R sample unit sizes.

Here, N, M, P, Q may be a positive integer. For example, N may be 1, M may be 4, P may be 8 and Q may be 16.

The range or maximum value of the amvr_precision_idx may be derived through a syntax signaled at a high level.

The size of each resolution candidate (e.g., at least one of O, P, Q or R) may be different from each other, but the order of resolution candidates may not be proportional to the value of amvr_precision_idx. In other words, the order of resolution candidates that may be selected by amvr_precision_idx may be determined based on at least one of the performance of video encoding, the characteristic of an input video or a statistical probability.

When a current block is an intra block copy skip mode or an intra block copy merge mode, a block vector candidate in a block vector candidate list identified by block vector candidate information (e.g., a merge index) may be used as the block vector of a current block.

Alternatively, when an intra block copy AMVP mode is applied to a current block, a prediction block vector candidate in a block vector candidate list identified by block vector candidate information may be set as the prediction block vector of a current block. The block vector of a current block may be derived by adding a block vector difference to be entropy encoded/decoded to a prediction block vector.

Equation 7 represents an example in which rounding is performed on a prediction block vector (mvX[0], mvX[1]).

$$offset = ( rightShift == 0 ) ? 0 : ( 1 ≪ ( rightShift ? 1 ) ) \qquad [ Equation 7 ]$$

$$mvX [ 0 ] = ( ( mvX [ 0 ] + offset ? ( mvX [ 0 ] >= 0 ) ) ≫ rightShift ) ≪ leftShift$$

$$mvX [ 1 ] = ( ( mvX [ 0 ] + offset ? ( mvX [ 1 ] >= 0 ) ) ≫ rightShift ) ≪ leftShift$$

According to Table 9, when amvr_flag is a first value (e.g., 0), rightshift and leftshift may be 4, respectively.

When amvr_flag is a second value (e.g., 1) and amvr_precision_idx is 0 (i.e., when a block vector is a ¼ sample unit size), rightshift and leftshift may be 2, respectively.

When amvr_flag is a second value and amvr_precision_idx is 1 (i.e., when a block vector is a ½ sample unit size), rightshift and leftshift may be 3, respectively.

When amvr_flag is a second value and amvr_precision_idx is 2 (i.e., when a block vector is a 1 sample unit size), rightshift and leftshift may be 4, respectively.

When amvr_flag is a second value and amvr_precision_idx is 0 (i.e., when a block vector has a size of 4 integer sample units), rightshift and leftshift may be 6, respectively.

As another example, when Table 10 is followed, when amvr_flag is a first value (e.g., 0) (i.e., when a block vector has a size of 1 integer sample unit), rightshift and leftshift may be 4, respectively.

Alternatively, when amvr_flag is a second value (e.g., 1) and amvr_precision_idx is 0, a first value (i.e., when a block vector has a size of 1 integer sample unit), rightshift and leftshift may be 4, respectively.

Alternatively, when amvr_flag is a second value (e.g., 1) and amvr_precision_idx is a second value (e.g., 1) (i.e., when a block vector has a size of 2 integer sample units), rightshift and leftshift may be 5, respectively.

Alternatively, when amvr_flag is a second value (e.g., 1) and amvr_precision_idx is a third value (e.g., 2) (i.e., when a block vector has a size of 4 integer sample units), rightshift and leftshift may be 6, respectively.

Alternatively, when amvr_flag is a second value (e.g., 1) and amvr_precision_idx is a fourth value (e.g., 3) (i.e., when a block vector has a size of 8 integer sample units), rightshift and leftshift may be 7, respectively.

At least one of the amvr_precision_idx, resolution of a block vector difference or resolution of a prediction block vector may be derived based on at least one of the encoding parameters of a current block/a CTB.

Information representing the maximum value of the amvr_precision_idx may be encoded and signaled. As an example, a syntax max_amvr_precision_idx indicating the maximum value of amvr_precision_idx may be encoded and signaled. The maximum value of a syntax amvr_precision_idx may be less than or equal to a value indicated by a syntax max_amvr_precision_idx.

Table 11 illustrates an example of a syntax structure including a syntax for determining the resolution of a block vector.

TABLE 11

| | Descriptor |
|---|---|
| coding_unit( x0, y0, cbWidth, cbHeight, treeType ) { | |
| ... | |
| } else if ( CuPredMode[ x0 ][ y0 ] = = MODE_IBC) | |
| { | |
| mvd_coding(x0,y0,0,0) | |
| mvp_l0_flag[ x0 ][ y0 ] | ae(v) |
| if( sps_amvr_enabled_flag && | |
| ( MvdL0[ x0 ][ y0 ][ 0 ] != 0 \| \| | |
| MvdL0[ x0 ][ y0 ][ 1 ] != 0 ) ) { | |
| amvr_flag[ x0 ][ y0 ] | ae(v) |
| if( amvr_flag[ x0 ][ y0 ] ) | |
| amvr_precision_idx[ x0 ][ y0 ] | ae(v) |
| } | |
| } else { | |
| ... | |

In Table 11, it was illustrated that amvr_flag and amvr_precision_idx are included in a syntax structure to determine the resolution of a block vector. In addition, it was illustrated that a syntax amvr_precision_idx is encoded and signaled only when the value of amvr_flag is 1.

Instead of amvr_precision_idx, based on amvr_precision_flag, the integer sample unit size of a block vector may also be derived. The number/type of resolution candidates available to a current block may be different between a case where amvr_precision_idx is used and a case where amvr_precision_flag is used. As an example, when amvr_precision_flag is used, one of two resolution candidates may be selected based on amvr_precision_flag. On the other hand, when amvr_precision_idx is used, one of N resolution candidates may be selected. Here, N is a natural number greater than 2, and may represent 3, 4, or 5, etc.

Table 12 illustrates a syntax structure that includes amvr_flag and amvr_precision_flag.

TABLE 12

| | Descriptor |
|---|---|
| coding_unit( x0, y0, cbWidth, cbHeight, treeType ) { | |
| ... | |
| } else if ( CuPredMode[ x0 ][ y0 ] = = MODE_IBC ) | |
| { | |
| mvd_coding(x0, y0,0,0) | |
| mvp_l0_flag[ x0 ][ y0 ] | ae(v) |
| if( sps_amvr_enabled_flag && | |
| ( MvdL0[ x0 ][ y0 ][ 0 ] != 0 \| \| | |
| MvdL0[ x0 ][ y0 ][ 1 ] != 0 ) ) { | |
| amvr_flag[ x0 ][ y0 ] | ae(v) |
| if( amvr_flag[ x0 ][ y0 ] ) | |
| amvr_precision_flag[ x0 ][ y0 ] | ae(v) |
| } | |
| } else { | |
| ... | |

As in an example of Table 12, rounding may be performed on a prediction block vector (mvX[0], mvX[1]) based on at least one of amvr_flag or amvr_precision_flag that is entropy encoded/decoded. As an example, when amvr_flag is a first value (e.g., 0), a block vector may have a size of N integer sample units.

As an example, when amvr_flag is a second value (e.g., 1), a block vector may have a size of M integer or P integer sample units.

As an example, when amvr_flag is a second value and amvr_precision_flag is a first value (e.g., 0), a block vector may have a size of M integer sample units.

As an example, when amvr_flag is a second value and amvr_precision_flag is a second value (e.g., 1), a block vector may have a size of P integer sample units.

Here, N, M and P may be a positive integer. For example, N may be 1, M may be 4 and P may be 16.

In addition, N may be smaller than M and P. In addition, P may be greater than N and M.

In performing a rounding operation according to Equation 7, when amvr_flag is a first value (e.g., 0) (i.e., when a block vector has a size of 1 integer sample unit), rightshift and leftshift may be 4, respectively.

Alternatively, when amvr_flag is a second value (e.g., 1) and amvr_precision_flag is a first value (e.g., 0) (i.e., when a block vector has a size of 4 integer sample units), rightshift and leftshift may be 6, respectively.

Alternatively, when amvr_flag is a second value (e.g., 1) and amvr_precision_flag is a second value (e.g., 1) (i.e., when a block vector has a size of 16 integer sample units), rightshift and leftshift may be 8, respectively.

At least one of amvr_flag, amvr_precision_flag, the resolution of a block vector difference or the resolution of a prediction block vector may be derived according to at least one of the encoding parameters of a current block/a CTB/a CTU.

The resolution of a prediction block vector and a block vector difference may be determined by using only a syntax amvr_precision_idx without omitting encoding/decoding of a syntax amvr_flag or referring to amvr_flag that is encoded/decoded. Specifically, rounding may be performed on a prediction block vector (mvX[0], mvX[1]) according to the value of amvr_precision_idx that is entropy encoded/decoded.

Here, a block vector difference and the resolution of a prediction block vector may be determined according to the value of amvr_precision_idx.

As an example, when amvr_precision_idx is a first value (e.g., 0), a block vector may have a size of N integer sample units.

As an example, when amvr_precision_idx is a second value (e.g., 1), a block vector may have a size of M integer sample units.

As an example, when amvr_precision_idx is a third value (e.g., 2), a block vector may have a size of L integer sample units.

Here, N, M and L may be a positive integer. As an example, N may be 1, M may be 4 and L may be 8.

Table 13 represents the size of an integer sample unit of a block vector according to the value of amvr_precision_idx.

TABLE 13

| [symbol] mvr_{—} | AMVR rounding shift |
|---|---|
| precision_{—} | CuPredMode[ chType ][ x0 ][ y0 ] = = |
| idx | MODE_IBC |
| 0 | 4 (1 luma sample) |
| 1 | 6 (4 luma samples) |
| 2 | 7 (8 luma samples) |
| . . . | . . . |

[symbol]

indicates data missing or illegible when filed

Rounding on a prediction block vector may be performed according to Equation 7. When Table 13 is followed, when amvr_precision_idx is a first value (e.g., 0) (i.e., when a block vector has a size of 1 integer sample unit), rightshift and leftshift may be 4, respectively. Alternatively, when amvr_precision_idx is a second value (e.g., 1) (i.e., when a block vector has a size of 4 integer sample units), rightshift and leftshift may be 6, respectively. Alternatively, when amvr_precision_idx is a third value (e.g., 2) (i.e., when a block vector has a size of 8 integer sample units), rightshift and leftshift may be 7, respectively.

Alternatively, according to the following Table 14, the size of an integer sample unit of a block vector may be determined.

TABLE 14

| [symbol] mvr_{—} | AMVR rounding shift |
|---|---|
| precision_{—} | CuPredMode[ chType ][ x0 ][ y0 ] = = |
| idx | MODE_IBC |
| 0 | 4 (1 luma sample) |
| 1 | 5 (2 luma samples) |
| 2 | 6 (4 luma samples) |
| 3 | 7 (8 luma samples) |
| . . . | . . . |

[symbol]

indicates data missing or illegible when filed

The size of an integer sample unit applied to a block vector may vary according to the value of amvr_precision_idx. As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 2 integer samples.

As an example, when amvr_precision_idx is 2, the integer sample unit size of a block vector of a current block may be the same as the size of 4 integer samples.

As an example, when amvr_precision_idx is 3, the integer sample unit size of a block vector of a current block may be the same as the size of 8 integer samples.

Rounding on a prediction block vector may be performed according to Equation 7.

When Table 14 is followed, when amvr_precision_idx is a first value (e.g., 0) (i.e., when a block vector has a size of 1 integer sample unit), rightshift and leftshift may be 4, respectively.

Alternatively, when amvr_precision_idx is a second value (e.g., 1) (i.e., when a block vector has a size of 2 integer sample units), rightshift and leftshift may be 5, respectively.

Alternatively, when amvr_precision_idx is a third value (e.g., 2) (i.e., when a block vector has a size of 4 integer sample units), rightshift and leftshift may be 6, respectively.

Alternatively, when amvr_precision_idx is a third value (e.g., 3) (i.e., when a block vector has a size of 8 integer sample units), rightshift and leftshift may be 7, respectively.

Alternatively, according to the following Table 15, the size of an integer sample unit of a block vector may be determined.

TABLE 15

| amvr_{—} | AMVR rounding shift |
|---|---|
| precision_{—} | CuPredMode[ chType ][ x0 ][ y0 ] = = |
| idx | MODE_IBC |
| 0 | 4 (1 luma sample) |
| 1 | 6 (4 luma samples) |
| 2 | 7 (8 luma samples) |
| 3 | 8 (16 luma samples) |
| . . . | . . . |

The size of an integer sample unit applied to a block vector may vary according to the value of amvr_precision_idx. As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 4 integer samples.

As an example, when amvr_precision_idx is 2, the integer sample unit size of a block vector of a current block may be the same as the size of 8 integer samples.

As an example, when amvr_precision_idx is 3, the integer sample unit size of a block vector of a current block may be the same as the size of 16 integer samples.

Rounding on a prediction block vector may be performed according to Equation 7. When Table 15 is followed, when amvr_precision_idx is a first value (e.g., 0) (i.e., when a block vector has a size of 1 integer sample unit), rightshift and leftshift may be 4, respectively.

Alternatively, when amvr_precision_idx is a second value (e.g., 1) (i.e., when a block vector has a size of 4 integer sample units), rightshift and leftshift may be 6, respectively.

Alternatively, when amvr_precision_idx is a third value (e.g., 2) (i.e., when a block vector has a size of 8 integer sample units), rightshift and leftshift may be 7, respectively.

Alternatively, when amvr_precision_idx is a third value (e.g., 3) (i.e., when a block vector has a size of 16 integer sample units), rightshift and leftshift may be 8, respectively.

Unlike the above-described example, when amvr_flag is 0, block vector resolution may be set as ¼ and when amvr_flag is 1, block vector resolution may be set as 1 or 4 according to amvr_precision_idx.

At least one of amvr_flag, amvr_precision_idx, the resolution of a block vector difference or the resolution of a prediction block vector may be derived according to at least one of the encoding parameters of a current block/a CTB.

Table 16 illustrates a syntax structure including a syntax for determining the resolution of a block vector.

TABLE 16

| | |
|---|---|
| } else if ( CuPredMode[ x0 ][ y0 ] = = | |
| MODE_IBC ) { | |
| mvd_coding( x0, y0, 0, 0) | |
| if( MaxNumMergeCand > 1) | |
| mvp_l0_flag[ x0 ][ y0 ] | ae(v) |
| if( sps_amvr_enabled_flag & & | |
| ( MvdL0[ x0 ][ y0 ][ 0 ] != 0 \| \| | |
| MvdL0[ x0 ][ y0 ][ 1 ] != 0 ) ) { | |
| amvr_precision_idx[ x0 ][ y0 ] | ae(v) |
| } | |

In Table 16, it was illustrated that amvr_flag is not encoded/decoded and amvr_precision_idx is encoded/decoded immediately. As in the above-described example, information about block vector candidates may be encoded and signaled.

Alternatively, in an encoder and a decoder, a mapping table defining a mapping relationship between information related to the integer pixel size of a block vector (e.g., at least one of amvr_flag or amvr_precision_idx) and resolution candidates may be predefined. In a decoder, a resolution candidate mapped to decoded integer pixel size-related information may be selected based on a predefined mapping table.

Alternatively, a plurality of mapping tables may be pre-stored in an encoder and a decoder. After selecting one of a plurality of mapping tables, a resolution candidate may be selected by using a selected mapping table. In this case, information identifying one of a plurality of mapping tables may be encoded and signaled. Alternatively, one of a plurality of mapping tables may be adaptively selected based on at least one of the size/shape of a current block, the size of a block vector or the resolution of a neighbor block.

Meanwhile, block vector resolution candidates (e.g., 1, 4, 16 integer sample units) used in an intra block copy AMVP mode may be the same as a result of performing a multiplication by K or a left shift operation by J on motion vector resolution candidates (e.g., ¼, 1, 4 integer sample units) used in an inter AMVP mode or an affine AMVP mode. Here, K and J may be a positive integer, and for example, K may be 4 and J may be 2.

Meanwhile, at least one of information indicating the maximum number of candidates in a block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

Information indicating the maximum value of amvr_precision_idx (max_amvr_precision_idx) may be entropy encoded/decoded in at least one of a parameter set, a header, a brick, a CTU, a CU, a PU, a TU, a CB, a PB or a TB.

In this case, the value of information indicating the maximum value of amvr_precision_idx (max_amvr_precision_idx) may be an integer greater than or equal to 0.

Table 17 is an example for describing an example in which the value of amvr_precision_idx is restricted according to max_amvr_precision_idx.

TABLE 17

| amvr_{—} | AMVR rounding shift |
|---|---|
| precision_{—} | CuPredMode[ chType ][ x0 ][ y0 ] = = |
| idx | MODE_IBC |
| 0 | 4 (1 luma sample) |
| 1 | 5 (2 luma samples) |
| 2 | 6 (4 luma samples) |
| 3 | 7 (8 luma samples) |
| 4 | 8 (16 luma samples) |
| 5 | 9 (32 luma samples) |
| . . . | . . . |

When the value of max_amvr_precision_idx is 5, it represents that the maximum value of amvr_precision_idx is 5. In other words, the value of amvr_precision_idx may have a value from 0 to max_amvr_precision_idx.

In the example, when the value of amvr_precision_idx is the same as the value of max_amvr_precision_idx (i.e., values of amvr_precision_idx and max_amvr_predicion_idx are 5), the maximum integer sample unit size of a block vector may be determined as 32. In this case, in Equation 7, rightshift and leftshift may be 9, respectively.

Meanwhile, a resolution candidate having a value greater than max_amvr_precision_idx may not be available for a current block.

As an example, when max_amvr_precision_idx is 4, the value of amvr_precision_idx may not be greater than 4. Accordingly, a resolution candidate (i.e., a size of 32 integer samples) mapped to 5, the value of amvr_precision_idx, may not be available for a current block.

Alternatively, when max_amvr_precision_idx is 4, candidates that the value of amvr_precision_idx is greater than 4, through clipping, may be set as a resolution candidate (in Table 17, a size of 16 integer sample units) when the value of amvr_precision_idx is the maximum value (i.e., 4).

At least one of information indicating the maximum number of candidates in a block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

Meanwhile, information representing the maximum size of a resolution candidate (i.e., the maximum size of an integer sample unit that a block vector may have) may be encoded and signaled. As an example, a syntax max_amvr_precision representing the maximum size of an integer sample unit that a block vector may have may be encoded and signaled.

A syntax max_amvr_precision may be an integer greater than or equal to N. A syntax max_amvr_precision may represent a value derived when taking Log 2 to the maximum value of the maximum integer sample unit size of a block vector. As an example, the maximum value of an integer sample unit size determined by max_amvr_precision may be derived as 2^{max_amvr_precision}.

Meanwhile, according to the value of max_amvr_precision_idx, a resolution candidate to which amvr_precision_idx is applied may be determined. As an example, when max_amvr_precision_idx is 4, it represents that the value of amvr_precision_idx is not greater than 4. Accordingly, when max_amvr_precision_idx is 4, the value of a resolution candidate that amvr_precision_idx is equal to or greater than 4 may be derived as 2^{max_amvr_precision}.

Meanwhile, at least one of information indicating the maximum value of amvr_precision_idx (e.g., max_amvr_precision_idx) and/or information indicating the maximum integer sample unit size that a block vector may have (e.g., max_amvr_precision) may be entropy encoded/decoded in at least one of a parameter set, a header, a brick, a CTU, a CU, a PU, a TU, a CB, a PB or a TB.

In the above-described embodiments, at least one of a parameter set, a header, a brick, a CTU, a CU, a PU, a TU, a CB, a PB or a TB may be at least one of a video parameter set, a decoding parameter set, a sequence parameter set, an adaptation parameter set, a picture parameter set, a picture header, a sub-picture header, a slice header, a tile group header, a tile header, a brick, a coding tree unit (CTU), a coding unit (CU), a prediction unit (PU), a transform unit (TU), a coding block (CB), a prediction block (PB) or a transform block (TB).

Here, prediction using an intra block copy mode may be performed by using at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) in at least one of a unit of a parameter set, a header, a brick, a CTU, a CU, a PU, a TU, a CB, a PB or a TB signaled above.

Here, at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) may be derived according to at least one of the encoding parameters of a current block/a CTB/a CTU.

When at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) does not exist in a bitstream, at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) may be inferred as a first value (e.g., 0).

When an intra block copy merge mode is applied to a current block, block vector information derived from an intra block copy merge candidate list may be improved through template matching.

For a current sequence/a current picture/a current slice, ibc_merge_tm_enabled_flag indicating whether a template matching-based block vector improvement method may be applied under an intra block copy merge mode may be entropy encoded/decoded in at least one of a parameter set, a header, a brick, a CTU, a CU, a PU, a TU, a CB, a PB or a TB.

For a current block, ibc_merge_tm_flag indicating whether a template matching-based block vector improvement method is applied under an intra block copy merge mode may be entropy encoded/decoded in at least one of a CTU, a CU, a PU, a TU, a CB, a PB or a TB.

When the prediction mode of a current block is an intra block copy merge mode and the ibc_merge_tm_enabled_flag is 1, ibc_merge_tm_flag indicating whether a template matching-based block vector improvement method will be applied under an intra block copy merge mode may be entropy encoded/decoded.

When the prediction mode of a current block is an intra block copy merge mode and the ibc_merge_tm_enabled_flag is 0, ibc_merge_tm_flag indicating whether a template matching-based block vector improvement method will be applied under an intra block copy merge mode may be omitted.

When the ibc_merge_tm_enabled_flag is 1 and the ibc_merge_tm_flag of a current block is 1, a template matching-based block vector improvement method may be applied under an intra block copy merge mode.

In this case, an intra prediction mode to which a template matching-based block vector improvement method is applied may be stored as a PLANAR mode, a DC mode and/or a directional intra prediction mode.

Alternatively, an intra prediction mode to which a template matching-based block vector improvement method is applied may be stored as a template-based intra mode derivation (TIMD) and/or decoder side intra mode derivation (DIMD) intra prediction mode.

Information representing whether a block vector other than an integer pel is available may be encoded and signaled through an upper header. As an example, a 1-bit flag may be signaled through a slice header, a picture header, a picture parameter set or a sequence parameter set. A template matching-based block vector improvement method may be used under an intra block copy merge mode only when the 1-bit flag indicates that a block vector other than an integer pel is available. When the 1-bit flag indicates that only an integer pel is available, the block vector of a merge candidate may be applied to a current block as it is without applying a template matching-based block vector improvement method.

The template matching-based block vector improvement method may be applied as follows under an intra block copy merge mode.

When an intra block copy merge mode is applied to a current block, ibc_merge_idx, an index indicating one of the intra block copy merge candidates included in an intra block copy merge candidate list, may be entropy encoded/decoded.

An intra block copy merge candidate indicated by the ibc_merge_idx may refer to a prediction block vector or an initial block vector.

The block vector resolution where each candidate block vector in the intra block copy merge candidate list is stored may be 1/16 pixel unit resolution.

Each candidate block vector in the intra block copy merge candidate list may have a variety of resolution such as a ¼ pixel unit, a ½ pixel unit, a 1 pixel unit or 4 pixel units, etc.

The prediction block vector may include an index value ibc_amvr_idx indicating the resolution of the prediction block vector.

The resolution of a prediction block vector may be determined by the resolution of a block vector indicated by the ibc_amvr_idx.

When the prediction block vector is expressed according to a bit depth corresponding to the maximum resolution that a block vector may have, the resolution of the prediction block vector may be determined by referring to the value of the least significant N bits.

For example, it is assumed that a prediction block vector is expressed in the unit of a ¼ pixel unit which is the maximum resolution. In this case, when both 2 lower bits of a prediction block vector are 0, the resolution of a corresponding prediction block vector may be determined to have the resolution of 1 pixel unit.

Alternatively, when the value of 2 lower bits of a prediction block vector is not 0, the resolution of a corresponding prediction block vector may be determined to have the resolution of a ½ pixel unit or a ¼ pixel unit. As an example, when the value of 2 lower bits of a prediction block vector is not 0 and the value of 1 lower bit is 0, the resolution of a corresponding prediction block vector may be determined to have the resolution of a ½ pixel unit. As an example, when the value of 2 lower bits of a prediction block vector is not 0 and the value of 1 lower bit is not 0, the resolution of a corresponding prediction block vector may be determined to have the resolution of a ¼ pixel unit.

The maximum resolution of a prediction block vector may vary depending on a color component. As an example, while a ¼ pixel unit is the maximum resolution for a luma component, a ½ pixel unit may be the maximum resolution for a chroma component.

A template matching-based block vector improvement method may be applied as follows under an intra block copy merge mode.

When a merge candidate is selected, the block vector of a selected merge candidate may be set as a prediction block vector. Then, based on template matching, a prediction block vector may be modified based on the resolution unit of a prediction block vector. In other words, a range in which a prediction block vector may be modified may be determined based on the resolution of a merge candidate, i.e., a prediction block vector.

In applying a template matching-based block vector improvement method under an intra block copy merge mode, resolution at which template matching is performed may be determined according to the resolution of a prediction block vector, as in an example of Table 18.

TABLE 18

| Resolution of Prediction | Resolution at which Template |
|---|---|
| Block Vector | Matching is performed |
| ¼-pel | ¼-pel, ½-pel, 1-pel, 4-pel, 8-pel |
| ½-pel | ½-pel, 1-pel, 4-pel, 8-pel |
| 1-pel | 1-pel, 4-pel, 8-pel |
| 4-pel | 4-pel, 8-pel |

Alternatively, resolution at which template matching is performed may be determined according to the example of Table 19.

TABLE 19

| Resolution of Prediction | Resolution at which Template |
|---|---|
| Block Vector | Matching is performed |
| ¼-pel | ¼-pel, ½-pel, 1-pel, 4-pel, 8-pel, 16-pel |
| ½-pel | ½-pel, 1-pel, 4-pel, 8-pel, 16-pel |
| 1-pel | 1-pel, 4-pel, 8-pel, 16-pel |
| 4-pel | 4-pel, 8-pel, 16-pel |

Alternatively, resolution at which template matching is performed may be determined according to the example of Table 20.

TABLE 20

| Resolution of Prediction | Resolution at which Template |
|---|---|
| Block Vector | Matching is performed |
| ¼-pel | ¼-pel, ½-pel, 1-pel, 4-pel |
| ½-pel | ½-pel, 1-pel, 4-pel |
| 1-pel | 1-pel, 4-pel |
| 4-pel | 4-pel |

In an example of Tables 18 to 20, the lowest resolution at which template matching is performed may be equal to or lower than the lowest resolution of a block vector (e.g., 4 pixel units). In addition, the maximum resolution at which template matching is performed may be equal to or lower than the maximum resolution of a block vector (e.g., a ¼ pixel unit).

Alternatively, in performing a template matching search, resolution at which template matching is performed may exist within an arbitrary range.

For example, when the resolution of a prediction block vector is 4 pixel units, resolution at which template matching is performed may fall within a range from the resolution of arbitrary 8 pixel units to 1 pixel unit.

For example, when the resolution of a prediction block vector is 4 pixel units, resolution at which template matching is performed may fall within a range from the resolution of arbitrary 8 pixel units to 4 pixel unit.

For example, when the resolution of a prediction block vector is 4 pixel units, resolution at which template matching is performed may be set as 4 pixel units.

A prediction block vector may be modified based on a unit by resolution at which template matching is performed. As an example, in an example of Table 18, when the resolution of a prediction block vector is a ¼-pel, at least one of the x-axis component or the y-axis component of a prediction block vector may be modified to a ¼-pel unit, a ½-pel unit, a 1-pel unit or a 4-pel unit through template matching.

Improvement for a prediction block vector may be performed according to at least one of Tables 18 to 20. In this case, in an encoder and a decoder, a mapping table for improvement of a prediction block vector may be predefined.

Alternatively, one of a plurality of mapping tables may be selected and improvement for a prediction block vector may be performed based on an selected mapping table. In this case, information indicating one of a plurality of mapping tables may be encoded and signaled. Alternatively, one of a plurality of mapping tables may be selected based on at least one of the size/shape of a current block, the resolution of a prediction block vector and the size of a prediction block vector.

Furthermore, improvement for a prediction block vector may be performed by using a mapping table different from that illustrated in Tables 18 to 20.

As an example, in Tables 18 to 20, it was illustrated that resolution at which template matching is performed is resolution equal to or higher/lower than the resolution of a prediction block vector. An available resolution range may be set by using a rule different from that in an example. As an example, resolution N times or up to 1/N times the resolution of a prediction block may be set as a search range for performing template matching.

When the template matching-based block vector improvement method is applied to a current block under an intra block copy merge mode (e.g., when ibc_merge_tm_flag is 1), a template matching-based block vector improvement method may be applied as follows.

### Template Setting

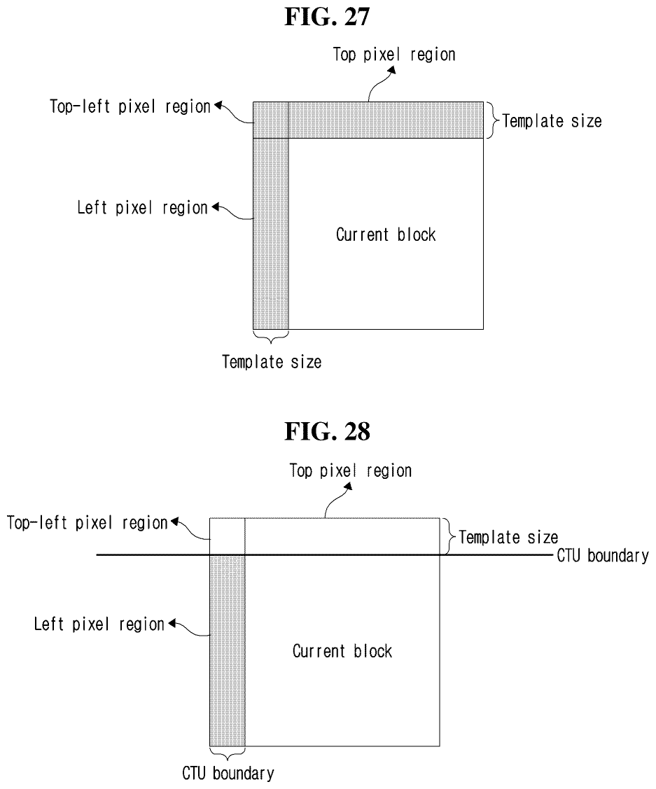

Some of the encoding/decoding region pixels adjacent to a current block may be set as a template region. A template region may have a predetermined size and a predetermined shape. FIG. 27 illustrates the shape of a template region.

As in an example shown in FIG. 27, a template region may include at least one of the encoded/decoded pixel regions at the top, left or top-left position of a current block.

Meanwhile, a region not included in a CTU in which a current block is included (i.e., a current CTU) among the encoding/decoding regions around a current block may be excluded from a template region.

FIG. 28 shows an example in which a reconstructed region not included in a current CTU is excluded from a template region.

As in an example shown in FIG. 28, when a top pixel region and a top-left pixel region adjacent to a current block are included in a CTU different from a current CTU, a template region may be configured without including a top pixel region and a top-left pixel region. Accordingly, a template region may be configured only with left pixel regions.

All or part of a template region may be set as a template. In this case, a region not included in a current CTU among the encoding/decoding regions around a current block may not be set as a template.

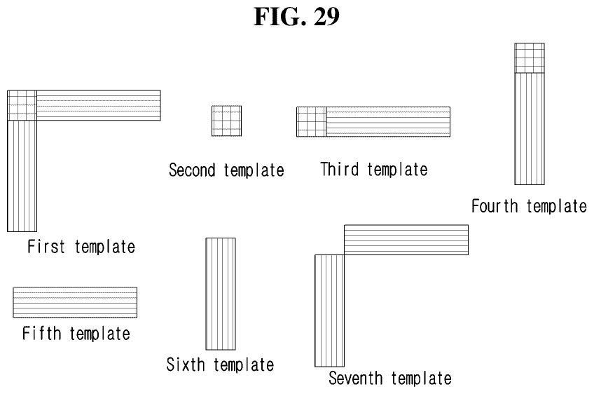

FIG. 29 illustrates various shapes of template derived from the template region of a current block.

As in an example shown in FIG. 29, among the template regions around a current block, at least one of a top-left region, a top region or a left region may be set as a template.

In an example shown in FIG. 29, a first template represents an example in which a template is configured to include all of a top-left region, a top region and a left region.

A second template represents an example in which a template is configured only with a top-left region.

A third template represents an example in which a template is configured to include a top-left region and a top region.

A fourth template represents an example in which a template is configured to include a top-left region and a left region.

A fifth template represents an example in which a template is configured only with a top region.

A sixth template represents an example in which a template is configured only with a left region.

A seventh template represents an example in which a template is configured to include a top region and a left region.

The size of a template may be an integer number of pixels greater than or equal to 1. Here, the size of a template represents the number of lines included in a template. As an example, when the size of a template is N, it represents that N rows are included in a reconstructed region adjacent to the top of a current block and that N columns are included in a reconstructed region adjacent to the left of a current block. For example, a template size may be 4.

Alternatively, a template may be configured by sub-sampling a template region.

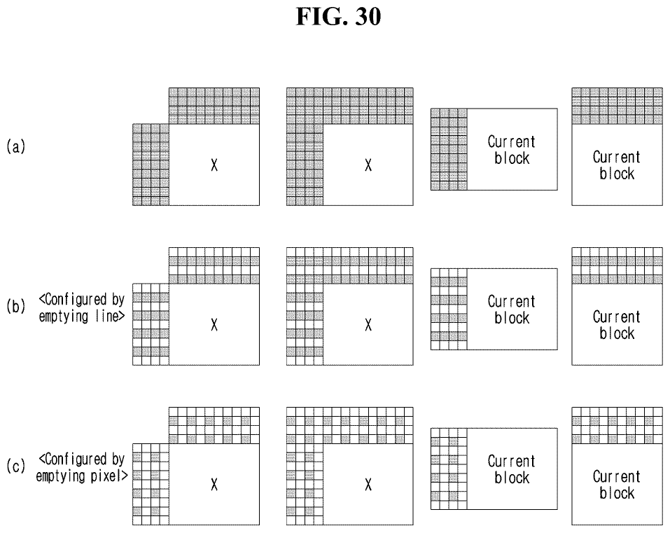

FIG. 30 shows an example in which a template is configured by sub-sampling a template region.

FIG. 30(a) represents an example in which a template is derived without performing sub-sampling.

Sub-sampling may be performed on at least one of a vertical direction and a horizontal direction. As an example, FIG. 30(b) represents an example in which sub-sampling is performed only for a vertical direction. As a result, as in an example shown in FIG. 30(b), a template may be configured to include pixels belonging to a line whose y-axis coordinate is an odd number.

As an example, as in an example shown in FIG. 30(c), sub-sampling may be performed for both horizontal and vertical directions. As a result, as in an example shown in FIG. 30(c), a template may be configured to include pixels where a x-axis coordinate is an even number and a y-axis coordinate is an odd number.

### a Determination of a Template Matching Search Start Position

A start position for performing template matching may be determined by the sum between the position of a current block and a prediction block vector. In other words, a position spaced apart from a current block by a prediction block vector may be set as a start position for template matching.

Meanwhile, the top-left pixel P(x, y) of a current block may be expressed as a 1-pixel unit. In other words, the top-left pixel P(x, y) of a current block may be an integer pixel position.

In addition, the resolution of a prediction block vector may be set as a ¼ pixel unit, a ½ pixel unit, a 1 pixel unit or a 4-pixel unit.

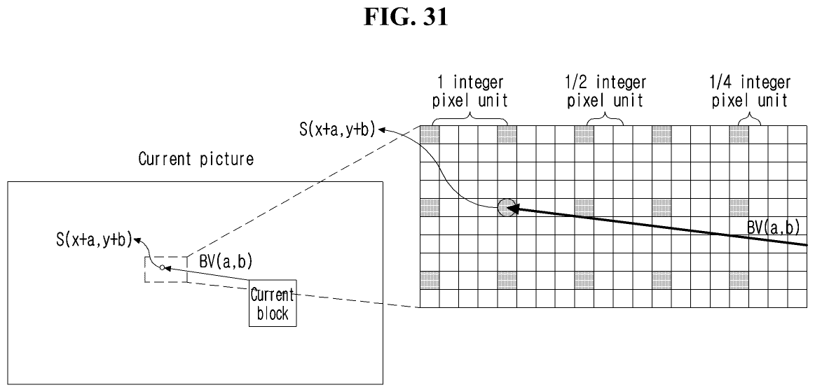

FIGS. 31 to 34 show an example in which a search start position is set.

In an example of FIG. 31, it is assumed that the top-left pixel position of a current block is P(x, y) and a prediction block vector has 1-pixel unit resolution. When the prediction block vector of a current block is BV (a, b), a template matching search start position S may be determined as (x+a, y+b). The search start position S may be positioned at an integer pixel according to prediction block resolution.

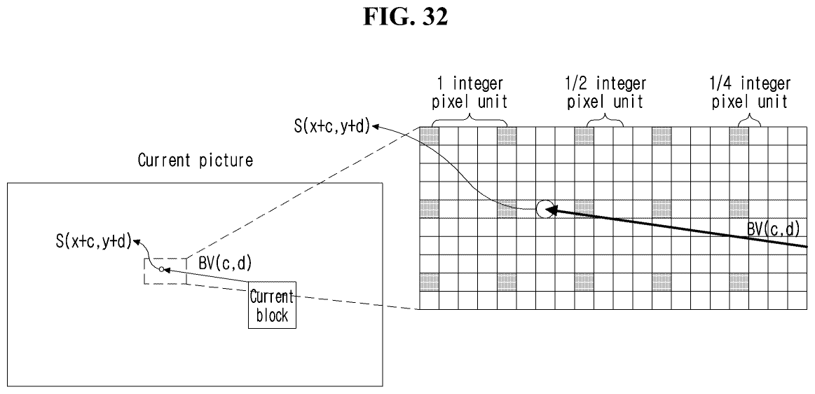

In an example of FIG. 32, it is assumed that the top-left pixel position of a current block is P(x, y) and a prediction block vector is ½-pixel unit resolution. When the prediction block vector of a current block is BV (c, d), a template matching search start position S may be determined as (x+c, y+d). The search start position S may be positioned at a position expressed in a ½-pixel unit according to prediction block resolution.

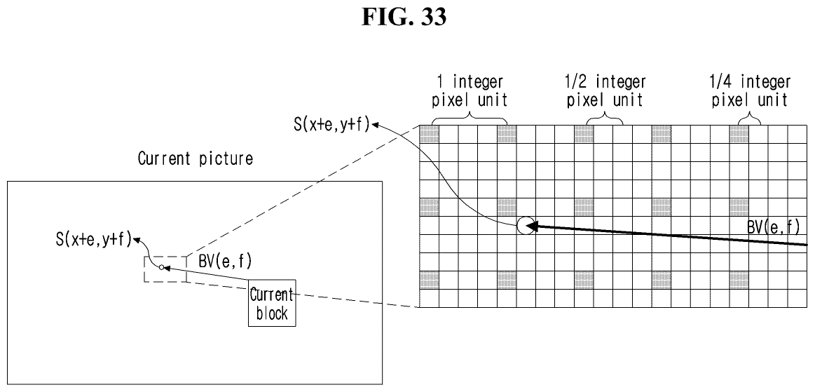

In an example of FIG. 33, it is assumed that the top-left pixel position of a current block is P(x, y) and a prediction block vector is ¼-pixel unit resolution. When the prediction block vector of a current block is BV(e, f), a template matching search start position S may be determined as (x+e, y+f). The search start position S may be positioned at a position expressed in a ¼-pixel unit according to prediction block resolution.

Meanwhile, when a search start position is positioned at a fractional pixel, a search start position may be changed to an integer pixel through rounding.

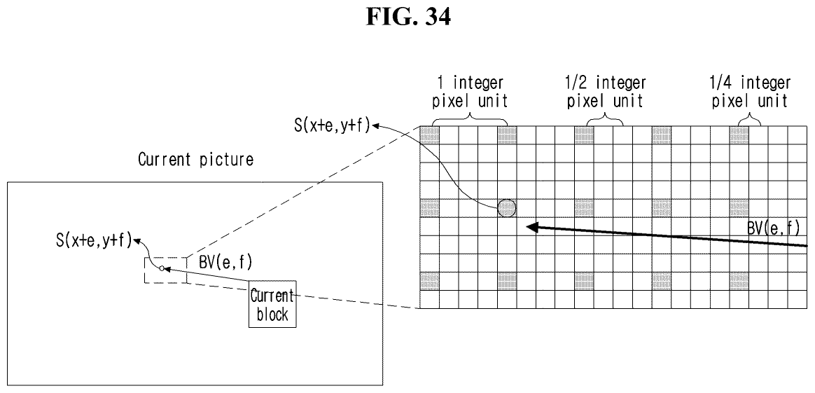

As an example, in an example of FIG. 34, it is assumed that the top-left pixel position of a current block is P(x, y) and a prediction block vector is ½-pixel unit or ¼-pixel unit resolution. When the prediction block vector of a current block is BV(g, h), a template matching search start position S may be determined as (x+i, y+j).

Here, i and j may be a value derived by rounding a fractional pixel position. As an example, when a prediction block vector has a ½-pixel unit, (i, j) may be (INT(g+½), INT(h+½)). Alternatively, when a prediction block vector has a ¼-pixel unit, (i, j) may be (INT(g+½), INT(h+½)). Here, INT(n) refers to an operation that discards a fractional part of an arbitrary real number n.

### a Determination of Template Matching Search Resolution

In performing template matching search, in a current search step, an arbitrary pixel unit R for an offset O used to determine a next search position may be determined.

For example, it is assumed that a current search position is C (x, y) and an offset O for determining a next search position is (−1, −1). In this case, when a pixel unit R is 4, a next search position (i.e., a position where next template matching is performed) may be (x+ (−1)*4, y+ (−1)*4).

Alternatively, when a pixel unit R is ½, a next search position may be (x+(−1)*(½), y+(−1)*(½)).

The template matching search resolution may be set as one of the maximum template matching search resolution candidates from the lowest template matching search resolution candidate. As an example, the lowest template matching search resolution candidate may be an integer greater than or equal to 1. For example, the lowest template matching search resolution candidate may be 8. The highest template matching search resolution may be 1 or a fraction less than 1. As an example, the highest template matching resolution may be ⅛.

The value of the lowest template matching search resolution candidate and the highest template matching search resolution candidate may be predefined in an encoder and a decoder. Alternatively, the value of the lowest template matching search resolution candidate and the highest template matching search resolution candidate may be entropy encoded/decoded in a parameter set and explicitly transmitted.

### a Determination of a Template Matching Search Range

A template matching search range may be at least one of a rectangular shape, a square shape, a rhombus shape or a cross shape.

A template matching search range may be adaptively determined based on at least one of the resolution of a prediction block vector, template matching search resolution or the shape of a template.

Alternatively, the shape of a template matching search range may be fixed in an encoder and a decoder.

Alternatively, information representing the shape of a template matching search range may be encoded and signaled.

A template matching search range may be the entire encoded/decoded region of a picture or a partition region of encoded/decoded region in a picture.

A template matching search range may be defined as a region including a predetermined number of blocks. In other words, a region other than a region occupied by a predetermined number of blocks may not be a template matching search range. Accordingly, encoding/decoding based on template matching may not be allowed in a residual region excluding a region occupied by a predetermined number of blocks around a current block.

Meanwhile, a block configuring a template matching search range may be at least one of an encoding tree block, an encoding block, a prediction block, a transform block, a virtual pipeline data unit (VPDU) or a block in a predetermined size.

As an example, a template matching search range may be composed of one VPDU around a current block. In other words, a residual region excluding a region occupied by one VPDU region may not be a template matching search range. Accordingly, encoding using template matching may not be allowed in a region excluding one VPDU region around a current block.

As an example, a template matching search range may be composed of one encoding tree block around a current block. In other words, a residual region excluding a region occupied by one encoding tree block may not be a template matching search range. Accordingly, encoding using template matching may not be allowed in a region excluding one encoding tree block around a current block.

As an example, a template matching search range may be composed of one encoding tree block to which a current block belongs. In other words, a residual region excluding a region occupied by one encoding tree block may not be a template matching search range. Accordingly, encoding using template matching may not be allowed in a region excluding one encoding tree block in which a current block is included.

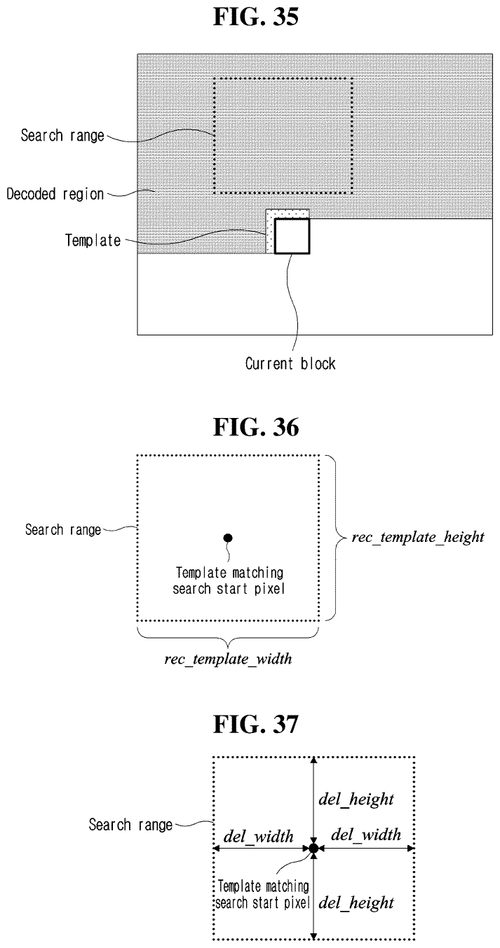

FIGS. 35 to 42 is a diagram for describing a template search range.

FIG. 35 is an example of a case where a template matching search range is a rectangle.

When a template matching search range is a rectangle, the size of a template matching search range may be defined by a width and a height.

As an example, as in an example shown in FIG. 36, a rectangular template matching search range may be a rectangle centered on a template matching search start point. In this case, the size of the rectangle may be defined by a width (rec_template_width) and a height (rec_template_height). At least one of a width rec_template_width and a height rec_template_height may be encoded and signaled in a high level syntax element such as a coding parameter, a sequence parameter, a picture parameter or a slice header, etc. or may be encoded and signaled in a coding tree unit or a predetermined block unit.

Alternatively, as in an example shown in FIG. 37, a template matching search range may be defined as a horizontal distance (del_width) and a vertical distance (del_width) from a template matching search start point to one side boundary of a template matching search range. In other words, as in an example of FIG. 37, a template matching search range size may be expressed as (1+2*del_width)*(1+2*del_height).

Meanwhile, at least one of a horizontal distance del_width and a vertical distance del_height may be signaled in at least one of a high level syntax element such as a coding parameter, a sequence parameter, a picture parameter or a slice header, or a coding tree unit or a predetermined block unit.

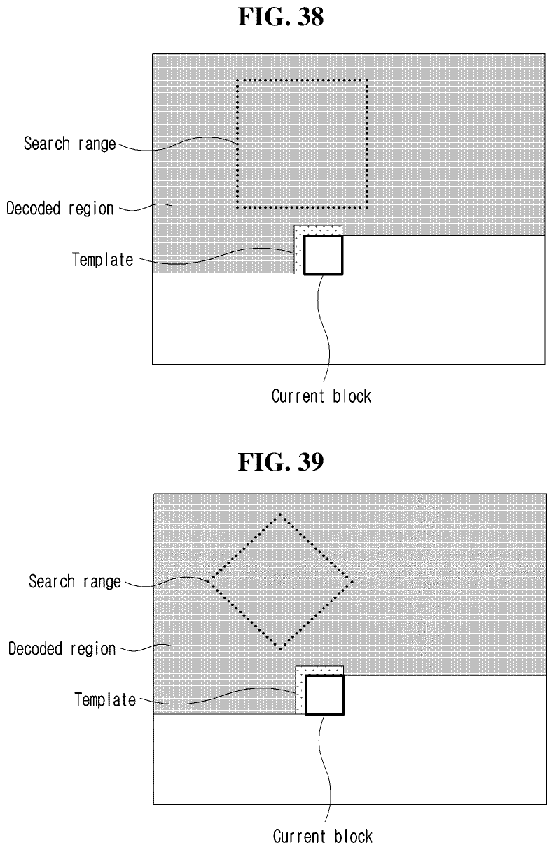

FIG. 38 illustrates a case in which a template matching search range is a square.

When a template matching search range is a square, the size of a template matching search range may be defined by a width or a height. In this case, one of a width (rec_template_width) or a height (rec_template_height) of a template matching search range may be encoded and signaled. In other words, when the search range of template matching is square, encoding/decoding of any one of a width (rec_template_width) or a height (rec_template_height) may be omitted.

Alternatively, when a template matching search range is square, the size of a template matching region may be defined by a horizontal distance or a vertical distance from a template matching search start position within a template matching search range to one side boundary of a template matching search range. In this case, one of a horizontal length (del_width) or a vertical length (del_height) for a template matching search range may be encoded and signaled. In other words, when the search range of template matching is square, encoding/decoding of any one of a horizontal length (del_width) or a vertical length (del_height) may be omitted.

FIG. 39 illustrates a case in which a template matching search range is rhombic.

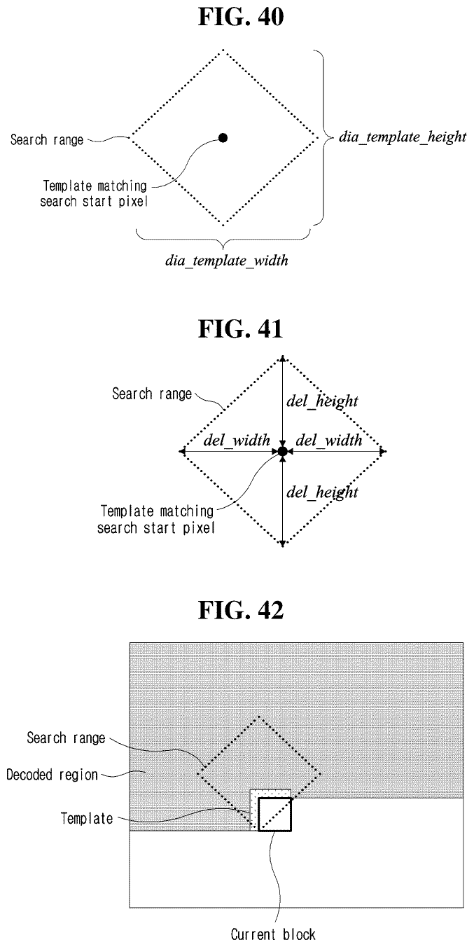

When a template matching search range is rhombic, as in an example shown in FIG. 40, the size of a template matching search range may be defined based on two diagonals. In this case, each of the two diagonals may represent a distance between opposite vertices of a rhombus.

In order to represent the size of a rhombic template matching search range, at least one of a width (i.e., a horizontal diagonal, dia_template_width) and a height (i.e., a vertical diagonal, dia_template_height) may be encoded/decoded. In this case, at least one of dia_template_width and dia_template_height may be encoded in a high level syntax element such as a coding parameter, a sequence parameter, a picture parameter or a slice header, or may be encoded and signaled in a coding tree unit or a predetermined block unit.

When the size of a horizontal diagonal of a rhombus is the same as the size of a vertical diagonal of a rhombus, encoding/decoding of one of a horizontal diagonal dia_template_width or a vertical diagonal dia_template_height may be omitted.

Alternatively, as in an example shown in FIG. 42, the size of a template matching search range may be defined based on a horizontal distance (del_width) showing a distance from a template matching search start point within a template matching search range to a horizontal vertex and a vertical distance (del_height) showing a distance to a vertical vertex. In this case, the size of a template matching search range is ½*(1+2*del_width)*(1+2*del_height).

In this case, at least one of a horizontal distance del_width and a vertical distance del_height may be encoded through a high level syntax element such as a coding parameter, a sequence parameter, a picture parameter or a slice header or may be encoded in a coding tree unit or a predetermined block unit.

If the size of a horizontal diagonal of a rhombus is the same as the size of a vertical diagonal of a rhombus, encoding/decoding of one of a width del_width or a height del_height may be omitted.

In a template matching search range, an undecoded region, e.g., a region overlapping with a current block, may be excluded.

As an example, as in an example shown in FIG. 42, when a current block (i.e., an undecoded region) is included in a template matching search range, a region overlapping with a current block may be excluded from a template matching search range.

### a Determination of a Template Matching Search Pattern

Template matching may be performed according to an arbitrary pattern in a template matching search range. In this case, a position where template matching is performed may be all/some integer pixel positions and/or all/some sub-pixel positions in a template matching search range.

When template matching is performed at integer pixel positions and/or some sub-pixel positions in the template matching search range, positions where template matching is performed may be determined according to an arbitrary search pattern.

A template matching search method may be at least one of a full search, a 2D logarithmic search, a N-step search, a Diamond search, a Hexagonal search or a Test zone search.

A full search may be a search of all pixels in a template matching search range. A 2D logarithmic search, a N-step search, a Diamond search, a Hexagonal search or a Test zone search are clearly understandable to those skilled in the art, so a detailed description thereof is omitted.

A syntax element (e.g., template_matching_search_idx) that specifies one of a plurality of search methods may be encoded and signaled.

As an example, when template_matching_search_idx is a first value, it represents that a full search is applied. When template_matching_search_idx is a second value, it represents that a 2D logarithmic search is applied. When template_matching_search_idx is a third value, it represents that a N-step search is applied. When template_matching_search_idx is a fourth value, it represents that a Diamond search is applied. When template_matching_search_idx is a fifth value, it represents that a hexagonal search is applied. When template_matching_search_idx is a sixth value, it represents that a test zone search is applied.

According to template matching search resolution, a predefined search pattern may be selected. As an example, when the template matching search resolution is greater than or equal to 4 pixel units, a diamond search pattern may be followed. Alternatively, when the template matching search resolution is less than 4 pixel units, the cross search pattern may be followed.

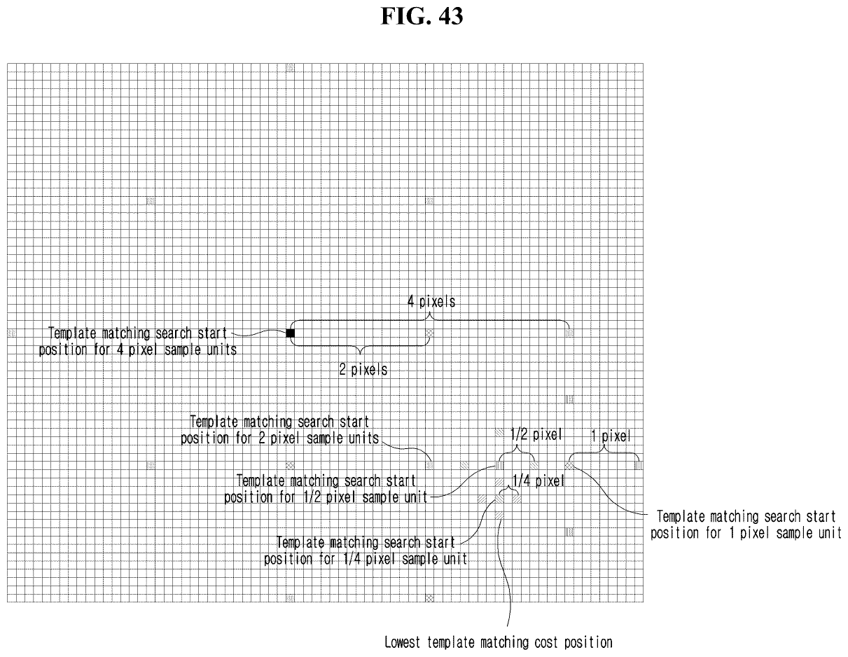

FIG. 43 is a diagram for describing an example of a process for performing a template matching search within a template matching search range.

For convenience of a description, it is assumed that the resolution of a prediction block vector is a ¼ pixel unit.

As in an example shown in FIG. 43, when template matching search resolution is 4 pixel units, a template matching cost may be calculated for pixel positions according to a diamond search pattern, centered on a template matching start position.

After calculating a template matching cost for pixel positions according to a diamond search pattern, a position with the smallest template matching cost is determined. Afterwards, a position with the minimum template matching may be set as a template matching search start position in a unit of ‘2 pixel sample units’.

Based on a template matching search start position in the unit of 2 pixel sample units, a template matching cost at positions where a distance from a template matching search start position in a unit of 2 pixel sample units is 2 pixels may be calculated according to a cross search pattern.

After calculating a template matching cost for pixel positions according to a cross search pattern, a position with the smallest template matching cost is determined. Afterwards, a position with the minimum template matching may be set as a template matching search start position in a unit of ′1 pixel sample units'.

Based on a template matching search start position in the unit of 1 pixel sample units, a template matching cost at positions where a distance from a template matching search start position in a unit of 1 pixel sample units is 1 pixels may be calculated according to a cross search pattern.

After calculating a template matching cost for pixel positions according to a cross search pattern, a position with the smallest template matching cost is determined. Afterwards, a position with the minimum template matching may be set as a template matching search start position in a unit of ‘a ½ pixel sample unit’.

Based on a template matching search start position in the unit of a ½ pixel sample unit, a template matching cost at positions where a distance from a template matching search start position in a unit of a ½ pixel sample unit is a ½ pixel may be calculated according to a cross search pattern.

After calculating a template matching cost for pixel positions according to a cross search pattern, a position with the smallest template matching cost is determined. Afterwards, a position with the minimum template matching may be set as a template matching search start position in a unit of ‘a ¼ pixel sample unit’.

Based on a template matching search start position in the unit of a ¼ pixel sample unit, a template matching cost at positions where a distance from a template matching search start position in a unit of a ¼ pixel sample unit is a ¼ pixel may be calculated according to a cross search pattern.

After calculating a template matching cost for pixel positions according to a cross search pattern, a position with the smallest template matching cost is determined. A pixel position having the minimum template cost determined in a search process in a unit of a ¼ pixel unit may be determined as ‘the lowest template matching cost position’.

In the above-described example, it was illustrated that template matching search resolution is set as ½ of the previous search resolution each time a search is repeated. In addition, it was illustrated that for a template matching search based on 4 pixel sample units, a diamond pattern is applied and for a template matching search in a unit of 2 pixels or less, a cross pattern is applied.

However, a template matching search pattern according to resolution at which template matching is performed is not limited to a shown example.

### Calculation of a Template Matching Cost

In a template matching search process, in performing template matching at integer pixel positions and/or sub-pixel positions within a template matching region, a template matching cost between the template of a current block (i.e., a current template) and a reference template corresponding to a current template may be calculated at each position.

The template matching cost may be calculated by comparing all pixel values and/or some pixel values corresponding between the current template and the reference template. As an example, a cost function for calculating a template matching cost may include at least one of SAD (Sum of Absolute Difference), MR-SAD (Mean-Removed Sum of Absolute Differences), MSE (Mean Squared Error) or SSE (Sum of Squared Error). However, the types of cost function are not limited to listed examples.

When calculating the template matching cost, a different weight may be applied per pixel position in a template.

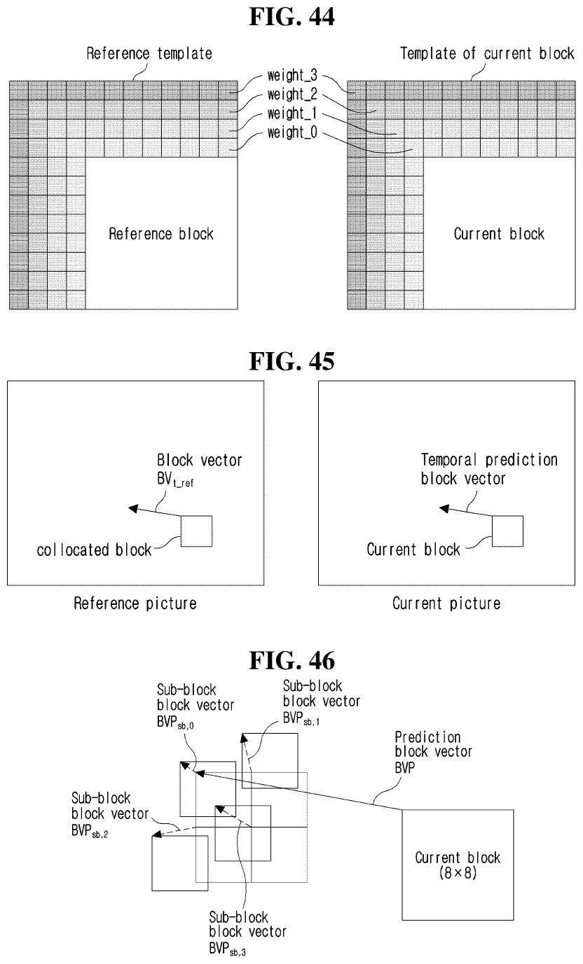

FIG. 44 shows an example in which a different weight is applied for each line within a template.

As in an example shown in FIG. 44, let's assume that the size of a template is 4. In this case, in calculating a template cost between a current template and a reference template, a different weight may be applied according to a distance from the boundary of each of a current block and a reference block to a pixel line in a template. As an example, as in an example shown in FIG. 44, for four lines belonging to a template, weights weight_0, weight_1, weight_2 and weight3 may be applied in order of distance from a block boundary, respectively. A weight may be set differently to set samples belonging to a specific line to have a higher influence on calculating a template cost. As an example, a weight allocated to a line adjacent to a block boundary (e.g., weight_0) may be set to have a larger value than a weight allocated to a line not adjacent to a block boundary (e.g., at least one of weight_1, weight_2 or weight_3).

A weight value may be determined according to at least one of template matching resolution or a template size. Alternatively, information for determining a weight may be encoded through a high level syntax element such as a coding parameter, a sequence parameter, a picture parameter or a slice header or may be encoded and signaled in at least one of a coding tree unit or a predetermined block unit.

At least one of the processes may be performed repeatedly or recursively. In other words, through the process, a template matching cost may be calculated for each of a plurality of pixel positions in a template.

In a decoder, a block vector improvement method based on template matching may be applied in the same manner as in an encoder.

Unlike the above-described example, an encoder may also explicitly signal information for block vector improvement. A method for improving the block vector of a current block based on information for block vector improvement that is explicitly encoded/decoded may be referred to as an improved block vector transmission method.

ibc_merge_mbvd_enabled_flag which indicates whether an improved block vector transmission method may be applied to a current sequence/picture/slice under an intra block copy merge mode may be entropy encoded/decoded in at least one of a parameter set, a header, a brick, a CTU, a CU, a PU, a TU, a CB, a PB or a TB.

ibc_merge_mbvd_flag which indicates whether an improved block vector transmission method is applied to a current block under an intra block copy merge mode may be entropy encoded/decoded in at least one of a CTU, a CU, a PU, a TU, a CB, a PB or a TB.

When ibc_merge_mbvd_flag for a current block is 1, information for determining a predetermined angle and offset combination for improving a prediction block vector may be additionally encoded/decoded.

An angle and offset combination may be one of the angle candidates included in an angle list and one of the offset candidates included in an offset list.

Each of the angle candidates included in an angle list is related to an angle with a X-axis and/or a Y-axis. Each angle candidate may have an angle that is i_ANGLE×π/NUM ANGLE. Here, i_ANGLE may be an integer in the range of 0 to (2*NUM_ANGLE−1). NUM ANGLE may be 1 or an integer greater than 1. As an example, NUM_ANGLE may be 2.

At least one of i_ANGLE or NUM_ANGLE may be predefined in an encoder and a decoder.

For example, when the NUM_ANGLE is 2 and i_ANGLE is 0, it may refer to 0 degree (the right direction of the x-axis).

For example, when the NUM_ANGLE is 2 and i_ANGLE is 1, it may refer to 90 degrees (the top direction of the y-axis).

For example, when the NUM_ANGLE is 2 and i_ANGLE is 2, it may refer to 180 degrees (the left direction of the x-axis).

For example, when the NUM_ANGLE is 2 and i_ANGLE is 3, it may refer to 270 degrees (the bottom direction of the y-axis).

Offset candidates included in an offset list represent the size of an offset vector for improving the block vector of a current block. In other words, an offset candidate may represent a distance between a position indicated by the prediction block vector of a current block and a position indicated by an improved block vector. The value of offset candidates may be 1, 2 or a predetermined positive integer.

For example, the predetermined offset list may be composed of {1, 2, 4, 8, 16, 24, 32, 40, 48, 56, 64, 72, 80, 88, 96, 104, 112, 120, 128}. Values of each element (i.e., offset candidate) in the predetermined offset list may refer to a corresponding number of pixel units.

As another example, a predetermined offset list may include at least one offset candidate having a fractional value such as ½ or ¼ and at least one offset candidate having an integer value such as 1 or 2.

For example, the predetermined offset list may be composed of {¼, ½, 1, 2, 4, 8, 16, 24, 32, 40, 48, 56, 64, 72, 80, 88, 96, 104, 112, 120, 128}. Values of each element (i.e., offset candidate) in the predetermined offset list may refer to a corresponding number of pixel units.

Information representing whether an offset vector in a fractional pixel unit may be used may be encoded and signaled. As an example, a syntax fpel_mbvd_enabled_flag representing whether an offset vector in a fractional pixel unit may be used may be encoded and signaled through a picture header such as a sequence parameter, a picture header or a slice header. When the value of the syntax is 1, it represents that an offset vector in a fractional pixel unit may be used. In this case, an offset list may be configured by including a fractional pixel offset (e.g., {¼, ½, 1, 2, 4, 8, 16, 24, 32, 40, 48, 56, 64, 72, 80, 88, 96, 104, 112, 120, 128}). On the other hand, when the value of the syntax is 0, it represents that an offset vector in a fractional pixel unit may not be used. In this case, an offset list may be composed of only integer pixel offsets (e.g., {1, 2, 4, 8, 16, 24, 32, 40, 48, 56, 64, 72, 80, 88, 96, 104, 112, 120, 128}).

When the value of an angle candidate selected from an angle list is ANGLE and an offset candidate selected from an offset list is OFFSET, an improved block vector may be a block vector indicating a position that is OFFSET away from the prediction block vector of a current block in a direction where an angle with the X-axis/Y-axis is ANGLE. In other words, an offset vector which is a difference between an improved block vector and a prediction block vector may be defined as a vector having an OFFSET size in an ANGLE direction.

An index indicating one of the angle candidates included in an angle list and an index indicating one of the offset candidates belonging to an offset list may be encoded and signaled. In this case, each index may be binarized into a rice code with a rice parameter of 1.

Meanwhile, through template matching, only some of the candidates included in an offset list and/or an angle list may be set to be available for a current block.

As an example, after deriving the prediction block vector of a current block, a template matching cost is calculated for all positions that may be improved by an offset vector. Among them, N offset vector candidates with the smallest cost may be set to be available for a current block. Here, N may be a natural number greater than or equal to 1.

Among the candidates included in an offset list and/or an angle list, a candidate not used to derive N offset vector candidates may be unavailable for a current block. After updating to remove unavailable candidates in an offset list and/or an angle list, an offset candidate and/or an angle candidate may be selected from an updated offset list and/or angle list to derive the offset vector of a current block.

Meanwhile, when N is 1, it represents that an offset vector with the lowest template matching cost is used to improve the prediction block vector of a current block.

Alternatively, a template matching cost is calculated for positions that are 1 pixel away from a position indicated by the prediction block vector of a current block. Afterwards, a template matching cost is calculated for positions that are ¼ pixel away from a position with the smallest template matching cost.

In this case, when the value of fpel_mbvd_enabled_flag is 0, 1 pixel and ¼ pixel in the embodiment may be changed to 4 pixels and 1 pixel, respectively, and implemented.

Through the process, an offset list and/or an angle list may be updated to set a candidate with the smallest template matching cost as an offset vector or select N candidates with a small template matching cost.

Under an intra block copy merge mode, an improved block vector may be obtained by applying an improved block vector transmission method. Afterwards, a template matching-based block vector improvement method may be additionally applied under an intra block copy merge mode to obtain a re-improved block vector.

Alternatively, a template matching-based block vector improvement method may be applied under an intra block copy merge mode to obtain an improved block vector. Afterwards, an improved block vector transmission method may be additionally applied under an intra block copy merge mode to obtain a re-improved block vector.

Meanwhile, the intra prediction mode of a block to which an improved block vector transmission method is applied under an intra block copy merge mode may be stored as a PLANAR, DC and/or directional intra prediction mode.

Alternatively, the intra prediction mode of a block to which an improved block vector transmission method is applied under an intra block copy merge mode may be stored as a template-based intra mode derivation (TIMD) and/or decoder side intra mode derivation (DIMD) intra prediction mode.

A block vector prediction method using a temporal block vector may be applied to a current block. A block vector prediction method using a temporal block vector may be called Temporal Block Vector Prediction (TBVP).

In order to determine whether a block vector prediction method using a temporal block vector is applied to a current block, at least one of tbvp_enabled_flag and/or tbvp_flag may be entropy encoded/decoded in at least one of a parameter set, a header, a brick, a CTU, a CU, a PU, a TU, a CB, a PB or a TB.

In this case, at least one of a parameter set, a header, a brick, a CTU, a CU, a PU, a TU, a CB, a PB or a TB may be at least one of a video parameter set, a decoding parameter set, a sequence parameter set, an adaptation parameter set, a picture parameter set, a picture header, a sub-picture header, a slice header, a tile group header, a tile header, a brick, a coding tree unit (CTU), a coding unit (CU), a prediction unit (PU), a transform unit (TU), a coding block (CB), a prediction block (PB) or a transform block (TB).

In generating a candidate block vector list for improved block vector prediction (IBC-ABVP) or improved intra block copy merge (IBC-merge), a temporal block vector (TBV) may be used. A temporal prediction block vector may represent a prediction block vector referred to from at least one reference picture that is temporally different from a current picture among the reference pictures of a current picture.

A temporal prediction block vector may be derived from a reference picture that is temporally closest to a current picture among the reference pictures that may be referred to by a current picture.

Alternatively, a temporal prediction block vector may be derived from a reference picture defined as colPic among the reference pictures that may be referred to by a current picture. In this case, the colPic may be selected based on an index indicating a reference picture transmitted in at least one of a parameter sets or a header.

The temporal prediction block vector may be set as the block vector of a block (a Col block) having the same position as a current block in a reference picture or colPic.

In this case, a block having the same position as a current block may refer to a block covering a position with the same difference between the top-left pixel position of a reference picture or a picture in colPic and the top-left position of a current block. Alternatively, a block having the same position as a current block may refer to a block covering the center position or bottom-right position of a reference picture or a current block in colPic.

A reference picture used to derive a temporal prediction block vector may be an I type (e.g., I_SLICE) or a non-I type (e.g., non-I_SLICE).

Here, an I type represents that all blocks in a picture are predicted and encoded/decoded by using only pre-encoded/decoded pixels in a current picture. In other words, a block included in an I-type picture may be encoded/decoded based on intra prediction and/or intra block copy.

A non-I type represents that a block may be encoded/decoded by using not only pre-encoded/decoded pixels in a current picture, but also pre-encoded/decoded pixels in reference pictures that are temporally different from a current picture. In other words, a block included in a non-I type picture may be encoded/decoded by using intra prediction, intra block copy and/or inter prediction.

The intra prediction mode of a block to which a block vector prediction method using a temporal block vector is applied may be stored as a PLANAR, DC and/or directional intra prediction mode.

Alternatively, the intra prediction mode of a block to which a block vector prediction method using a temporal block vector is applied may be stored as a template-based intra mode derivation (TIMD) and/or decoder side intra mode derivation (DIMD) intra prediction mode.

FIG. 45 shows an example in which a temporal prediction block vector is derived.

As in an example shown in FIG. 45, the block vector BV_{t_ref} of a block at the same position as a current block in a reference picture may be used as a temporal prediction block vector.

A temporal prediction block vector may be added as a candidate block vector in an improved block vector prediction (IBC-ABVP) list and/or an improved merge (IBC-merge) list for the intra block copy of a current block.

A template matching-based block vector improvement method may be applied to a temporal prediction block vector.

Alternatively, a temporal prediction block vector may be derived by using a plurality of reference pictures. As an example, two reference pictures may be selected from a reference picture list and a plurality of temporal prediction block vector candidates may be derived from two reference pictures. Here, two reference pictures may be two reference pictures with the smallest index in a reference picture list or two reference pictures with the smallest temporal distance (i.e., POC difference) from a current picture.

As an example, for each of two reference pictures, a temporal prediction block vector candidate may be derived from a block having the same position as a current block.

Afterwards, for each of a plurality of temporal prediction vector candidates, a template matching cost based on template matching may be calculated. Among a plurality of temporal prediction block vector candidates, a temporal prediction block vector candidate with the smallest template matching may be set as a temporal prediction block.

A sub-block-based block vector prediction method may be applied to a current block. A sub-block-based block vector prediction method may be referred to as sub-block Block Vector Prediction (sub-block BVP).

In order to determine whether to apply a sub-block-based block vector prediction method, at least one of sb_bvp_enabled_flag and/or sb_bvp_flag may be entropy encoded/decoded in at least one of a parameter set, a header, a brick, a CTU, a CU, a PU, a TU, a CB, a PB or a TB.

In this case, at least one of a parameter set, a header, a brick, a CTU, a CU, a PU, a TU, a CB, a PB or a TB may be at least one of a video parameter set, a decoding parameter set, a sequence parameter set, an adaptation parameter set, a picture parameter set, a picture header, a sub-picture header, a slice header, a tile group header, a tile header, a brick, a coding tree unit (CTU), a coding unit (CU), a prediction unit (PU), a transform unit (TU), a coding block (CB), a prediction block (PB) or a transform block (TB).

The intra prediction mode of a block to which a sub-block-based block vector prediction method is applied may be stored as a PLANAR, DC and/or directional intra prediction mode.

Alternatively, the intra prediction mode of a block to which a sub-block-based block vector prediction method is applied may be stored as a template-based intra mode derivation (TIMD) and/or decoder side intra mode derivation (DIMD) intra prediction mode.

FIG. 46 shows an example in which a sub-block-based block vector prediction method is applied.

A reference block may be derived based on the prediction block vector BVP of a current block. Afterwards, a reference block may be partitioned into N×N-sized sub-blocks. Here, N may be 1 or an integer greater than 1. For example, N may be 4.

Afterwards, the block vector of a sub-block in a current block may be set as the block vector of a sub-block at a corresponding position in a reference block.

As an example, in an example shown in FIG. 46, it was illustrated that the block vector of each partitioned sub-block is BVP_{sb,0}, BVP_{sb,1}, BVP_{sb,2} and BVP_{sb,3}.

Accordingly, the prediction block vector of N×N-sized partitioned sub-blocks in a current block may be set as BVP_{sb,0}, BVP_{sb,1}, BVP_{sb,2} and BVP_{sb,3}, respectively.

When a block vector exists in a sub-block at a position corresponding to a partitioned sub-block in a current block (i.e., a sub-block in a reference block), the block vector of a sub-block at a corresponding position may be set as the block vector of a sub-block in a current block. Meanwhile, the block vector of a sub-block in a current block may also be improved through a template matching-based block vector improvement method.

In addition, when the block vector of a partitioned sub-block in a reference block does not exist, the block vector of a sub-block may be derived by applying a template matching-based block vector improvement method to a sub-block. In other words, after setting the prediction block vector of a current block as the prediction block vector of a sub-block, a template is configured to include regions adjacent to a sub-block. Afterwards, template matching may be performed between the template of a sub-block in a current block and the template of a sub-block in a reference block to derive the block vector of a sub-block.

When an intra block copy mode is applied, the range of a block vector or the position of a reference block indicated by a block vector may be limited.

If the range of a block vector or the position of a reference block indicated by a block vector is not limited, the reconstructed image of all regions encoded/decoded before a current block in a current picture must be stored. In this case, when implementing an encoder/a decoder, a lot of memory is required to store a reconstructed image.

In order to solve the problem, when an intra block copy mode is applied, the range of a block vector or the position of a reference block indicated by a block vector may be limited.

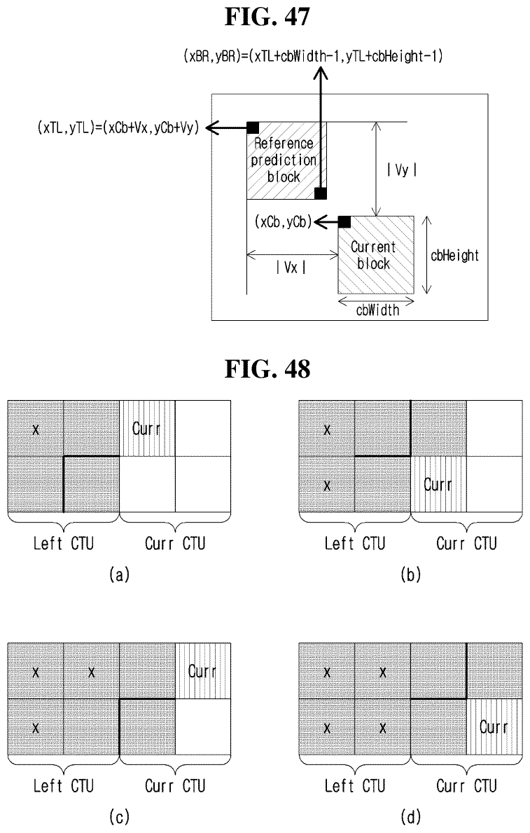

FIG. 47 is a diagram for describing an example in which the range of a block vector is restricted.

As in an example shown in FIG. 47, it is assumed that the coordinate of the top-left sample position of a current block is (xCb, yCb), the width of a current block is cbWidth, the height of a current block is cbHeight and the block vector of a current block is (Vx, Vy). In this case, the coordinate (xTL, yTL) of the top-left sample position of a reference block obtained by using the block vector of a current block may be (xCb+Vx, yCb+Vy) and the coordinate (xBR, yBR) of the bottom-right sample position of a reference block may be (xTL+cbWidth−1, yTL+cbHeight−1).

A method for limiting the range of values held by a block vector or the position of a reference block indicated by a block vector may be at least one of the following.

The range of values held by a block vector or the position of a reference block indicated by a block vector may be limited based on the encoding parameter of at least one of a current block or a neighboring block adjacent to a current block. Alternatively, the range of values held by a block vector or the position of a reference block indicated by a block vector may be limited based on the encoding parameter of at least one of a current CTU and a neighboring CTU adjacent to a current CTU.

A region including (xTL, yTL), the coordinate of the top-left sample position of a reference block, and a region including (xBR, yBR), the coordinate of a bottom-right sample position, may be available. Here, being available may mean that a corresponding region exists/is referenceable. Specifically, it may mean that a corresponding position is reconstructed or that a reconstructed sample for a corresponding position is stored.

In the embodiment and/or other embodiments of the present disclosure, the top-left coordinate of a reference block may refer to the coordinate of the top-left sample position of a reference block and the bottom-right coordinate of a reference block may refer to the coordinate of the bottom-right sample position of a reference block.

The size of a block vector may be limited so that the bottom-right coordinate of a reference block is not included in a current block. In other words, the size of a block vector may be limited so that a reference block does not overlap with a current block. To this end, a block vector may have to satisfy at least one of the following conditions.

$$Vx + cbWidth \leq 0$$

$$Vy + cbHeight \leq 0$$

A reference block may be included in at least one of the same CTB as a current block or (N−1) left CTBs of a current CTB. When a CTB size is 128×128, N may be 2. When a CTB size is smaller than 128×128, when a CTB size is 64×64 or when a CTB size is smaller than 64×64, the size of a region including a current CTB and left (N−1) may be the same as (height of CTB*(N*width of CTB)).

In this case, N may be determined based on the encoding parameter of at least one of a current CTU and a neighboring CTU adjacent to a current CTU.

When a CTB size is 128×128, a reference block may be included in the same CTB as a current block or a left CTB. When a reference block is included in the same CTB as a current block, a reference block may be included in a region encoded/decoded before a current block. For example, when a current CTB and the left CTB of a current CTB are partitioned in a 64×64 unit size, a reference block may exist in at least one of a 64×64 block to which a current block belongs or three 64×64 blocks encoded/decoded before a 64×64 block to which a current block belongs.

FIG. 48 is a diagram for describing the position of a reference block.

In an example of FIG. 48, a 64×64 block to which a reference block may belong is indicated according to the position of a 64×64 block to which a current block (Curr) in a CTB belongs. As in a shown example, a reference block may be included in one of a 64×64-sized block to which a current block belongs or three 64×64-sized blocks encoded/decoded before a 64×64-sized block to which a current block belongs.

In an example of FIG. 48, a region marked with “x” represents a region that may not include a reference block.

With a setting as in FIG. 48, the number of reconstructed samples that must be stored to derive a reference block may be limited to up to four 64×64 blocks, i.e., the number of 128×128-sized samples.

A reference region that may be used in an intra block copy mode may be stored in an independent buffer. By using the independent buffer, the range of a reference block may be limited.

As an example, under an intra block copy mode, the size of a reference region buffer may be M1×M2 and may be stored in M3 bits per sample. In this case, M1 and M2 may be a positive integer that is a multiple of 2 (e.g., 8, 16, 32, 64, 128, etc.), respectively, and M3 may be any positive integer (e.g., 3, 4, 5, 6, 7, 8, 9, 10, 11, 12, etc.).

Values stored in a corresponding buffer may be the value of a reconstructed sample to which loop filtering is not applied. In addition, when a corresponding reconstructed sample is not expressed as M3 bits per sample, it may be converted to be M3 bits per sample.

At least one of the M1, M2 and M3 may be determined based on the encoding parameter of at least one of a current block and a neighboring block adjacent to a current block. Alternatively, at least one of the M1, M2 and M3 may be determined based on the encoding parameter of at least one of a current CTU/CTB and a neighboring CTU/CTB adjacent to a current CTU/CTB.

A reference region buffer may be newly set for each CTB or CTU row of a brick or a tile or a slice or a sub-picture or a picture or a tile group. Being newly set may refer to resetting or initializing a corresponding buffer.

A corresponding buffer may be configured in at least one of the following ways.

The size of a reference region buffer for a luma component may be the same as the size of a CTB including a current block. For example, when a CTB size is 128×128, the size of a reference region buffer may be 128×128. Alternatively, the size of a reference region buffer may be smaller than a CTB size.

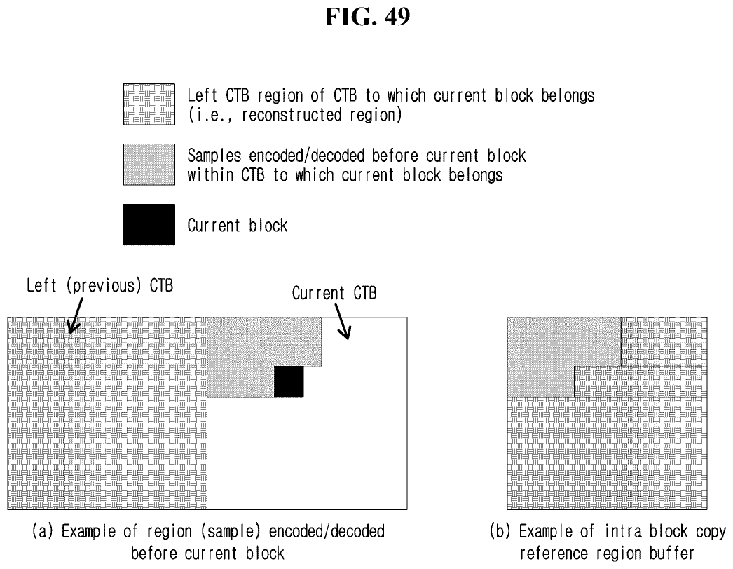

FIG. 49 is a drawing for describing a reference region buffer.

In an example shown in FIG. 49(a), a reference region buffer may be configured to include a region encoded/decoded before a current block in a CTB (a current CTB) including a current block and an encoded/decoded region in a CTB at the left position of a current CTB (refer to FIG. 49(b)).

In a reference region buffer, a position where reconstructed samples of a region encoded/decoded before a current block in a current CTB in a reference region buffer are stored may be the same position as the relative position of reconstructed samples in a current CTB. In the remaining region excluding a region corresponding to a region encoded/decoded before a current block in a reference region buffer and a current block in a current CTB, reconstructed samples included in a CTB adjacent to the left of a current CTB may be stored. In this case, a position where reconstructed samples included in a left CTB in a reference region buffer are stored may be the same as the relative position of reconstructed samples in a left CTB.

In other words, when the coordinate of a reconstructed sample is (x, y), a position where a corresponding reconstructed sample is stored in a reference region buffer may be (x % CTB width or height, y % CTB width or height), (x % M1, y % M2) or (x % M1, y % CTB height). Here, (x, y) may represent a relative distance from the top-left sample position of a CTB. Here, an operation result of Modulo Operation “%” may always be a positive value. In other words, when x is a negative value, x % L may be −(−x % L). For example, when M1 or a CTB width and/or height is 128, (−3% 128) may be 125.

When a block vector is (Vx, Vy), a prediction sample for a prediction target sample positioned at (x, y) may be set as a sample value at a position of ((x+Vx) % 128, (y+Vy) % 128) in a reference block buffer.

As described above, a region occupied by a current block in a reference region buffer may store reconstructed samples of a region corresponding to a current block in a left CTB. Accordingly, when a reference region buffer is used, a reference block may be allowed to overlap at least a part of a current block.

When a reference region buffer is used, there may be a limit that the block vector of a current block indicates a region included in a reference region buffer.

As an example, when the block vector of a current block is (Vx, Vy), the block vector of a current block may satisfy a condition in Equation 8 below.

$$MinVx \leq Vx \leq MaxVx \qquad [ Equation 8 ]$$

$$MinVy \leq Vy \leq MaxVy$$

In Equation 8, MinVx, MaxVx, MinVy and MaxVy may be derived as follows.

When the top-left coordinate of a reference region buffer is (0,0): MinVx=0,

$$MaxVx = ( Width of Reference Region Buffer - 1 ) ,$$

$$MinVy = 0 ,$$

$$MaxVy = ( Height of Reference Region Buffer - 1 )$$

Meanwhile, in a reference region buffer, a coordinate may be set based on the center position.

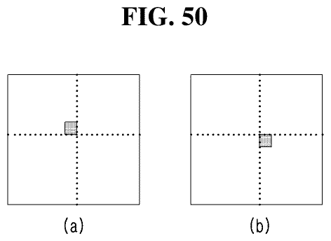

FIG. 50 shows an example in which a coordinate is set based on the center position of a reference region.

As in an example shown in FIG. 50(a), when the coordinate of a top-left sample at the center position is set as (0, 0), variables may be derived as follows.

$$MinVx = - ( ( Width of Reference Region Buffer / 2 ) - 1 ) ,$$

$$MaxVx = ( Width of Reference Region Buffer / 2 ) ,$$

$$MinVy = - ( ( Width of Reference of Region Buffer / 2 ) - 1 ) ,$$

$$MaxVy = ( Height of Reference Region Buffer / 2 )$$

As in an example shown in FIG. 50(b), when the coordinate of a sample at the center position is set as (0, 0), variables may be derived as follows.

$$MinVx = - ( Width of Reference Region Buffer / 2 ) ,$$

$$MaxVx = - ( ( Width of Reference of Region Buffer / 2 ) - 1 ) ,$$

$$MinVy = - ( Width of Reference of Region Buffer / 2 ) ,$$

$$MaxVy = ( ( Height of Reference Region Buffer / 2 ) - 1 )$$

At least one of the MinVx, Max Vx, MinVy and MaxVy may be determined based on the encoding parameter of at least one of a current block or a neighboring block adjacent to a current block. Alternatively, at least one of the MinVx, Max Vx, MinVy and MaxVy may be determined based on the encoding parameter of at least one of a current CTU or a neighboring CTU adjacent to a current CTU.

By limiting a value that a block vector may have in a reference region buffer, whether an invalid block vector is signaled/used in a current block may be determined.

Specifically, when the block vector of a current block exceeds the range of a reference region buffer or when the block vector of a current block is (0, 0), the block vector of a current block may be determined to be invalid.

When a block vector signaled/derived for a current block is out of a limited range, at least one of the following methods may be applied to adjust the block vector of a current block to fall within a limited range or to generate a prediction block based on the block vector of a current block.

When the block vector of a current block is out of a limited range, the block vector of a current block may be replaced with the closest block vector. In other words, it is assumed that a block vector signaled/derived for a current block is (V1x, V1y) and V1x is smaller than MinVx. In this case, the block vector of a current block may be replaced with (MinVx, V1y).

Alternatively, it is assumed that a block vector signaled or derived for a current block is (V1x, V1y) and V1x is larger than Max Vx. In this case, the block vector of a current block may be replaced with (Max Vx, V1y).

Alternatively, it is assumed that a block vector signaled or derived for a current block is (V1x, V1y) and V1y is smaller than MinVy. In this case, the block vector of a current block may be replaced with (V1x, MinVy).

Alternatively, it is assumed that a block vector signaled or derived for a current block is (V1x, V1y) and V1y is greater than MaxVy. In this case, the block vector of a current block may be replaced with (V1x, MaxVy).

Alternatively, the value of an unavailable sample indicated by a block vector may be padded with the closest available sample value. As an example, a sample value at a position out of a reference region buffer may be replaced with a sample value positioned at the boundary of a reference region buffer and a replaced sample value may be derived as the prediction sample of a current block.

Alternatively, when the block vector of a current block is unavailable, the block vector of a current block may be set as any fixed value. For example, the block vector of a current block may be replaced with (0,0) (i.e., a value indicating the position of a current block), (0, P1), (P2, 0) or (P3, P4). In this case, P1, P2, P3 or P4 may be any integer value.

Alternatively, instead of replacing the block vector of a current block, the value of a prediction sample obtained by using the block vector of a current block may be set as any fixed value.

In this case, any fixed value may be a value from 0 to 2\hat{ }(bitdepth)−1. Here, bitdepth is a positive integer greater than 5, and may be 5, 6, 7, 8, 9, 10, 11, 12, etc. As an example, any fixed value may be 0, 2\hat{ }(bitdepth−1) or 2\hat{ }(bitdepth)−1.

Alternatively, any fixed value may be a value from 0 to ((2<<bitdepth)−1). As an example, any fixed value may be 0, (2<< (bitdepth−N−1)) or ((2<< (bitdepth−N))−1). Here, N may be 0 or a positive integer. The N may be a value preset in an encoder/a decoder. Alternatively, information representing N may be signaled from an encoder to a decoder.

bitdepth may refer to the bit depth/depth of an input sample. The bitdepth may be a value preset in an encoder/a decoder. Alternatively, in an encoder, a bitdepth value may be encoded and signaled to a decoder.

At least one of the N and bitdepth may be set as a different value in a luma component block and a chroma component (Cb and/or Cr) block.

At least one of the N and bitdepth may be set as a different value according to the encoding mode of a current block. Here, an encoding mode may include at least one of an intra block copy skip mode, an intra block copy merge mode or an intra block copy AMVP mode.

At least one of the N and bitdepth may be determined according to at least one of the encoding parameters of a current block/CTB.

After a current block is encoded/decoded, the value of a reconstructed sample in a current block may be stored in a reference region buffer. This process may be called a reference region buffer update process. After a reference region buffer is updated, encoding/decoding of a next block may be performed based on an updated reference region buffer.

Through the reference region buffer update, sample values included in a reference region buffer are gradually updated, and as a result, when encoding/decoding of all blocks in a current CTB is completed, only reconstructed image samples in a current CTB may be included in a reference region buffer.

The size of a reference region buffer may be expressed as M1*M2. M1 represents the width of a reference region buffer, and M2 represents the height of a reference region buffer. M1 may be the width of a CTB or N times the width of a CTB. M2 may be the height of a CTB or N times the height of a CTB. As an example, N may be a positive integer that makes M1 and M2 128 respectively.

The height M2 of a reference region buffer may be the same as the height M1 of a reference region buffer.

Alternatively, the width M1 of a reference region may be ((128/CTB width)*K). K may represent the width of a reference region buffer when a CTB width is 128. As an example, K may be 256, 128 or 64.

At least one of the M1, M2, N and K may be determined based on the encoding parameter of at least one of a current block or a neighboring block adjacent to a current block. Alternatively, at least one of the M1, M2, N and K may be determined based on the encoding parameter of at least one of a current CTU/CTB or a neighboring CTU/CTB adjacent to a current CTU/CTB.

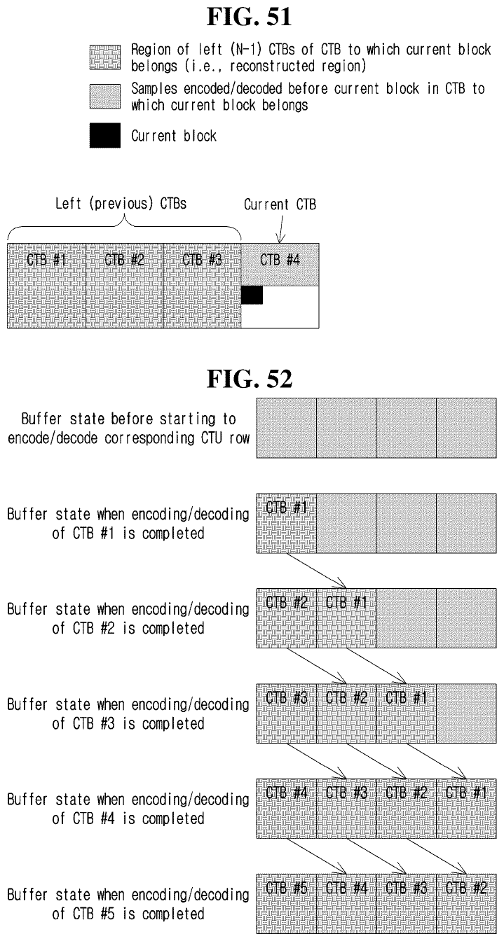

FIG. 51 shows a configuration example of a reference region buffer.

As in an example shown in FIG. 51, a reference region buffer may include (N−1) left CTBs encoded/decoded before a current CTB. In addition, a region encoded/decoded before a current block in a current CTB may also be included in a reference region buffer.

FIGS. 52 to 55 show an aspect in which a reference region buffer is updated as a CTB is encoded/decoded.

In an example shown in FIGS. 52 to 55, a reference region buffer may include (N−1) left CTBs encoded/decoded before a current CTB.

When CTB #1 is the first CTB of a current CTB row, a reference region buffer before starting to encode/decode CTB #1 may be empty. The block vector of a current block must not indicate an empty region in a reference region buffer.

Alternatively, an empty region in a reference region buffer may be filled with an initial value. An initial value may be a predetermined value within a range that a reconstructed sample may have. In this case, an initial value may be any integer value that is greater than or equal to 0 and less than or equal to “2\hat{ }(bitdepth)−1”. As an example, an initial value may be 0, 2\hat{ }(bitdepth−1) or (2\hat{ }(bitdepth)−1).

Alternatively, an initial value may be a value from 0 to (2<<bitdepth)−1. As an example, an initial value may be 0, (2<< (bitdepth−N−1)) or ((2<< (bitdepth−N))−1). Here, N may be an positive integer including 0.

The N may be a value preset in an encoder/a decoder. Alternatively, information representing N may be signaled from an encoder to a decoder.

bitdepth may refer to the bit depth/depth of an input sample. The bitdepth may be a value preset in an encoder/a decoder. Alternatively, in an encoder, a bitdepth value may be encoded and signaled to a decoder.

At least one of the N and bitdepth may be set as a different value in a luma component block and a chroma component (Cb and/or Cr) block.

At least one of the N and bitdepth may be set as a different value according to the encoding mode of a current block. Here, an encoding mode may include at least one of an intra block copy skip mode, an intra block copy merge mode or an intra block copy AMVP mode.

At least one of the N and bitdepth may be determined according to at least one of the encoding parameters of a current block/CTB.

When an empty region in a reference region buffer is filled with an initial value, the block vector of a current block may be allowed to indicate a region set as an initial value. In other words, according to whether an initial value is allocated to an empty region in a reference block buffer, whether it is allowed to predict a current block may be determined based on a corresponding region.

When encoding/decoding of CTB #1 is completed, all of the reconstructed samples of CTB #1 may be stored in a reference region buffer.

When encoding/decoding of CTB #2 is completed, reconstructed samples of CTB #2 may be additionally stored in a reference region buffer.

In this case, when encoding/decoding of CTB #2 is completed, as in an example shown in FIG. 52, the storage position of samples of CTB #1 may be moved to the right by one CTB size in a reference region buffer and the reconstructed samples of CTB #2 may be stored in a position where CTB #1 was stored. In other words, as in an example shown in FIG. 52, the most recently encoded/decoded reconstructed sample in a CTB may be set to be stored on the leftmost of a reference region buffer.

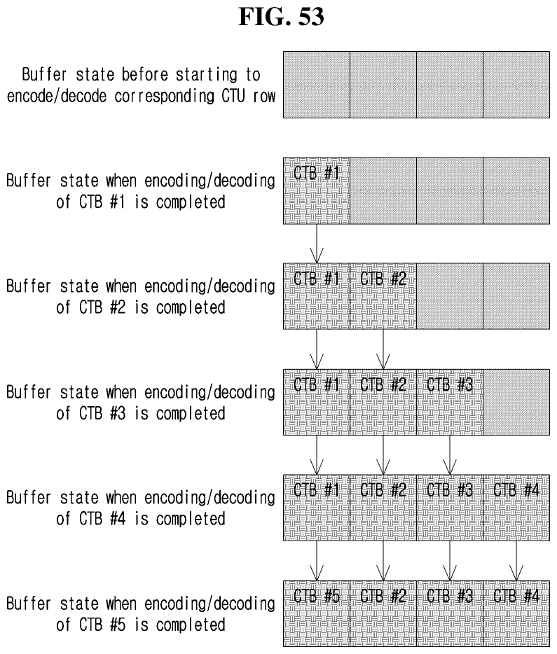

Alternatively, as in an example shown in FIG. 53, the storage position of samples of CTB #1 may be left as it is and reconstructed samples of CTB #2 may be additionally stored in the right region of CTB #1. In other words, as in an example shown in FIG. 53, a reference region buffer may be filled sequentially.

When encoding/decoding of CTB #4 is completed, a reference image buffer becomes full.

In this state, when encoding/decoding of CTB #5 is performed, as in an example shown in FIG. 52, reconstructed samples of CTB #5 may be stored on the leftmost of a reference region buffer.

Alternatively, as in an example shown in FIG. 53, when encoding/decoding of CTB #5 is performed, reconstructed samples of CTB #5 may be stored at a position where reconstructed samples of CTB #1 were stored.

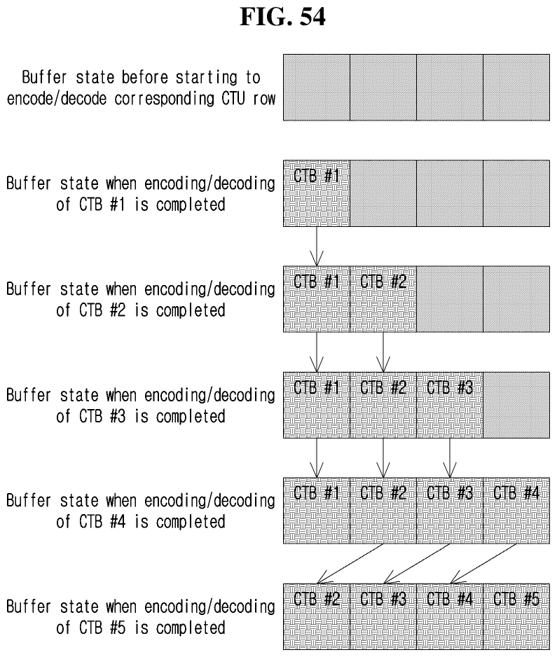

Meanwhile, as in an example shown in FIG. 54, the storage position of reconstructed samples of CTB #2 to CTB #4 may be moved to the left by one CTB size, and reconstructed samples of CTB #5 may be stored at a position where reconstructed samples of CTB #4 were stored.

By doing this, a position between CTBs in a picture and the position of CTBs in a reference region buffer may be set to be the same. Accordingly, the prediction block of a current block may be derived without converting a block vector.

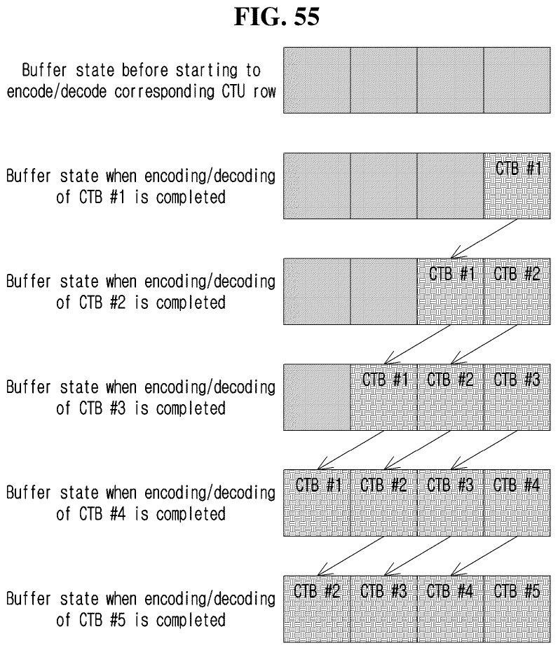

As another example, as in an example shown in FIG. 55, the reconstructed sample of the last encoded/decoded CTB may be stored on the rightmost of a reference block buffer. In this case, when encoding/decoding of CTB #2 is completed, the storage position of samples of CTB #1 may be moved to the left by one CTB size in a reference region buffer, and reconstructed samples of CTB #2 may be stored at a position where CTB #1 was stored.

When encoding/decoding of CTB #4 is complete, a reference image buffer becomes full. In this state, when CTB #5 is encoded/decoded, the storage position of reconstructed samples of CTB #1 to CTB #4 may be moved to the left by one CTB size, and reconstructed samples of CTB #5 may be stored at a position where reconstructed samples of CTB #4 were stored.

At the time of starting to encode/decode the K-th CTB, i.e., at the time of starting to encode/decode the first block of the K-th CTB, reconstructed samples of the (K−1), (K−2) to (K−N)-th CTBs may be stored in a reference region buffer. For example, when a CTB size is 64×64, N may be 4. In this case, at the time of starting to encode/decode the K-th CTB, reconstructed samples of the (K−1), (K−2), (K−3) and (K−4)-th CTBs may be stored in a reference region buffer.

The K may refer to any positive integer. As an example, K may be an integer greater than or equal to 5. A first block in the K-th CTB may be encoded/decoded by referring to a reference region buffer. After encoding/decoding of a corresponding block is completed, at least one of the state of a reference region buffer or a range that a block vector may have may be determined as follows.

In a reference region buffer, reconstructed samples of the (K−N)-th CTB may be deleted from a reference region buffer, and reconstructed samples of the first block of the K-th CTB may be stored in a reference region buffer. A reference region that the A-th block of the K-th CTB may refer to may be limited to (N−1) CTBs on the left of a current CTB. This may mean that the top-left coordinate (or position) and the bottom-right coordinate (or position) of a prediction block derived by the block vector of the A-th block are included in a region composed of (N−1) left CTBs. Here, A may be any positive integer greater than 1. Alternatively, A may be 0 or a positive integer.

Alternatively, the reference region of the A-th block of the K-th CTB may be limited to a region including blocks encoded/decoded before the A-th block in a current CTB and (N−1) CTBs on the left of a current CTB. This may mean that the top-left coordinate (or position) and the bottom-right coordinate (or position) of a prediction block derived by the block vector of the A-th block are included in a region composed of (N−1) left CTBs and blocks encoded/decoded before the A-th block of a current CTB.

As another example, in a reference region buffer, only samples at a position where a relative position in a CTB is the same as that of the first block of the K-th CTB among the reconstructed samples of the (K−N)-th CTB may be deleted. In a deleted position, reconstructed samples of the first block of the K-th CTB may be stored. In this case, the reference region of a current block in a reference region buffer may be limited to blocks encoded/decoded before a current block in a current CTB and (N−1) CTBs on the left of a current CTB. According to this method, when configuring a reference region buffer, all regions of a reference region buffer may be configured with reconstructed samples, improving encoding efficiency.

In the above-described embodiments related to a reference region buffer, when starting to encode/decode the first block of the K-th CTB or before encoding/decoding the first block of the K-th CTB, a region where reconstructed sample values of the encoded/decoded block of the K-th CTB or a block to be encoded/decoded will be stored may be initialized to an any fixed value or may be empty. Since a method for deriving an initial value has been described above, a detailed description is omitted at this step.

When a region included in a reference region buffer is empty, it represents that a corresponding region may not be indicated by a block vector. In other words, a block vector indicating an empty region may be unavailable to a current block.

On the other hand, when a region included in a reference region buffer is filled with an initial value, it represents that a corresponding region may be indicated by a block vector. When the block vector of a current block indicates a region filled with an initial value, the prediction sample value of a current block may be derived in the same manner as an initial value.

After a specific block in a current CTB is encoded/decoded, reconstructed sample values of an encoded/decoded block may be stored in an empty region in a reference region or a region set as an initial value. A region that is not encoded/decoded among the regions where a current CTB will be stored in a reference region buffer may be still empty or may be filled with an initial value.

The K may be determined according to at least one of the encoding parameters of a current block/CTB.

It is assumed that the width and height of a CTB are C1 and C2, respectively. When it is assumed that a current CTB and (N−1) CTBs on the left of a current CTB may be stored in a reference region buffer, a position where a block whose coordinate in a picture is (x, y) will be stored in a reference region buffer may be set as follows. Here, N may be determined according to at least one of the encoding parameters of a current block/CTB.

When following an embodiment shown in FIG. 52, a block whose coordinate in a picture included in the K-th CTB is (x,y) may be stored at the position of (x % C1, y % C2) in a reference picture buffer. At the time when blocks included in the K-th CTB are stored, the storage position of blocks included in the left CTBs of the K-th CTB in a reference region buffer may be as follows. A block whose coordinate included in the (K−1)-th CTB is (x1, y1) may be stored at (x1% C1+C1, y1% C2) within a reference picture buffer. A block whose coordinate included in the (K−2)-th CTB is (x1, y1) may be stored at (x1% C1+ (C1*2), y1% C2) within a reference picture buffer. A block whose coordinate included in the (K−3)-th CTB is (x1, y1) may be stored at (x1% C1+ (C1*3), y1% C2) within a reference picture buffer. In other words, a block whose coordinate included in the (K−A)-th CTB is (x1, y1) may be stored at (x1% C1+ (C1*A), y1% C2) within a reference picture buffer. In this case, A may be a value greater than or equal to 0 and less than or equal to (N−1).

According to an embodiment shown in FIG. 53, a block whose coordinate included in the K-th CTB is (x,y) may be stored at the position of (x % C1, y % C2) in a reference picture buffer. At the time when blocks included in the K-th CTB are stored, the storage position of blocks included in the left CTBs of the K-th CTB in a reference region buffer may be as follows. A block whose coordinate included in the (K−1)-th CTB is (x1, y1) may be stored at (x1% C1+ (C1*3), y1% C2). A block whose coordinate included in the (K−2)-th CTB is (x1, y1) may be stored at (x1% C1+ (C1*2), y1% C2). A block whose coordinate included in the (K−3)-th CTB is (x1, y1) may be stored at (x1% C1+ (C1*1), y1% C2). In other words, a block whose coordinate included in the (K−A)-th CTB is (x1, y1) may be stored at (x1% C1+ (C1*(N−A)), y1% C2). A may be a value greater than or equal to 0 and less than or equal to (N−1). Alternatively, a block whose coordinate included in the (K−A)-th CTB is (x1, y1) may be stored at the position of (x % M1, y % M2), (x % M1, y % CTB Height) or (x % M1, y).

When following an embodiment shown in FIG. 54 or FIG. 55, a block whose coordinate included in the K-th CTB is (x,y) may be stored at the position of (x % C1+ (C1*(N−1)), y % C2) in a reference picture buffer. At the time when blocks included in the K-th CTB are stored, the storage position of blocks included in the left CTBs of the K-th CTB in a reference region buffer may be as follows. A block whose coordinate included in the (K−1)-th CTB is (x1, y1) may be stored at (x1% C1+ (C1*(N−2), y1% C2). A block whose coordinate included in the (K−2)-th CTB is (x1, y1) may be stored at (x1% C1+ (C1*(N−3)), y1% C2). A block whose coordinate included in the (K−3)-th CTB is (x1, y1) may be stored at (x1% C1+ (C1*(N−4)), y1% C2). In other words, a block whose coordinate included in the (K−A)-th CTB is (x1, y1) may be stored at (x1% C1+ (C1*(N−(A+1))), y1% C2). A may be a value greater than or equal to 0 and less than or equal to (N−1).

A block vector may be expressed in one of the following method. Alternatively, it may be signaled or derived so that it may be expressed in one of the following methods.

When a coordinate within a picture at the top-left position of a current block is (x,y) and a coordinate within a picture at the top-left position of a prediction block is (x+VPx, y+VPy), a block vector may be expressed as (VPx, VPy), a difference between two coordinates.

When a coordinate within a reference region buffer at the top-left position of a current block is (x,y) and a coordinate within a reference region buffer at the top-left position of a prediction block is (x+VBx, y+VBy), a block vector may be expressed as (VBx, VBy), a difference between two coordinates.

In this case, when there is an empty region in a reference region buffer, the range of a block vector may be limited so that a prediction block does not include a corresponding region. Specifically, a block vector (VBx, VBy) may be limited so that both (x+VBx, y+VBy), the top-left coordinate of a prediction block, and (x+VBx+cbWidth−1, y+Vby+cbHeight−1), the bottom-right coordinate of a prediction block, are not included in the empty region of ahe reference region buffer. In other words, when the top-left coordinate of a prediction block is (x+VBx, y+VBy), the range of a block vector may be limited to satisfy (0≤x+VBx) and (0≤y+VBy).

In addition, when the bottom-right coordinate of a prediction block is (x+VBx+cbWidth−1, y+Vby+cbHeight−1), the range of a block vector may be limited to satisfy (x+VBx+cbWidth−1≤((C1*(N−1))−1)) and (y+VBy+cbHeight−1≤(C2−1)). When it is assumed that it is possible to refer to a region encoded/decoded before a current block in a current CTB, a block vector may be limited to satisfy (x+VBx+cbWidth−1<x) or (y+VBy+cbHeight−1<y).

Alternatively, when an empty region in a reference region buffer is filled with an initial value, the range of a block vector may be limited to a range in which a prediction block is included in a reference buffer region. In other words, when the top-left coordinate of a prediction block is (x+VBx, y+VBy), the range of a block vector may be limited to satisfy (0≤x+VBx) and (0≤y+VBy). In addition, when the bottom-right coordinate of a prediction block is (x+VBx+cbWidth−1, y+Vby+cbHeight−1), a block vector may be limited to satisfy (x+VBx+cbWidth−1≤((C1*N)−1)) and (y+VBy+cbHeight−1≤(C2−1)).

As in embodiments described above, a template matching technique may be applied under aun intra block copy merge mode or an intra block copy AMVP mode. Specifically, when an intra block copy merge mode or an intra block copy AMVP mode is applied to a current block, at least one of a technique for reordering a block vector candidate list based on template matching or a technique for improving a block vector based on template matching may be applied.

In this case, only one of a template matching-based intra block copy merge mode and a general intra block copy merge mode may be used for a current block. In other words, based on a flag indicating whether a template matching-based intra block copy merge mode is applied (e.g., a TM-merge flag), whether to apply a template matching-based intra block copy merge mode or whether to use a general intra block copy merge mode may be selected.

Meanwhile, when a template matching-based merge/AMVP mode is applied, the first N block vector candidates may be inserted into a block vector candidate list. Afterwards, a template matching cost for each of the N block vector candidates may be calculated, and only M block vector candidates with a low cost may be set to be available for a current block. Here, M may be a number smaller than N. As an example, when it is assumed that N is 3 and M is 2, one candidate with a low cost among the three block vector candidates may be set to be unavailable for a current block.

As another example, when a template matching-based merge/AMVP mode is applied, a block vector may be limited to be improved only in an integer pixel unit. As an example, a block vector derived from a block vector candidate may be set to be improved only in a 1-pel unit or a 4-pel unit. In this case, there is an advantage that block vector improvement is possible without performing interpolation.

Meanwhile, an improved block vector must meet the range restriction of a block vector which will be described later.

As another example, each block vector candidate included in a block vector candidate list may be improved based on template matching to update a block vector candidate list. In other words, a block vector candidate list may include improved block vector candidates obtained by improving block vector candidates that are inserted first.

Meanwhile, a block vector candidate may be improved and improved block vector candidates may be pruned to select a candidate to be inserted into a block vector candidate list.

A template matching-based block vector improvement method may also be performed in a sub-block unit. As an example, when a block vector is derived for a current block, the block vector of a current block may be set as the prediction block vector of each sub-block. Afterwards, a template may be set for each sub-block to apply a template matching-based block vector improvement method independently to each sub-block.

### [E1-2/D1-2] A Step for Deriving the Block Vector of a Chroma Component Block;

When a single tree type (SINGLE_TREE) where the block partition structure of a luma component and a chroma component within the same CTU is the same is applied and a current chroma component block is encoded/decoded in an intra block copy mode, the block vector of a current chroma component block may be derived as follows.

First, a luma component block corresponding to a current chroma component block may be determined as follows.

Let's assume that the top-left sample position of a current chroma component block is (xc, yc), the width of a current chroma component block is Wc and the height of a current chroma component block is Hc. In this case, the top-left sample position of a luma component block corresponding to a current chroma component block may be (xc/K1, yc/K2), a width may be K1×Wc and a height may be K2×Hc. In this case, K1 and K2 may have a different value according to a chroma component format.

As an example, when the chroma component format of a current picture is a 4:2:0 format, both K1 and K2 may be 2.

As an example, when the chroma component format of a current picture is a 4:2:2 format, K1 may be 2 and K2 may be 1.

As an example, when the chroma component format of a current picture is a 4:4:4 format, both K1 and K2 may be 1.

Since the block partition structure of a chroma component block and a luma component block is the same, only one luma component block may be included in a region specified by the position, width and height of a luma component block corresponding to a current chroma component block.

When the block vector of a luma component block corresponding to a chroma component block is (MVL[0], MVL[1]), the block vector of a corresponding chroma component block may be set as (MVL[0]/K1, MVL[1]/K2). As described above, K1 and K2 may be determined according to a chroma component format.

In embodiments described below, it is described by assuming that the basic unit of MVL[0] and MVL[1] is 1 sample. However, the basic unit of MVL[0] and MVL[1] may be 1/16 sample, 1/N sample or N samples. Here, N is a positive integer, and may be 1, 2, 4 or 8.

Let's assume that a dual tree structure in which the block partition structure of a luma component and a chroma component in the same CTU is configured independently is applied and a current block is a chroma component block (DUAL_TREE_CHROMA). When a current chroma component block is encoded/decoded in an intra block copy mode, the block vector of a current chroma component block may be derived as follows.

A luma component region corresponding to a current chroma component block may be determined as follows.

Let's assume that the top-left sample position of a current chroma component block is (xc, yc), a width is Wc and a height is Hc. In this case, the top-left sample position of a luma component region corresponding to a current chroma component block may be (xc/K1, yc/K2), a width may be K1×Wc and a height may be K2×Hc. As described above, K1 and K2 may have a different value according to a chroma component format.

Since the partition structure of a chroma component block and a luma component block is independently determined, a luma component region corresponding to a current chroma component block may include only a part of a partitioned luma component block or may include at least one luma component block.

Considering this, a current chroma component block may be partitioned into N×M-sized sub-blocks and a luma component region corresponding to a current chroma component may also be partitioned into (N*K1)×(M*K2)-sized sub-blocks. Afterwards, the block vector of a N×M-sized sub-block in a current chroma component block may be derived from a (N*K1)×(M*K2)-sized luma component sub-block corresponding thereto. In this case, N and M may be an integer greater than or equal to 1.

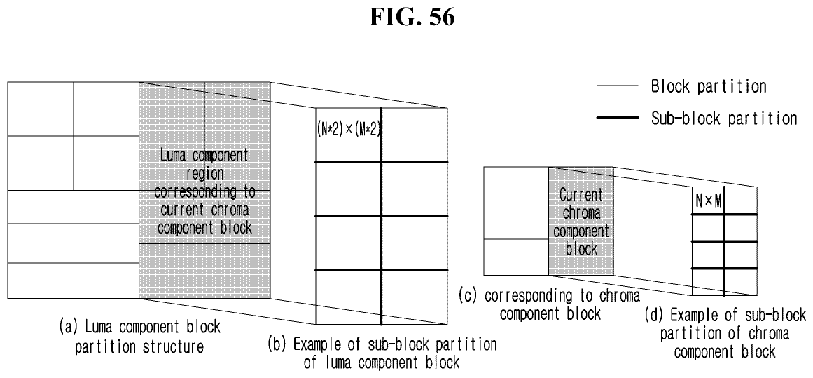

FIG. 56 shows an example in which a block vector is derived for each sub-block after a current chroma block is partitioned into a plurality of sub-blocks.

A current chroma component block may be partitioned into N×M-sized sub-blocks and a luma component region corresponding to a current chroma component block may also be partitioned into (N*K1)×(M*K2)-sized sub-blocks. In this case, N and M may be an integer greater than or equal to 1.

As another example, when the width of a current chroma component block is Wc and a height is Hc, a current chroma component block may be partitioned into P1 parts horizontally and P2 parts vertically to generate N×M-sized sub-blocks. In this case, N may be Wc/P1 and M may be Hc/P2. In addition, P1 and P2 may be an integer greater than or equal to 1.

When there is a luma component sub-block corresponding to a sub-block in a current chroma component block, the block vector of a sub-block in a current chroma component block may be derived from the block vector of a corresponding luma component sub-block.

As an example, when the block vector of a luma component sub-block corresponding to a sub-block in a chroma component block is (MVL[0], MVL[1]), the block vector of a sub-block in a corresponding chroma component block may be (MVL[0]/K1, MVL[1]/K2). As described above, K1 and K2 may be a value determined by a chroma component format.

Meanwhile, there may be a case where sub-blocks in a luma component region corresponding to a current chroma component block are not encoded/decoded in the same prediction mode. In other words, since the block partition structure of a luma component and a chroma component is independent, a luma component sub-block corresponding to a sub-block in a chroma component block may not match a luma component prediction block or at least two luma component prediction blocks may exist in a luma component sub-block.

Here, a luma component prediction block may refer to a leaf node block. In other words, a luma component prediction block may refer to a block to which the same prediction or the same transform/inverse transform is applied in encoding/decoding. A luma component prediction block may be determined by block partition for a luma component.

A luma component region corresponding to a chroma component block mentioned in the present disclosure does not refer to only a block (i.e., a leaf node block) determined by luma component block partition, as in an example shown in FIG. 56. A luma component region may refer to a region corresponding to the position and size of a chroma component block. Accordingly, in a luma component region, only a single leaf node block may exist or a plurality of leaf node blocks may exist.

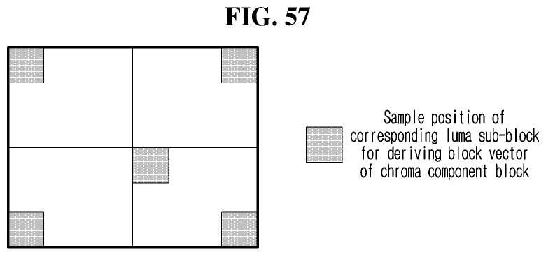

Accordingly, the block vector of a luma component sub-block corresponding to a sub-block in a current chroma component block may be the block vector of a luma component prediction block including a sample at a predefined position in a luma component block. FIG. 57 illustrates a sample at a predefined position.

When a luma component prediction block including one of the sample positions indicated in FIG. 57 is encoded/decoded in an intra block copy mode, the block vector of a corresponding luma component prediction block may be derived as the block vector of a sub-block in a current chroma component block.

As an example, the block vector of a sub-block in a current chroma component block may be derived based on the block vector of a luma component prediction block including the top-left sample of a luma component sub-block.

Alternatively, the block vector of a sub-block in a current chroma component block may be derived based on the block vector of a luma component prediction block including a sample at the center position of a luma component sub-block.

Alternatively, after sequentially searching for a plurality of samples at a predefined position, the block vector of a sub-block in a current chroma component block may be derived from the luma component prediction block of a block encoded/decoded in an intra block copy mode that is found first.

Alternatively, the block vector of a sub-block in a current chroma component block may be derived from a luma component prediction block that includes the largest number of samples among a plurality of samples at a predefined position.

Alternatively, the block vector of a sub-block in a current chroma component block may be derived based on the block vector of a luma component prediction block that occupies the largest region in a luma component sub-block.

Meanwhile, when a luma component prediction block selected according to the condition is not encoded/decoded in an intra block copy mode or is encoded/decoded in an intra prediction mode, a problem may occur in which a block vector may not be derived from a corresponding luma component prediction block. In other words, when the prediction mode of a luma component sub-block corresponding to a sub-block in a current chroma component is not an intra block copy mode, a problem may occur in which it is difficult to derive the block vector of a sub-block in a current chroma component block from a corresponding luma component sub-block.

In this case, the block vector of a sub-block in a current chroma component block may be derived by one of the following methods.

The block vector of a current sub-block may be set as (0,0) or (D1, D2). In this case, D1 and D2 may be an integer such as 0, ±1, ±2 or ±3.

The block vector of a current sub-block may be set as (Wc+D1, D2) or (D1, Hc+D2). In this case, Wc may represent the width of a current chroma component block, and Hc may represent the height of a current chroma component block.

The block vector of a current sub-block may be set as one of (−(Wc<<n)+a, −(Hc<<n)+b), (−(Wc<<n)+c, 0) or (0, −(Hc<<n)+d). In this case, n may be a positive integer, and a, b, c and d may have an integer value.

The block vector of the neighboring sub-block of a current sub-block (e.g., at least one of a top sub-block, a bottom sub-block, a left sub-block, a right sub-block, a top-left sub-block, a top-right sub-block, a bottom-left sub-block, a bottom-right sub-block, etc.) may be used as the block vector of a current sub-block.

The block vector of a current sub-block may be derived by using the block vector statistical value of sub-blocks where a block vector is derived from a corresponding luma component sub-block among the sub-blocks of a current chroma component block.

For example, the mean, median, maximum or minimum value of block vectors of sub-blocks where a block vector is derived from a corresponding luma component sub-block may be set as the block vector of a current sub-block.

Alternatively, a block vector with the highest occurrence frequency among the block vectors of the sub-blocks may be set as the block vector of a current sub-block.

Alternatively, when a luma component sub-block corresponding to a current sub-block is not encoded/decoded in an intra block copy mode, a corresponding sub-block may not be encoded/decoded in an intra block copy mode. Alternatively, when there is a sub-block where a corresponding luma component sub-block is not encoded/decoded in an intra block copy mode among the sub-blocks in a current chroma component block, a current chroma component block may be set not to be encoded/decoded in an intra block copy mode.

The prediction mode of a luma component sub-block corresponding to a sub-block in a current chroma component block may be at least one of an intra prediction mode, an inter prediction mode or an intra block copy mode. More specifically, an inter prediction mode may be at least one of a skip mode, a merge mode, an AMVP mode, an affine skip mode or an affine inter mode, and an intra block copy mode may be at least one of an intra block copy skip mode, an intra block copy merge mode or an intra block copy AMVP mode.

The prediction mode of a luma component sub-block may be set to be the same as the prediction mode of a luma component prediction block including a sample at a predefined position in a luma component sub-block. As in an example shown in FIG. 57, a sample at a predefined position may include at least one of a top-left sample, a central sample, a top-right sample, a bottom-left sample or a bottom-right sample.

Alternatively, the prediction mode of a luma component prediction block including the largest number of samples among a plurality of samples at a predefined position may be set as the prediction mode of a luma component sub-block.

Alternatively, the prediction mode of a luma component prediction block occupying the largest region in a luma component sub-block may be set as the prediction mode of a luma component prediction block.

For a chroma component block, block vector resolution which is a fractional pixel may be used.

Meanwhile, when block vector resolution is a fractional pixel unit, a sample at a fractional pixel position may be generated by interpolating integer pixels. In this case, an interpolation filter for a luma component block and a chroma component block may be different. As an example, a 8-tap interpolation filter may be used for a luma component block and a 6-tap block vector may be used for a chroma component block.

In addition, at least one of the number or type of available resolution candidates may be different between a luma component block and a chroma component block.

For a chroma component block, at least one of a template matching-based block vector improvement method or an improved block vector transmission method may be applied.

### [E2/D2] A Step for Deriving a Prediction Block;

In describing a step for deriving a prediction block for prediction in an intra block copy mode, a step for deriving the prediction block of a luma component block ([E2-1/D2-1]) and a step for deriving the prediction block of a chroma component block ([E2-2/D2-2]) are described separately.

### [E2-1/D2-1] A Step for Deriving the Prediction Block of a Luma Component Block;

A block indicated by the block vector of a luma component block derived from a current luma component block may be called a reference block. In this case, a reference block may be determined as the prediction block of a current block.

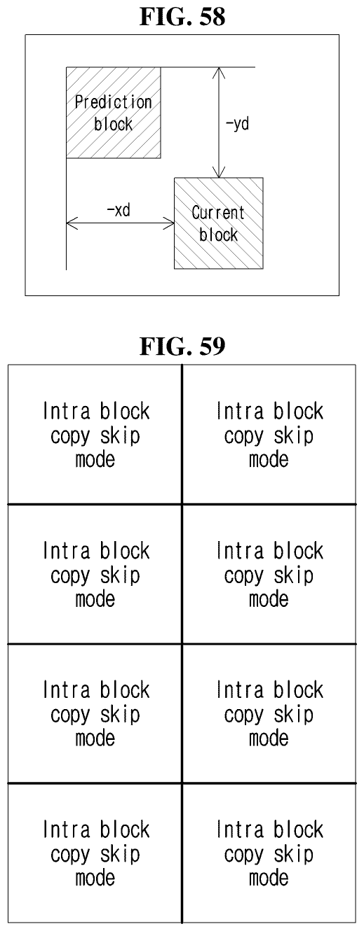

FIG. 58 is to describe an example in which a reference block indicated by a block vector is set as a prediction block.

As in an example of FIG. 58, it is assumed that the top-left sample position of a current luma component block is (x0, y0), a width is WL and a height is HL. When the block vector of a current luma component block is (xd, yd), a sample position (x0+xd, y0+yd) spaced apart by (xd, yd) from the top-left sample position of a current luma component block in the same picture may be set as a top-left sample, and a reference block (i.e., a block in the size of WL×HL) having the same width and height as a current block may be set as the prediction block of a current block.

In this case, when xd is a negative integer, it represents that a reference block is positioned at a position spaced apart by xd in a left horizontal direction based on (x0,y0), and when xd is a positive integer, it represents that a reference block is positioned at a position spaced apart by xd in a right horizontal direction based on (x0, y0). In addition, when yd is a negative integer, it represents that a reference block is positioned at a position spaced apart by yd in a top vertical direction based on (x0,y0), and when yd is a positive integer, it represents that a reference block is positioned at a position spaced apart by yd in a bottom vertical direction based on (x0,y0).

FIG. 58 shows an example in which both xd and yd are a negative integer.

The sample value of a reference block may be set as the prediction sample value of a current luma component block. In other words, a reference block may be called the prediction block of a current luma component block.

The sample value of a reference block may be a reconstructed sample value to which at least one of the loop filterings is not applied.

When a block vector is (0,0), the value of a prediction sample may be set as a fixed value. A fixed value may be a predetermined value within a range that a reconstructed sample may have. In other words, a fixed value may be any integer value greater than or equal to 0 and less than or equal to “2\hat{ }(bitdepth)−1”. For example, a fixed value may be 0, 2\hat{ }(bitdepth−1) or (2\hat{ }(bitdepth)−1).

As another example, a fixed value may be a value from 0 to ((2<<bitdepth)−1_. bitdepth is a positive integer, and for a detailed description of a variable bitdepth, refer to the above-described embodiment. As an example, a fixed value may be 0, (2<< (bitdepth−N−1)) or ((2<< (bitdepth−N))−1).

Here, N may be an positive integer including 0. In addition, the N may be a preset value in an encoder/a decoder and may be a value signaled from an encoder to a decoder.

The bitdepth may refer to the bit depth/depth of an input sample. In addition, the bitdepth may be a preset value in an encoder/a decoder and may be a value signaled from an encoder to a decoder.

At least one of the N and the bitdepth may have a different value in a luma component block and a chroma component (Cb and/or Cr) block.

At least one of the N and the bitdepth may have a different value according to at least one of an intra block copy skip mode, an intra copy merge mode and an intra block copy AMVP mode that are the encoding mode of a current block.

At least one of the N and bitdepth may be determined according to at least one of the encoding parameters of a current block/CTU.

For a block vector, its value may be limited so that a reference block is positioned in a limited region. When a block vector does not have a value within a limited range, the prediction block of a block having a corresponding block vector may set a prediction block sample value as a fixed value. A corresponding fixed value may be set to be the same as a fixed value set when the above-described block vector is (0,0).

When encoding/decoding is performed by applying a reference region buffer, a region spaced apart by the block vector of a current block from a current block position in a reference region buffer may be set as a reference block. In other words, a reference block may be included in a reference region buffer.

When a coordinate in a picture of a sample in a current block is (x,y) and a block vector is (Vx, Vy), the position of a corresponding reference sample positioned in a reference block in a reference region buffer may be ((x+Vx) % M1, (y+Vy) % M2) or ((x+Vx) % M1, (y+Vy)).

### [E2-2/D2-2] A Step for Deriving the Prediction Block of a Chroma Component Block;

For a single tree type (SINGLE_TREE) where the block partition structure of a luma component and a chroma component in the same CTU is the same, the prediction block of a current chroma component block encoded/decoded in an intra block copy mode may be derived as follows.

A reference block spaced apart from a current chroma component by the block vector of a current chroma component block may be set as the prediction block of a current chroma component block.

For example, it is assumed that the top-left sample position of a current chroma component block is (x0, y0), a width is Wc and a height is Hc. When the block vector of a current chroma component block is (xd, yd), a block in the same size as a current chroma component block (i.e., a block in the size of Wcx Hc) where a sample position (x0+xd, y0+yd) spaced apart by (xd, yd) from the top-left sample position of a current chroma component block in the same picture is set as a top-left sample position may be set as the prediction block of a current chroma component block.

In this case, when xd is a negative integer, it represents that a reference block is positioned at a position spaced apart by xd in a left horizontal direction based on (x0,y0), and when xd is a positive integer, it represents that a reference block is positioned at a position spaced apart by xd in a right horizontal direction based on (x0, y0). In addition, when yd is a negative integer, it represents that a reference block is positioned at a position spaced apart by yd in a top vertical direction based on (x0,y0), and when yd is a positive integer, it represents that a reference block is positioned at a position spaced apart by yd in a bottom vertical direction based on (x0,y0).

The sample value of a reference block may be set as the prediction sample value of a current chroma component block. In other words, a reference block may be called the prediction block of a current chroma component block.

Under a dual tree structure where the block partition structure of a luma component and a chroma component within the same CTU is independent, the prediction block of a current chroma component block (DUAL_TREE_CHROMA) encoded/decoded in an intra block copy mode may be derived as follows.

A prediction block for each sub-block may be derived by using a block vector derived in a sub-block unit within a current chroma component block.

In this case, a block indicated by the block vector of a sub-block within a current chroma component block (i.e., a reference block) may be called a prediction sub-block.

For example, it is assumed that the top-left sample position of a sub-block within a current chroma component block is (sx0, sy0), a width is SWc and a height is SHc. When the block vector of a sub-block in a current chroma component block is (Sxd, Syd), a reference block in the same size as a current sub-block (i.e., a block in the size of SWc×SHc) where a sample position (sx0+Sxd, sy0+Syd) spaced apart by (Sxd, Syd) from the top-left sample position of a current sub-block in the same picture is set as a top-left sample position may be set as a prediction sub-block.

The sample value of a prediction sub-block may be set as the prediction sample value of a sub-block in a current chroma component block. In addition, a prediction sub-block may be referred to as the prediction block of a sub-block in a current chroma component block.

Sub-block prediction blocks for sub-blocks included in a current chroma component block may be configured with prediction blocks of a current chroma component block.

Meanwhile, the prediction block of a current block may also be obtained by combining an intra block copy mode and another prediction mode. As an example, the final prediction block of a current block may be derived through the weighted sum of a first prediction block obtained based on an intra block copy mode and a second prediction block obtained based on a second prediction mode. Here, a second prediction mode may be intra prediction or inter prediction.

Meanwhile, when a second prediction mode is intra prediction, a predefined intra prediction mode may be used to obtain a second prediction block. Here, a predefined prediction mode may be a planar, a DC, a vertical mode, a horizontal mode, a top-left diagonal mode, a top-right diagonal mode or a bottom-left diagonal mode.

Alternatively, when a second prediction mode is intra prediction, an intra prediction mode for deriving a second prediction block may be selected from a MPM list.

Meanwhile, a weight applied to a first prediction block and a second prediction block may be determined differently depending on whether an intra block copy mode is an intra block copy merge mode or an intra block copy AMVP mode. As an example, a weight applied to a first prediction block may be set as a larger value when an intra block copy merge mode is applied compared to when an intra block copy AMVP mode is applied.

As another example, an intra block copy mode and geometric partition prediction may be combined to obtain a prediction block. As an example, after a current block is partitioned into two partitions, the block vector candidate of each of the two partitions may be selected from a block vector candidate list.

Afterwards, a first prediction block may be derived based on the first block vector candidate of a first partition, and a second prediction block may be derived based on the second block vector candidate of a second partition. Afterwards, the final prediction block of a current block may be derived through the weighted sum of a first prediction block and a second prediction block.

Alternatively, after a current block is partitioned into two partitions, an intra block copy mode may be applied to a first partition of the two partitions and a different prediction mode may be applied to a second partition. A prediction mode applied to a second partition may be inter prediction or intra prediction.

Meanwhile, geometric partition prediction may be applied to a current block when an intra block copy merge mode is applied to a current block or when a template matching-based intra block copy merge mode is applied to a current block.

As another example, an intra block copy merge mode and an intra block copy AMVP mode may be applied to a current block simultaneously. Specifically, under an intra block copy merge mode, a first block vector for a current block may be derived to obtain a first prediction block for a current block. In addition, under an intra block copy AMVP mode, a second block vector for a current block may be derived to obtain a second prediction block for a current block. Afterwards, based on the average or weighted sum operation of a first prediction block and a second prediction block, the final prediction block of a current block may be derived.

### [E3/D3] A Step for Deriving a Residual Block;

When a residual block exists, generally in an encoding process, at least one of transform and quantization may be performed on a residual block and a transformed and quantized residual block may be entropy encoded. In a decoding process, coefficients in a residual block may be entropy decoded and at least one of dequantization and inverse transform may be performed to reconstruct a residual block. Here, a reconstructed residual block may refer to a residual block.

Identifier information representing whether residual block-related information which is entropy encoded/decoded (e.g., a quantized transform coefficient, a quantized level or a transform coefficient) exists may include at least one of the following.

cu_cbf

When a luma component and a chroma component have the same block partition structure, whether the quantized transform coefficient of a luma component block and the quantized transform coefficient of a chroma component block exist may be determined by the cu_cbf.

When a luma component and a chroma component have an independent block partition structure, the cu_cbf may represent whether the quantized transform coefficient of a luma component block exists or whether the quantized transform coefficient of a chroma component block exists.

When information representing whether a quantized transform coefficient exists in a residual block is a first value (e.g., 1), it may mean that a quantized transform coefficient exists for the residual block of a corresponding block. When the information is a second value (e.g., 0), it may mean that a quantized transform coefficient does not exist for the residual block of a corresponding block.

When a luma component and a chroma component have the same block partition structure and when a quantized transform coefficient exists in a residual block for at least one of a luma component block and a chroma component (Cb and Cr) block, the information may have a first value. On the other hand, when a quantized transform coefficient does not exist in a residual block for all components, the information may have a second value.

tu_cbf_luma

u_cbf_luma may represent whether a quantized transform coefficient exists in the residual block of a luma component block.

When information on whether a quantized transform coefficient exists in the residual block of a luma component block is a first value (e.g., 1), it may mean that a quantized transform coefficient exists in the residual block of a corresponding luma component block.

When information on whether a quantized transform coefficient exists in the residual block of a luma component block is a second value (e.g., 0), it may mean that a quantized transform coefficient does not exist in the residual block of a corresponding luma component block.

tu_cbf_cr, tu_cbf_cb

tu_cbf_cr represents whether a quantized transform coefficient exists in the residual block of a chroma component Cr, and tu_cbf_cb represents whether a quantized transform coefficient exists in the residual block of a chroma component Cb.

When information on whether a quantized transform coefficient exists in the residual block of a chroma component (Cr or Cb) block is a first value (e.g., 1), it may mean that a quantized transform coefficient exists in the residual block of a corresponding chroma component (Cr or Cb) block.

When information on whether a quantized transform coefficient exists in the residual block of a chroma component (Cr or Cb) block is a second value (e.g., 0), it may mean that a quantized transform coefficient does not exist in the residual block of a corresponding chroma component (Cr or Cb) block.

In the embodiment and/or other embodiments of the present disclosure, a quantized transform coefficient may refer to at least one of a quantized level or transform coefficient. In addition, a quantized transform coefficient may refer to a quantized transform coefficient having a non-zero value. A residual block may include a quantized transform coefficient. In other words, when a quantized transform coefficient does not exist in a residual block, it represents that the value of all coefficients in a residual block is 0.

At least one of tu_cbf_luma, tu_cbf_cr or tu_cbf_cb may be additionally signaled only when cu_cbf is a first value. Based on tu_cbf_luma, tu_cbf_cr and tu_cbf_cb, whether a quantized transform coefficient exists in the residual block of a luma component, a chroma component Cr and a chroma component Cb may be determined.

When a luma component and a chroma component have an independent block partition structure, cu_cbf may be the same information as tu_cbf luma.

Let's assume that it is a single tree type (SINGLE_TREE) where the block partition structure of a luma component and a chroma component in a current encoding target CTU is the same. When an intra block copy skip mode is applied to a current luma component block, the residual block of a current luma component block and a current chroma component block may be derived as follows.

When an intra block copy skip mode is applied to a current luma component block, as in a skip mode in inter prediction, a residual block for a current luma component block may not exist. In this case, a residual block may be set as a value of ‘0’.

In the embodiment and/or other embodiments of the present disclosure, when a residual block is set to have a value of ‘0’, it may mean that the value of all quantized transform coefficients in a residual block is set as 0 or that the value of all residual coefficients in a residual block is set as 0 or that all residual samples in a residual block are set as a value of 0.

When an intra block copy skip mode is applied to a luma component block corresponding to a current chroma component block, a residual block may not exist for a current chroma component block, similarly to a luma component block. In this case, the residual block of a current chroma component block may be set to have a value of ‘0’.

When an intra block copy skip mode is applied, information identifying whether a residual block exists (e.g., an identifier, a flag or an index (e.g., at least one of cu_cbf, tu_cbf_luma, tu_cbf_cr or tu_cbf_cb)) may not be signaled.

For example, encoding/decoding of cu_cbf indicating whether all quantized transform coefficients exist in the residual block of a luma component, a chroma component Cr and a chroma component Cb may be omitted. In this case, in an encoding/decoding process, the value of the cu_cbf may be inferred (set) as a second value indicating that all quantized transform coefficients do not exist in the residual block of a luma component, a chroma component Cr and a chroma component Cb.

In addition, encoding/decoding of tu_cbf_luma indicating whether a quantized transform coefficient exists in the residual block of a luma component, tu_cbf_cr indicating whether a quantized transform coefficient exists in the residual block of a chroma component Cr and tu_cbf_cb indicating whether a quantized transform coefficient exists in the residual block of a chroma component Cb may also be omitted. Syntaxes where the encoding/decoding is omitted may be derived (set) as a second value in an encoding/decoding process. In other words, each syntax may be inferred (set) as a value indicating that a quantized transform coefficient does not exist in a residual block for a corresponding component block.

Let's assume that under a single tree typ (SINGLE_TREE) where the block partition structure of a luma component and a chroma component in a current encoding target CTU is the same, an intra block copy merge mode is applied to a current luma comopnent block. In this case, the residual block of a current luma component block and a chroma component block may be derived as follows.

When an intra block copy merge mode is applied to a current luma component block, a residual block may always exist for a current luma component block. In this case, transform and/or quantization may be performed on a residual block in an encoding process, and a quantized transform coefficient may be encoded and signaled. In a decoding process, dequantization and/or inverse transform may be performed on a quantized transform coefficient to derive a residual block.

When an intra block copy merge mode is applied to a luma component block corresponding to a current chroma component block, a residual block may also exist for a current chroma component block. In this case, transform and/or quantization may be performed on a residual block in an encoding process, and a quantized transform coefficient may be encoded and signaled. In a decoding process, dequantization and/or inverse transform may be performed on a quantized transform coefficient to derive a residual block.

When an intra block copy merge mode is applied, information identifying whether a residual block exists (e.g., an identifier, a flag or an index (e.g., cu_cbf)) may not be signaled. In other words, when an intra block copy merge mode is applied, a residual block always exists, so encoding/decoding of cu_cbf may be omitted and the value of cu_cbf may be inferred (set) as a first value in a decoding process. In other words, the value of cu_cbf may infer that a quantized transform coefficient exists in the residual block of at least one of a luma component, a chroma component Cr or a chroma component Cb. Information identifying whether a residual block exists may not be signaled, and quantized transform coefficient information of a residual block may be encoded and signaled.

However, when an intra block copy merge mode is applied, there may be a case in which a quantized transform coefficient does not exist in the residual block of at least one of a luma component, a chroma component Cr or a chroma component Cb. Accordingly, identifiers representing whether a quantized transform coefficient exists in a residual block for each component (e.g., tu_cbf_luma for a luma component, tu_cbf_cr and tu_cbf_cb for a chroma component) may be encoded and signaled.

Let's assume that under a single tree typ (SINGLE_TREE) where the block partition structure of a luma component and a chroma component in a current encoding target CTU is the same, an intra block copy AMVP mode is applied to a current luma comopnent block. In this case, the residual block of a current luma component block and a chroma component block may be derived as follows.

When an intra block copy AMVP mode is applied to a current luma component block, the residual block of a current luma component block may exist or may not exist. Accordingly, information identifying whether a residual block exists may always be encoded and signaled.

When the residual block of a current luma component block exists, transform and/or quantization may be performed on a residual block in an encoding process. Afterwards, a quantized transform coefficient may be encoded and signaled. In a decoding process, dequantization and/or inverse transform may be performed on a quantized transform coefficient to derive a residual block.

When the residual block of a current luma component block does not exist, a residual block may be set as a value of 0.

When an intra block copy AMVP mode is applied to a luma component block corresponding to a current chroma component block, a residual block may or may not exist in a current chroma component block in the same way as in a luma component block. When the residual block of a current chroma component block exists, transform and/or quantization may be performed on a residual block in an encoding process. Afterwards, a quantized transform coefficient may be encoded and signaled. In a decoding process, a quantized transform coefficient may be dequantized and/or inversely transformed to derive a residual block. On the other hand, when a residual block does not exist, a residual block may be set as a value of 0.

As described above, when an intra block copy AMVP mode is applied, a quantized transform coefficient may or may not exist in a residual block for each of a luma component, a chroma component Cr and a chroma component Cb. Accordingly, information identifying whether a residual block exists which indicates whether a quantized transform coefficient exists in the residual block of at least one of a luma component, a chroma component Cr or a chroma component Cb (e.g., an identifier, a flag or an index (e.g., cu_cbf)) may always be encoded and signaled.

In addition, when information identifying whether the residual block exists has a first value representing that a residual block exists, there may be a case where at least one of a luma component, a chroma component Cr or a chroma component Cb has a quantized transform coefficient in a residual block, while the other does not have a quantized transform coefficient in a residual block. Accordingly, when the information identifying whether a residual block exists is a first value, an identifier representing whether a quantized transform coefficient exists in a residual block (e.g., tu_cbf_luma for a luma component, tu_cbf_cr and tu_cbf_cb for a chroma component) may be encoded and signaled for each component.

Under a dual tree structure where the block partition structure of a luma component and a chroma component in a current encoding target CTU is independent, when an intra block copy skip mode is applied to a current luma component block (DUAL_TREE_LUMA), the residual block of a current luma component block may not exist, as in a skip mode in an inter prediction mode. In this case, the residual block of a current luma component block may be set to have a value of ‘0’. In addition, information identifying whether a residual block exists (e.g., an identifier, a flag or an index (e.g., at least one of cu_cbf or tu_cbf_luma)) may not be signaled.

Under an independent partition structure, when an intra block copy skip mode is applied to a luma component block, cu_cbf signaled for a luma component block may indicate whether a quantized transform coefficient exists in the residual block of a luma component block. When an intra block copy skip mode is applied to a luma component block, a quantized transform coefficient does not always exist in the residual block of a luma component block, so cu_cbf is not signaled and may be inferred (set) as a second value (e.g., ‘0’) in a decoding process.

In addition, identification information indicating whether the residual block of a luma component exists (e.g., tu_cbf_luma) is also not signaled and may be inferred (set) as a second value (e.g., ‘0’) in a decoding process.

When the block partition structure of a luma component and a chroma component in a current encoding target CTU is an independent dual tree structure and an intra block copy merge mode is applied to a current luma component block (DUAL_TREE_LUMA), the residual block of a current luma component block may always exist, as in a merge mode in inter prediction. In this case, transform and/or quantization may be performed on a residual block in an encoding process. Afterwards, a quantized transform coefficient may be encoded and signaled. In a decoding process, a quantized transform coefficient may be dequantized and/or inversely transformed to derive a residual block.

Under an independent partition structure, when an intra block copy merge mode is applied to a luma component block, cu_cbf signaled for a luma component block may indicate only whether a quantized transform coefficient exists in the residual block of a luma component block. When an intra block copy merge mode is applied to a luma component block, a quantized transform coefficient always exists in the residual block of a luma component block, so the value of cu_cbf may be inferred (set) as a first value (e.g., ‘1’) in a decoding process without signaling cu_cbf.

Meanwhile, under an independent partition structure, identification information indicating whether the residual block of a luma component exists (e.g., tu_cbf_luma) has the same meaning/value as cu_cbf signaled for a luma component block. Accordingly, the value of tu_cbf_luma may be inferred (set) as a first value (e.g., ‘1’) in a decoding process without signaling tu_cbf_luma.

When the block partition structure of a luma component and a chroma component in a current encoding target CTU is an independent dual tree structure and an intra block copy AMVP mode is applied to a current luma component block (DUAL_TREE_LUMA), the residual block of a current luma component block may exist or may not exist, as in an AMVPO mode in inter prediction. When a residual block exists, transform and/or quantization may be performed on a residual block in an encoding process. Afterwards, a quantized transform coefficient may be encoded and signaled. In a decoding process, a quantized transform coefficient may be dequantized and/or inversely transformed to derive a residual block. When a residual block does not exist, a residual block may be set as a value of 0.

Under an independent partition structure, when an intra block copy AMVP mode is applied to a luma component block, cu_cbf signaled for a luma component block may indicate only whether a quantized transform coefficient exists in the residual block of a luma component block. In this case, a quantized transform coefficient may exist or may not exist in the residual block of a corresponding luma component block. Accordingly, when an intra block copy AMVP mode is applied to a luma component block, cu_cbf for a luma component block may always be encoded and signaled.

Meanwhile, under an independent partition structure, identification information indicating whether the residual block of a luma component exists (e.g., tu_cbf_luma) has the same meaning/value as cu_cbf signaled for a luma component block. Accordingly, it may be inferred (set) as the same value as cu_cbf in a decoding process without signaling tu_cbf_luma.

Whether a residual block exists may be set according to the value of cu_cbf or tu_cbf luma. For example, when the value of at least one of cu_cbf or tu_cbf luma has a first value, it may be determined that a residual block exists.

When the block partition structure of a luma component and a chroma component in the same CTU is an independent dual tree structure and an intra block copy mode is applied to a current chroma component block (DUAL_TREE_CHROMA), the residual block of a current chroma component block may be derived as follows.

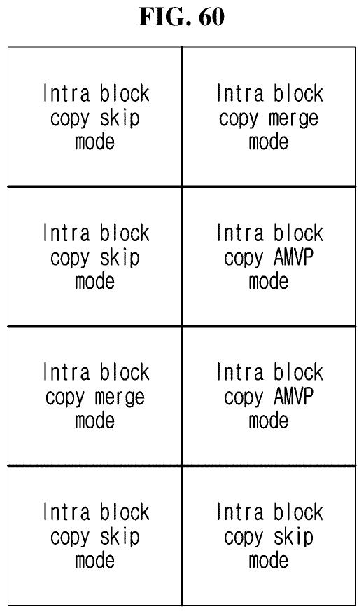

FIGS. 59 and 60 are a drawing for describing an embodiment in which the residual block of a current chroma component block is derived.

There may be a case where all sub-blocks in a current chroma component block and sub-blocks included in a luma component block corresponding to a current chroma component block are encoded/decoded in an intra block copy mode or have the same intra block copy mode. Here, an intra block copy mode may be an intra block copy skip mode, an intra block copy merge mode or an intra block copy AMVP mode.

As an example, as in an example shown in FIG. 59, there may be a case where all sub-blocks in a current chroma component block and sub-blocks in a luma component block corresponding thereto are encoded in an intra block copy skip mode. Alternatively, unlike an example shown in FIG. 59, there may be a case where all sub-blocks in a current chroma component block and sub-blocks in a luma component block corresponding thereto are encoded/decoded in an intra block copy merge mode.

When all sub-blocks in a luma component block corresponding to a current chroma component block have the same intra block copy mode, whether to encode/decode a residual block for a corresponding chroma component block may be determined based on the intra block copy mode of a corresponding luma component block.

As an example, when all sub-blocks included in a corresponding luma component block are encoded/decoded in an intra block copy skip mode, a residual block may not exist for a chroma component block, just as in a case where a luma component block is an intra block copy skip mode. Accordingly, a residual block may not be encoded/decoded for a chroma component block and residual block information may not be signaled. The residual block of a current chroma component block may be set as a value of “0”.

In this case, information identifying whether the residual block of a chroma component block exists (e.g., an identifier or a flag (e.g., at least one of cu_cbf, tu_cbf_cr or tu_cbf_cb)) may not be signaled. When information identifying whether a residual block exists has a first value, it may represent that the residual block of a chroma component block exists. On the other hand, when information identifying whether a residual block exists has a second value, it may represent that the residual block of a chroma component block does not exist. When an intra block copy skip mode is applied to a chroma component block, encoding/decoding of information identifying whether a residual block exists may be omitted, and the value of information identifying whether a residual block exists may always be inferred (set) as a second value in a decoding process.

As an example, when all sub-blocks included in a corresponding luma component block are encoded/decoded in an intra block copy merge mode, a residual block may always exist for a chroma component block, just as in a case where a luma component block is an intra block copy merge mode. Accordingly, in an encoding process, transforma and/or quantization may be performed on the residual block of a chroma component block, and a quantized transform coefficient may be encoded and signaled. In a decoding process, a quantized transform coefficient may be dequantized and/or inversely transformed to derive a residual block.

Under an independent partition structure, information identifying whether there is a residual block signaled for a chroma component block (e.g., an identifier or a flag (e.g., cu_cbf)) may indicate whether there is a quantized transform coefficient in the residual block of at least one of the chroma component Cb or chroma component Cr blocks.

Accordingly, when all sub-blocks included in a corresponding luma component block are encoded/decoded in an intra block copy merge mode, information identifying whether there is a residual block (e.g., an identifier or a flag or an index (e.g., cu_cbf)) may not be signaled. In other words, in a merge mode, since a residual block always exists, encoding/decoding of the information may be omitted, and the value of the information (cu_cbf) may always be inferred (set) as 1 in a decoding process. In other words, in a decoding process, the value of cu_cbf may be inferred as a value indicating that a quantized transform coefficient exists in the residual block of at least one of a chroma component Cr or a chroma component Cb.

However, even when all sub-blocks included in a corresponding luma component block are encoded/decoded in an intra block copy merge mode, there may be a component where a quantized transform coefficient does not exist in the residual block of a chroma component Cr or a chroma component Cb. Accordingly, an identifier (e.g., tu_cbf_cr and tu_cbf_cb) representing whether a quantized transform coefficient exists in a residual block for each chroma component may be encoded and signaled.

As an example, when all sub-blocks included in a corresponding luma component block are encoded/decoded in an intra block copy AMVP mode, a residual block may or may not exist for a chroma component block, just as in a case where a luma component block is an intra block copy AMVP mode. Accordingly, information identifying whether a residual block exists for a chroma component block may always be signaled. When the residual block of a chroma component block exists, transform and/or quantization may be performed on a residual block in an encoding process, and a quantized transform coefficient may be encoded and signaled. In a decoding process, a quantized transform coefficient may be dequantized and/or inversely transformed to derive a residual block. On the other hand, when the residual block of a chroma component block does not exist, a residual block may be set as a value of “0”.

Under an independent partition structure, information identifying whether there is a residual block signaled for a chroma component block (e.g., an identifier or a flag (e.g., cu_cbf)) may indicate whether there is a quantized transform coefficient in the residual block of at least one of the chroma component Cb or chroma component Cr blocks.

When all sub-blocks included in a corresponding luma component block are encoded/decoded in an intra block copy AMVP mode, a quantized transform coefficient may exist or may not exist in the residual block of at least one of a chroma component Cr block or a chroma component Cb block. Accordingly, information identifying whether a quantized transform coefficient exists in the residual block of at least one of a chroma component Cr or a chroma component Cb (e.g., an identifier or a flag or an index (e.g., cu_cbf)) may always be encoded and signaled.

Even when the information identifying whether a residual block exists (e.g., an identifier or a flag or an index or cu_cbf) has a first value representing that a residual block exists, a quantized transform coefficient may exist or may not exist in the residual block of one of a chroma component Cr or a chroma component Cb. Accordingly, for each chroma component, an identifier (e.g., tu_cbf_cr and tu_cbf_cb) representing whether a quantized transform coefficient exists in a residual block may be encoded and signaled.

When an identifier (e.g., tu_cbf_cr) representing that a quantized transform coefficient exists in the residual block of a chroma component Cr has a first value, information about a quantized transform coefficient in a residual block for a Cr component may be signaled. When an identifier (e.g., tu_cbf_cr) representing that a quantized transform coefficient exists in the residual block of a chroma component Cb has a first value, information about a quantized transform coefficient in a residual block for a Cb component may be signaled.

As another example, even when sub-blocks in a corresponding luma component block are encoded/decoded in the same intra block copy mode (e.g., an intra block copy skip mode, an intra block copy merge mode or an intra block copy AMVP mode), this does not mean that all samples included in a luma component block are encoded/decoded in the same intra block copy mode. For example, when a sub-block is occupied by two luma component prediction blocks, some samples in a sub-block may be encoded/decoded in a different intra block copy mode or a prediction mode other than an intra block copy mode. Accordingly, it may not be efficient to encode/decode the residual block of a chroma component block by considering the mode of a luma component block corresponding to a chroma component block.

Considering the problem, when an intra block copy mode is applied to a chroma component block, regardless of the encoding mode of sub-blocks within a corresponding luma component block, information identifying whether there is residual block indicating whether there is a quantized transform coefficient in the residual block of at least one of a chroma component Cr and a chroma component Cb (e.g., an identifier, a flag or an index (e.g., cu_cbf)) may always be encoded and signaled.

In addition, when the information identifying whether there is a residual block (e.g., an identifier, a flag, an index or cu_cbf) has a first value representing that there is a residual block, for each chroma component, an identifier representing whether there is a quantized transform coefficient in a residual block (e.g., tu_cbf_cr and tu_cbf_cb) may be encoded and signaled.

When an identifier (e.g., tu_cbf_cr) representing that a quantized transform coefficient exists in the residual block of a chroma component Cr has a first value, quantized transform coefficient information in a residual block for a Cr component may be signaled. When an identifier (e.g., tu_cbf_cr) representing that a quantized transform coefficient exists in the residual block of a chroma component Cb has a first value, quantized transform coefficient information in a residual block for a Cb component may be signaled.

When quantized transform coefficient information in a residual block is signaled, a quantized transform coefficient may be dequantized and/or inversely transformed to derive a residual block in a decoding process. When there is no residual block of a chroma component block, quantized transform coefficient information in the residual block of a chroma component block may not be signaled, and the residual block of a chroma component may be set to have a value of “0”.

When an intra block copy mode is applied to a current chroma component block or when all sub-blocks included in a luma component block corresponding to a current chroma component block are encoded/decoded in an intra block copy mode, there may be a case where the intra block copy mode (e.g., an intra block copy skip mode, an intra block copy merge mode, an intra block copy AMVP mode) of sub-blocks in a luma component block corresponding to a chroma component block is different.

As an example, as in an example shown in FIG. 60, some sub-blocks in a luma component block may be encoded/decoded in an intra block copy skip mode, other sub-blocks may be encoded/decoded in an intra block copy merge mode and the remaining sub-blocks may be encoded/decoded in an intra block copy AMVP mode.

In this way, when the intra block copy mode of sub-blocks in a luma component block is not the same, regardless of an intra block copy mode applied to sub-blocks in a luma component block, information identifying whether there is a residual block indicating whether there is a quantized transform coefficient in the residual block of at least one of a chroma component Cr or a chroma component Cb (e.g., an identifier or a flag or an index (e.g., cu_cbf)) may always be encoded and signaled.

In addition, when the information identifying whether there is a residual block (e.g., an identifier, a flag, an index or cu_cbf) has a first value representing that there is a residual block, for each chroma component, an identifier representing whether there is a quantized transform coefficient in a residual block (e.g., tu_cbf_cr and tu_cbf_cb) may be encoded and signaled.

When an identifier (e.g., tu_cbf_cr) representing that a quantized transform coefficient exists in the residual block of a chroma component Cr has a first value, quantized transform coefficient information in a residual block for a Cr component may be signaled. When an identifier (e.g., tu_cbf_cr) representing that a quantized transform coefficient exists in the residual block of a chroma component Cb has a first value, quantized transform coefficient information in a residual block for a Cb component may be signaled.

When quantized transform coefficient information in a residual block is signaled, a quantized transform coefficient may be dequantized and/or inversely transformed to derive a residual block in a decoding process. When there is no residual block of a chroma component block, quantized transform coefficient information in the residual block of a chroma component block may not be signaled, and the residual block of a chroma component may be set to have a value of “0”.

### [E4/D4] A Step for Configuring a Reconstructed Block;

The reconstructed block of a current luma component block may be derived by adding the residual block of a luma component block to the prediction block of a luma component block.

When a luma component residual block does not exist, a luma component prediction block may be set as a luma component reconstructed block.

The reconstructed block of a current chroma component (Cb or Cr) block may be derived by adding the residual block of a chroma component (Cb or Cr) block to the prediction block of a chroma component (Cb or Cr) block.

When a chroma component (Cb or Cr) residual block does not exist, a chroma component (Cb or Cr) prediction block may be set as a chroma component (Cb or Cr) reconstructed block.

### [E5/D5] A Step for Entropy Encoding/Decoding Intra Block Copy-Related Encoding Information;

Intra block copy-related encoding information may be entropy encoded into a bitstream or may be entropy decoded from a bitstream. Here, intra block copy-related encoding information may include at least one of the following information.
cu_skip_flag representing whether a skip mode is used,
merge_flag representing whether a merge mode is used,
merge_idx (merge index) indicating a merge candidate,
pred_mode_flag representing whether a prediction mode is an intra prediction mode
pre_mode_ibc_flag representing whether a prediction mode is an inter prediction mode or an intra block copy mode,
block vector candidate index (mvp_l0_flag),
block vector difference,
cu_cbf, tu_cbf_luma, tu_cbf_cb, tu_cbf_cr representing whether a quantized transform coefficient exists in a residual block

The cu_skip_flag may mean information on whether a skip mode is used, and may be entropy encoded/decoded in at least one unit of an encoding block and a prediction block. For example, information on whether to use a skip mode may indicate the use of a skip mode when it has a first value of 1, and may not indicate the use of a skip mode when it has a second value of 0. In this case, cu_skip_flag may indicate the use of an intra block copy skip mode.

The merge_flag may mean information on whether to use a merge mode, and may be entropy encoded/decoded in at least one unit of an encoding block and a prediction block. For example, information on whether to use a merge mode may indicate the use of a merge mode when it has a first value of 1, and may not indicate the use of a merge mode when it has a second value of 0. In this case, merge_flag may indicate the use of an intra block copy merge mode.

The merge_idx may mean information indicating a merge candidate in a merge candidate list, and may be entropy encoded/decoded in at least one unit of an encoding block and a prediction block. In addition, merge_idx may mean merge index information. In addition, merge_idx may indicate a block from which a merge candidate is derived among the blocks reconstructed to be spatially adjacent to a current block. In addition, merge_idx may indicate at least one of the motion information that a merge candidate has. For example, merge index information may indicate a first merge candidate in a merge candidate list when it has a first value of 0, indicate a second merge candidate in a merge candidate list when it has a second value of 1, and indicate a third merge candidate in a merge candidate list when it has a third value of 2. Similarly, when it has a fourth to N-th value, it may indicate a merge candidate corresponding to a value according to the order in a merge candidate list. Here, N may be a positive integer including 0. In this case, merge_idx may indicate a merge index when using an intra block copy merge mode. In other words, the merge candidate list may mean a block vector candidate list, and a merge candidate may mean a block vector candidate.

The pred_mode_flag may mean information on whether to apply an intra prediction mode, and may be entropy encoded/decoded in at least one unit of an encoding block, a prediction block or an encoding unit. For example, information on whether to apply an intra prediction mode may indicate that an intra prediction mode is applied when it has a first value of 1, and may indicate that an intra prediction mode is not applied when it has a second value of 0.

The pred_mode_ibc_flag may mean information on whether to apply an intra block copy mode, and may be entropy encoded/decoded in at least one unit of an encoding block, a prediction block or an encoding unit. For example, information on whether to apply an intra block copy mode may indicate that an intra block copy mode is applied when it has a first value of 1, and may indicate that an inter prediction mode is applied when it has a second value of 0.

The block vector candidate index (mvp_l0_flag) may indicate a prediction block vector used by a current block in the prediction block vector candidate list of an intra block copy AMVP mode, and for this purpose, a block vector candidate index may be entropy encoded/decoded. A current block may derive the prediction block of a current block by using the block vector candidate index and a prediction block vector candidate list. In this case, a block vector candidate index may mean a L0 block vector prediction flag.

The block vector difference may mean a difference between a block vector and a predicted block vector in an intra block copy AMVP mode, and a block vector difference may be entropy encoded/decoded for a current block. A current block may derive the prediction block of a current block by using the block vector difference.

Among cu_cbf, tu_cbf_luma, tu_cbf_cb and tu_cbf_cr representing whether there is a quantized transform coefficient in the residual block, cu_cbf may mean information on whether the quantized transform coefficient of a luma component block exists and whether the quantized transform coefficient of a chroma component block exists when a luma component and a chroma component have the same block partition structure, and may mean information on whether the quantized transform coefficient of a luma component block or a chroma component block exists when a luma component and a chroma component have an independent block partition structure. Information on whether a quantized transform coefficient exists may mean that the quantized transform coefficient of corresponding blocks exists when it has a first value of 1, and may mean that the quantized transform coefficient of corresponding blocks does not exist when it has a second value of 0. tu_cbf_luma may mean whether the quantized transform coefficient of a luma component block exists, and tu_cbf_cr and tu_cbf_cb may mean whether the quantized transform coefficient of chroma components Cr and Cb exists, respectively. Information on whether the quantized transform coefficient of a luma component block exists may mean that the quantized transform coefficient of a corresponding luma component block exists when it has a first value of 1, and may mean that the quantized transform coefficient of a corresponding luma component block does not exist when it has a second value of 0. Information on whether the quantized transform coefficient of a chroma component (Cb, Cr) exists may mean that the quantized transform coefficient of a corresponding chroma component block exists when it has a first value of 1, and may mean that the quantized transform coefficient of a corresponding chroma component block does not exist when it has a second value of 0.

At least one of the intra block copy-related encoding information may be entropy encoded/decoded in at least one of a parameter set, a header, a brick, a CTU, a CU, a PU, a TU, a CB, a PB or a TB.

In this case, at least one of a parameter set, a header, a brick, a CTU, a CU, a PU, a TU, a CB, a PB or a TB may be at least one of a video parameter set, a decoding parameter set, a sequence parameter set, an adaptation parameter set, a picture parameter set, a picture header, a sub-picture header, a slice header, a tile group header, a tile header, a brick, a coding tree unit (CTU), a coding unit (CU), a prediction unit (PU), a transform unit (TU), a coding block (CB), a prediction block (PB) or a transform block (TB).

Here, prediction using an intra block copy mode may be performed by using the intra block copy-related encoding information in at least one of the signaled parameter set, header, brick, CTU, CU, PU, TU, CB, PB, or TB unit.

For example, when at least one of the intra block copy-related encoding information is entropy encoded/decoded in a sequence parameter set, prediction using an intra block copy mode may be performed by using at least one of the intra block copy-related encoding information having the same syntax element value in a sequence unit.

As another example, when at least one of the intra block copy-related encoding information is entropy encoded/decoded in a slice header, prediction using an intra block copy mode may be performed by using at least one of the intra block copy-related encoding information having the same syntax element value in a sequence unit.

As another example, when at least one of the intra block copy-related encoding information is entropy encoded/decoded in an adaptation parameter set, prediction using an intra block copy mode may be performed by using at least one of the intra block copy-related encoding information having the same syntax element value in a unit that refers to the same adaptation parameter set.

As another example, when at least one of the intra block copy-related encoding information is entropy encoded/decoded in a CU, prediction using an intra block copy mode may be performed by using at least one of the intra block copy-related encoding information having the same syntax element value in the same CU unit.

As another example, when at least one of the intra block copy-related encoding information is entropy encoded/decoded in a CB, prediction using an intra block copy mode may be performed by using at least one of the intra block copy-related encoding information having the same syntax element value in the same CB unit.

As another example, when at least one of the intra block copy-related encoding information is entropy encoded/decoded in a PU, prediction using an intra block copy mode may be performed by using at least one of the intra block copy-related encoding information having the same syntax element value in the same PU unit.

As another example, when at least one of the intra block copy-related encoding information is entropy encoded/decoded in a PB, prediction using an intra block copy mode may be performed by using at least one of the intra block copy-related encoding information having the same syntax element value in the same PB unit.

As another example, when at least one of the intra block copy-related encoding information is entropy encoded/decoded in a TU, prediction using an intra block copy mode may be performed by using at least one of the intra block copy-related encoding information having the same syntax element value in the same TU unit.

As another example, when at least one of the intra block copy-related encoding information is entropy encoded/decoded in a TB, prediction using an intra block copy mode may be performed by using at least one of the intra block copy-related encoding information having the same syntax element value in the same TB unit.

Here, at least one of the intra block copy-related encoding information may be derived according to at least one of the encoding parameters of a current block/a CTB/a CTU.

When at least one of the intra block copy-related encoding information does not exist in a bitstream, at least one of the intra block copy-related encoding information may be inferred as a first value (e.g., 0).

An adaptation parameter set may mean a parameter set that may be shared by being referenced by a different picture, sub-picture, slice, tile group, tile or brick. In addition, a sub-picture, a slice, a tile group, a tile or a brick in a picture may refer to a different adaptation parameter set to use information in an adaptation parameter set.

In addition, an adaptation parameter set may use the identifier of a different adaptation parameter set to refer to a different adaptation parameter set in a sub-picture, a slice, a tile group, a tile or a brick in a picture.

In addition, an adaptation parameter set may use the identifier of a different adaptation parameter set to refer to a different adaptation parameter set in a slice, a tile group, a tile or a brick in a sub-picture.

In addition, an adaptation parameter set may use the identifier of a different adaptation parameter set to refer to a different adaptation parameter set in a tile or a brick in a slice.

In addition, an adaptation parameter set may use the identifier of a different adaptation parameter set to refer to a different adaptation parameter set in a brick in a tile.

By including information on an adaptation parameter set identifier in the parameter set or header of the sub-picture, an adaptation parameter set corresponding to a corresponding adaptation parameter set identifier may used in a sub-picture.

By including information on an adaptation parameter set identifier in the parameter set or header of the tile, an adaptation parameter set corresponding to a corresponding adaptation parameter set identifier may used in a tile.

By including information on an adaptation parameter set identifier in the header of the brick, an adaptation parameter set corresponding to a corresponding adaptation parameter set identifier may used in a brick.

The picture may be partitioned into at least one tile row and at least one tile column.

The sub-picture may be partitioned into at least one tile row and at least one tile column in a picture. The sub-picture is a region having a rectangular/square shape in a picture, and may include at least one CTU. In addition, one sub-picture may include at least one tile/brick/slice.

The tile is a region having a rectangular/square shape in a picture, and may include at least one CTU. In addition, a tile may be partitioned into at least one brick.

The brick may mean at least one CTU row in a tile. A tile may be partitioned into at least one brick, and each brick may have at least one CTU row. A tile that is not partitioned into at least two parts may also mean a brick.

The slice may include at least one tile in a picture, and may include at least one brick in a tile.

Tables 21 to 24 show encoding information signaled in relation to a block partition structure.

In particular, Tables 21 to 25 relate to a method for removing redundant signaling of cu_cbf and tu_cbf luma when a luma component block is predicted by using an intra block copy mode under an independent block partition structure.

TABLE 21

| | Descriptor |
|---|---|
| coding_unit( x0, y0, cbWidth, cbHeight, treeType ) { | |
| if( slice_type != I \| \| sps_ibc_enabled_flag ) { | |
| if( treeType != DUAL_TREE_CHROMA && | |
| !( cbWidth == 4 && cbHeight == 4 & & | |
| !sps_ibc_enabled_flag ) ) | |
| cu_skip_flag[ x0 ][ y0 ] | ae(v) |
| if( cu_skip_flag[ x0 ][ y0 ] == 0 && slice_type != I | |
| && !( cbWidth = = 4 && cbHeight = = 4) ) | |
| pred_mode_flag | ae(v) |
| if( ( ( slice_type = = I && cu_skip_flag[ x0 ][ y0 ] = = 0 | |
| ) | |
| ( slice_type != I && ( CuPredMode[ x0 ][ y0 ] != | |
| MODE_INTRA | |
| ( cbWidth == 4 && cbHeight == 4 && | |
| cu_skip_flag[ x0 ][ y0 ] == 0 ) ) ) ) && | |
| sps_ibc_enabled_flag && ( cbWidth != 128 \| \| | |
| cbHeight != 128 ) ) | |
| pred_mode_ibc_flag | ae(v) |
| } | |
| if( CuPredMode[ x0 ][ y0 ] = = MODE_INTRA ) { | |
| ... | |
| } else if( treeType != DUAL_TREE_CHROMA ) { /* | |
| MODE_INTER or MODE_IBC */ | |
| if( cu_skip_flag[ x0 ][ y0 ] = = 0) | |
| general_merge_flag[ x0 ][ y0 ] | ae(v) |
| if( general_merge_flag[ x0 ][ y0 ] ) { | |
| merge_data( x0, y0, cbWidth, cbHeight ) | |
| } else if ( CuPredMode[ x0 ][ y0 ] = = MODE_IBC ) { | |
| mvd_coding(x0, y0, 0, 0) | |
| mvp_l0_flag[ x0 ][ y0 ] | ae(v) |
| if( sps_amvr_enabled_flag && | |
| ( MvdL0[ x0 ][ y0 ][ 0 ] != 0 \| \| | |
| MvdL0[ x0 ][ y0 ][ 1 ] != 0 ) ) { | |
| amvr_precision_flag[ x0 ][ y0 ] | ae(v) |
| } | |
| } else if( treeType != DUAL_TREE_CHROMA ) { /* | |
| MODE_INTER or MODE_IBC */ | |
| ... | |
| } | |
| } | |
| if( !pcm_flag[ x0 ][ y0 ] ) { | |
| if( CuPredMode[ x0 ][ y0 ] != MODE_INTRA && | |
| merge_flag[ x0 ][ y0 ] = = 0) | |
| cu_cbf | ae(v) |
| if( cu_cbf ) { | |
| ... | |
| transform_tree( x0, y0, cbWidth, cbHeight, treeType ) | |
| } | |
| } | |
| } | |

TABLE 22

| | Descriptor |
|---|---|
| transform_unit( x0, y0, tbWidth, tbHeight, tree Type, sub TuIndex ) { | |
| if( treeType = = SINGLE_TREE \| \| treeType = = | |
| DUAL_TREE_LUMA ) { | |
| if( ( IntraSubPartitionsSplitType = = ISP_NO_SPLIT | |
| && !( cu_sbt_flag && ( ( subTuIndex == 0 && cu_sbt_pos_flag ) \| \| | |
| ( subTuIndex == 1 && !cu_sbt_pos_flag) ) ) ) \| \| ( | |
| IntraSubPartitionsSplitType != ISP_NO_SPLIT && | |
| ( sub TuIndex < Num IntraSubPartitions - 1 | |
| !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && | |
| !tu_cbf_luma[ x0 ][ y0 ] | |
| } | |
| if( ( treeType = = SINGLE_TREE \| \| treeType == | |
| DUAL_TREE_CHROMA ) { | |
| if( ( IntraSubPartitionsSplitType = = ISP_NO_SPLIT | |
| && !( cu_sbt_flag && ( ( subTuIndex == 0 && cu_sbt_pos_flag ) \| \| | |
| ( subTuIndex == 1 && !cu_sbt_pos_flag) ) ) ) \| \| ( | |
| IntraSubPartitionsSplitType != ISP_NO_SPLIT && | |
| ( subTuIndex = = Num IntraSubPartitions - 1) ) ) { | |
| tu_cbf_cb[ x0 ][ y0 ] | ae(v) |
| tu_cbf_cr[ x0 ][ y0 ] | ae(v) |
| } | |
| } | |
| ... | |
| if( tu_cbf_luma[ x0 ][ y0 ] ) | |
| residual_coding( x0, y0, Log2( tbWidth), Log2( tbHeight), 0) | |
| if( tu_cbf_cb[ x0 ][ y0 ] ) | |
| residual_coding( xC, yC, Log2(wC), Log2(hC), 1) | |
| if( tu_cbf_cr[ x0 ][ y0 ] ) | |
| residual_coding( xC, yC, Log2(wC), Log2(hC),2) | |
| } | |

TABLE 23

| | Descriptor |
|---|---|
| transform_unit( x0, y0, tb Width, tbHeight, treeType, subTuIndex ) { | |
| if( treeType = = SINGLE TREE \| \| ( treeType = = | |
| DUAL_TREE_LUMA && CuPredMode[x0][y0] = = MODE_INTRA)) { | |
| if( ( IntraSubPartitionsSplitType = = ISP_NO_SPLIT | |
| && !( cu_sbt_flag && ( ( subTuIndex = = 0 && cu_sbt_pos_flag ) \| \| | |
| ( subTuIndex == 1 && !cu_sbt_pos_flag) ) ) ) \| \| | |
| IntraSubPartitionsSplitType != ISP_NO_SPLIT && | |
| ( subTuIndex < Num IntraSubPartitions - 1 \| \| | |
| !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && | |
| !tu_cbf_luma[ x0 ][ y0 ] | |
| } | |
| if( ( treeType = = SINGLE_TREE \| \| treeType = = | |
| DUAL_TREE_CHROMA ) { | |
| if( ( IntraSubPartitionsSplitType = = ISP_NO_SPLIT | |
| && !( cu_sbt_flag && ( ( subTuIndex = = 0 && cu_sbt_pos_flag ) \| \| | |
| ( subTuIndex = = 1 && !cu_sbt_pos_flag) ) ) ) \| \| ( | |
| IntraSubPartitionsSplitType != ISP_NO_SPLIT && | |
| ( subTuIndex = = Num IntraSubPartitions - 1 ) ) ) { | |
| tu_cbf_cb[ x0 ][ y0 ] | ae(v) |
| tu_cbf_cr[ x0 ][ y0 ] | ae(v) |
| } | |
| } | |

As in an example of Tables 21 to 23, tu_cbf_luma may be signaled only when the prediction mode of a luma component block (i.e., treeType is DUAL_TREE_LUMA) is an intra prediction mode under an independent block partition structure (i.e., CuPredMode[x0][y0]==MODE_INTRA). By this, tu_cbf_luma may be set not to be signaled when the luma component block of an independent block partition structure is an intra block copy mode.

TABLE 24

| | Descriptor |
|---|---|
| transform_unit( x0, y0, tbWidth, tbHeight, treeType, sub TuIndex ) { | |
| if( treeType = = SINGLE_TREE \| \| ( tree Type = = | |
| DUAL_TREE_LUMA && !CuPredMode[x0][y0]= =MODE_IBC ) { | |
| if( ( IntraSubPartitionsSplitType = = ISP_NO SPLIT | |
| && !( cu_sbt_flag && ( ( subTuIndex == 0 && cu_sbt_pos_flag ) \| \| | |
| ( subTuIndex == 1 && !cu_sbt_pos_flag) ) ) ) \| \| ( | |
| IntraSubPartitionsSplitType != ISP_NO_SPLIT && | |
| ( sub TuIndex < NumIntraSubPartitions - 1 \| \| | |
| ! InferTuCbfLuma ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && | |
| !tu_cbf_luma[ x0 ][ y0 ] | |
| } | |
| if( ( treeType = = SINGLE_TREE treeType = = | |
| DUAL_TREE_CHROMA ) { | |
| if( ( IntraSubPartitionsSplitType = = ISP_NO_SPLIT | |
| && !( cu_sbt_flag && ( ( subTuIndex = = 0 && cu_sbt_pos_flag ) \| \| | |
| ( subTuIndex == 1 && !cu sbt_pos_flag) ) ) ) \| \| ( | |
| IntraSubPartitionsSplitType != ISP_NO_SPLIT && | |
| ( subTuIndex = = NumIntraSubPartitions - 1) ) ) { | |
| tu_cbf_cb[ x0 ][ y0 ] | ae(v) |
| tu_cbf_cr[ x0 ][ y0 ] | ae(v) |
| } | |
| } | |
| ... | |
| } | |

As in an example of Table 24, tu_cbf luma may be signaled only when the prediction mode of a luma component block (i.e., treeType is DUAL_TREE_LUMA) is not an intra block copy mode under an independent block partition structure (i.e., CuPredMode[x0][y0]==MODE_IBC). By this, tu_cbf_luma may be set not to be signaled when the luma component block of an independent block partition structure is an intra block copy mode.

TABLE 25

| | Descriptor |
|---|---|
| transform_unit( x0, y0, tbWidth, tbHeight, treeType, subTuIndex ) { | |
| if( ( treeType = = SINGLE_TREE \| \| tree Type = = | |
| DUAL_TREE_CHROMA ) { | |
| if( ( IntraSubPartitionsSplitType = = ISP_NO_SPLIT | |
| && !( cu_sbt_flag && ( ( subTuIndex == 0 && cu_sbt_pos_flag ) \| \| | |
| ( subTuIndex == 1 && !cu_sbt_pos_flag) ) ) ) \| \| | |
| ( IntraSubPartitionsSplitType != ISP_NO_SPLIT && ( subTuIndex | |
| NumIntraSubPartitions - 1) ) ) { | |
| tu_cbf_cb[ x0 ][ y0 ] | ae(v) |
| tu_cbf_cr[ x0 ][ y0 ] | ae(v) |
| } | |
| } | |
| if( treeType = SINGLE_TREE \| \| treeType = = | |
| DUAL_TREE_LUMA ) { | |
| if( ( IntraSubPartitionsSplitType = = ISP_NO_SPLIT | |
| && !( cu_sbt_flag && ( ( sub TuIndex == 0 && cu_sbt_pos_flag ) \| \| | |
| ( subTuIndex = = 1 && !cu_sbt_pos_flag ) ) ) && | |
| CuPredMode[ x0 ][ y0 ] = = MODE_INTRA \| \| tu_cbf_cb[ x0 ][ y0 | |
| ] \| \| tu_cbf_cr[ x0 ][ y0 ] \| \| CbWidth[ x0 ][ y0 ] > MaxTbSizeY \| \| CbHeight[ | |
| x0 ][ y0 ] > Max Tb Size Y | |
| \| \|( (IntraSubPartitionsSplitType != ISP_NO_SPLIT) | |
| && ( subTuIndex < NumIntraSubPartitions - 1 \| \| ! InferTuCbfLuma ) ) ) | |
| tu_cbf_luma[ x0 ][ y0 ] | ae(v) |
| ... | |
| } | |
| } | |
| ... | |
| } | |

As in an example of Table 25, tu_cbf_luma may be signaled based on tu_cbf_cb and tu_cbf_cr. Under an independent block partition structure, when the prediction mode of a luma component block is an intra block copy mode, tu_cbf_luma may not be signaled. Under an independent block partition structure, tu_cbf_cb and tu_cbf_cr may not be signaled for a luma component block (i.e., treeType is DUAL_TREE_LUMA), and tu_cbf_cb and tu_cbf_cr may be set as ‘0’ in an encoding/decoding process, respectively, when tu_cbf_luma is not signaled. In this case, according to the embodiment of Table 23, when both tu_cbf_cb and tu_cbf_cr are ‘0’, tu_cbf_luma may not be signaled. In this case, the value of tu_cbf_luma that is not signaled may be inferred to be the same as the value of cu_cbf.

As in an example of Tables 21 to 25, when a luma component block is predicted in an intra block copy mode under an independent block partition structure, the value of cu_cbf may be set as the value of tu_cbf luma without signaling tu_cbf_luma.

In Tables 21 to 25, IntraSubPartitionsSplitType may represent whether a corresponding block is predicted by being divided into sub-blocks when applying intra prediction. When a luma component block applies prediction using an intra block copy mode, a block is not encoded by being divided into sub-blocks, so IntraSubPartitionsSplitType may correspond to ISP NO SPLIT. In addition, cu_sbt_flag may represent whether to perform transform in a sub-block unit in case of inter prediction. When applying prediction using an intra block copy mode, transform in a sub-block unit may not be applied, so cu_sbt_flag may always have a value of 0 in case of an intra block copy mode.

According to an indicator tu_joint_cbcr_residual for a method for performing encoding/decoding by integrating the residual signal of chroma components (a Cb component and a Cr component), at least one of tu_cbf_cb and tu_cbf_cr may not be entropy encoded/decoded in a block (a transform block, a transform unit) where tu_joint_cbcr_residual corresponds to a second value (e.g., 1). In addition, at least one of tu_cbf_cb and tu_cbf_cr may be entropy encoded/decoded in a block (a transform block, a transform unit) where tu_joint_cbcr_residual corresponds to a first value (e.g., 0).

For example, when the residual signal of a specific component does not exist in a bitstream due to tu_joint_cbcr_residual, tu_cbf_cb or tu_cbf_cr for a corresponding component may not be entropy encoded/decoded in a block (a transform block, a transform unit) for a corresponding component.

Here, tu_joint_cbcr_residual may mean whether the residual signal of a Cb component is used to derive the residual signal of a Cb component and a Cr component.

For example, when tu_joint_cbcr_residual is a first value (e.g., 0), it may indicate that the residual signal of a Cr component exists in a bitstream according to another syntax element value, and when tu_joint_cbcr_residual is a second value (e.g., 1), it may indicate that the residual signal of a Cb component is used to derive the residual signal of a Cb component and a Cr component.

When tu_joint_cbcr_residual means that the residual signal of a Cb component is used to derive the residual signal of a Cb component and a Cr component, a Cr component may become the specific component and a residual signal for a Cr component may not exist in a bitstream. In this case, tu_cbf_cr may not be entropy encoded/decoded in a block (a transform block, a transform unit) for a Cr component.

In addition, tu_joint_cbcr_residual may mean that the residual signal of a Cr component is used to derive the residual signal of a Cb component and a Cr component.

For example, when tu_joint_cbcr_residual is a first value (e.g., 0), it may indicate that the residual signal of a Cr component exists in a bitstream according to another syntax element value, and when tu joint_cbcr_residual is a second value (e.g., 1), it may indicate that the residual signal of a Cr component is used to derive the residual signal of a Cb component and a Cr component.

When tu_joint_cbcr_residual means that the residual signal of a Cr component is used to derive the residual signal of a Cb component and a Cr component, a Cb component may become the specific component and a residual signal for a Cb component may not exist in a bitstream. In this case, tu_cbf_cb may not be entropy encoded/decoded in a block (a transform block, a transform unit) for a Cb component.

A detailed description of syntaxes proposed in the present disclosure is as follows.

amvr_flag

amvr_flag may mean whether to apply a method for determining the resolution of a block vector when a current block is an intra block copy mode.

When a current block is an intra block copy mode and the value of amvr_flag does not exist, the value of amvr_flag may be inferred to 1.

amvr_precision_flag

When a current block is an intra block copy mode and the value of amvr_precision_flag does not exist, the value of amvr_precision_flag may be inferred to 1.

amvr_precision_idx

When a current block is an intra block copy mode and the value of amvr_precision_idx does not exist, the value of amvr_precision_idx may be inferred to 1.

The value of amvr_precision_idx may have an integer value less than or equal to the value of max_amvr_precision_idx.

max_amvr_precision_idx

The value of max_amvr_precision_idx may be an integer greater than or equal to 0.

The value of max_amvr_precision_idx may be an integer less than or equal to 8.

When the value of max_amvr_precision_idx does not exist, the value of max_amvr_precision_idx may be inferred to a pre-defined value.

When the value of max_amvr_precision_idx does not exist, the value of max_amvr_precision_idx may be inferred to a value obtained by combining num_amvr_precisions and num_additional_amvr_precisions.

An embodiment below shows the value of amvr_precision_idx and an integer sample unit size corresponding thereto when a current block is an intra block copy mode.

In this case, the value of available amvr_precision_idx may be limited to a value from 0 to 3.

In this case, when the value of max_amvr_precision_idx does not exist, the value of max_amvr_precision_idx may be inferred to 3.

Table 26 illustrates the resolution of a block vector according to the value of amvr_precision_idx.

TABLE 26

| amvr_{—} | AMVR rounding shift |
|---|---|
| precision_{—} | CuPredMode[ chType ][ x0 ][ y0 ] = = |
| idx | MODE_IBC |
| 0 | 4 (1 luma sample) |
| 1 | 5 (2 luma samples) |
| 2 | 6 (4 luma samples) |
| 3 | 7 (8 luma samples) |

max_amvr_precision

The value of max_amvr_precision may be an integer greater than or equal to 0.

The value of max_amvr_precision may be an integer less than or equal to 128.

The value of max_amvr_precision may be an integer less than or equal to log (128).

When the value of max_amvr_precision does not exist, it may be inferred to a pre-defined value as in the embodiment.

When the value of max_amvr_precision exists, an integer sample unit size value applied to a corresponding block vector may be determined by the value of max_amvr_precision when the value of amvr_precision_idx is the same as the maximum value that amvr_precision_idx may have.

amvr_separate_prec_flag

amvr_separate_prec_flag may be a value indicating whether an integer sample unit size applied to the horizontal value and vertical value of a block vector is the same or different.

Here, when amvr_separate_prec_flag is 0, the same integer sample unit size may be applied to the horizontal direction and vertical direction of a block vector.

Here, when amvr_separate_prec_flag is 1, a different integer sample unit size may be applied to the horizontal direction and vertical direction of a block vector.

amvr_separate_prec_flag may be a value indicating any one of horizontal and vertical directions of a block vector as a reference direction.

Here, when amvr_separate_prec_flag is 0, the vertical direction of a block vector may be a reference direction.

Here, when amvr_separate_prec_flag is 0, the horizontal direction of a block vector may be a reference direction.

When amvr_separate_prec_flag does not exist, it may be inferred to 0.

amvr_separate_precision

amvr_separate_precision may be a value indicating a ratio between integer sample unit size values applied to the horizontal value and vertical value of a block vector.

The value of amvr_separate_precision may be an integer greater than or equal to 0.

If the value of the amvr_separate_prec_flag is 0, the value of amvr_separate_precision may be inferred to 0.

If the value of the amvr_separate_precision is a non-zero integer, the value of amvr_separate_prec_flag may be inferred to 1.

The value of amvr_separate_precision may be an integer less than or equal to 128.

The value of amvr_separate_precision may be an integer less than or equal to log (128).

When the value of amvr_separate_precision does not exist, the value of amvr_separate_precision may be inferred to 0.

Here, when the value of amvr_separate_precision is 0, the same integer sample unit size value may be applied to the horizontal direction and vertical direction of a block vector.

In using the value of amvr_separate_precision, any one of horizontal and vertical directions of a block vector may be determined as a reference direction.

In this case, for a non-zero amvr_separate_precision value, when a vertical direction is a reference direction, the horizontal value of a block vector may be inferred to 2^{(amvr_separate_precision)} times a vertical value.

In this case, for a non-zero amvr_separate_precision value, when a horizontal direction is a reference direction, the vertical value of a block vector may be inferred to 2^{(amvr_separate_precision)} times a vertical value.

The value of amvr_separate_precision may be an integer greater than or equal to −128 and less than or equal to 128.

If the value of the amvr_separate_prec_flag is 0, the value of amvr_separate_precision may be inferred to 0.

If the value of the amvr_separate_precision is a non-zero integer, the value of amvr_separate_prec_flag may be inferred to 1.

If the value of the amvr_separate_precision is a non-zero integer, the value of amvr_separate_prec_flag may be inferred to −1.

The value of amvr_separate_precision may be an integer greater than or equal to −log (128) and less than or equal to log (128).

num_amvr_precisions

num_amvr_precisions may mean the number of integer sample unit size values that may be applied to a block vector.

When the value of num_amvr_precisions does not exist, the value of num_amvr_precisions may be inferred to 0.

When the value of num_amvr_precisions does not exist, the value of num_amvr_precisions may be inferred to the number of predefined integer sample unit size values.

When the value of num_amvr_precisions does not exist, the value of num_amvr_precisions may be inferred to the value of max_amvr_precision_idx.

The value of num_amvr_precisions may be an integer greater than 0.

amvr_precisions[num_amvr_precisions]

amvr_precisions[num_amvr_precisions] may be a set of integer sample unit size values having the size of a non-zero num_amvr_precisions value.

When num_amvr_precisions is 0, amvr_precisions may be omitted.

When num_amvr_precisions is greater than 0, the element value of amvr_precisions[i] indicated by an integer i greater than or equal to 0 and less than num_amvr_precisions may be a block vector integer sample unit size or a sequence of its log values.

An amvr_precisions set may consist of integer sample unit size values of a block vector indicated by amvr_flag and/or amvr_precision_flag and/or amvr_precision_idx.

num_additional_amvr_precisions

num_additional_amvr_precisions may mean the number of integer sample unit size

values of a block vector that may be additionally used in addition to integer sample unit size values that may be applied to a block vector inferred by a pre-defined and/or num_amvr_precisions and/or amvr_precisions set.

When the value of num_additional_amvr_precisions does not exist, the value of num_additional_amvr_precisions may be inferred to 0.

The value of num_additional_amvr_precisions may be an integer greater than 0.

When the value of num_additional_amvr_precisions does not exist, the value of num_additional_amvr_precisions may be inferred to a difference value between the value of max_amvr_precision_idx and the value of max_amvr_precision_idx.

additional_amvr_precisions[num_additional_amvr_precisions]

additional_amvr_precisions[num_additional_amvr_precisions] may be a set of integer sample unit size values having a size of a non-zero num_additional_amvr_precisions value.

When num_additional_amvr_precisions is 0, additional_amvr_precisions may be omitted.

When num_additional_amvr_precisions is greater than 0, the element value of additional_amvr_precisions[i] indicated by an integer i greater than or equal to 0 and less than num_additional_amvr_precisions may be a block vector integer sample unit size or a sequence of its log values.

An additional_amvr_precisions set may consist of integer sample unit size values of a block vector indicated by amvr_flag and/or amvr_precision_flag and/or amvr_precision_idx.

At least one of the syntax elements for the intra block copy-related encoding information which is entropy encoded in the encoder and entropy decoded in the decoder may use at least one of the following binarization, debinarization and entropy encoding/decoding methods.
Signed 0-th order Exponential Golomb (Exp_Golomb) binarization/debinarization method (se(v))
Signed k-th order Exp_Golomb binarization/debinarization method (sek(v))
0-th order Exp_Golomb binarization/debinarization method for an unsigned positive integer (ue(v))
k-th order Exp_Golomb binarization/debinarization method for an unsigned positive integer (uek(v))
Fixed-length binarization/debinarization method (f(n))
Truncated Rice binarization/debinarization method or truncated unary binarization/debinarization method (tu(v))
Truncated binary binarization/debinarization method (tb(v))
Context-adaptive arithmetic encoding/decoding method (ae(v))
Bit string in bytes (b(8))
Signed integer binarization/debinarization method (i(n))
Unsigned positive integer binarization/debinarization method (u(n))
In this case, u(n) may mean a fixed-length binarization/debinarization method.

### Unary Binarization/Debinarization Method

When entropy encoding/decoding at least one of the intra block copy-related encoding information, a context model may be determined by using at least one of the intra block copy-related encoding information of a neighboring block or at least one of the previously encoded/decoded intra block copy-related encoding information or information on a current unit/block depth or information on a current unit/block size.

When entropy encoding/decoding at least one of the intra block copy-related encoding information, entropy encoding/decoding may be performed by using at least one of the intra block copy-related encoding information of a neighboring block or at least one of the previously encoded/decoded intra block copy-related encoding information or information on a current unit/block depth or information on a current unit/block size as a prediction value for at least one of the intra block copy-related encoding information.

Only any one of the embodiments is not applied to the encoding/decoding process of a current block, and a specific embodiment or at least one combination of the embodiments may be applied to the encoding/decoding process of a current block.

An available binarization method for entropy encoding/decoding of syntax elements for implementing the present invention may be performed as follows.

amvr_flag
Unary binarization (u(1))
   amvr_precision_flag
Unary binarization (u(1))
   amvr_precision_idx
Binarization and entropy encoding/decoding may be performed by using one of:
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary
binarization/debinarization method (tu(v)),
a truncated binary binarization/debinarization method (tb(v)) and
a context-adaptive arithmetic encoding/decoding method (ae(v)).
   max_amvr_precision_idx

Binarization and entropy encoding/decoding may be performed by using one of:
an unsigned positive integer binarization/debinarization method (u(n)),
the 0-th order Exp_Golomb binarization/debinarization method for an unsigned positive
integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   max_amvr_precision

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   amvr_separate_prec_flag
Unary binarization (u(1))
   amvr_separate_precision

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a signed 0-th order Exponential Golomb (Exp_Golomb) binarization/debinarization method (se(v)),
the k-th order Exp_Golomb binarization/debinarization method for an unsigned positive integer (uek(v)),
a signed k-th order Exp_Golomb binarization/debinarization method (sek(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   num_amvr_precisions

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   amvr_precisions[num_amvr_precisions]

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ac (v)).
   num_additional_amvr_precisions

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   additional_amvr_precisions [num_additional_amvr_precisions]

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).

In the embodiments, values used in the integer sample unit size of a block vector that may be applied to an intra block copy mode and/or syntaxes that may indicate an integer sample unit size and/or a series of processes deriving this may be an integer sample unit size value or a shift value applied in a rounding process for applying that integer sample unit size or the log (log 2) value of an integer sample unit size value.

The shift value may mean a left shift and/or right shift value.

The log value may mean a value calculated from a logarithmic function with a base of 2.

The integer sample unit size may mean the resolution of a block vector.

In the embodiments, the resolution of a block vector may be applied to the resolution of a block vector, the resolution of a block vector difference and/or the resolution of a block vector prediction value.

Each syntax element may be expressed as a bin string through a binarization process, and each bin of a bin string may be entropy encoded/decoded as a context bin and a bypass bin.

In performing entropy encoding/decoding by using context-adaptive binary arithmetic encoding, a bin to be encoded may be processed as a context bin or a bypass bin.

In the entropy encoding/decoding process of a context bin, a process of taking and updating the context of each bin may be applied.

In this case, a context may be probability information for entropy encoding/decoding the bin.

In the entropy encoding/decoding process of a bypass bin, the probability of each bin value 0 and 1 is fixed to ½.

In this case, in a bypass bin, the process of taking and updating a context may be omitted.

As a process of loading/updating a context is performed in order to perform entropy encoding/decoding, a context bin may have a limit in throughput.

However, since a bypass bin does not have the process of loading/updating a context, multiple bypass bins may be entropy encoded/decoded at once, improving the entropy encoding/decoding throughput compared to a context bin.

The syntax structure of the block vector difference (BVD) may be as in Table 27 below.

TABLE 27

| | Descriptor |
|---|---|
| bvd_coding( x0, y0, refList, cpIdx ) { | |
| abs_bvd_greater0_flag[ 0 ] | ae(v) |
| abs_bvd_greater0_flag[ 1 ] | ae(v) |
| if( abs_bvd_greater0_flag[ 0 ] ) | |
| abs_bvd_greater1_flag[ 0 ] | ae(v) |
| if( abs_bvd_greater0_flag[ 1 ]) | |
| abs_bvd_greater1_flag[ 1 ] | ae(v) |
| if( abs_bvd_greater0_flag[ 0 ] ) { | |
| if( abs_bvd_greater1_flag[ 0 ] ) | |
| abs_bvd_minus2[ 0 ] | ae(v) |
| bvd_sign_flag[ 0 ] | ae(v) |
| } | |
| if( abs_bvd_greater0_flag[ 1 ] ) { | |
| if( abs_bvd_greater1_flag[ 1 ]) | |
| abs_bvd_minus2 [ 1 ] | ae(v) |
| bvd_sign_flag[ 1 ] | ae(v) |
| } | |
| } | |

In the syntax structure, the meaning of each syntax element may be as follows.

abs_bvd_greater0_flag may mean whether the absolute value of an element in the horizontal or vertical direction of bvd encoded/decoded is greater than 0.

abs_bvd_greater1_flag may mean whether the absolute value of an element in the horizontal or vertical direction of bvd encoded/decoded is greater than 1.

If abs_bvd_greater1_flag does not exist, abs_bvd_greater1_flag may be considered as 0. abs_bvd_minus2 may mean a value that is smaller by 2 than the absolute value of an element in the horizontal or vertical direction of bvd encoded/decoded.

If the value of abs_bvd_minus2 does not exist, abs_bvd_minus2 may be considered as −1.

bvd_sign_flag may mean the sign of an element value in the horizontal or vertical direction of bvd encoded/decoded.

In this case, when the value of bvd_sign_flag is 0, an element value in the horizontal or vertical direction of bvd may be a value greater than 0.

In this case, when the value of bvd_sign_flag is 1, an element value in the horizontal or vertical direction of bvd may be a value smaller than 0.

If bvd_sign_flag does not exist, bvd_sign_flag may be considered as 0.

For the value of each syntax element of BVD information having the syntax structure, especially, BVD_x and BVD_y which are an element value in the horizontal or vertical direction of the BVD encoded/decoded may be determined as follows.

When abs_bvd_greater0_flag[0] is 0, BVD_x may be 0.

It may be determined as BVD_x=abs_bvd_greater0_flag[0]*(abs_bvd_minus2[0]+2)*(1−2*bvd_sign_flag[0]).

When abs_bvd_greater0_flag[1] is 0, BVD_y may be 0.

It may be determined as BVD_y=abs_bvd_greater0_flag[1]*(abs_bvd_minus2[1]+2)*(1−2*bvd_sign_flag[1]).

The syntax structure of the block vector difference (BVD) may be as follows.

The abs_bvd_greater0_flag syntax element may be entropy encoded/decoded as a context bean.

The abs_bvd_greater1_flag syntax element may be entropy encoded/decoded as a context bean.

The k-th order Exponential Golomb binarization method may be applied to the abs_bvd_minus2 syntax element.

The limited k-th order Exponential Golomb binarization method may be applied to the abs_bvd_minus2 syntax element.

All bins of a binarized bin string of the abs_bvd_minus2 syntax element may be entropy encoded/decoded as a bypass bin.

At least one bin of a binarized bin string of the abs_bvd_minus2 syntax element may be entropy encoded/decoded as a context bin.

Among the bin strings, positive integer N bins may be context-based binary arithmetic encoded. In this case, N may be 5.

Bypass encoding/decoding may be applied to the remaining bins excluding bins that are context-based binary arithmetic encoded among the bin strings.

The bvd_sign_flag syntax element may be entropy encoded/decoded as a bypass bin.

The bvd_sign_flag syntax element may be entropy encoded/decoded as a context bin.

The syntax structure of the block vector difference (BVD) may be as in Table 28 below.

TABLE 28

| | Descriptor |
|---|---|
| bvd_coding(x0, y0, ... ) { | |
| abs_bvd_greater0_flag[ 0 ] | ae(v) |
| abs_bvd_greater0_flag[ 1 ] | ae(v) |
| if( abs_bvd_greater0_flag[ 0 ] ) { | |
| abs_bvd_minus1[ 0 ] | ae(v) |
| bvd_sign_flag[ 0 ] | ae(v) |
| } | |
| if( abs_bvd_greater0_flag[ 1 ] ) { | |
| abs_bvd_minus1[ 1 ] | ae(v) |
| bvd_sign_flag[ 1 ] | ae(v) |
| } | |
| } | |

In the syntax structure, the meaning of each syntax element may be as follows.

abs_bvd_greater0_flag may mean whether the absolute value of an element in the horizontal or vertical direction of bvd encoded/decoded is greater than 0.

abs_bvd_minus1 may mean a value that is smaller by 1 than the absolute value of an element in the horizontal or vertical direction of bvd encoded/decoded.

If the value of abs_bvd_minus1 does not exist, abs_bvd_minus1 may be considered as 0.

bvd_sign_flag may mean the sign of an element value in the horizontal or vertical direction of bvd encoded/decoded.

In this case, when the value of bvd_sign_flag is 0, an element value in the horizontal or vertical direction of bvd may be a value greater than 0.

In this case, when the value of bvd_sign_flag is 1, an element value in the horizontal or vertical direction of bvd may be a value smaller than 0.

If bvd_sign_flag does not exist, bvd_sign_flag may be considered as 0.

For the value of each syntax element of BVD information having the syntax structure, especially, BVD_x and BVD_y which are an element value in the horizontal or vertical direction of the BVD encoded/decoded may be determined as follows.

When abs_bvd_greater0_flag[0] is 0, BVD_x may be 0.

It may be determined as BVD_x=abs_bvd_greater0_flag[0]*(abs_bvd_minus1[0]+1)*(1−2*bvd_sign_flag[0]).

When abs_bvd_greater0_flag[1] is 0, BVD_y may be 0.

It may be determined as BVD_y=abs_bvd_greater0_flag[1]*(abs_bvd_minus1[1]+1)*(1−2*bvd_sign_flag[1]).

The syntax structure of the block vector difference (BVD) may be as follows.

The abs_bvd_greater0_flag syntax element may be entropy encoded/decoded as a context bean.

The k-th order Exponential Golomb binarization method may be applied to the abs_bvd_minus1 syntax element.

The limited k-th order Exponential Golomb binarization method may be applied to the abs_bvd_minus1 syntax element.

All bins of a binarized bin string of the abs_bvd_minus1 syntax element may be entropy encoded/decoded as a bypass bin.

At least one bin of a binarized bin string of the abs_bvd_minus1 syntax element may be entropy encoded/decoded as a context bin.

Among the bin strings, positive integer N bins may be context-based binary arithmetic encoded. In this case, N may be 5.

Bypass encoding/decoding may be applied to the remaining bins excluding bins that are context-based binary arithmetic encoded among the bin strings.

The bvd_sign_flag syntax element may be entropy encoded/decoded as a bypass bin.

The bvd_sign_flag syntax element may be entropy encoded/decoded as a context bin.

The syntax structure of the block vector difference (BVD) may be as in Table 29 below.

TABLE 29

| | Descriptor |
|---|---|
| bvd_coding( x0, y0, refList, cpIdx ) { | |
| abs_bvd_greater0_flag[ 0 ] | ae(v) |
| abs_bvd_greater0_flag[ 1 ] | ae(v) |
| if( abs_bvd_greater0_flag[ 0 ] ) | |
| abs_bvd_greater1_flag[ 0 ] | ae(v) |
| if( abs_bvd_greater0_flag[ 1 ] ) | |
| abs_bvd_greater1_flag[ 1 ] | ae(v) |
| if( abs_bvd_greater0_flag[ 0 ] ) { | |
| if( abs_bvd_greater1_flag[ 0 ]) | |
| abs_bvd_minus2 [ 0 ] | ae(v) |
| } | |
| if( abs_bvd_greater0_flag[ 1 ] ) { | |
| if( abs_bvd_greater1_flag[ 1 ]) | |
| abs_bvd_minus2[ 1 ] | ae(v) |
| } | |
| if( abs_bvd_greater0_flag[ 0 ] ) { | |
| bvd_sign_flag[ 0 ] | ae(v) |
| } | |
| if( abs_bvd_greater0_flag[ 1 ] ) { | |
| bvd_sign_flag[ 1 ] | ae(v) |
| } | |

In the syntax structure, the meaning of each syntax element may be as follows.

abs_bvd_greater0_flag may mean whether the absolute value of an element in the horizontal or vertical direction of bvd encoded/decoded is greater than 0.

abs_bvd_greater1_flag may mean whether the absolute value of an element in the horizontal or vertical direction of bvd encoded/decoded is greater than 1.

If abs_bvd_greater1_flag does not exist, abs_bvd_greater1_flag may be considered as 0. abs_bvd_minus2 may mean a value that is smaller by 2 than the absolute value of an element in the horizontal or vertical direction of bvd encoded/decoded.

If the value of abs_bvd_minus2 does not exist, abs_bvd_minus2 may be considered as −1.

bvd_sign_flag may mean the sign of an element value in the horizontal or vertical direction of bvd encoded/decoded.

In this case, when the value of bvd_sign_flag is 0, an element value in the horizontal or vertical direction of bvd may be a value greater than 0.

In this case, when the value of bvd_sign_flag is 1, an element value in the horizontal or vertical direction of bvd may be a value smaller than 0.

If bvd_sign_flag does not exist, bvd_sign_flag may be considered as 0.

For the value of each syntax element of BVD information having the syntax structure, especially, BVD_x and BVD_y which are an element value in the horizontal or vertical direction of the BVD encoded/decoded may be determined as follows.

When abs_bvd_greater0_flag[0] is 0, BVD_x may be 0.

It may be determined as BVD_x=abs_bvd_greater0_flag[0]*(abs_bvd_minus2[0]+2)*(1−2*bvd_sign_flag[0]).

When abs_bvd_greater0_flag[1] is 0, BVD_y may be 0.

It may be determined as BVD_y=abs_bvd_greater0_flag[1]*(abs_bvd_minus2[1]+2)*(1−2*bvd_sign_flag[1]).

The syntax structure of the block vector difference (BVD) may be as follows.

The abs_bvd_greater0_flag syntax element may be entropy encoded/decoded as a context bean.

The abs_bvd_greater1_flag syntax element may be entropy encoded/decoded as a context bean.

The k-th order Exponential Golomb binarization method may be applied to the abs_bvd_minus2 syntax element.

The limited k-th order Exponential Golomb binarization method may be applied to the abs_bvd_minus2 syntax element.

All bins of a binarized bin string of the abs_bvd_minus2 syntax element may be entropy encoded/decoded as a bypass bin.

At least one bin of a binarized bin string of the abs_bvd_minus2 syntax element may be entropy encoded/decoded as a context bin.

Among the bin strings, positive integer N bins may be context-based binary arithmetic encoded. In this case, N may be 5.

Bypass encoding/decoding may be applied to the remaining bins excluding bins that are context-based binary arithmetic encoded among the bin strings.

The bvd_sign_flag syntax element may be entropy encoded/decoded as a bypass bin.

The bvd_sign_flag syntax element may be entropy encoded/decoded as a context bin.

The syntax structure of the block vector difference (BVD) may be as in Table 30 below.

TABLE 30

| | Descriptor |
|---|---|
| bvd_coding( x0, y0, refList, cpIdx ) { | |
| abs_bvd_greater0_idx | ae(v) |
| if( abs_bvd_greater0_flag[ 0 ] ) | |
| abs_bvd_greater1_flag[ 0 ] | ae(v) |
| if( abs_bvd_greater0_flag[ 1 ] ) | |
| abs_bvd_greater1_flag[ 1 ] | ae(v) |
| } | |
| if( abs_bvd_greater0_flag[ 0 ] ) { | |
| if( abs_bvd_greater1_flag[ 0 ] ) | |
| abs_bvd_minus2[ 0 ] | ae(v) |
| } | |
| if( abs_bvd_greater0_flag[ 1 ] ) { | |
| if( abs_bvd_greater1_flag[ 1 ]) | |
| abs_bvd_minus2[ 1 ] | ae(v) |
| } | |
| if( abs_bvd_greater0_flag[ 0 ] ) { | |
| bvd_sign_flag[ 0 ] | lae(v) |
| } | |
| if( abs_bvd_greater0_flag[ 1 ] ) { | |
| bvd_sign_flag[ 1 ] | lae(v) |
| } | |

The abs_bvd_greater0_idx may mean whether the x-element value and the y-element value of the block vector difference are a value greater than 0.

A corresponding index may be entropy encoded/decoded by pairing whether the x-element value and the y-element value of the block vector difference is a value greater than 0.

The value of abs_bvd_greater0_flag[0] and abs_bvd_greater0_flag[1] corresponding to the value of the abs_bvd_greater0_idx may be as in Table 31 below.

TABLE 31

| abs_bvd_{—} | abs_bvd_{—} | abs_bvd_{—} |
|---|---|---|
| greater0_idx | greater0_flag[ 0 ] | greater0_flag[ 1 ] |
| 0 | 0 | 0 |
| 1 | 0 | 1 |
| 2 | 1 | 0 |
| 3 | 1 | 1 |

A Truncated binary binarization method may be applied to the abs_bvd_greater0_idx. A unary binarization method may be applied to the abs_bvd_greater0_idx.

All bins of a binarized bin string of the abs_bvd_greater0_idx syntax element may be entropy encoded/decoded as a bypass bin.

At least one bin of a binarized bin string of the abs_bvd_greater0_idx syntax element may be entropy encoded/decoded as a context bin.

The syntax structure of the block vector difference (BVD) may be as follows.

In the syntax structure, the meaning of each syntax element may be as follows. abs_bvd_greater0_flag may mean whether the absolute value of an element in the horizontal or vertical direction of bvd encoded/decoded is greater than 0.

abs_bvd_greater1_flag may mean whether the absolute value of an element in the horizontal or vertical direction of bvd encoded/decoded is greater than 1.

If abs_bvd_greater1_flag does not exist, abs_bvd_greater1_flag may be considered as 0. abs_bvd_minus2 may mean a value that is smaller by 2 than the absolute value of an element in the horizontal or vertical direction of bvd encoded/decoded.

If the value of abs_bvd_minus2 does not exist, abs_bvd_minus2 may be considered as −1.

bvd_sign_flag may mean the sign of an element value in the horizontal or vertical direction of bvd encoded/decoded.

In this case, when the value of bvd_sign_flag is 0, an element value in the horizontal or vertical direction of bvd may be a value greater than 0.

In this case, when the value of bvd_sign_flag is 1, an element value in the horizontal or vertical direction of bvd may be a value smaller than 0.

If bvd_sign_flag does not exist, bvd_sign_flag may be considered as 0.

For the value of each syntax element of BVD information having the syntax structure, especially, BVD_x and BVD y which are an element value in the horizontal or vertical direction of the BVD encoded/decoded may be determined as follows.

When abs_bvd_greater0_flag[0] is 0, BVD_x may be 0.

It may be determined as BVD_x=abs_bvd_greater0_flag[0]*(abs_bvd_minus2[0]+2)*(1−2*bvd_sign_flag[0]).

When abs_bvd_greater0_flag[1] is 0, BVD_y may be 0.

It may be determined as BVD_y=abs_bvd_greater0_flag[1]*(abs_bvd_minus2[1]+2)*(1−2*bvd_sign_flag[1]).

The syntax structure of the block vector difference (BVD) may be as follows.

At least one bin of a binarized bin string of the abs_bvd_greater0_idx syntax element may be entropy encoded/decoded as a context bin.

A truncated binary binarization method may be applied to the abs_bvd_greater0_idx syntax element.

A unary binarization method may be applied to the abs_bvd_greater0_idx syntax element.

The abs_bvd_greater1_flag syntax element may be entropy encoded/decoded as a context bean.

The k-th order Exponential Golomb binarization method may be applied to the abs_bvd_minus2 syntax element.

The limited k-th order Exponential Golomb binarization method may be applied to the abs_bvd_minus2 syntax element.

All bins of a binarized bin string of the abs_bvd_minus2 syntax element may be entropy encoded/decoded as a bypass bin.

At least one bin of a binarized bin string of the abs_bvd_minus2 syntax element may be entropy encoded/decoded as a context bin.

Among the bin strings, positive integer N bins may be context-based binary arithmetic encoded. In this case, N may be 5.

Bypass encoding/decoding may be applied to the remaining bins excluding bins that are context-based binary arithmetic encoded among the bin strings.

The bvd_sign_flag syntax element may be entropy encoded/decoded as a bypass bin.

The bvd_sign_flag syntax element may be entropy encoded/decoded as a context bin.

The syntax structure of the block vector difference (BVD) may be as in Table 32 below.

TABLE 32

| | Descriptor |
|---|---|
| bvd_coding( x0, y0, ... ) { | |
| abs_bvd_greater0_flag[ 0 ] | ae(v) |
| abs_bvd_greater0_flag[ 1 ] | ae(v) |
| if( abs_bvd_greater0_flag[ 0 ] ) | |
| abs_bvd_minus1 [ 0 ] | ae(v) |
| if( abs_bvd_greater0_flag[ 1 ] ) | |
| abs_bvd_minus1[ 1 ] | ae(v) |
| if( abs_bvd_greater0_flag[ 0 ] ) | |
| bvd_sign_flag[ 0 ] | ae(v) |
| if( abs_bvd_greater0_flag[ 1 ]) | |
| bvd_sign_flag[ 1 ] | ae(v) |
| } | |

In the syntax structure, the meaning of each syntax element may be as follows. abs_bvd_greater0_flag may mean whether the absolute value of an element in the horizontal or vertical direction of bvd encoded/decoded is greater than 0.

abs_bvd_minus1 may mean a value that is smaller by 1 than the absolute value of an element in the horizontal or vertical direction of bvd encoded/decoded.

If the value of abs_bvd_minus1 does not exist, abs_bvd_minus1 may be considered as 0.

bvd_sign_flag may mean the sign of an element value in the horizontal or vertical direction of bvd encoded/decoded.

In this case, when the value of bvd_sign_flag is 0, an element value in the horizontal or vertical direction of bvd may be a value greater than 0.

In this case, when the value of bvd_sign_flag is 1, an element value in the horizontal or vertical direction of bvd may be a value smaller than 0.

If bvd_sign_flag does not exist, bvd_sign_flag may be considered as 0.

For the value of each syntax element of BVD information having the syntax structure, especially, BVD_x and BVD_y which are an element value in the horizontal or vertical direction of the BVD encoded/decoded may be determined as follows.

When abs_bvd_greater0_flag[0] is 0, BVD_x may be 0.

It may be determined as BVD_x=abs_bvd_greater0_flag[0]*(abs_bvd_minus1[0]+1)*(1−2*bvd_sign_flag[0]).

When abs_bvd_greater0_flag[1] is 0, BVD_y may be 0.

It may be determined as BVD_y=abs_bvd_greater0_flag[1]*(abs_bvd_minus1[1]+1)*(1−2*bvd_sign_flag[1]).

The syntax structure of the block vector difference (BVD) may be as follows.

The abs_bvd_greater0_flag syntax element may be entropy encoded/decoded as a context bean.

The k-th order Exponential Golomb binarization method may be applied to the abs_bvd_minus1 syntax element.

The limited k-th order Exponential Golomb binarization method may be applied to the abs_bvd_minus1 syntax element.

All bins of a binarized bin string of the abs_bvd_minus1 syntax element may be entropy encoded/decoded as a bypass bin.

At least one bin of a binarized bin string of the abs_bvd_minus1 syntax element may be entropy encoded/decoded as a context bin.

Among the bin strings, positive integer N bins may be context-based binary arithmetic encoded. In this case, N may be 5.

Bypass encoding/decoding may be applied to the remaining bins excluding bins that are context-based binary arithmetic encoded among the bin strings.

The bvd_sign_flag syntax element may be entropy encoded/decoded as a bypass bin.

The bvd_sign_flag syntax element may be entropy encoded/decoded as a context bin.

The syntax structure of the block vector difference (BVD) may be as in Table 33 below.

TABLE 33

| | Descriptor |
|---|---|
| bvd_coding( x0, y0, ... ) { | |
| abs_bvd_greater0_idx | ae(v) |
| if( abs_bvd_greater0_flag[ 0 ] ) | |
| abs_bvd_minus1 [ 0 ] | ae(v) |
| if( abs_bvd_greater0_flag[ 1 ] ) | |
| abs_bvd_minus1 [ 1 ] | ae(v) |
| if( abs_bvd_greater0_flag[ 0 ] ) | |
| bvd_sign_flag[ 0 ] | ae(v) |
| if( abs_bvd_greater0_flag[ 1 ] ) | |
| bvd_sign_flag[ 1 ] | ae(v) |
| } | |

The abs_bvd_greater0_idx may mean whether the x-element value and the y-element value of the block vector difference are a value greater than 0.

A corresponding index may be entropy encoded/decoded by pairing whether the x-element value and the y-element value of the block vector difference is a value greater than 0.

The value of abs_bvd_greater0_flag[0] and abs_bvd_greater0_flag[1] corresponding to the value of the abs_bvd_greater0_idx may be as in Table 34 below.

TABLE 34

| abs_bvd_{—} | abs_bvd_{—} | abs_bvd_{—} |
|---|---|---|
| greater0_idx | greater0_flag[ 0 ] | greater0_flag[ 1 ] |
| 0 | 0 | 0 |
| 1 | 0 | 1 |
| 2 | 1 | 0 |
| 3 | 1 | 1 |

A truncated binary binarization method may be applied to the abs_bvd_greater0_idx. A unary binarization method may be applied to the abs_bvd_greater0_idx.

All bins of a binarized bin string of the abs_bvd_greater0_idx syntax element may be entropy encoded/decoded as a bypass bin.

At least one bin of a binarized bin string of the abs_bvd_greater0_idx syntax element may be entropy encoded/decoded as a context bin.

The syntax structure of the block vector difference (BVD) may be as follows.

In the syntax structure, the meaning of each syntax element may be as follows.

abs_bvd_greater0_flag may mean whether the absolute value of an element in the horizontal or vertical direction of bvd encoded/decoded is greater than 0.

abs_bvd_minus1 may mean a value that is smaller by 1 than the absolute value of an element in the horizontal or vertical direction of bvd encoded/decoded.

If the value of abs_bvd_minus1 does not exist, abs_bvd_minus1 may be considered as 0. bvd_sign_flag may mean the sign of an element value in the horizontal or vertical direction of bvd encoded/decoded.

In this case, when the value of bvd_sign_flag is 0, an element value in the horizontal or vertical direction of bvd may be a value greater than 0.

In this case, when the value of bvd_sign_flag is 1, an element value in the horizontal or vertical direction of bvd may be a value smaller than 0.

If bvd_sign_flag does not exist, bvd_sign_flag may be considered as 0.

For the value of each syntax element of BVD information having the syntax structure, especially, BVD_x and BVD_y which are an element value in the horizontal or vertical direction of the BVD encoded/decoded may be determined as follows.

When abs_bvd_greater0_flag[0] is 0, BVD_x may be 0.

It may be determined as BVD_x=abs_bvd_greater0_flag[0]*(abs_bvd_minus1[0]+1)*(1−2*bvd_sign_flag[0]).

When abs_bvd_greater0_flag[1] is 0, BVD_y may be 0.

It may be determined as BVD_y=abs_bvd_greater0_flag[1]*(abs_bvd_minus1[1]+1)*(1−2*bvd_sign_flag[1]).

The syntax structure of the block vector difference (BVD) may be as follows.

At least one bin of a binarized bin string of the abs_bvd_greater0_idx syntax element may be entropy encoded/decoded as a context bin.

A truncated binary binarization method may be applied to the abs_bvd_greater0_idx syntax element.

A unary binarization method may be applied to the abs_bvd_greater0_idx syntax element.

The k-th order Exponential Golomb binarization method may be applied to the abs_bvd_minus1 syntax element.

The limited k-th order Exponential Golomb binarization method may be applied to the abs_bvd_minus1 syntax element.

All bins of a binarized bin string of the abs_bvd_minus1 syntax element may be entropy encoded/decoded as a bypass bin.

At least one bin of a binarized bin string of the abs_bvd_minus1 syntax element may be entropy encoded/decoded as a context bin.

Among the bin strings, positive integer N bins may be context-based binary arithmetic encoded. In this case, N may be 5.

Bypass encoding/decoding may be applied to the remaining bins excluding bins that are context-based binary arithmetic encoded among the bin strings.

The bvd_sign_flag syntax element may be entropy encoded/decoded as a bypass bin.

The bvd_sign_flag syntax element may be entropy encoded/decoded as a context bin.

At least one of the syntax elements for the intra block copy-related encoding information which is entropy encoded in the encoder and entropy decoded in the decoder may use at least one of the following binarization, debinarization and entropy encoding/decoding methods.
Signed 0-th order Exponential Golomb (Exp_Golomb) binarization/debinarization method (se(v))
Signed k-th order Exp_Golomb binarization/debinarization method (sek(v))
0-th order Exp_Golomb binarization/debinarization method for an unsigned positive integer (ue(v))
k-th order Exp_Golomb binarization/debinarization method for an unsigned positive integer (uek(v))
Fixed-length binarization/debinarization method (f(n))
Truncated Rice binarization/debinarization method or truncated unary binarization/debinarization method (tu(v))
Truncated binary binarization/debinarization method (tb(v))
Context-adaptive arithmetic encoding/decoding method (ae(v))
Bit string in bytes (b(8))
Signed integer binarization/debinarization method (i(n))
Unsigned positive integer binarization/debinarization method (u(n))

In this case, u(n) may mean a fixed-length binarization/debinarization method.

### Unary Binarization/Debinarization Method

When entropy encoding/decoding at least one of the intra block copy-related encoding information, a context model may be determined by using at least one of the intra block copy-related encoding information of a neighboring block or at least one of the previously encoded/decoded intra block copy-related encoding information or information on a current unit/block depth or information on a current unit/block size.

When entropy encoding/decoding at least one of the intra block copy-related encoding information, entropy encoding/decoding may be performed by using at least one of the intra block copy-related encoding information of a neighboring block or at least one of the previously encoded/decoded intra block copy-related encoding information or information on a current unit/block depth or information on a current unit/block size as a prediction value for at least one of the intra block copy-related encoding information.

Only any one of the embodiments is not applied to the encoding/decoding process of a current block, and a specific embodiment or at least one combination of the embodiments may be applied to the encoding/decoding process of a current block.

The embodiments may be performed by using the same/corresponding method by the encoding apparatus 1600 and by the decoding apparatus 1700. Also, the image may be encoded/decoded using at least one of the embodiments or at least one combination thereof.

The order of application of the embodiments may be different from each other by the encoding apparatus 1600 and the decoding apparatus 1700, and the order of application of the embodiments may be (at least partially) identical to each other by the encoding apparatus 1600 and the decoding apparatus 1700.

The embodiments may be performed for each of a luma signal and a chroma signal, and may be equally performed for the luma signal and the chroma signal.

The form of a block to which the embodiments are applied may have a square or non-square shape.

Whether at least one of the above-described embodiments is to be applied and/or

performed may be determined based on a condition related to the size of a block. In other words, at least one of the above-described embodiments may be applied and/or performed when the condition related to the size of a block is satisfied. The condition includes a minimum block size and a maximum block size. The block may be one of blocks described above in connection with the embodiments and the units described above in connection with the embodiments. The block to which the minimum block size is applied and the block to which the maximum block size is applied may be different from each other.

For example, when the block size is equal to or greater than the minimum block size and/or less than or equal to the maximum block size, the above-described embodiments may be applied and/or performed. When the block size is greater than the minimum block size and/or less than or equal to the maximum block size, the above-described embodiments may be applied and/or performed.

For example, the above-described embodiments may be applied only to the case where the block size is a predefined block size. The predefined block size may be 2×2, 4×4, 8×8, 16×16, 32×32, 64×64, or 128×128. The predefined block size may be (2*SIZEX)×(2*SIZEY). SIZEX may be one of integers of 1 or more. SIZEY may be one of integers of 1 or more.

For example, the above-described embodiments may be applied only to the case where the block size is equal to or greater than the minimum block size. The above-described embodiments may be applied only to the case where the block size is greater than the minimum block size. The minimum block size may be 2×2, 4×4, 8×8, 16×16, 32×32, 64×64, or 128×128. Alternatively, the minimum block size may be (2*SIZEMIN_X)×(2*SIZEMIN_Y). SIZEMIN_X may be one of integers of 1 or more. SIZEMIN_Y may be one of integers of 1 or more.

For example, the above-described embodiments may be applied only to the case where the block size is less than or equal to the maximum block size. The above-described embodiments may be applied only to the case where the block size is less than the maximum block size. The maximum block size may be 2×2, 4×4, 8×8, 16×16, 32×32, 64×64, or 128×128. Alternatively, the maximum block size may be (2*SIZEMAX_X)×(2*SIZEMAX_Y). SIZEMAX_X may be one of integers of 1 or more. SIZEMAX_Y may be one of integers of 1 or more.

For example, the above-described embodiments may be applied only to the case where the block size is equal to or greater than the minimum block size and is less than or equal to the maximum block size. The above-described embodiments may be applied only to the case where the block size is greater than the minimum block size and is less than or equal to the maximum block size. The above-described embodiments may be applied only to the case where the block size is equal to or greater than the minimum block size and is less than the maximum block size. The above-described embodiments may be applied only to the case where the block size is greater than the minimum block size and is less than the maximum block size.

In the above-described embodiments, the block size may be a horizontal size (width) or a vertical size (height) of a block. The block size may indicate both the horizontal size and the vertical size of the block. The block size may indicate the area of the block. Each of the area, minimum block size, and maximum block size may be one of integers equal to or greater than 1. In addition, the block size may be the result (or value) of a well-known equation using the horizontal size and the vertical size of the block, or the result (or value) of an equation in embodiments.

Further, in the embodiments, a first embodiment may be applied to a first size, and a second embodiment may be applied to a second size.

The embodiments may be applied depending on a temporal layer. In order to identify a temporal layer to which the embodiments are applicable, a separate identifier may be signaled, and the embodiments may be applied to the temporal layer specified by the corresponding identifier. Here, the identifier may be defined as the lowest (bottom) layer and/or the highest (top) layer to which the embodiments are applicable, and may be defined as being indicating a specific layer to which the embodiments are applied. Further, a fixed temporal layer to which the embodiments are applied may also be defined.

For example, the embodiments may be applied only to the case where the temporal layer of a target image is the lowermost layer. For example, the embodiments may be applied only to the case where the temporal layer identifier of a target image is equal to or greater than 1. For example, the embodiments may be applied only to the case where the temporal layer of a target image is the highest layer.

A slice type or a tile group type to which the embodiments to which the embodiments are applied may be defined, and the embodiments may be applied depending on the corresponding slice type or tile group type.

In the above-described embodiments, it may be construed that, during the application of specific processing to a specific target, assuming that specified conditions may be required and the specific processing is performed under a specific determination, a specific coding parameter may be replaced with an additional coding parameter when a description has been made such that whether the specified conditions are satisfied is determined based on the specific coding parameter, or such that the specific determination is made based on the specific coding parameter. In other words, it may be considered that a coding parameter that influences the specific condition or the specific determination is merely exemplary, and it may be understood that, in addition to the specific coding parameter, a combination of one or more additional coding parameters functions as the specific coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include examples in various aspects. Although all possible combinations for indicating various aspects cannot be described, those skilled in the art will appreciate that other combinations are possible in addition to explicitly described combinations. Therefore, it should be understood that the present disclosure includes other replacements, changes, and modifications belonging to the scope of the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

A computer-readable storage medium may include information used in the embodiments of the present disclosure. For example, the computer-readable storage medium may include a bitstream, and the bitstream may contain the information described above in the embodiments of the present disclosure.

A bitstream may include a computer-executable code and/or program. A computer-executable code and/or program may include information described in embodiments and may include syntax elements described in embodiments. In other words, information and syntax elements described in embodiments may be considered as a computer-executable code within a bitstream and may be considered as at least a part of a computer-executable code and/or program expressed in a bitstream. The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

1. A method of decoding an image, the method comprising:
configuring a block vector candidate list of a current block;
deriving a block vector of the current block based on the block vector candidate list; and
deriving a prediction block of the current block based on the block vector,
wherein the block vector is obtained by improving a prediction block vector derived from a block vector candidate included in the block vector candidate list.

2. The method of claim 1, wherein:
the block vector is obtained by searching for a reference template having a lowest template matching cost and a current template adjacent to the current block in a search range including a search start position indicated by the prediction block vector in a current picture.

3. The method of claim 2, wherein:
a shape of the search range is determined based on index information indicating one of shape candidates,
a first shape candidate among the shape candidates is a rectangular shape, and a second shape candidate is a rhombus shape.

4. The method of claim 2, wherein:
when at least a part of a region to be set as the search range overlaps with the current block, a residual region excluding a region overlapping with the current block is set as the search range.

5. The method of claim 2, wherein:
searching for a reference template having the lowest matching cost includes searching for a template matching cost for first candidate positions spaced apart by a first pixel from the search start position.

6. The method of claim 5, wherein:
searching for the reference template having the lowest matching cost further includes searching for the template matching cost for second candidate positions spaced apart by a second pixel from a first candidate position having a smallest template matching cost among the first candidate positions,
the second pixel is smaller than the first pixel.

7. The method of claim 5, wherein:
a size of the first pixel is adaptively determined according to a block vector resolution of the current block.

8. The method of claim 7, wherein:
the block vector resolution is selected among a plurality of block vector resolution candidates,
a first block vector resolution candidate among the plurality of block vector resolution candidates is a fractional pixel unit, and a second block vector resolution candidate is an integer pixel unit.

9. The method of claim 7, wherein:
the size of the first pixel has a value equal to or greater than a pixel unit indicated by the block vector resolution.

10. The method of claim 1, wherein:
the block vector is derived by adding an offset vector to the prediction block vector in a current picture,
the offset vector is derived based on a size index indicating one of size candidates of the offset vector and a direction index indicating one of direction candidates of the offset vector.

11. A method of encoding an image, the method comprising:
configuring a block vector candidate list of a current block;
deriving a block vector of the current block based on the block vector candidate list; and
deriving a prediction block of the current block based on the block vector,
wherein the block vector is obtained by improving a prediction block vector derived from a block vector candidate included in the block vector candidate list.

12. The method of claim 11, wherein:
the block vector is obtained by searching for a reference template having a lowest template matching cost and a current template adjacent to the current block in a search range including a search start position indicated by the prediction block vector in a current picture.

13. The method of claim 12, wherein:
a shape of the search range is determined based on index information indicating one of shape candidates,
a first shape candidate among the shape candidates is a rectangular shape, and a second shape candidate is a rhombus shape.

14. The method of claim 12, wherein:
when at least a part of a region to be set as the search range overlaps with the current block, a residual region excluding a region overlapping with the current block is set as the search range.

15. The method of claim 12, wherein:
searching for a reference template having the lowest matching cost includes searching for a template matching cost for first candidate positions spaced apart by a first pixel from the search start position.

16. The method of claim 15, wherein:
searching for the reference template having the lowest matching cost further includes searching for the template matching cost for second candidate positions spaced apart by a second pixel from a first candidate position having a smallest template matching cost among the first candidate positions,
the second pixel is smaller than the first pixel.

17. The method of claim 15, wherein:
a size of the first pixel is adaptively determined according to a block vector resolution of the current block.

18. The method of claim 17, wherein:
the block vector resolution is selected among a plurality of block vector resolution candidates,
a first block vector resolution candidate among the plurality of block vector resolution candidates is a fractional pixel unit, and a second block vector resolution candidate is an integer pixel unit.

19. The method of claim 17, wherein:
the size of the first pixel has a value equal to or greater than a pixel unit indicated by the block vector resolution.

20. A recording medium storing a bitstream generated by an image encoding method, the recording medium comprising:
configuring a block vector candidate list of a current block;
deriving a block vector of the current block based on the block vector candidate list; and
deriving a prediction block of the current block based on the block vector,
wherein the block vector is obtained by improving a prediction block vector derived from a block vector candidate included in the block vector candidate list.
